(19) United States
(12) Patent Application Publication
(10) Pub. No.: US 2006/0206246 A1
(43) Pub. Date: Sep. 14, 2006

(54) Second national / international management and security system for responsible global resourcing through technical management to brige cultural and economic desparity

(76) Inventor: Richard Clark Walker, Waldorf, MD (US)

Correspondence Address: Richard Walker, 15000 Hunters Harbor Lane, Waldorf, MD, 20601, US

(21) Appl. No.: 11/259,201

(22) Filed: Oct. 27, 2005

Related U.S. Application Data
(60) Provisional application No. 60/651,974, filed on Feb. 14, 2005.
(60) Provisional application No. 60/622,709, filed on Oct. 28, 2004.

(51) Int. Cl. G06G 7/70

(52) U.S. Cl. 701/16; 340/961; 701/3

(57) ABSTRACT

This invention is a societal management and security system to aid the United States and world populous in discovering a secure and civil way to move from a finite economy of fossil fuels that is causing today's future shock, cultural encroachment and tension; to a technically and economically expansive co-existence available through alternative fueling with new and diversified technologies, which can reduce today's cultural tensions worldwide. Societies can fairly voice concerns and accurately monitor, evaluate, manage and control the impact of equipment, technology and technology policy on the earth's environment, its societies, cultures and infrastructures. The invention can help humanity frame the issues locally, regionally, nationally and globally to answer the relevant questions and maintain a healthy, stable, civil and respectful co-existence, together. A free existence with positive security and public safety that is complete, cohesive and fair but, still separate nationally. The development of the invention will grow global economies and make them more robust compatible and stable, by accurately identifying and meeting real needs and presenting them as new commercial opportunities designed to cause less disruption and limit waste. The inventions electronic messaging, transactions, sensing and controls can improve and make every facet of life safer and more enjoyable, but none more than, providing critical awareness of how to make that safe, respectful and inclusive life together. It has been said; that “humans are hardwired for self preservation and to be social at the same time”. Now is the time for humanity to use technology in a socially sound manner. And, its time for the greatest human development and best chance to survive. Its time to development of our “Social Self” through Critically Awareness.

### RELATED APPLICATIONS

This application claims priority to from U.S. Provisional Patent 60/651,974 filed Feb. 14, 2005 which claims priority from U.S. Provisional Patent 60/622,709 filed on Oct. 28, 2004 which claims priority from U.S. patent application Ser. No. 10/975,109 filed Oct. 28,2004 which claims priority from U.S. Provisional Patent Application No. 60/514,833 filed on Oct. 28 2003; 60/421.572, filed Sep. 22, 2003; Oct. 28, 2002, filed incorporated herein.

This application also claims priority from U.S. Provisional Patent Application No. 60/363,950, filed Mar. 14, 2002, incorporated herein.

This application also claims priority from and/or is related to U.S. Provisional Application Nos. 60/325,538, filed Oct. 1, 2001; 60/330,088, filed Oct. 19, 2000; 60/200,872, filed May 1, 2000; 60/176,818, filed Jan. 19, 2000; 60/139,759, filed Jun. 15, 1999; 60/140,029, filed Jun. 18, 1998, 60/032,217 filed on Dec. 2, 1996, all of which are hereby incorporated by reference.

This application also claims priority from and/or is related to U.S. patent application Ser. No. 08/975,140, filed Nov. 20, 1997; Ser. No. 09/357,373, filed Jul. 20, 1999; Ser. No. 09/738,901, filed Dec. 18, 2000; Ser. No. 09/914,299, filed Jan. 14, 2002; Ser. No. 10/018,095, filed Dec. 14, 2001; Ser. No. 10/260,525, filed Oct. 1, 2002 and International Patent Application No. PCT/US97/21516, filed on Nov. 24, 1997; all of which are hereby incorporated by reference.

### BACKGROUND OF THE INVENTION

1. Field of the Invention

Even after 911, today computer networks are disparate between government agencies, and commercial IT networks as far as providing public safety and national security data to Homeland Security. Much of this disparity is because intelligence agencies and law enforcement are protecting their funded purviews as rigorously as they are trying to identify terrorism domestically. The best way to keep individual sovereignty, integrity and cooperation between these agencies, institutions and commercial entities is to gather data first hand and disperse it immediately from local sources like the PFN relay nodes in this invention to the various special intranets and private interests to process, then re-merge harvested data with the raw data at agreed upon higher levels for homeland security through IT connections, with the use of the Internet for commercial intranets inputs and alerts. The following describes how this is accomplished by the invention The PFN/TRAC movement management system and Federal Access Control Technology, FACT security controls for homeland security.

2. Terminology of the Invention

The following are basic terms:
The PFN is a Protected Primary Focal Node:
It is a local protected accountable box on vehicles and or equipment that is both a controller and wireless relay station.
The PFN process or controller is named TRAC:
Because it is a Trusted Remote Activity Controller that performs and records the robotics and remote control activities of the equipment they are interfaced with.
FACT stands for Federal Access Control Technology.
PS1 Sensors are wireless commercial sensor arrays
HS1 Sensors are wireless Homeland Security sensor arrays

PS1 and HS1 Sensors are used together by repeating PFNS throughout all the data bases whether they are reporting to government or privately owned IT intranets. This allows for first hand data in real-time to be available to all stake holders in case of a public safety or national security threat, also referred to as a FACT event. This includes first responders, state and national backup and command centers, and any affected industry. PFNS also provide the latest in public notifications to an affected area from all of the above through vehicle and equipment radios they control. And they offer immediate equipment robotics and remote control to first responders of all the local equipment interfaced with a PFN.

In one aspect the invention is a movement management technology or smart material handling network. This aspect allows for the constant monitoring of products materials and personnel through out the country and through out the world. The flexible web allows for the freedom of movement so crucial to the US economy and provides for flexible boarder control up to the nations boarders and throughout the country. It is continual, vigilant and responsible security because it is designed and the technology has been taught to function within The United States Constitutional guidelines and is always open for review by all stakeholders.

It is built on wireless communication controllers called PFNS. These Primary Focal Nodes, PFNS control the machine they are interfaced with and they are powered by the machines electrical system. The PFN serves as a protected relay station for wireless sensor arrays, like the PS1 and HS1, as well as a relay station for other wireless transmissions. The PS1 and HS1 sensor arrays are commercial (PSI) and Homeland Security (HS1) sensing or data return device.

To project the extent of the system, visualize every vehicle and piece of equipment as a mini relay station that receives Alert signals and data from millions of wireless sensors and then retransmits their weak signals or data to preprogrammed emergency addresses or commercial electronic addresses for the normal tracking of product materials and people. Additionally, visualize that every vehicle or equipment can be controlled by the appropriate 911 and first responders, as well as local and national Homeland Security command and control centers. And all is accomplished through each individual PFN node attached to every piece of equipment. This provides the ultimate security in controlling movement in the event of a national emergency with the least amount of human beings at risk.

Another aspect of The PFN/TRAC System was invented to integrate machines, industries, and a nation's populous into a more closely knit financial fabric of fair management in utilizing global resources and protecting the environment to better achieve stable and healthy life cycles for human beings, both physically and emotionally. Over an eight year period fourteen basic patent applications have been written to teach how to construct and develop this new economic tool based on the PFN/TRAC System, and to help the United States plan appropriately for employment levels, health and human services along with national security, while safe guarding the environment and replacing fossil fuels with alternative forms of reusable energy. The fix, this Invention involves the replacement of the fuel tax with monitoring technology that revenues work performed by alternative powered equipment fairly to support the nations infrastructure (highway system etc.).

Envision every piece of equipment reporting where it is to state and federal DOT impact computers, and driver/owners paying an impact fee for their use of the highway via electronic payment. A transaction that is immediate, reviewable and accountable to all parties. Now there is a means for the US to get off the fuel tax as a financial narcotic for supporting the national highway system. The invention is a most necessary economic tool to replace this nation's dependence on oil, and one of the main reasons the PFN was designed originally as a vehicle controller.

The invention has been to develop an accountable communication and control link via local and national reporting and recording of data while providing real-time controls over the movement and use of machines and equipment and to control the unauthorized use of equipment for economic, environmental, public safety and or national security reasons. This was the objective of this invention long before 911 and if in place as a information and controlled security system much of the world tension that caused the 911 event could have been recognized, and dealt with in any number of preemptive ways and all requiring far less violence.

A point of consideration for this application is that the invention is made of numerous innovations all of which have been reviewed separately and granted patents or are patent pending. In this application, they are not simply stated as related technology but have been included into the application as part of the specification to support the inclusive; socioeconomic, environmental, commercial, public service and national security claim for this electronic linking of industry to relevant federal agencies, domestic commercial and privately owned equipment to relevant federal agencies, state and local government services, agencies and equipment to relevant federal agencies, departments and branches of the federal government via wireless communications, information technologies and Telematics as the invention, and or part of The PFN/TRAC movement management system and Federal Access Control Technology FACT Security network, which is an economic tool and security system to safely expand the economy and relieve the confines of limited wealth bound solely by the available reserves of fossil fuels and market instruments; ( What it will bare?)

The essential recognition of this invention as an economic tool, movement management system and proactive security control system is necessary to commercialize the invention and keep the United States freedom of movement and commerce in place for economic tranquility. Then and only then can the United States gain world respect for it's position and practice of democracy and human rights. When it is not based on another country's natural resources, which we sheepishly call American interests, and when that interest is not throttled with private profiteering from both American and foreign thugs. That's when the United States grows from a super power to a world leader and that's when it will be able to enjoy it's greatest state of national security.

The development of the invention will serve to employ many in this nation and around the world. The country and international community would do well to embrace the technology and work together to develop it and interface it globally so that critical data can be gathered processed and the world community can name and frame the issues to build trust in working them out. This is a necessary social foot print for an expanding economy. And an expanding economy provides a better quality of life for more and more people, if environmentally warranted. The invention also provides the data to have insight in seeing limits on resources if there are any and the negative impacts from improper use of a technology. This kind of information can help global societies to adjust fairly, and help individuals make critical decisions regarding when to reproduce, and how many times as a responsible member of humanity, a most necessary individual maturity for humanity to have a peaceful existence and life together (God's, Ale's, Abraham's, Buda's', and whomever's thinking, . . . will).

Conversely, a limited economy based on a finite resource like oil, has to be horded to assure security. Therefore, limited and greedy minds feel someone has to win and therefore another must lose to guarantee personal supply and or personal wealth. These short sighted and emotionally scared individuals, lack the courage to plan and be with others and make a life with them. They rationalize war to hoard a resource and wealth and then give thanks to God for blessing them with the resource and wealth taken by force as now willed by God or a higher Deity. Then with a pampas self righteous claim over another's resources they commit the greatest crime against their ideology by forcing the expansion of that etiology like democracy through preemptive violent force. This ignorant attitude and behavior has done a greater disservice to a democratic way of life, then their limited minds can ever grasp.

The present presidor of the United States and his unilateral collation into Iraq, which is destine next through private interest to attack Iran and then on to the east coast of Africa is driven by personal gain and the gain of all like minded and national economies that see their future only with the use oil and those who control that market, whether desired or without option.

With much of the sweet oil in middle-eastern Muslim countries like Saudi Arabia, this single mined energy policy has created a present day Holy Grail out of the conquest for oil, and the tension between the Christian-Judea wealth and powerful elite and the impoverished Muslims as a present day crusade. Additionally, it is an insult to democracies everywhere to force an etiology like democracy on a people who culturally and religiously believe in a different social way to make a life together. There is no way an individual citizen in the United States would tolerate this being done to them. It shows ignorance and gull beyond belief, that any legitimate United States leader would have ever attempt such an act. An act doomed to fail in conflict. It shows no respect for individual free choice, something so dear in the lesson of democracy. It has been a true global abortion by the close minded who claim to fight for life with Godly direction when they stubbornly exercise self centered ignorance to support their personal greed and unfair advantages in life.

This invention can secure the United States and free it from its present oil addiction as well as, preserve and promote the general quality of life here and abroad. The invention was created to integrate new energy alternatives with fossil fuels so as to maintain social economic stability. From the inception of the invention it was planned to manage the peaceful co-utilization of all energy technologies to serve an expanding economy, while providing a diverse environment for different cultures and religious beliefs to thrive and exist. This is the way the United States needs to lead, with its democratic values and not by being just a super power fueled by oil and mentally deficient personal morals.

### SUMMARY OF THE INVENTION

The invention is a movement management technology and a smart material handling network. It consists of wireless communication controllers called PFNS or Primary Focal Nodes that can control the machines they are interfaced with and they are powered by the machines electrical system. The PFN nodes are also protected relay stations for wireless sensor arrays termed PS1 and HS1, as well as relay stations for other wireless transmissions. The inventions components allow for local national and global sensing and monitoring, real time routing of critical data, and local and national remote control of the prime moving equipment transporting any sensed national security threat.

To know the extent of the system visualize every vehicle and piece of equipment as a mini relay station that receives Alert signals and data and then retransmits those signals or data to preprogrammed emergency addresses or commercial electronic addresses. Additionally, visualize that every vehicle or equipment can be controlled by the appropriate 911 and first responders, and local and national Homeland Security command and control centers. And all is accomplished through each individual PFN node attached to every piece of equipment.

With so many PFNS linked from private vehicles, commercial vehicles, industrial machinery and government equipment the movement management system becomes one great sensing web that flexibly covers the nation and allows the nation's populous to freely travel while constantly maintaining vigilant surveillance for public safety hazards and national security threats.

The PFNS also serve as local wireless terminals and connection points to access the internet web via wireless gateways, which include an early warning system globally if employed to announce catastrophic events via GPS location activation to areas not yet reached by adequate public communications.

Prior filings contained all the related writings as part of the current specification, to teach the entire invention in a handy text for nations, companies and global organizations. However, do to the increased cost per specification volume in the United States each figure representing a portion of the entire specification/teaching will contain only a condensed version to guide a reader and those skilled in the art to the previous filings for more detailed instruction and data concerning the full development of the invention.

### BRIEF DESCRIPTION OF THE DRAWINGS

FIG. 1

Shows the first commercialization of the Primary Focal Node or PFN, which began in 1995 as a portable protected multi wireless interface platform in the form of a stop and control box for vehicles and equipment.

The Patent or full technology and teachings are provided here as Appendix I

FIG. 2

Summarizes the second patent application filed in 1997 which further developed the wireless equipment controller platform as a protected primary focal node powered by everyday equipment and provides data back on the environment and economy to include the electronic payment industry.

The full technology and teachings are provided here as Appendix II

FIG. 3

This figure introduces the second patent and 3^{rd} progressive filing of the PFN system. It teaches the PFN interface to OEM manufacturer's Electrical E/E systems, their control modules and all the actuators to control vehicles and equipment

The full technology is provided in Appendix III

FIG. 4

Details out the protective encasement for the PFN or any controller responsible for shared equipment control

FIG. 5

This diagram covers all the surface vehicles and the types of actuators that are employed to control them. More are covered in Appendix III and the other appendices

FIG. 6

Discusses military policing applications and introduces the PFN processor the Trusted Remote Activity Controller as a control component that can be incorporated into vehicles and equipment and serve in hostile areas rather than placing American men and women in harms way.

This application was filed in 1998 as a way to help the United State fulfill the greater policing role it's military was being asked to perform and introduces Appendix IV

FIG. 7

Shows all the management and security domains in which the invention can interface and connect.

This Figure introduces Appendix V

FIG. 8

Is a home equipment and appliance controller that can interface into a residential PFN/TRAC System with FACT Security

FIG. 9

This figure develops the PFN/TRAC system as a data mining technology locally, regionally, nationally and globally.

This figure introduces Appendix VI

FIG. 10

This figure discusses RF scanning, translating, routing and relaying that is performed by the PFN node on all the pieces of equipment.

FIG. 11

The figure shows and teaches Aviation robotics and remote control through the use of the PFN/TRAC System supporting FACT Control

This figure introduce Appendix VII

FIG. 12

FIG. 12 is a TRAC ASIC processor configuration for air craft

FIG. 13

FIG. 13 is a TRAC ASIC processor configuration for surface equipment

FIG. 14

Is the further development of terrestrial PFNs

FIG. 15

Details the actuators and FACT control mobility devices to control virtually every transportation platform.

FIG. 16

This figure illustrates the multiple FACT computer display at an Airport as an example and it introduces Appendix VIII

FIG. 17

Shows the PFN components working in a port.

FIG. 18

Details the wireless self powered commercial sensor PS1 and it's homeland security counter part the HS1

FIG. 19

Nineteen discusses the FACT Sensing web at a port and introduce appendix IX

FIG. 20

FACT set of Transportation and equipment networks for homeland security

FIG. 21

PFN/TRAC and FACT IT processing using the various commercial telecommunication clouds/networks to repeat the wireless alert signals throughout the network and directly to the first responders. An all as a more efficient IT service for regular business.

FIG. 22

Is a homeland security application to solve the threat from a container shipment.

FIG. 23

Shows the PFN/TRAC System with FACT as it was envisioned in 99 an 2000 long before 911

FIG. 24

Details of a Commercial PFN/TRAC machine control and security system introduces Appendix X

FIG. 25

The PFN/TRAC Management System

FIG. 26

The basic software design for the government registries

FIG. 27

The general flow of information and control for the FACT Registry System

FIG. 28

Is an other software application for the FACT Registries

FIG. 29

Shows the responsive IT tree for homeland security to quickly have information on all pieces of equipment and vehicles and physical control over their use in real time.

FIG. 30

Details out the FACT interface components to allow for vehicle and equipment tracking through the registry and various public and private networks.

FIG. 31

Details out the Ghost Circuit to better track and control stolen or lost electronic equipment

FIG. 32

Is a hypothetical military Application of locate and control technology

FIG. 33

Simple illustration of electronic controlled mobility of the technology

FIG. 34

Another military example of using controlled mobility wireless to safe guard vehicle during global transport

FIG. 35

An application of the portable sensing web the invention supports

FIGS. 36-41

Are 5 slides from a 12 slide presentation given to Maru Benni and Symbol detailing the interface capacity of the PFN/TRAC System (Architecture).

### DETAILED DESCRIPTION OF THE DRAWINGS

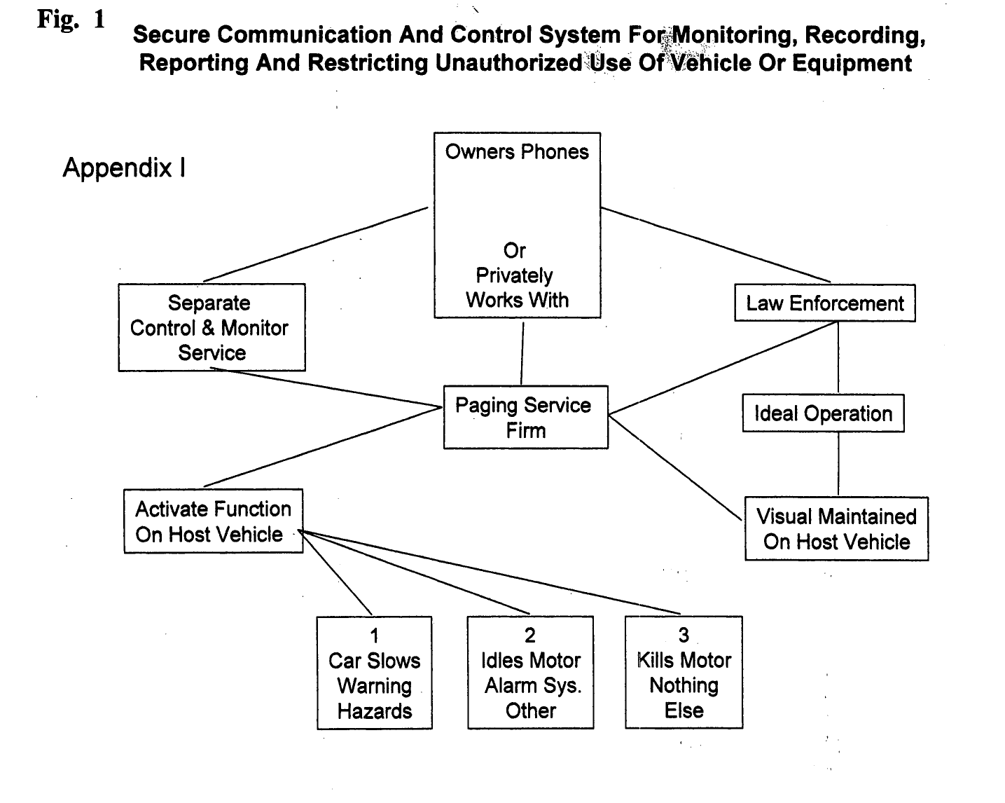

FIG. 1

In 1995-96 this diagram was created for the first U.S. Pat. No. 6,157,317. This was a stop and secure box technology and the first secure telematics node for a vehicle or piece of equipment. This application focuses on paging and wireless telephony to receive Alert Signals and transmit Control signal with a piece of equipment and back to a local monitoring and control service, law enforcement, or the private owner, who could have control capacity in the first generation. The preliminary device to control the unauthorized use of equipment was developed further in additional patents and patent applications to serve society further than just public safety on the highways and commercial monitoring. It has been designed progressively to include environmental sensing, movement management, electronic messaging, electronic payment technology, public safety and national security.

This drawing serves to introduce the first patent's teachings. The complete patent is presented in Appendix “I” and incorporated into this specification for the purpose of advancing a national and global movement management, material handling economic tool and national security system. The PFN/TRAC System with FACT Security, to monitor and deliver voice and data in a fair and just manner to all stakeholders simultaneously as a general rule. And provide authorities with the capacity to positively interdict the unauthorized and or un safe use of vehicles and equipment, when endangering public safety and national security. The PFN/TRAC System with Federal Access Control Technology or FACT Security incorporates the integration of all the disparate and or privately owned and operated databases with any respective governing data base of which a complete and detailed set of specifications are presented Additionally, this application has accompanying appendices of prior patents and patents pending which are application specific innovations tied together to support a unique set of claims to commercialize the total management and security process in keeping with the US and world economy in a constitutional manner.

The specifics of FIG. 1 and this technology are covered in depth in Appendix “A” however basically what is shown is a secure physically protected transceiving telematics unit which is represented by the box worded Activate Function On Host Machine in the lower left hand corner. The three lower boxes in the figure display a three phase shutdown process of a vehicle, however it could be any piece of equipment. These phases can be performed from individual remote control command signals or as an automated sequence preprogrammed for a unique signal to activate. The designed incorporated a slow stop and secure sequence where control was left for steering, however with each application of the brake, speed was reduced and the RPMS could not be increased until engine idle would slow the car down to a near stop and then the brakes would apply. Later patens employ a guidance package as well in U.S. Pat. No. 6,647,328 B2 & Second Divisional 10/654992.

As displayed in the top center box The original design provided the owner the capacity to phone the pager company center box directly to activate the functions, however this was never recommended nor commercialized for obvious safety reasons especially for highway vehicles. It has always been presented with law enforcement participation and professionals having visual and electronic monitoring to control deployment of the functions.

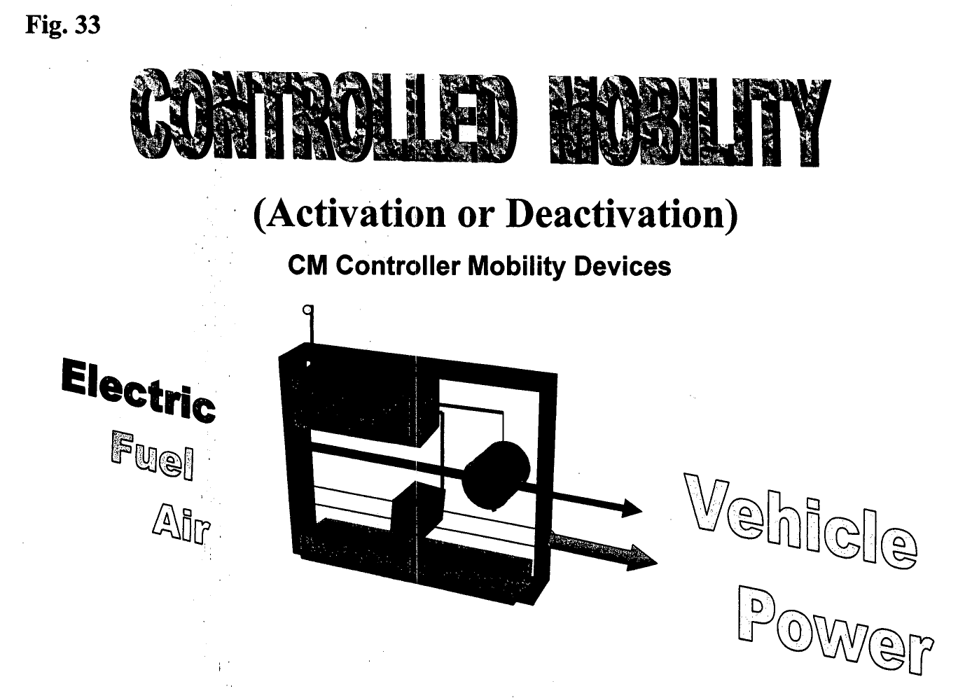

What is important to understand is that from this first patent of a protected stop and control box there has been a bases for a protected telematics or node connected and interfaced with a vehicle or machine's electrical system so as to control the unauthorized use and or unsafe use of that equipment via the responsibility of a public safety act. This technology has been patented in other nations and pursued there and with the military more vigorously that in the US automotive markets. An application of this technology is shown simply in FIG. 33 in a military application of Controlled Mobility. To insure that the enemy can not use or steal US material/equipment.

The 10 Appendices are provided not just as Related Technology but as a series of progressive industry steps for the nation to take to really provide technology to homeland security and to reduce the US dependency on oil and the fossil fuels. These two steps will greatly secure all nations around the globe via relieving tensions over this limited resource. This technology was developed long before 911 to introduce a new and novel energy system, which has been deliberately retarded to make sure the correct economic tool and management system is in place to provide a safe, secure and stable transition to multiple energy sources.

While free enterprise is fine, the hoarding and profiteering that goes on with controlling a limited resource like oil governs national economies and destroys democratic opportunity and the pursuit of happiness for the majority of citizens. It is immoral behavior and destructive to the United States.

However that is not to say the United States and other nations should be held up by thieves that own the raw resource either. This is why the global populous need to be more involved and not just a few. This technology is designed to by employed this way, so that humanity can view the hard data and decide how best to move forward.

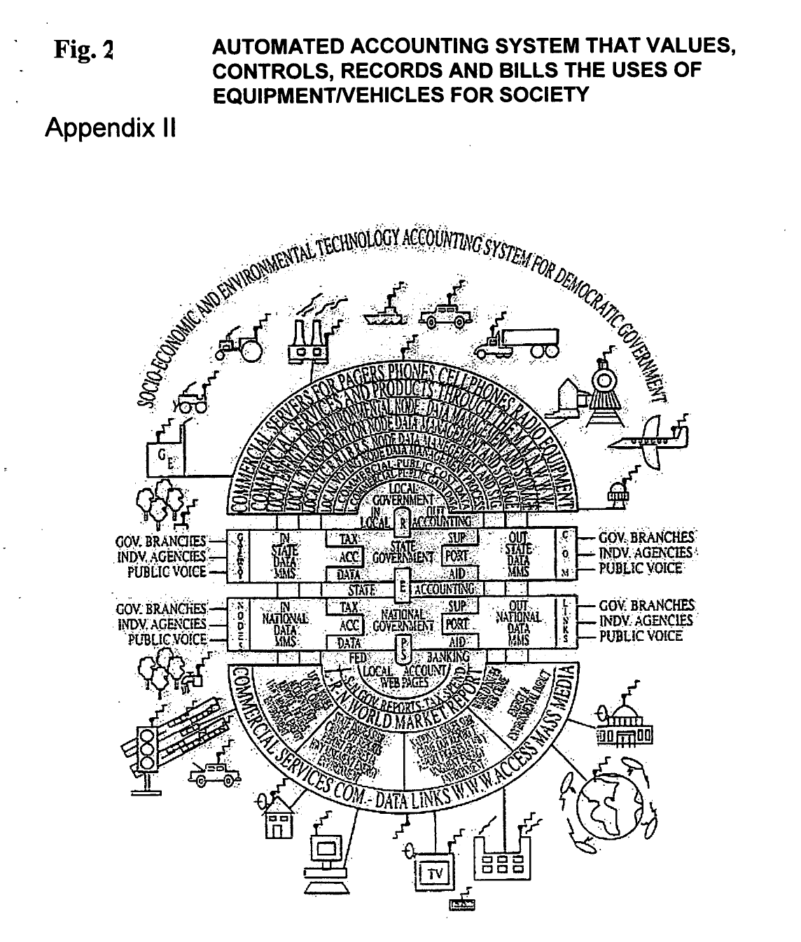

FIG. 2

FIG. 2 is from Appendix “II” filings WO 99/36297, PCT US99/000919 and pictorializes in a map form local, state and national government functioning with industry, commerce and private citizenry via the PFN/TRAC System of electronically linking of equipment and other computer networks. While, this linking optimally would serve a democracy with timely literacy and the greatest depth of mass intelligence, it is unlikely to be developed fairly and honestly today due to shallow, selfish and the terrorized few in power that find it difficult to live with others on an equal basis.

Even with this in mind this whole diagram will be described in this specification as this is a tool to develop critical awareness which is the most important understanding this inventor can draw humanity's attention to. All other questions of life pale in comparison to The Why We Are All Here Together Question, and to quote another American Rodney King, Why can't we all just get a long and live together? It is truly amazing where society's consciousness comes from and goes to in our life between being an independent individual and also being a human being with social responsibility and skill. While the questions of life holds mystery the facts of life do not. We may not explain in the same terms the reason for our existence, but we cannot deny the fact that we all exist together no matter how different we are and believe.

This invention is designed to gather data and information, process it, and disperse it to a democratic society in a fair and just manner to maintain a healthy robust creative and expansive economy while maintaining a safe environment. So that individuals can thrive, explore and enjoy their lives and being with others. This is not just the best way to have a safe and secure world it's the only way. And it is the only way technology can serve this goal. This is the diagram description. All of the technology to accomplish it is contained in appendix “B” and accompanying appendices

This invention addresses environmental social and commercial uses of equipment and includes a monitoring system which is a set of networks of on, in, out and off-board devices working together with people through software and interfaces to provide services and make accountable humanity's machines and the actions they perform. Control devices are provided as well as accountability for the socioeconomic and environmental impacts. Along with these systems networked together, additional devices and variations are provided to progressively complete these operations nationally and world wide. Unique ways to interface networks of separate devices or disparate electronics to create an interactive secure control system through one local unit that can be remotely controlled from a multiple architecture for various application specific tasks.

FIG. 2 is the entire inventions control system from the Primary Focal Node on every piece of equipment to all accounting processes of public government in every agency desired to an accountable presentation of this Data to the public in general via local state and national Accountability Web pages. It is the WWW.PFN.MMN. A social economic and environmental technology accounting system for Democratic Government with a responsible free enterprise system.

At the very top of the page is a group of ten icons symbolizing where the PFN's would be utilized. These few representative icons are by no means to be interpreted as the only places that PFN's will be utilized. They are intended to be used in some form on all pieces of equipment and or placed any where it is determined their needs to be monitoring for public safety after meeting any necessary legal requirements for their installation.

PFN's can have more than one purpose e.g. they can be used to bill for service or a particular service of a machine and simultaneously be gathering data on an incident or accident even controlled by off board control systems. In fact, as machine messaging continues to encroach into the vehicle and equipment world the more necessary and easy this invention's Primary Focal Node will be to achieve to govern and organize all these systems. The icons from the top left are trees with a (PFN) box to monitor the environment, weather, air pollution, etc., either sensors or video camera or any number or types of sensing devices. This box is given a squiggly line to indicate a wireless transmission. Once again these monitoring devices are in existence presently, so the invention will add communication to them if they do not have it and return their data in real time to the agencies that are to govern them and any private or commercial operators of this equipment could be given a tax rebate. The agency will then pass the data on to data management for posting, CCing and any proper storage determined by any governing software. The PFN's software will be configured to retrieve the data in an easy to handle format to simplify this process. Part of the accounting system is to be able to support this mass data acquisition system with out breaking anyone group, e.g. the individual, the governments, and or any commercial enterprises. So to be fair and because every action is electronically traceable in the message headers if anyone's vehicle or equipment is used to capture video for the publics business they are credited for the services and if a news or commercial enterprise wishes to use or tap into their systems to show, e.g., a traffic tie-up then they must pay the owner of the vehicle or not use the data gathered unless the owner complies with a request. The owner would be notified if their system was being asked to use its data link for sensors for any commercial request or the owner could call in and offer location viewing to the news agencies. This is done to accurately pay for the advancement of this extraordinarily large monitoring system.

The next icon up on the left is a generating plant and it shows a direct black line going to the commercial servers semi circle. This is a land line phone link and also a squiggly line to indicate a wireless transmission if needed as a back up or more cost effective modality, etc. The invention could list here all the standards for air quality for SO2 point source standards, particle point source standards, NOx point source standards, all the green house gas CO2, etc. However, there are government agencies and private watchdog groups already involved in monitoring this and they have established standards which can be used a s a starting point. The invention will house all the appropriate sensor arrays to detect these toxin or just the “Nose a NASA development along with a communication link to these agencies to insure real-time compliance and report any amount of violation. Much of this data already exist and can be easily prepared for the web account pages.

The next piece of equipment is a bull dozer and most of the time there is a limited amount of construction equipment but because they are forced to work in dusty environments and therefore are incredibly susceptible to clogged air systems which causes an increase in rich unused fuel being partially burned that deliver a great deal of pollutants into the air. Farm equipment as well, is inherently a dusty environment and also these pieces of equipment are in many cases working with food products and should be monitored for toxic fluid loss as well as any storage tank facilities for fuel pesticides and or concentrated fertilizers. Both construction and agriculture will be serviced in the most part by wireless-pagers with small short range fin transceivers and processors as described earlier. The Rf transceiver is for networking all monitored farm equipment to one land line, transceiver where ever possible and the pagers will be used for inexpensive longer transmissions, also this will provide for the repeater function of a short range signal to a long range transmission or telephone communication line, e.g., people locator (Child find). With every land based line so outfitted with a transceiver an emergency network could be developed making every land line part of the repeater net system coupled to all vehicle PFN's. The short range transmitter would have the same one tuning crystal the same as the tot spot system mentioned earlier this would be a specially dedicated frequency by the F.C.C.

Also other crucial Agricultural Data gathered can be sent immediately to the government agencies to monitor and advise the farming area. some GPS systems are employed by Archer Daniel Midland (ADM) for the governing of irrigation and crop monitoring from satellite systems. Along with the equipment and ground monitoring thee systems could be interfaced to return accurate crop data back to the government and to send aid and services to help a farmer or farming district in trouble due to weather or blight ect. When this was done the farmer could be given a tax break with respect to crop investment and loss. Also if the data gathered in a specific area was used for public use or commercial use the farmer could be reimbursed for the access to their electronic gathered data.

The next icon is a factory and depending on how many pieces of equipment and the proximity they are to land lines these pieces of equipment may also only have a short range radio transceiver that is in communication with a secondary node with in the company (land based line) and reports directly to a company control system in which these machines are monitored and recorded for their operations, but can also be provided instructions from plant management directly to their operators or are operated robotically without operators. This in house network system could provide a data link for service contractors and show a history of operational readings which when run through their software diagnostic programs and or those programs owned by the factory would limit the repair choices and suggest the materials needed to effect an appropriate repair. This would be a great time saver and money saver. Also personal calls could be routed to the operator without them having to leave their machine to answer them.

In the material handling industry many robotic order picking systems already exist and converting them to collect emissions data toxic fluid loss as well as gather performance data would be relatively easy. As well as, store the data either on board each PFN or (existing converted remote control systems) which would be able to store data either on board the machine or in the secondary company node or the commercial service company or any government monitoring agency or any or all of the above.

12 O'clock on the drawing there are icons for a boat and a car. The boat would have sensors on all toxic fluids and in the bilge to determine if the fluid had been passed back into the environment. Having the PFN on board would be a great way to increase safety and to know navigation location at all times. In areas where cell phones and beepers were unable to communicate either a satellite or global digital phones might serve as a replacement. And also marine band radios would be used. And in this case the radio receiver station for the coast guard would receive a data link transmission along with any voice with the boats ESN or registry and a full report as to it's mechanical condition along with any SOS broadcast automatically sent or initiated by the boat occupants.

The car icon is very well described in this whole application and is used to describe most all the PFN's properties and qualities in all the other industries.

This is also true for the trucking industry the next icon at 1 O'clock. However, just a moment will be taken to point out that the intense concern for air pollution due to the trucking industry Commonly referred to as the colors of smoke blue, black and white. These smokes could be monitored in real time as well as the charging and paying of all fuel taxes and highway tolls. This could be paid electronically without creating toll plazas and the traffic tie-ups that accompany them. merely have a standard signal sent out by the highway computer that requested every vehicle via short range transceiver to broadcast its ID ESNVIN back or to call it in on a cellular highway node system. The ESNVIN would also have a special tariff smart card number already swiped into the cars PFN which was bought earlier. this national card only pays for tolls and gas or use tax or commercial cards can be used when they are accompanied be encrypted transmission and reception for security. And, of course, for the interactive highways or any smart cars to be a reality for society they will need to process all their remote control instructions through a secure PFN that can record and account for all the robotic actions for any legal decision involving a driver accountability and an automated systems liability.

The railway trains and subways, etc. already have many monitoring systems or networks. These systems would be tied into the all inclusive network system to account for energy use and environmental impact. And they might carry these PFN systems in addition to the ones they use now as a back up or all these systems will be universalized but only be specific as to the jobs they per form. At 2.30 on the drawing there is a picture of an airplane with a radio signal from the plane and a land line signal to the tower. Here pertinent data from the plane could be logged into the MMN from the traditional FAA black box set up to down load on landings and during service or this data could be downloaded as is discussed in servicing equipment in the third application for the automobile. The tower and or airport facility is normally well endowed with environmental and weather sensing equipment and all this data would be also segmented by agency protocols and CC for the proper mass storage and also presented in the public account web pages. Also at 8 o'clock on the MMNWWW local node gate way protocol is a icon for the interactive high way and in most cases this will act as a primary local node to down load any PFN data that is standing ready for data transfer in the PFN Buffer an has been CC to it's PFN's unit storage.

There are in the upper portion of the page, eight concentric semicircles, which are layered protocols established by government standards for the data acquisition into their systems for processing. Their could easily be added more layers and most definitely will, but these eight will suffice to demonstrate how the system will process the data.

The first ring is the commercial communication server and MMN gateway via Land line systems. More and more in the future standard phone systems are going to have faster switching and for any one to operate a commercial node they must have all their phone support lines be Asymmetric Digital Subscriber Lines (ADSL). The second ring in and the first ring provides any emergency service if the PFN did not call or was not able to reach an emergency service phone node for some reason. In this case the commercial server will maintain any and all contact e.g. voice and data links till the customer is served or connected to the emergency personnel, otherwise the second ring can provide any number of services from making web connections to down loading entertainment packages for the board driver. The next three smaller circles are for energy accounting and environment, transportation and traffic, and the criminal incident reporting system.

It is important to remember in all these systems used in the MMN for the most part they are two way capable in communication and definitely all those used in the spider eyes program are two way. This means in the protocol for reporting crime all reports will be time and geographic stamped and will be reported in real time if certain software is triggered in a PFN or local law enforcement will be able to remotely activate any number of vehicles or PFN's they have recent reports from or any that are in use and giving out a signal to a local cell so that law enforcement can activate cameras and appraise an area in which they have just received an incident reported. Of course all these protocols have to be approved by the public and decide on how the billing will be assigned and credited.

The voting node allows for the public with their special pin Id to vote on the road or in the home. Originally first to respond to issues as they drive home to let their representatives know how they feel on the issues that are at hand. They can view them in their cars on LCD screens or see by hologram wind shields, and hear data delivered by voice. (Not Radio) This system would be developed to sanction a vote with a positive finger print ID and or an accompanying pin code. Also a driver could send a voice mail that coverts to a written message to address an issue on, e.g., area roads and specific conditions.

The two inner circles will be a continual running account of commercial and public cost and gains so an area can judge how well it is doing and also to determine where best to invent or create its finances and use its resources. This data would primarily be gathered over land lines and this accounting system could be used to make cases commercially to communities to lower taxes or provide support aid in a lean time or help to retrain workers in an eventual lay off. This is not the way business is done to day but it should and could provide a better way of life without stress for all in the future. Business would learn it's local community can help guarantee its survival even if it has to change the way it is doing business.

The inner center of the top semi circle is local government and all the way down through the center of the drawing is government with three pegs interlocking the local government the state government and the national government with the local account web pages that are displayed as local, state, national and international web pages. The pegs have letters in them and they spell out REPS for representative or the elected officials.

With the public much more interactive with government at all three levels; all officials in all three levels of government will have to become much more interactive on all the issues and this is why reps is spelled out interlocking the levels of government as another medium by which decisions will be condensed and justified to the public. Basically the objective here is to integrate the process of individual power and responsibility for any one representative to be directly responsible to the empowerment structure held by the public individually.

At 3 O'clock in the center is the state government and below that the national government which are inter locked with the mass data management and storage network. To the left side of the system is data input for the state and the federal government. All the eight semicircles feed data that is presented to all citizens in the same manner unless security protocols have dictated a different path. The two inner circles provide in real-time the financial cost and gains and representatives and citizens can view this information and the representatives can make policy on taxing or crediting back or providing aid and the rest of the public will have the opportunity to completely see this transaction and voice there opinion in real time.

In between each section of government is an accounting process all the way to the federal banking commission. All the data is accounted for so that the financial and economical controls can be better balanced to meet the needs to provide for its society while stimulating growth.

The lower section semicircle is the delivery of data to the web account pages with government numbers on money spent and received locally, in the state, and nationally, Stock reports and financial reports on the local commercial companies, the regional companies and corporations, and the national and world stock markets.

In the bottom semicircle there are four web account pages that anyone can access from commercial servers communication data links, the world wide web or mass media. Most all of these support response back systems even cable TV with a web box, although there is still a lot of problems getting service to all citizens so access could would and should be provided at any responsive PFN that supports a video display. And in public places as well like police departments and libraries. The four web pages would list issues plainly for the public to view and respond to. And their would be a section to frame issues in which the public could start a question. Also there would be a Yeah and Nay section on issues that were up for a representative vote. Also, there would be data given on the environment, the highway systems, the recent crime and much more vital information. This would be determined by the issues and events that were current first and then anyone, who wished to have data to explore their theories, e.g., on global warming would have at their finger tips all the data and expert opinion as well as an auto tutor to learn understand and relate their informed opinion back to the rest of the world.

The figures from left to right at the bottom of the page are agriculture being remotely controlled. The highway systems being monitored and ultimately remotely controlled, The car is receiving remote service and the house being monitored and for it's energy use. The computer is a web access, the tv at 6 o'clock is mass media with a web response box. The factory can review all that is on the web as to the public opinion and government policy and the world receives all the data from every where and all the world populous can see how the planet and the other humans are faring around the world. And for this to take place all the national governments agencies must clear the data to be freely posted. Well at least they can start some of this.

Obviously, this exposure environmentally and commercially on a global scale could create difficulties for the dubious and greedy in industry and government, but it would stop the world wide dislike for the US economic oil tool. It is ironic that the US is admired and looked up to for the type of-government and etiology it has grown from and hated for how it does business world wide. Mostly, because it is based on a finite limiting economic tool like the need for the barrels of oil. With a healthy set of PFN numbers in the environmental category and in the proper energy use categories, world investment in US companies world be greatly enhanced as well as followed quickly. This single change will bring greater security to the United States and it's citizens as well as, to the rest of the world. But this new way of doing business does not provide the rocks to hide under for a few that would profit from controlling the energy flow to the world fairly. Mainly the choke point people from the source and the choke point people who rule over the markets. Inordinate wealth of the few does not help any nation on either side of this issue. It hurts as much as the wrongful life style imposed on those left needy in all of humanities cultures. PFN awareness at every social strata and cultural gathering will constantly provide the cause and effect data from every decision made and will help limit the negative impacts to affect a nation and it's people with critical awareness.

Short term monetary gain from being dubious in business has always proved a greater expense to the public to correct and inevitably has to be corrected anyway. The PFN provides more real-time democratic feedback to reduce individual frustration and fanatical behavior. It is hoped with the reduction of individual tension and danger the disenfranchised with fear and hatred will feel safer and better represented helping to stabilize and reduce national and world tension. The development alone of the PFN/TRAC System will employ millions where ever it is developed, which will also serve humanity in every country. But no better than here in the United States where the technology is state of the art and the skilled labor is unemployed. It is an ideal and can be a tremendous boost in the correct direction to expand this country's economy for the many people who make a life here. If the paranoid and greedy can learn this hard lesson of life—“To live with others as equals”. We just might be able to stop another 911.

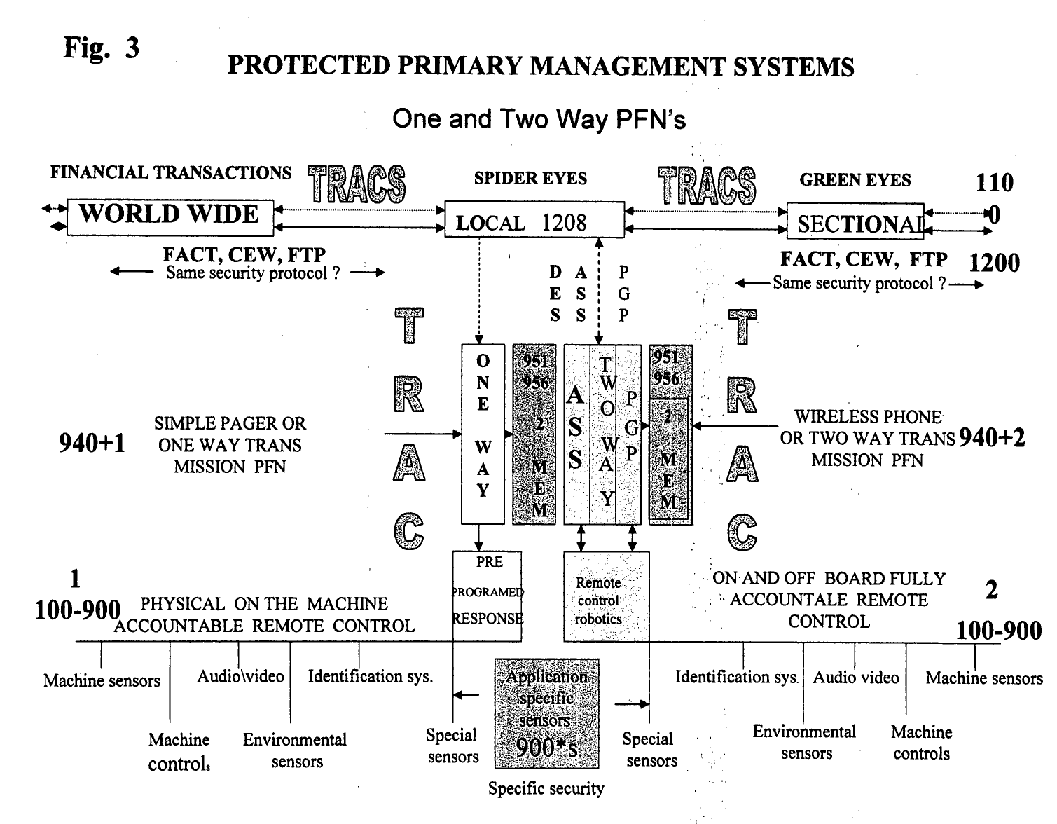

FIG. 3

This figure displays the two main types of PFN's. This drawing has been added in at this point because it gives a better understanding to the reader how the remote control capabilities of this technology are achieved for its automated devices, and how they have been specifically planned for, designed for and how the PFN systems are structured to include any and all other remote control devices by this technology.

FIG. 3 shows the two basic PFN communication categories which are being developed as prototypes. There will be one-way transmission devices and there will be two way transceiver devices with varied peripheral capabilities in protective containments. The drawing also illustrates the monitoring and remote control system or networking from the local level to the global level. The figure also shows all the management of peripherals as well as moderate security systems that conditionalize the two way transmissions.

11-1200 is the monitoring and remote control system network that can be part of any interactive highway or government gateway land line node, commercial server to phone node for a private system or for web access, and any number of servers or providers could be contacted by the PFN to transfer data for remote control, management OD data and the reporting of data for memory storage in at least one remote location. Number 108 representing the off-board PFN data storage. Directly below that is the two dotted lines representing wireless transmissions. The two directional dotted line on the right has the letters ASS on the left side which is an acronym for application specific security and PGP on the right which is an acronym for Pretty Good Protection. PGP is the C.O.T.S. products out today to encrypt a signal so that only the one with the appropriate key would be able to decipher the data. This technology recognizes that for its billing box function to be able to card swipe credit cards special banking encryption systems and verification protocols might well be required and that is the meaning of the ASS application specific security. It is possible that other high security encryption might be required as well (e.g. government and military which might well require hard ware as well as software change). These systems are not detailed in this application, but are considered.

Security system protocols would basically be reserved for the two way transmissions capable PFNs, and any of their remote computer terminals or gateways, including any and all network data storage and access to that data storage. Programs like this technology's spider eyes and green eyes or green watch would utilize protected data protocols to preserve individual privacy, track access and provide data to the public as prescribed by societies laws and via its institutions media, and the inter net and the (WWW). So standards will be set for the handling of sensitive PFN data transfers whether it was removed physically in the one-way capable PFN or the two way communication system that can transmit sensitive data streams in real time.

PGP is the commercial versions of encrypted data. And as explained earlier there is a great number of such systems that can afford reasonably good protection for many security programs. Some of these are just software down loads and can be part of the software in a PFN capable of running a encryption program as well as the software to delineate restricted data from unrestricted data if so desired. Chip sets with imbedded software are another possibility. With both ASS and PGP both ends of the transmission must be equipped to cipher and decipher the encryption key no mater which technology is used and in what form of hardware, hardware embedded software firmware, or solely software added to any existing hardware either in the processor or computer section, modem circuitry, and/or as part of any of the communication devices circuitry.

When security protocols are used effectively they must be in place in every retransmission through any connectable system including throughout any of the 11-1200 networks or web connections for wireless and land wired systems and this is why the phase “Same Security Protocols” (with arrows) parallels the horizontal 1100-1200 network labeled—world—local—and sectional blocks illustrating networking.

The basic reason the encryption protocols are only shown on the two way transmission PFNs is because they can be broadcasting personal and/or private owned information video and other sensitive telemetry data. It may not be as necessary to protect one-way directional remote control communications with additional security applications, because, there will be less signals transmitted to them and no return signal so it will be more difficult to figure out their purpose. However, in the higher security applications this encryption may be required as well for one-way command level remote control.

940+2 is the two way communication device with the ASS and the PGP systems on each side showing the options of encryption and the small arrow to the right of PGP points to the right block is the 2 stage memory on-board the two way PFN which are parts numbered 951-956 in FIG. 1. Number 2-100-900 is a line list of possible accountable functions for full remote control and remote monitored robotics. At least one variation of this two way PFN will completely support all of these functions including any special sensors, identification systems environmental sensors, audio video systems, all machine controls and will monitor all machine sensors.

940+1 points to the simple one-way receiver PFN. The dotted line coming down from the top depicts the one-way communication for one-way remote control of equipment. However, 940 +1 also can support a 2 stage memory storage and can also, support and be constructed with any of the processor's capacity to do all the same functions as the more sophisticated two way PFN with one important exception; it by itself can not report back its data to the remote control and/or monitoring system by its own transmission. The 940+1 one-way system must have its data recovered physically through a secure download communication port. This interface communication port can also be in place on the two way PFNs if so desired. However, remote control functions can be specific preprogrammed responses and/or guided or warranted through other two way PFNs on location that are videoing a one-way PFN or reporting other telemetry data about the one-way PFN that warrants specific remote commands be sent to the one-way PFN thereby providing complete remote control of the one-way PFN. Total accountability is still provided in two levels in the one-way PFN (re-writable and permanent memory). Also, this technology provides a piston extendable\retractable connector either hydraulic, air and/or electrically activated and controlled which will connect the one-way PFN to any of the communication ports on same equipped two way PFN to report back any pertinent data that needs, near real time consideration. In fact in a confined local setting only one two way PFN mobile device could recover data from all the inexpensive one-way PFNs and report it back to the remote monitoring and remote control system. This mobile two way PFN could also accompany any one-way PFN to give report back data for real-time remote control of the one-way PFN equipped machine whether it was a stationary or mobile one-way PFN.

However, any accountable aggressive remote control with one-way PFN's for the automotive applications will have specific preprogramming protocols laws and standards for their shut down procedures and most always will involve law enforcement and accountable TRAC software.

1-100-900 illustrates all the same functions that are listed for the two way PFN and states that it has only a physical retrieval accountability for any data stored. 900*s is a block at the bottom of the page and its functions can be performed by both the one and two-way PFNs. 900*s is the special sensors section that will be gathering application specific data for any application specific requirement, e.g., hazardous materials, or anything that can be detected qualified and quanitized and transduced into an electronic signal for the processor software to evaluate through compare lists programming in any application specific software running in a PFN or as burned in firmware on simple device where simple PFNs are set up as environmental specific sensors and are powered by solar cells and backed with batteries. 900*s special sensors will be many different application specific sensors that send an electrical signal to applications specific software programs in the PFNs (e.g., like hydraulic weight sensors). Many of these peripheral devices and sensors exist as C.O.T.S. products and there are flexible software products that can be easily adapted to support these applications. Another 900*s special sensor is the nose, which is a sensor that can identify odors 2000 times more accurately than the human nose and is capable of discriminating substances at a molecular and even atomic level. This sensor is already designed to deliver unique electronic signals for its application specific software compare list library of known substances will serve well in many applications to identify biological and chemical toxins explosives, e.g., potassium nitrates etc., and leaks in regular chemical containers in any commercial or governmental installations when coupled to a mobile PFN preferably a two way PFN. Also, the PFNs could be programmed to operate electrically controlled military devices in unmanned equipment that was damaged or unmanned either due to the loss of life or to prevent the loss of life by using the machinery and equipment through remote control and/or full robotics (based on the level of PFN computers and on-board programming). The options are vast and varied to improve security and safety for all facets to include high security protocols, more adequately covered in U.S. Provisional application No. 60/122,108.

The PFN and TRAC software systems could help world order and nation building by monitoring equipment and material movement while robotically controlling terrain and police it for aggression without risking personnel any more than is absolutely necessary. To help enforce treaties so that the assignees and their constituents are on the same dotted line with the non-emotional objective cold hard reality of equipment that stands fast to the terms that have been agreed upon. Of course, this technology's audio recordings in the native language would be remotely activated or sent as an automated message to precursor any automated physical intervention. First, more of a persuasive nature actions would be used (e.g., water cannon, safe but annoying gases, rubber bullets and as a final option lethal weapons activation) only as a last resort and to save lives. These PFN armored machines and/or equipment would be all terrain like tanks track vehicles, humVs wheeled vehicles, hover crafts. Even drone aircraft, etc. and basically the PFNs would be added to all equipment And of course the peripheral accessories could be all of the same and more military weapons could either be automated or their automated controls could be interfaced with the PFN systems. Eventually, special peacekeeping PFN controlled equipment would be created to help maintain order in an unstable area, but first the PFNs should be a part of every piece of equipment networked and remotely controlled and made accountable to the public the individual and government and commerce.

This alternative with the PFNs would allow the United Nations and NATO to take its nose and face out of troubled areas and those malcontents faces while restricting the amount of harm they can inflict on one another. To insure better tranquillity while reverberating there own commitments and better insuring fair play. The use of this device by the military that is trained for nation building might better keep respect for the military as a fair intermediary rather than just a brute face to face hand to hand combat force as has been the previous option for the military. In tremendously hostile areas where there is no agreement the automated weaponry can be deployed as part of any military maneuver and in place for any rocky social reconstruction time period. The 1200 Spider Eyes program is designed to be used in policing a normal at peace society with respect for individual privacy. The laws and standards and punishments for violating an individual's privacy have to be addressed by the public and its government before its implementation and any protocol of use, but ultimately it will improve life and the management of machinery, society its economy and the environment.

Recently, another new device has been developed, the “car plane” designed by Moller for future three dimensional transportation for the individual. The technology exists today to set up a guidance systems with the three coordinates delivered by the current GPS systems. There is latitude, longitude and elevation and when used with the military's accuracy achieved with an additional correction signal for the ionosphere distortion of satellite signals the GPS accuracy is within centimeters and instantaneous on a hot reading. So most probably this invention will see government use for a while before it is a general public individual transportation tool. In any case the FAA could more readily organize and develop the car-plane technology with this invention. And the PFN will be invaluable in consolidating the accountable black box, communication systems and locating equipment all in one concise system that is easily tailored for monitoring and controlling an ever increasing numbers of these car planes in the future.

Appendix 1 lists some of the present prototype C.O.T.S. components used in the one and two way PFN's. These components are more extensively covered in the related patents. However these prototypes parts also demonstrate the feasibility and capability of all the systems interfaced through a PFN. Items 1, 2, 3, 5, 7, 8, all camera systems and are being experimented with for the different industries to see what application they are best suited for.

When these cameras are utilized for automated guidance in the mobile management patent a system using a laser light beam will be targeted on a lane marker or the road edge. Once the laser light is locked on the line or road target a software algorithm will compare the electrical signal from any camera(s) viewing the roadway to detect the cars position by the relationship of the laser dot on the road and how far away from the lines the dot is as well as the direction the dot has moved from the line during movement. This is determined through the electrical signals digital pixel representation identifying the road target and the laser dot an activating the automated steering stepper motors to turn the steering linkage to maintain the correct lane position for the vehicle through an algorithm in the TRAC software program, PAGSSS and MASMP. This might require two camera angles and two reference laser spots. Of course the PFN will be receiving distance data as another electrical signal transduced from sound echoes and/or infrared systems to be compared in software protocols for proper travel spacing between vehicles which will adjust the speed of the vehicle through the many modalities detailed in this application for automated acceleration and braking processed through the PFN. 4, and 6 in this figure are a video card and converter for laptops to be used in a plug and play modality with personal laptops for sending images via the web and for any personal or business reasons. Web functions can also be performed by the PFN computers through TRAC software.

The reader is referred to Appendix Three for more description of vehicle and machine interfacing, remote and robotics control. The next slide discusses the multiple protective walls and protection planned for the local PFN controller, router relay station to maintain integrity and security with the system.

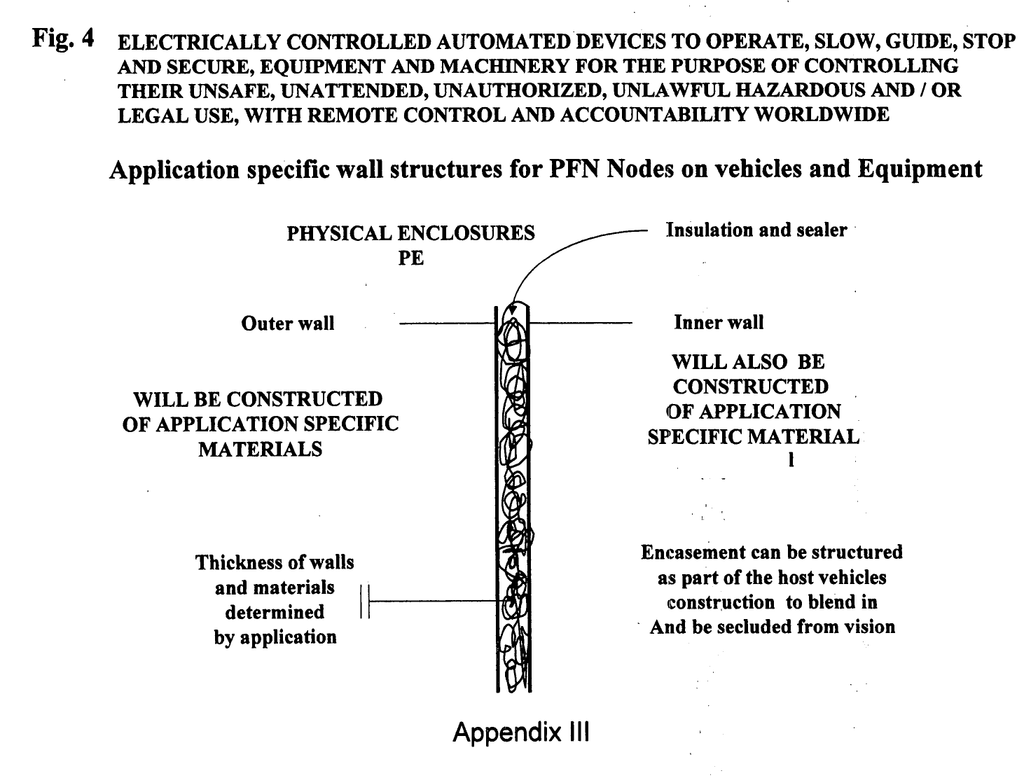

FIG. 4

This diagram from the same patent application is included to show that the physical protection of the local node is governed by the application it is applied to. In appendix III WO 99/36297, PCT US99/000919 the many wireless technologies are further developed into a local processing relay or routing station supported by the power systems they are interfaced with on the equipment they are connected to. As they are in different environments the telematics functions are specific to the equipment they are connected with. These various environments and different pieces of equipment provide the opportunity to develop a mobile sensing network of various types of sensor arrays to collect data locally and transmit it from these nodes to the appropriate mass data processing networks and storage facilities simultaneously. This application is also where the local nodal unit is first called a PFN for Primary Focal Node. In this application much of the sensing is done by OEM sensing systems directly connected to the PFN. In later filings an entire wireless sensor network, the PS1 and HS1 are also supported by these continually powered PFNS receiving and repeating their short range signals on to greater processing systems and data storage units.

The wall structure shown in figure two is indicative of the planned protection that should be considered for each PFN to maintain it's integrity. NEMA boxes are considered to fall with much of the PFN/TRAC standard to protect a primary focal node but they must have physical locking and electronic tamper protection in place to meet PFN/TRA/FACT System standards. The specification for local protection of the Primary Focal Node is through out all of the PFN/TRAC filings by application, but is further defined and detailed for this figure in Appendix “III” as well

The PFN is a Protect primary focal node ideally housing communication technology with control circuitry and memory storage devices that can accurately locate and remotely control a piece of machinery in an accountable manner through TRAC software that authorizes and authenticates remote activities with local and remote memory storage. This is an important quality to make any STANDARD for any automated and remote control and robotics for any piece of equipment.

FIG. 4, taken from another related patent application, depicts a double wall structure with an insulated center to protect from heat, moisture, impact, etc. The outer wall will most probably be constructed out of a difficult to penetrate metal AR plate at least with its thickness being application specific and detailed greater in the individual related patent applications for industry markets and products, but they will all confirm to any industry standard.

The inner wall will also be application specific and be determined by the standard set for the PFN device as well as the components that must have these protected encasements and the persons that will be permitted access and at what level of access persons will be permitted. The specific encasements are detailed greater in the specific industries and other related patents, however, this technology claims all protective encasements for the stated purposes as part of this technology. Of course military applications and hazardous materials will demand special enclosures. As will curtail areas that will have laws written to protect their access from the general public even if it is a privately owned piece of equipment. For example, this technology calls for at least permanent memory storage for accident related records which will be inaccessible to the general public and a crime to willing tamper with the compartment and the data stored as a standard and as law for its accountable automated and remote control and robotics protocols.

While it is a necessity for the PFN protective structure to provide a protected memory, these same protective enclosures could be found to have application specific importance for any and all electronic parts and components including peripheral devices. In no way should it be limited in structure (s), size, composition, and/or components.

The insulation is in most cases a product called solid smoke which was developed for NASA the space tiles. As a solid vacuum they do not transfer thermal heat. There are many good non-volatile insulators and a suitable replacement that meets any standard will be acceptable. The general description of the PFN structure at this point is only done to be inclusive. For example, in related patent application PCT/US99/0919, an entire dash mount PFN structure is detailed to accommodate all the necessary components and other personal electrical components that are interfaced with the vehicle and also afforded protection. These PFN structures would be scaled back because they enjoy a protected cabin in regular automotive applications.

Interface)—(Primary “Focal Node”) (PFN)

The physical properties and structure of the inventions primary focal node interface or secure box will be designed with the intent to be versatile for change but to universalize the structures to as few as possible configurations for all purposes. And especially for the automobile and transportation industry. It must be remembered that even though this application is accompanied with very specific drawings and descriptions that these in no way minimize limit or restrict the claims for any shielded protected or secluded interface in a host piece of machinery for the purposes stated in this application or any of the related filings.

The physical structure in most cases will have laminated walls with the first surface a 3/16″ or less thick plates of abrasive resistant steel (AR plate) or steel of greater hardness.

The center section will be a composite of Aerogel Space Tile, “Solid smoke” or “Geo bond”, and the final layer for the interior surface of the box is of ⅛ inch steel to the same AR Plate standards as the first plate.”

AeroGel” or “Solid Smoke” is made of silica, alumina and carbon as well as other materials. And is like having a solid piece of vacuum in this center area and this is why it does not transmit radiant heat. It was developed through NASA research to replace the space tiles on the shuttle to protect against the high heats generated on reentry through the earths atmosphere. Presently it is being marketed for the construction of refrigerators catalytic converters and furnaces. This products can insulate up to a 100 times better than the original space tiles. Geo bond is another product that is made from gypsum and other aggregate and silicates. These are but only two of the acceptable thermal insulating products on the market today and their mere mentioning here, is in no way intended to limit the inventions options on insulating products or systems.

For the automotive industry the invention has basically three shapes; it is prototyping but in no way is this to be considered a limitation on the designs possible and configurations needed either in the automobile industry or any other industry. There is a cube configuration that measures 12.5″ wide×12.5″ deep by 9′ high or longer for almost all regular sedans. This box replaces any need for a glove box and in many cases will also house the audio systems. A second design is a horizontal system that is 18-20″ long×12.5″ deep and 6″ thick internal. This system will be used in small vans or in center consol, or ceiling configurations. And the third one is the add on box system for commercial use which will not be a storage system for personal devices and its size will be governed by what products and services a company might want, e.g., a cab company or a truck fleet tracking program. But all will sooner or later carry equipment that are required to operate it legally, e.g., communication device a sensor array and record and report function and a G.P.S. as well as an automated shut down for the vehicle. The front of the cube will provide lockable access panels that can also be opened electrically and will close in some incidences from sensing inertia via inertia sensor or fluid sensors in stable reservoirs.

Once again these designs will be customized by the manufacturers and made aesthetic but ultimately they will have to meet a standard and will be tested to provide an acceptable protection for these vital devices and functions. There will be a government standard as there is for firewalls and the shapes and sizes will be standardized so many of manufactures can supply electrical accessories an peripherals. All mandated legal devices will be secured with a permanent access panel that only authorized persons can open and it will be an offense to tamper with any of this equipment or the area they are kept in. The size of this compartment can presently be greatly reduced. Manufacturers will integrate these products as they have been explained in this application, but this prototype was designed to allow individuals to add there own laptops and other loved accessories and many people in the future will look for this capability in an automobile rather than be put off by it. People have always been concerned for their valuables and having a mobile firebox and safe box will have as much appeal and so will the electronic, storage interface function. This is one major property of the invention's design and purpose is to provide a modular interface exchange with flexible customized compartments or areas to universally accommodate existing products. This was done to first provide a standard and a place to interface or to accommodate Commercial Off The Shelf (C.O.T.S.) products and personal accessories. And then to provide flexible retrofitting for future consolidated and integrated systems and their components. Basically, the customized versatility has been designed into the secure protective containment to increase the appeal for this kind of interface and to create a point to organize these merging technologies and to control and regulate them properly for society.

And, therefore, this invention's interface (PFN) device claims the right and capability to connect up with any diagnostic port or electrical connection (either hardwired or through infrared comports or any visual sensor arrays referred to in earlier applications (including fiber optics)) and use any software available or invented herein (i.e., OEM, or after market and/or C.O.T.S., and the like) to most easily accommodate or access any host piece of equipment's electrical and diagnostic system and individual devices or sensors either OEM or installed accessories either physically or remotely activated by and or controlled through this interface. Further, the invention claims the capability to install its own priority sensors, devices and software to either augment any existing host accessories or increase the capabilities of any diagnostic or analytical systems desired for any accounting application for services or products to be offered commercially and/or be described within this invention.

This versatility will allow all the individual communication, electronic, and automotive product manufactures to become involved and design specific shelves, trays, cassettes, cartridges, and or IC cards, etc. for the custom constructed modular compartments to feature their array of products and/or components. These developments and others are more fully discussed in Appendix III and in the following drawing from the same Patent.

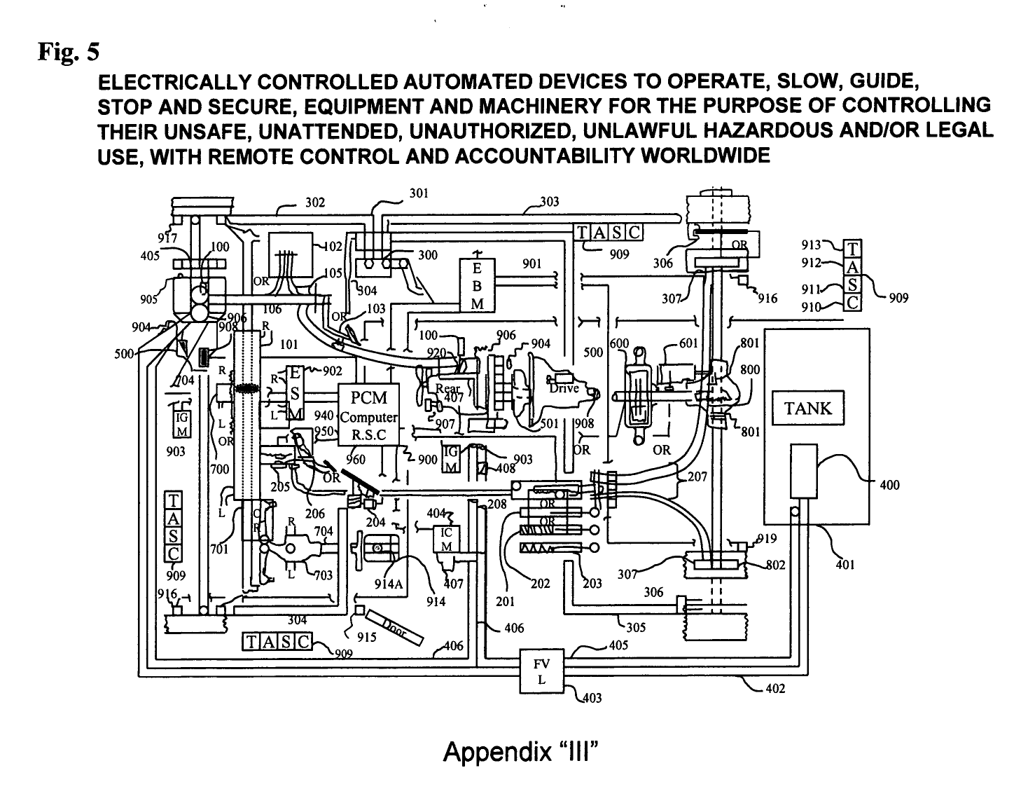

FIG. 5

FIG. 5 from Appendix “III” Pat. U.S. Pat. No. 6,647,328 B2 and additional divisional filing Ser. No. 10/654992. This specification teaches many modalities to control vehicles and machines through interfacing with standard E/E systems and automotive electrical bus and equipment controllers as well as, sub system control modules. As many as five more divisional applications will be filed as independent inventions just from this specification. But most importantly they are designed to be responsive and incorporated with the PFN/TRAC System and FACT security program. This specification provides the remote control and robotics actuators to keep humans out of harms way and to assist them in the safe and legitimate operation of equipment. The figure will be detailed further to better explain all the capacities of the remote control and robotics available to the system. The specification has engineering specifications for all types of machines and equipment to completely teach how to incorporate all equipment and interface them with the PFNS detailed in Appendix II.

FIG. 5

(This Drawing Completely Illustrates where these Automotive Devices will be Located and the Systems They will be Coupled to and the Manner in which they are Interfaced).

The following number system will be used throughout this application of drawings to be consistent with the systems these devices effect. Throttle control components will be numbered in the 100 series, the emergency brake system will be coded with the 200 series numbers, the service brake will be represented by the 300 series, the fuel system will be 400, and the transmission and transaxle will be 500 numbers, additional and accessory brake systems will be 600, the steering and guidance components will be numbered in the 700's, the rear axle will be 800 numbers and on-board electrical components sensors and control circuits will have 900 numbers, also the electrical components will have a lighting bolt indicator line in this figure while all other devices will be indicated by a standard curved indicating line to the number. And finally the reason there is duplicated numbers in this drawing is because this drawing represents the two most popular standard drive train systems, which are the front wheel drive and the rear wheel drive. This was done to give the most complete and exact description of these innovative device deployments 100 which is a throttle servo motor and/or a solenoid that can be energized to create a specific aperture or orifice opening of the throttle throat to directly effect the cubic feet of air allowed into the power plant, i.e., gasoline or diesel motors.

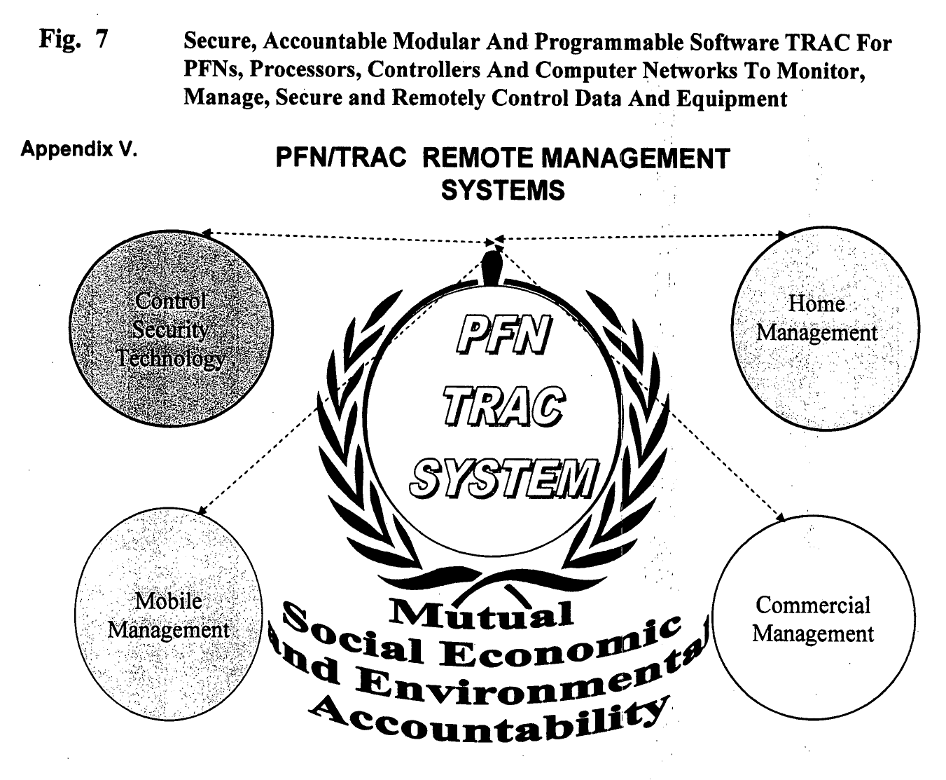

101 is the accelerator and/or throttle control cable that connects the pedal to the throttle valve, i.e., butterfly (This gating or blocking process) of the air flow can be accomplished by a number of devices and any such devices, e.g., even expandable bladders are considered within the scope of the invention, when any such device is used to control the engine rpm or are a part of any automated control system or shut down. 102 is a standard cable with a junction box that interrupts the cable from actuating the throttle valve. This is done by a solenoid releasing a seesaw lever, or a set of interlocked double discs or cam devices that is completely described in additional drawings FIGS. 7A-F. Also, in this drawing there is a standard cam system housed in a similar cable junction containment which accomplishes the same lever action result.

103 shows a pedal stop mechanism that restricts the driver from depressing the accelerator pedal and/or activating any linkage to increase engine RPMs, i.e., gear-nut drive, worm gear, ball screw or screw drive, angle or right angle gear drive, piston mechanism, i.e., hydraulic, air either from a compressed gas bottle and/or accumulated bottle system or energized by any such on-board pumps and/or compressors and/or any electric memory metal device, servo motors and/or solenoids that can activate any blocking mechanism and/or catch and latch devices to hold or make stationary any moving parts that control the throttle by restricting movement. All these same devices also could be used as part 100 to control throttle position by anyone skilled in the art with very little to have these devices activate the throttle linkage or through shaft to control air flow or any earlier mentioned means that can restrict air flow to the power plant.

The activation of any of these above mentioned parts will completely eliminate a driver from accelerating the vehicle by the regular accelerator controls. And also if cruise control is present it would be either electrically de-energized through the brake switch circuit with a series circuit relay or by using the same kind of series circuit relay to interrupt the main power supply to shut down the cruise control entirely. Also, the power train control module PCM could be directed to de-energize the cruise control on most all vehicles and/or simply be mechanically disengaged from the cruise control's capacity to accelerate the vehicle though interfering with any of the physical control mechanisms, i.e., linkages, cables cams, valves with the same modalities described for the standard acceleration and throttle system interruptions. This is the FIRST modality sequence to slow a vehicle down for either remote control or preprogrammed automated controls and it will be completely described and illustrated in this application, along with all the ways to SLOW and STOP a vehicle, as well as, secure a vehicle by either of the brake systems which are automated to be applied through an electrical current or signal from being sent from above referenced control systems termed as a PFN. There will also be other locking systems that keep the vehicle in a stationary position and/or also slow and stop the vehicle by engaging or disengaging drive train components electrically. And, of course, all these functions can be performed in real time with accountability through this technology's TRAC software.

The 200 series parts and/or innovative devices, in FIG. 1 comprise the standard emergency and/or parking brake system, which when coupled to the 100 series parts will comprise a complete detainment and securing system—first slowing the vehicle by eliminating any acceleration through the (100 series parts) and then implementing and applying the brake through the (200 series parts), bringing the slowing vehicle to a complete stop with the brake secured and applied so that the vehicle can not even coast or roll while unattended and/or under any improper control and/or unauthorized control. There will be additional drawings showing the circuitry and mechanical parts of all the 200 series parts and innovative devices.

However, at this time it is important to point out another uniqueness to this automated braking system and protocol, which will be incorporated in this automated series circuitry described for this brake application if so desired. It is that the brake will automatically be applied if the drivers seat switch reports no person present by opening a circuit and/or the driver's door and/or any door is opened while the wheel sensors and/or any motion sensing device is reporting vehicle movement and/or if the engine is running. A driver warning will also be given as is standard in many vehicles today, however, this technology is capable of providing this driver notification in verbal warnings, as well as, IP lights, LCD displays, buzzers and bells. It is also possible to activate these braking systems by the seat belt switch but it is possible a driver might just be readjusting the harness an falsely activate the warnings and brake slow down. The proper protocol or safe program for these and additional uses will take into consideration specific vehicle configurations and real life circumstances. Experimentation thus far for this protocol has demonstrated greater safety for the Off loading of passengers in the rear seat of the standard sedan, by preventing movement of the vehicle, while any door is open. Also, the car is immediately sent into emergency brake application mode if the driver or occupants are bailing out of the vehicle. This was designed to for the unsafe unattended auto theft scenario when the irresponsible thieves generally leave the stolen car running in drive as a mobile distraction to tie up police pursuit while they make a getaway on foot. With this technology's shut down protocol, when the thief bails the car stops, allowing the officers to mindfully pursue the culprits only. Once again, this protocol is accompanied with audio warnings and verbal warnings and hazard lights and information signs as well to inform law enforcement of the process. In most cases law enforcement will be knowledgeable of this protocol and be responsible for the activation of this shut down protocol command, whether it be initiated by the police or some cooperating commercial monitoring and remote control service.

The emergency Brake (200 series parts) are: part 200 displayed as a cable tension mechanism comprised of an inner and outer channel where the inner channel has a strip gear attached to it and meshes with a rotating gear either attached directly to a motor shaft or a gear transfer box as the systems mentioned earlier that is attached to the outer channel. With the rotation of the gear attached to the outer channel the inner channel will move back and forth as the rotating gear travels across the strip gear that is connected to the inner channel. When one of these channels is attached to part 207 the rear wheel parking bake cables and the other channel is attached in a fixed mount to the car chassis—when this mechanism is activated in this scenario it can either tense the cables applying the brake and/or relax the cables releasing the brake (for a motor application this would be accomplished by reversing the polarity on the motor and the same seat controls are used for this prototype).

For a solenoid application with just sliding guide channels this would be accomplished by energizing and/or de-energizing the solenoid and having spring tension to accomplish the reverse function. Of course, methods and parts to be decided by the specific vehicle and any leverage consideration to achieve this electrically energized mechanical activity. 201 is representative of either a hydraulic or an air and/or compressed gas driven piston system. Its ram and the cylinder base would be attached to the same attachments points as the part 200 strip gear channel tensing system which is also true for part 202 and 203 which all share piston configurations, but rely on different mechanisms and power sources to complete this task. That is why these parts are displayed in parallel in FIG. 1. Only one of these parts would be necessary to complete this tension function of both rear brake cables in a simultaneous manner. This is a push/pull action.

It is to be noted that all these parts 200-203 could be designed to work in the 100 series part functions and to alter and/or effect changes to the cars throttling system as well. Presently, some air piston throttling is done in car racing sports with a compressed gas bottle to energize a piston that effects the throttle. It is conceivable to use these mechanisms reconfigured for these functions to control a vehicle and to restrict its use and/or remotely control its speed using these devices as actuators; and solenoid valve to electrically energize desired flow. It is equally important to remember that most all types of vehicles can utilize either this modality and/or one of the other modalities detailed in this application to apply any of the cable brake systems on a vehicle and throughout all these application specific effected parts and their numbers will be named whereever readily known. However, the detailed modalities described herein and used are the uniqueness even without any detail with specific affected OEM parts and their numbers accompanying the drawings.

First, the 100 series systems will slow the vehicle and the 200 series will stop and secure the vehicle in a stationary position. Part 201 could receive its energy to function from either an emergency canister of a safe compressed gas as already mentioned, e.g., CO2 or dry air or its energy source could be provided by a small air compressor system like the ones used on cars that have air ride suspension systems for a softer and/or more responsive suspension, e.g., Olds Ninety-eight from the year circa 1987 to present. This is only meant as an example, any standard on-board compressor system could easily be regulated and electrically directed through 12 volt solenoid valves, i.e., Bellows corp style and Air equip. to complete these desired tasks. In fact, specific parts and part lines are only mentioned here to demonstrate the easy commercialization of these needed advancements through the readily available C.O.T.S. parts that can be easily obtained and reconfigured and combined to complete these unique functions, but this should in no way be considered the only way to complete these functions. These all can be reconfigured to work with remote control systems and/or be electrically controlled.

Part 201 if energized hydraulically could be served by the power steering pressure and/or an automatic transmission hydraulic pressure and, of course, regulated with pressure relief valves and electrically controlled valves, e.g., Vickers products, and/or the Waterman valves used in the industrial truck of fork lift industries which have 12 volt solenoids for the auto and applicable industries as well as many of the solenoid valves already in use in the auto industry for many of the transmission applications, etc. 201 could also be energized by the standard service brake system where through normal applications of the brakes an accumulator or blatter is pressurized to an adequate pressure to work the piston with specialized seals for brake systems and regulated by relief valves and controlled solenoid valves, i.e., Micro lock company line, also there are a lot of specialized racing companies that manufacture electric wheel locks energized on brake pressure.

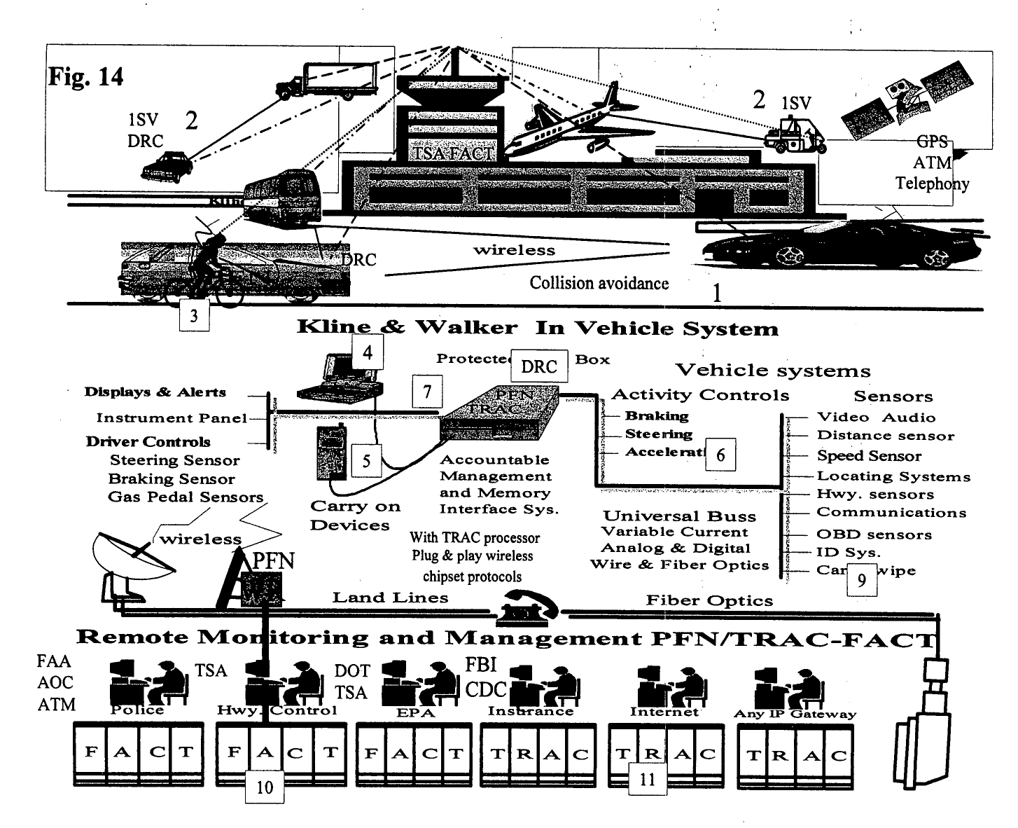

201 could receive its service brake fluid pressure from a modified ball screw piston modulator valve like the ones used in the new GM cars to control brake fluid pressure to each wheel in their antilock brake system. This modulator valve is referenced in FIG. 1 as part #301 and the modification and all other uses as they apply to these innovations of this ball screw piston valve system will be described completely when part 301 is described. However, to develop the pressure to work the 201 piston and any other automated pressure needs that have not been created by the master cylinder an electronic micro lock would be placed between the valve and master cylinder so that when energized will block the return of brake fluid back to the master cylinders reserve as illustrated in FIGS. 14A-F as part 397 which will allow the motor pack when energized to raise it respective pistons to compress the fluid in their cylinders. This is a fairly simple manufacturing change to an already existing part to achieve automated pressurization of the service brake system. There are other manufactures using brake modulators that can be converted to an electrically controlled automated brake pressure system to apply the brakes in a remote control scenario.

Another simplistic way to achieve this pressurization of the service brake is to install an automated master cylinder either incorporated through the power brake system and use either vacuum or hydraulic assist, i.e., power steering or transmission as is often done in the fork lift industry for power assisted braking and activate any of the actuator devices already described in the manner in which they are described, i.e., pistons, etc. The activation of the master cylinder and/or any additional automated parallel master cylinder installed in the circuit, specifically for any of these automated purposes, can also be achieved electrically, i.e., solenoids, electric cylinder, i.e., memory metal pistons, motor driven ball nuts, ball screws gear drives or gear transfers, as well as, any worm drive affixed to the master cylinders piston plunger directly and/or through activating any of the pedal linkages and/or cables to compress the fluid in the cylinder chamber. All of these devices have been and will be completely described but are being referenced here as varied applications that can be employed to achieve electrically controlled push pull functions and later rotation functions for the automated steering and other rotation functions.

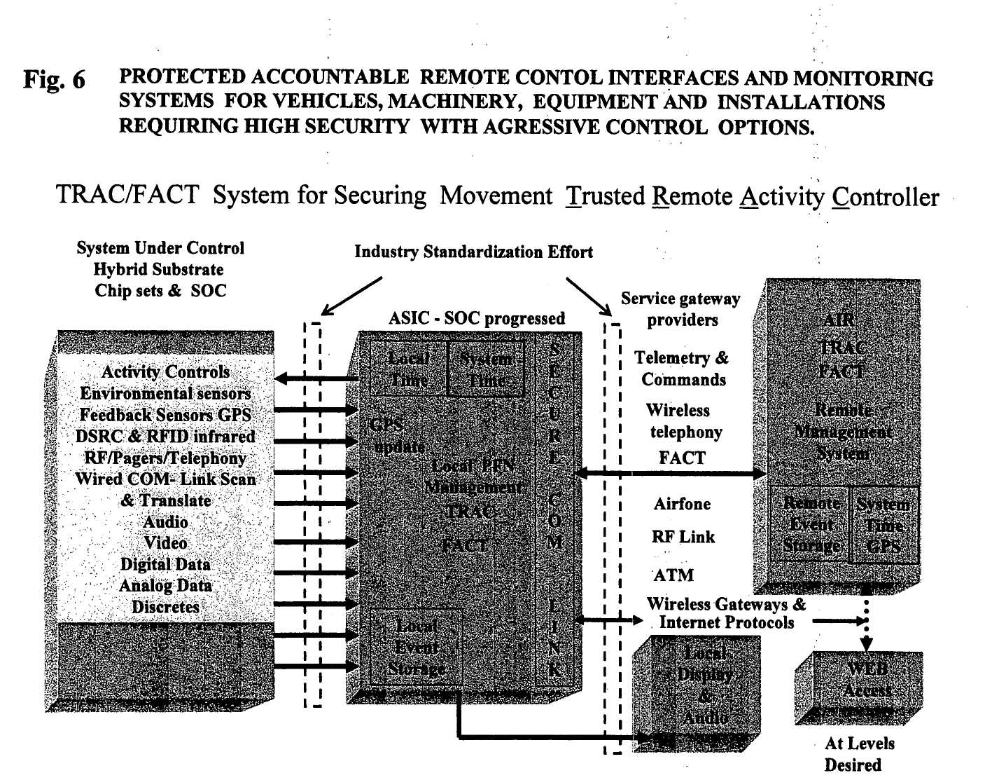

Part #202 represents a motorized mechanical ball screw-nut-worm gear piston application for this cable tensing function there is many such devices and manufactures of these devices and systems. Many of these product lines can be found through companies like Invetech American Bearing corporation along with complete literature to there specifications and functions. Part 203 illustrates some new electric pistons sold through Tech magazine and Digit Key Corp.; both are large mail order houses for electronic components. These are memory metal pistons which are not practical at this point for the brake tensing function, but might be in the future. They are mentioned at this point for their pulling action and piston configuration. And they are mentioned here because they have other functions involving this invention, primarily to electronically controlled catches, locks, and/or latch releases for the PFN and secure containments where these pistons will operate access panels and doors electrically through command codes given and received by the inventions communication and/or control circuits. Part 204 pictures a gear nut drive mounted under a hand pull parking brake lever which pulls part #208 which has a cable that is connected normally to the two rear wheel emergency brake cables where part #200 through 203 are positioned and illustrated in FIG. 1. Any of the other devices displayed earlier, i.e, pistons, worm gears, ball screws, solenoids gear drives and motors can also be configured and ultimately displayed and described to complete this function as well as activate this lever from different angles and/or attachment locations and chassis or frame mounts making any such device that automates the manual function of the hand held lever parking brake lever within the nature and scope of the invention. The pedal stop gear nut numbered 103 in figure one and is completely detailed in FIGS. 6A-B which is also the one used in the first prototypes for the hand lever.

Part 205 is shown to also connect to part #208 and it is an illustration of the standard foot applied emergency brake that assembly that has been modified with the same strip gear tensing device depicted as part #200. 205's function would be to pull the pedal down to apply the brake and also to return the pull down arm to release the brake so that when a responsible operator releases the brake cable it will relax releasing the rear brakes, another push/pull function. It is this mechanism that has been chosen and will be used in the prototype and demonstration units to commercialize these technologies. Once again all other earlier described systems can be most easily configured to achieve the automation of this standard foot pedal parking brake assembly. Also, the regular emergency brake ratch assemblies can be motorized with a gear drive and controlled electrically in the same manner. Note that in most vehicles only one of these innovations would be used with respect to how the OEM has set up their parking brake system. The OEM's set up would dictate the appropriate modality for the least expensive and most ideal configuration for these innovations to be employed.

The 200 series parts and innovations are responsible for continuing and controlling the slow down process and ultimately securing the vehicle in a stationary position. The 100 series parts and innovations eliminates any acceleration of the vehicle and begins the controlled slow down. It is the use of these two combined systems that the first prototypes and demo units will be constructed from. This will employ the 100 series device of the pedal stop ref # part 103 in FIG. 1 by using a typical seat control motor, drive a gear nut cable which in turn drives the gear nut to elevate a stop on a shaft off the floor board which is concealed under the carpet to stop the accelerator pedal in its highest position to keep the engine at an idle state. The elevation could be controlled to allow a specified certain capability to accelerate through the earlier mentioned control systems 900 series and onboard sensors on the vehicle, i.e., speed sensors 900 series parts, i.e., wheel and/or transmission. As referred to above the second stage 200 series will continue the slow down to a complete stop and secure state of the vehicle. This will be accomplished in the prototype and first demo units by applying the foot brake with a strip gear and inner and outer set of channels driven by another seat control motor and drive cable connected to a power transfer worm gear drive, i.e., like the one used in GM cars as a horizontal adjuster drive, in fact this whole mechanism, channels, slide buck bushings, cable drives, horizontal adjuster drive gear, are the C.O.T.S. parts for the first prototype. This and the nut drive that is the pedal stop for the accelerator are all C.O.T.S. parts and are used through out the auto industry as automated seat controls. However, when used for these unique uses to slow, guide and/or detain a vehicle either remotely, preprogrammed and/or by any series circuit relays activated by on-board switches and/or sensors to increase any safer operational level for vehicles machines and equipment as well as, control any of their use for any financial economic and/or environmental reasons, are all considered unique as thoroughly detailed and made to all fall within the nature and scope of these innovative patent applications for accountable remote control and robotics. All these already existing C.O.T.S. parts and devices will be described, illustrated, identified and named in these applications. The C.O.T.S. approach has been done deliberately to more quickly deploy these systems to save lives today.

The 300 series parts and components involve the service brake system and how it could be used in a similar manner as the emergency brake to complete a controlled slow down to a stop and secure the vehicle in a brake applied stationary position. The advantages and disadvantages will be described and illustrated completely as well as, all the parts and innovative mechanisms in FIG. 1 and subsequent drawings. Part #300 illustrates the master cylinder and brake pedal location. This part and assembly has already been described in the automated state by using some of the 100 and 200 components and will subsequently be described in greater detail with drawings to illustrate and name the specific parts and innovations for each of those systems in this formal application. 301 was also mentioned earlier and is the brake modulator valve body that has 3 motors in a motor pack and is currently being installed on late model GM cars form 1997. This system will be modified in accompanying drawings to activate the service brake system without using the master brake cylinder pressure which is not the case in the present version of this ball screw 3 piston assembly.

Presently the valve only can utilize whatever pressure the master cylinder creates and will go into bypass mode at any pressures greater than what is generated by the pedal being applied. As for normal service situations this would remain the same, but in the event that the vehicle needed to be slowed down through the service brake's system the return bypass relief would be blocked as the ball screw pistons were activated and a regulated flow controlled through either a preprogrammed EBCM electronic brake control module for the current anti-lock system and/or channeled through another valve body and controlled by other control circuitry either on-board or added on as the devices described throughout these applications for the invention. After 301 the modulator valve, parts 302, 303, 304 and 305 illustrate the brake fluid lines going to each wheel, respectively. 302 is the right front wheel brake line. 303 is the right rear wheel brake line. 304 is the left front wheel brake line, and 305 is the left rear wheel brake line. In reference to these brake lines if an add-on system was to be employed that created brake pressure either by accumulating pressure and storing that pressure in an accumulator or bladder or canister controlled by electric solenoid hydro-locks or if an additional automated master cylinder was employed and activated as described earlier the equalized pressurization of brake line part 303 and brake line part 305 would be the best mode for completing a safer controlled brake system application.

306 shows rear disk brakes. These disk brakes could be outfitted with an electrified magnet with an abrasive wear surface disk or plate that is supported from the caliper anchors and rides close to the disk and works by trying to hold the wheel disk fast and stop the wheel rotation. A C.O.T.S. substitute for this would be the electric trailer brakes set up made by Bendix, which would be configured to be equally effective on the rear two wheels rotation through matching the wheel rotation and individually energizing the braking magnets. Once again speed sensing devices on the car along with the OEM control and the invention's control circuits will be interfaced for the least expensive most effective modality for any specific vehicle and will be continually describe throughout these applications as specifically as possible. 307 the standard drum and brake shoe set up. These drum and shoe brakes could be modified to accept any of the earlier described mechanism to activate and expand the shoes out to the drum surface by, i.e., cams attached to gear drives, pistons, solenoids, as is done with electric trailer brakes and pulsed through a preprogrammed circuit that receives vehicle speed data and equates the on/off time or amount of current to be applied. These will also be completely described in subsequent drawings. They would be fix mounted on the backing plate dust cove on the stationary end and the actuator portion of any of these devices would be fixed to the emergency cam lever free to travel normally when not in the active state.

Electrical Vehicles and Machines

In this 300 series section, the invention foresees a use for different kinds of braking systems as a possibility to conserve weight in the emerging electric car industry. The use of a wheel generator attached to each wheel could accomplish a number of functions as its fields would be energized for a braking mode. First the inertia of the car would be slowed by the load it will take to generate electricity which would also charge any electrical power storage system, i.e., battery. As a result the distance an electrical vehicle can travel will be lengthened in an efficient use of the inertia from the car to generate and store additional electrical power. To take this one step further, it is well understood that DC electric motors can be electrically configured to generate electricity as well in a reverse function. So the advantage here is that the same drive motor could be configured to be part of a generating braking system through switching fields thereby creating a complete electrical drive train and braking system, which saves parts and weight with the switching controlled by the accelerator and brake pedals. This will allow for an easy conversion to automated and remote control scenarios electrically.

In an all-wheel-drive, four, two, three motors and the like could be employed. Four motors if each wheel is to be outfitted separately for some all-terrain applications with their own final drive gearing. It is also possible to use a three motor configuration if just the front two steer wheels are outfitted with motors to give drive traction and the rear two wheels would have posi-traction or a limited shift drive axle with both wheels powered through a standard differentials with a single motor attached to the input shaft of the differential. Just two motors could be employed if the motor drives were on the input shafts of the final differentials for the front and rear drives. For standard two-wheel-drive, just one motor that either drives through a differential for the front or rear set of wheels, but in this case and the last one mentioned. The two motor four-wheel-drive for the braking function properly the differential would have to be either a limited slip and/or fixed differential. For front wheel drive at least a limited slip to allow for tuning and in this case probably other braking systems described in the invention will be incorporated cost effectively to assure a smooth control in the braking process to accomplish the stop and secure scenario and sophisticated remote control. Of course, any number of motors may be used, depending on how many wheel systems and power/torque is desired.

These standard final drives are detailed in this technology with electrical motors, and controls because, this is the evolution of the auto industry to utilize a drive by wire technology. So the control of these circuits and components was foreseen early on that will control speed, braking and steering will all fall with in the nature and scope of this technology to provide responsible and accountable remote control through any electrical and/or mechanical means. Also, with the electronic OEM wheel sensor controls and modules, e.g., electronic brake control module anti-lock system of today only the voltage considerations should be reconfigured and instead of activating any modulator valve it would just send its directions to an EVC module. An electric vehicle control module mini computer or controller that through silicon relays diode thyrister field weakening systems and field switching system would through its preprogrammed soft ware would direct the sending and retrieving of power discharged from the battery and generated from the vehicles inertia. This will save parts and conserve energy by the EVC1070 ability to direct current and the polarity from the motor generator switching circuit through readily available current sensing IC circuits available today. This EVC1070 control module will have this technology's PFN/TRAC system.

Many of the familiar standard driver controls of today, i.e., accelerator and brake pedals and steering wheel will be apart of the electric cars of tomorrow and other energy alternative vehicles. These innovations completely and fully describe and detailed in this application and the preceding ones can also be used on these new vehicles.

This next section, the 400 series, will presently be completely given extensive description and illustrations. Part 400 is the standard fuel pump assembly for today's vehicles. It comprises an electric fuel pump with a strainer and fuel level float sensor and in some cases a bypass valve. The control of the fuel pump is performed by controlling the power train control module circuit to the pump and not either though the interruption of the fuel pump relay and/or any other direct interruption of electrical power sources to the pump. There is in most cases two circuits that can supply power to the pump. While it has not been the intent to utilize the pump as a primary slow down mechanism and/or the direction for the experimentation and development of this invention technologies, the invention does discuss in detail certain technology unique to controlling the fuel pump and pressure related devices and timing control devices in a fuel injection system and throttle body injection system in a safe manner and presently claims them as. This filing of the invention's technology concerning the control of the fuel pump that was developed through the testing of other unique circuits and devices that interface with an OEM's electric pump and the vehicles onboard control systems and which are effectively used to slow and stop the engine are going to be described completely. These will be shown to do so in a unique way to anyone skilled in the art. These unique innovative methods are completely described and will be forthcoming.

This invention's unique process allows the interruption of the fuel pump and/or injectors without running any specific separate engine timing software program that times the injectors to achieve the smooth slow down of the vehicle. In one modality it employs the above-mentioned 1000 series trickster circuits to control the fuel and spark timing through simple inexpensive relay controlled pre-adjusted resistors and/or preset pulse generating IC chips to send the desired electrical signal from an interrupted sensor to trick the OEM electronic module system. But makes no changes to its hardware and software, i.e., power train control module, injector control module theft deterrent module, and the ignition module. The desired signal is determined by taking a reading of a sensor in the RPM and RUN state desired. Then adjust the variable resistors to a multi-meter readings for analog voltage and/or tune the pulse and/or width of the signal with an oscilloscope for any digital data streams to the desired respective frequency or voltage level. The resistor or chip is wired most generally to a double pole double throw relay, that either gives the OEM sensors signal for normal operation or disconnects the OEM sensor and sends the trickster signal that makes the module software adjust to a predetermined desired level.

The sensor circuits interrupted most generally for this slow down process and specifically in this modality are shown in FIG. 1 as 900 series part locations and are normally OEM sensors. These sensors will be detailed later along with circuit designs displayed so presently they will only be named and referenced to FIG. 1 for locating their function and purpose. 920 is the throttle position sensor that gives a electrical signal data as to the aperture of the throttle valve to the power train control module and ignition module for the purpose to adjust the mixture of fuel. 921 is MAF mass Air Flow sensor most time located in the air horn and not appearing in FIG. 1, but in subsequent drawing #11A-B part 142 it also provides information to the PCM for fuel and emissions controls. 905 represents the camshaft sensor and also sends its signal to the ignition module and the injection control module. 906 is a distributor induction pick up and also is used to control engine timing function ignition and fuel. 904 is a standard fly wheel sensing design used frequently on Jeeps 907 is a harmonic balancer sensor once again both of these sensors are used for engine timing. In most cases, only two of these sensors would require the 1000 series trickster circuits to achieve the correct electrical setting to achieve the slow down. This has been coupled to the earlier fuel valve system 403 or any of the unique ways to interrupt fuel flow by tricking the ICM and the PCM to send less fuel by the 1000 series trickster signals. As an augmentation to this system there can be an automated gate valve controlled by solenoid or servo motors and/or any of the actuating devices already referenced either mounted as an addition to the front of the air horn or anywhere in the air horns intake passage to gate and thereby restrict the cubic feet of air to a preprogram level that is electrically controlled by the invention and activated in conjunction with the 1000 series trickster circuits to control the spark and/or fuel to keep a balance mixture with the restricted air flow. Alternatively, any of the above described air flow controls effecting the OEM throttle could be employed.

In continuing to describe FIG. 1, 401 is the fuel tank, 402 the fuel supply line, 403 depicts an in-house innovative accessory an earlier design of a valve which has already been explained and described, and therefore, will only be referred to as it pertains to interface with other new innovations or as might be necessary to clarify its uniqueness from any other related patents granted and/or any pending applications making claims involving fuel system parts. 404 is the injector control module and will be discussed and how this invention if employed uniquely alters the modules functions and injection system. 405 in the front wheel drive motor location is the injector rail. 407 in the rear drive motor configuration is an injector of which there is usually 4, 6 or 8 to equal the number of cylinders. 408 is the fuel regulator on the return line to the tank to maintain adequate fuel pressure. Another unique device that has been developed in the testing and experimentation of the fuel valve part 403 is an automated fuel regulator that, through an electronic solenoid or motor or pressure activated, can be a variable relief valve that when it is activated and deactivated can dump or increase the fuel rail pressure that result in slowing the vehicle down. Experimental units have been used with the earlier discussed add-on air horn gate valve to better balance air fuel mixture for yet another smooth slow down, and/or in other device couplings used with the 1000 series circuit to augment timing irregularities for yet another smooth slow down. This automated and/or variable regulator will be illustrated and described in further detail as a possible augmentation for some vehicles to achieve a smooth slow down.

The 500 series innovations will be parts and devices that control transmission and/or transaxle (i.e., front wheel drive vehicles) functions that can first slow a vehicle down and ultimately engage the park pin through solenoids and hydraulic dump valves for hydromatic/hydraulic/fluid drive and/or hydrostatic and/or automatic transmission. Also, this section will describe how a standard or manual transmission with a hydraulic clutch, and/or a mechanical clutch assembly with cables and/or linkage can be disengaged and engaged to first slow a vehicle and stop its motion if detected by any vehicle wheel and/or transmission speed sensor. The complete slow down and stationary stop protocol of this technology will be completed with the motor shut down and the clutch will be engaged to use the motor to brake the vehicle. The transmission is locked in gear from a solenoid latch which is activated, when the clutch was disengaged to slow the vehicle. So now when the clutch is re-engaged after the motor has been disabled at a creep speed it will hold the vehicle in a stationary position. With the automated engaging of the clutch in most all manual transmissions, today cars will be prevent from re-cranking their starter motor, because of the safety switch on the clutch which will be operated in the appropriate manner physically or simulated with a trickster circuit from this technologies of trickster circuits 1000 series.

These devices and innovations are the same design as those used for the 300 series service brake system to activate and/or create brake pressure as these hydraulic clutch mechanisms usually use brake fluid. However, if they are hydraulically assisted as is the case in some instances the earlier hydraulic device actuators and electronic controls would be employed. If the clutch is a mechanical either cable or linkage controlled device the 100 and 200 seat controls and other earlier described actuator devices would be employed. For other vehicles already using electronic signals to control shifting and/or transmission functions through OEM solenoids and/or servo motors. These signals would be interrupted and/or augmented through either any on-board control module PCM and/or any add-on control circuitry and preprogrammed software already discussed extensively but will be further illustrated and explained as to the transmission function to slow and to stop a vehicle.

Slip Disk Drive Train Interrupter

Part 500 represents a solenoid or servo motor to automate the functions on a transmission in FIG. 1. 501 depicts another innovation that will for the most part be comprised of C.O.T.S. parts. It is an electromagnetic surface magnet grooved clutch disc that is attached to the fly wheel which is bolted to the crank shaft of the motor. The motor flange housing that mates with the bell housing has brush paws that make two circular rotation contacts on an separated circuit insulated disc that is attached to flywheel with the magnetic clutch device so positioned so that it can easily be repaired through standard access ports for a part failure and/or bolts can be installed to return the vehicle to an attached flywheel to torque converter configurations for any reason. The torque converter has bolted to it a flexplate and/or an acceptor plate with a matching grooved surface to accept the electromagnetic clutch disc and engage the torque converter transmission hydraulic pump, and input shaft to the transmission. The earlier mentioned brush paws would be connected to ground on one brush paw and an interruptible 12 volt service from this inventions control circuitry would be supplied to the other brush paw which would energize the electromagnet clutch disk and drive it with the rest of the above-mentioned powertrain. Other applications are for fly wheel inertia vehicles and the electric wheel technology not just for remote control function but to better control the transfer of energy to the wheels and/or other industrial applications. Racing applications for quicker starts and definitely in engine repair as to easing the extraction and installation labor in removing all the standard torque convert bolts from the flex plate, for this system. There will be complete drawings and descriptions of parts and innovative design modifications. This also is a unique device for other machinery and equipment to disengage any power transfer system.

Part 600 is an illustration of add-on brake system to slow and lock up the drive shaft. This configuration balances the internal drum to function well at the RPMs that the automobile requires. However, this drawing is another ideal place to show the position of such a standard braking device which is extensively used in industrial settings such as heavy equipment fork lifts, and even stationary machinery that have shaft to gear and cam drives, i.e., presses, paper cutters HI Die's and metal stamp machinery. Part 601 is a more practical application of an add-on drive shaft brake system and is used by some truck manufacturer and especially in the past. It is a disc that is attached to the drive shaft which is much easier to balance for high revolutions with the caliper mounted to the frame or more preferably the differential to ride more consistently with the suspension and stay more true to the disk and the shaft it is mounted on. However, the best location on an automobile and/or truck would be close to a center shaft and bearing and/or fixed rear mount transmission. Once again this braking device gains most of its uses in the heavy equipment, material handling and industrial settings. Because these brake devices share many of the mechanical and hydraulic components as the service and parking brake systems already described they too would use the 100 and 200 series actuating mechanism with the control circuitry that has been explained.

The 700 series involves a detailed description and development of remote control steering that will be commercialized in a specific manner and over a period of time. These device innovations to be automated for remote and preprogrammed controlled steering will be discussed in the progression that they are to be commercialized in the safest manner possible especially in the automobile industry, first PASSS, then PAGSSS, then robotics driving. There is a great need to control vehicles that are operating in a dangerous manner and along with slowing and stopping them an automated guidance system can increased some margin of safety to these already destructive situations in a lot of circumstances.

Along with the automotive applications some of the other types of power steering used industrially that will be automated will be describe in figure one briefly and covered in more detail with illustrations in the formal application. Presently in figure one these elements will be named and described clearly enough that anyone skilled in the art can easily visualize and create these innovations for the most part from the C.O.T.S. parts already in service in different applications today as described presently in the following modalities.

700 Series Steering Systems

Because of the many different steering systems, manual and power steering for vehicles and equipment, a little time is going to be taken presently in this introduction (FIG. 1) to detail the steering systems that will be in this formal application. And all the provisional and experimental devices and prototypes will be given some detail.

Part 700 represents a standard pinion, or a steering gear. It also could be a standard orbital valve that guides the hydraulic fluid to one side of the cylinder to dive a ram with a center mounted piston in a desired direction to steer the wheels, i.e., forklift industry and highlifts. Or, once again, as a pinion steer gear would drive the rack in the cylinder mechanically, while directing the fluid flow to power assist the piston rack in moving the tie rod ends to steer the wheels. In the industrial truck and forklift industry the orbital valve or the hydraulic control flow assist valve could be part of a steering wheel gear box assembly like 703 a power steering gear box, i.e., Saginaw ball screw steer gear box with a directional valve and is hosed to an assist cylinder to aid in a mechanical steering system. 701 represents a piston. Also, 703 is a power steering box that is assisted hydraulically.

However, in the normal automotive rack and pinion steering the steering gear will be all one piece with the rack within the cylinder and it is this system that will be most extensively be detailed and illustrated to show how automated steering can most easily be achieved not so much by altering the OEM's systems but by adding the automated controls to them. This is why some detail is given to describe the operation of the systems they are connected to. So, throughout this application extensive descriptions on how all the other steering systems will be automated will be described in as much detail as possible.

These 700 parts and locations named and illustrated are where the innovative prototypes are designed to be attached. The prototypes will provide remote and preprogram sensor control of the rack and pinion, steering gear, steer shaft, any linkage, steering wheel, and/or steer column assembly with some or all of the following parts, as they are present, altered or modified and/or innovatively provided for any and all the vehicles and equipment for remote guidance through this technology. These areas for automation will be described in detail. The first modality chosen by the invention involves the use of the 100-200 series seat controls cable drive motor electrically connected to a controlled reversing circuit as displayed in this application similar to the ones employed for the accelerator stop and the emergency brake actuator mechanisms. Which in turn is controlled by either a 900 series onboard controller (ESCM) through any controller, computer system, or comparable similar control technology, which can either be interfaced with this invention's processor circuits, computers, their sensors arrays, i.e, distance and camera communications, i.e., and control relays.

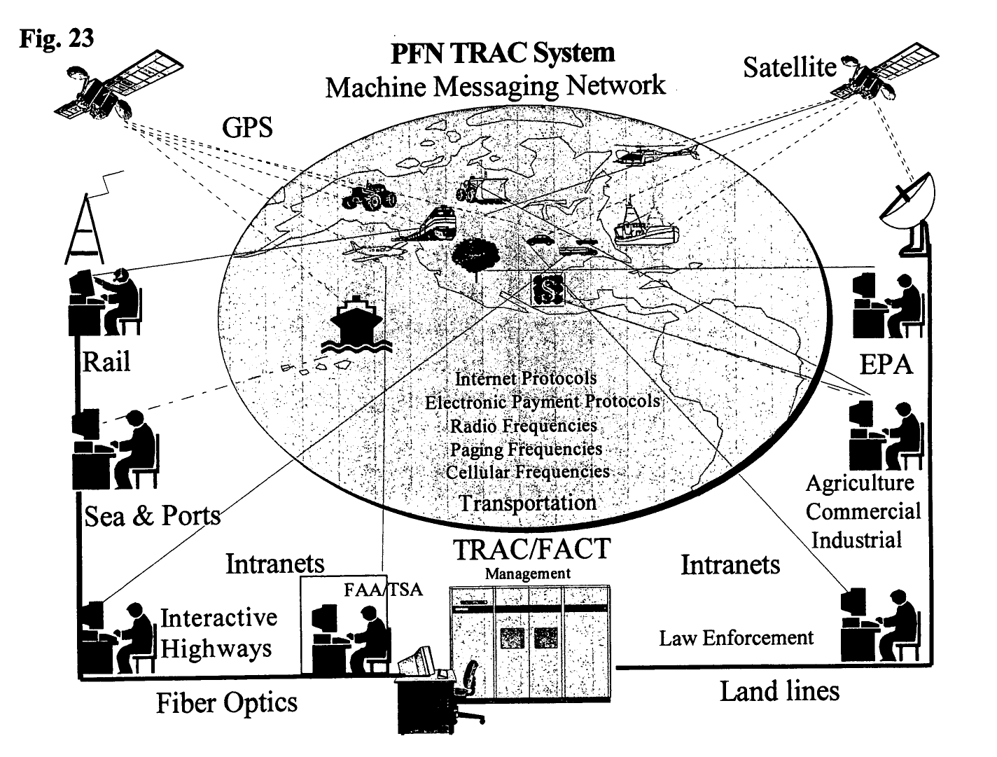

The 1000 series through 1200 series interface of these innovations will all energize the motor in either direction, with varying degrees of sophistication and responsibility. The 900-1000-1100-1200 series parts and systems will be discussed in full and in sequence later in this application. Only the vehicle steering automation will be discussed presently. However, all of these series will ultimately become a part of an intricate automated steering system. With the reversing of the motor being addressed completely in FIG. 4 and the motor assembly and the cable drive changing direction through electrical control circuits it is necessary to discuss an experimental innovation that has shown some promise for automated steering applications. It utilizes the same seat control device the emergency brake pedal uses the right angle horizontal adjuster drive. This drive has been mounted on the steering gear housing and/or supported on a bracket from the steering gear rack mount bolt so that it is in alignment with an add on gear 712 FIGS. 23A-B on the stub shaft of the pinion gear. There also is a pivot end mount on the horizontal gear activated by a solenoid to tilt the gear down and mesh it with 712. Otherwise, the stub shaft will free wheel, i.e., normal steering There also is some experimental work with small Air Condition system of electromagnetic clutches attached to a stub shaft with the inventions gear a variation of 712 that meshes with the horizontal drive being held in contact with the electric clutch surface, so when energized and pulled away from the inventions splined slip sleeve or collar which is connected to the steer shaft column linkage with a special column mount. All variations of the 712 part will be fully detailed and drawn in the formal application. Both these systems will work in automated steering applications.

A second modality to automate the standard rack and pinion power steering is to access any section of the steering wheel shaft and mount a gear or a sprocket or a pulley around its circumference and connected to a drive that would either mesh or be chain linked or even belt driven to the same or similar type of drive motor assembly, i.e., seat controls/horizontal adjuster drive with electric clutch, as described above and controlled in the same manner, and/or instead of a chain a cogged belt or v-belt with a shive mechanism or a locking cogged hub that is solenoid activated or electromagnetically locked in, e.g., electric clutch which gives control of the engagement as described and employed above already. There is another completely different steering modality.

This third modality for automated steering involves the hydraulic piston system of steering, and in this case the hydraulic delivery lines that activate the directional throw of the center attached piston to the ram would have their fluid flow controlled through a electronic solenoid shuttle valve circuit that is energized only for remote functions through a series of Waterman solenoid control valves first to activate the remote control circuit and also to control the directions. The shuttle valve could be a dual-sided spindle type valve that would control the flow through the orifice by degrees, this function could also be activated by a ball screw piston drive that would pass thorough the center of the double pointed piston to control the flow to each side of the piston. Also these types of control valve systems will work to turn directionally any hydraulic motor system to drive a strip gear in either direction. Most of these hydraulic systems are used in industrial slow speed applications like, e.g., lift trucks, hi lifts articulating loaders. All these parts and components will be detailed itemized and completely described and for the most part are comprised of C.O.T.S. parts for the initial offerings and prototypes.

The 800 series parts are various modalities to disengage rear ends and/or differentials, transaxle final drives, and rear axles to deactivate an automobile from accelerating through the final transfer of power to the wheels. And, then, secondly lock up the differential and/or final drive systems after the vehicle has been stopped and the motor has been disabled so as to secure the vehicle in a stationary state. 900 series parts—916-17-18-19 and/or 908 would serve as the monitoring devices, i.e., these standard speed sensors will report on the stopped and/or slowing condition so that the stopped state could be achieved and secured. The first modality for this altered differential would be to have a internally splined slip collar that is circumferential grooved to accept a fork lever arm that is either connected to an internal solenoid or servo motor or has a sealed shaft to an outside actuator mounted to the housing like the high low differential shifters on many trucks today. Another embodiment of this modality would be to have an engaging disc that normally road with the Bull gear and was connected to the planetary assembly which transferred the energy to the axles either by a solenoid that shifted out of the splined center hub of the receiving bull gear or servo motor and/or electromagnetic clutch, or in this case interlock. 801 displays the solenoid and/or servo motor external placements. As for the internal placements and types they will be fully describe and detailed as will these shown in figure one. The final modality 802 involves a slip sleeve either to an axle and/or in any wheel hub that will allow one wheel to free wheel as if a axle has been broken and can not torque against the other to propel the car in either direction. Once again these devices would be controlled electrically but could also be actuated hydraulically or any of the ways described extensively throughout this invention.

Introduction to the control devices, on and off the vehicle, include some which are already existing prototypes with their accompanying drawings and others will be described in their experimental and present design state. Also as they are described they will be explained as to how they are planned to be commercialized to maintain the safest and efficient marketing of these innovative devices to automate vehicle control. These devices described within this application or ones very close to them will most probably be the automated devices that remote control and computer systems will be governing to some degree everyday from the present long into the future. That is why this technology's product developments have been designed and developed first from this primary remote control device application and will be expanded to encompass every needed remote actuator to accountably control humanities equipment worldwide, from the PFN through TRAC software, a programmable and modular software system.

Those functions by onboard robotic systems and interactive highways, commercial and, governmental and/or industrial system, computers will complete the ultimate robotic interface of artificial intelligence for societies machine use through controllable machine messaging as has been detailed throughout all the related patents. This will involve all the series devices from 900-1200 electrically and electronically hardware, hardware imbedded software firmware a, software and encrypted systems. For this reason it is necessary to discuss the remote control devices and systems that will be utilized by law enforcement to control most especially the steering function but will also allow them to detain a vehicle through the slow, shut down, stop and secure device; protocols PASSS and PAGSSS, through all the specialized communication and control systems that will direct these automated controls of a vehicle, i.e., laser guided modulate signals, microwaves, receivers and transmitters set to respond to specific police controlled frequencies and provide instant vehicle identity (ESN), so that a vehicle can be singled out specifically, that is speeding or more importantly requiring immediate remote deactivation for public safety concerns.

In FIG. 1, 902 is a new innovation the electronic control steering module (ECSM), part of PAGSSS program. This module will receive its data from the computer which relies on the video systems and distance sensors on-board to give eyes to the vehicles guidance system. The electronic steering module will receive some of its sensor data from the EBCM the electronic brake module as to the coordination of controlled braking and the effortless control steering in GM cars. A Pintle valve in the power steering pump and controlled by the OEM EBCM relying on the steering wheel sensor data retrieved and processed to control ease of steering vs road sensitivity at higher speeds will be interfaced with the new innovative ESCM which will control the pindel for pressure and a second control valve system, e.g., electro solenoid Waterman valve will, control the hydraulic flow and direct it through electrical circuitry to energize either the oil flow to energize either a piston direction or hydraulic motors. ESCM (electronic steering control module) also can serve as a two way switch to direct the seat control type motors to rotate the steer shift linkage and stub shaft parts to steer left and right for the rack and pinion steering, modality, etc.

The 909 sensor array multi-antenna and target system is coupled to long and short range transceivers or crystals in the 900 control center. These transceivers will be completely described in the 1000 series devices. It is these devices coupled with police operated transmitters with special security measures that will allow an officer to point and stop a specific vehicle and/or control its automated systems. The law enforcement officer using this device will have his badge number or Social Security Number encrypted as part of the signal given to detain and/or control a citizens vehicle, which will be recorded in the inventions permanent record device as well as any accumulated sensor data from 909 and in the cabin audio video recorded data regarding the incident. The hand held device probably later consolidated as part of a radar device will be able to verify the officers identity before a chip inside the device will allow the device to work in stopping a vehicle, i.e., Lockheed Martin fingerprint system or the new system that can identify a gun owner and only let that person discharge the weapon with the needed accompanying identity wrist band, etc. All the possible identifying systems that prove good C.O.T.S. candidates for this purpose; and the stated purposes of the invention, i.e., earlier filings and driver identity systems, will be named and described as to how they can be utilized. Also earlier in prior applications interactive highway systems and commercial servers can be used to confirm logged on officers in a particular patrol area to authenticate an officer for the worried motorist through the various communication devices on-board their vehicle and these interfaced systems.

The 900 series is all the OEM's electrical components and others manufacture's add-ons along with this technology's peripheral sensing and control circuits to interface everything into accountable remote control systems. They are the primary electrical components and major computer controls, including the communications and GPS components, record keeping devices and sensors, all initially as C.O.T.S. innovations, which have always been a claim of this technology as well as, any type of physical secure interfacing for these devices and components on either a host vehicle or any piece of machinery or equipment. These initial 900 series C.O.T.S. products are thoroughly interfaced through many innovative 1000 series circuits and control systems, which are uniquely evolved to consolidated and integrate into a multitasking solid state system that will also benefit from this technology's claim of physical and legal protection with a secure environmental encasement to meet society's need and requirements to provide accountable data storage in the remote control scenarios and to protect other vital and expensive electrical components in a PFN containment. This claim for accountability and protected circuits including any and all of the necessary types of record keeping devices/systems and identification equipment/systems detailed is considered to be of a great and unique societal importance and value for the responsible development of automated remote control systems and robotics, along with the TRAC system, to authorize and authenticate commands and activities. And has been so stated as one of three most important and unique properties of this technology, with special emphasis and recognition here on any protected record keeping, locally and remotely, for society's accountability as unique to this technology. However, any and all attempts to protect any circuits to provide accountable and/or responsible remote control no matter what the specific circuit design and/or application and/or function should all be considered to fall with in the nature and scope claim of this technology.

It is immediately apparent that this technology has been expressly and inclusively designed to easily couple and provide technical interfaces and cooperative commercial settings to quickly and efficiently support any existing manufacture efforts in all of the effected industries with valuable commercial technology, plus a real responsible direction and insight to achieve accountable and acceptable automation and remote control for mans machines around the world. While, these control, communication and record keeping innovations are discussed and detailed at some length in this application the real focus of this filling is to detail the actuating devices on the host machinery. And also, to detail the on-board accountable sensing devices and systems that will report back to these above mentioned control, communication and data storage circuits and devices with data about the responsive actions from any of the remote and/or automated monitored activities that are a result of commands given and/or received from these same circuits and devices contained within a PFN as the most ideal setting.

Part 900 is on the vehicle command center or Protected Primary Focal Node a (PFN) which will ultimately be a protected and secured in, for example, a single location housing, but presently will also take the form of a series of equipment interfaces possibly housed in a number of locations on the vehicle to best combine all the present OEM, and C.O.T.S. devices, (some of these are protected and shielded and some are not, however, the accountable recording devices will all be protected from environmental damage, and tampering, as well as the accomanying TRAC software). All the OEM control systems, communication systems, geographic location systems, and trouble code data storage systems, will be interfaced with this technology's control devices, communication systems and sophisticated data storage to provide and fulfill the inventions stated purpose and capabilities, which is to be a sophisticated and accountable record keeping system capable of recording and reporting back on all vehicle operation, operator activities, and environmental data recovered, as well as, directly control the vehicle functions through these presently described automated devices, innovations and adaptive modalities of C.O.T.S. and products and OEM equipment.

920 is the powertrain control module. 940 through 959 is this technology's computers, programmable controllers and/or simple control circuits (also detailed in patent applications PCT/US97/21516, U.S. Provisional 60/122,108 and PCT/US99/00919) to control all the desired automated functions in this application. The reason the invention has 19 numbers allotted to its own control circuits is because it will have many various designs for all the specific vehicles and/or equipment as all these systems interface, and merge with. However, basically there is only 2 levels of computers. The 940 series and the advanced 950 series. 940 is the first inexpensive (Parallax ) Stamp I, Stamp II and the 188 euro-board 100 programmable controller and/or computers for the present prototypes of this accountable remote-control invention. These have been planned and configured to evolve as either a series of stamp computers to complete all the necessary functions for most any vehicle automation and communication routing, as well as, data storage routing desired. Of course, other computers may be used.

Most likely, the invention will seek to consolidate as much as possible through 949 into a more sophisticated mini computer like the 188 mentioned earlier, that can be tailored for the desired functions through a limited amount of hardware connections and software programs, so as to consolidated all the functions more efficiently. 950 is the advanced total equipment computer and/or programmable controller (with 386, 486 and/or Pentium processors on 100 euro-cards with plug in edge connectors that can run all the robotics and accessory functions driven by other plug in cards that function also function as communication modems and that can incorporate all the crucial OEM control software or can even replace the OEM circuits as well as, handle all radio and cellular phone interfaces and modems (with the appropriate firmware and software to even function as a mobile work station PC for the automated commuter). All will run TRACT software to be made part of any accountable process, as determined by application specific standards.

With respect to 920, Philips Corporation in Europe is one of many companies developing sophisticated automotive electronic controls to handle a lot of these accessory duties. There are many other manufacturers in the electronics and automotive industry that are doing the same. However, this technology has been designed to do all these functions in different and unique inexpensive ways to drive this development with real responsible commercial direction and to combine any and all existing manufacture efforts, as well as, enhance any and all of them through this technology's vast versatility. This has been done to insure the most complete and accountable development in all the remote control fields for all types of equipment including all forms of machine messaging, communications, control circuits and computer networks as well as all the detailed peripheral devices. 951 personal computers (laptops, organizers and notebooks) 952 and 953 voice recording devices 954 equipment data record device. 954 video record log inside cabin 955 outside video record log 956, i.e., with all records burned into condensed or compressed on Disks or comparable storage system or held in RAM chips and/or a hard drive device.

Either and/or all the systems will be able to preserve and protect software determined relevant as application specific data for authorized retrieval from a physical and legally protected area. Even though the functions are given different numbers here for easier understanding; the data will be stored primarily in two forms on any vehicle and/or piece of equipment. (a temporary real time limited storage and a application specific permanent storage that will have a redundant off-board storage by being reported to at least one remote location in any of the two way communication systems. All these devices to 955 will ultimately be part of the 950 series vehicle computer with the capability to support keyboard operations, along with this technology's steering wheel mouse control device. Also, all systems will be voice recognition and command capable with basic learned operator commands (in any appropriate language). The system will also provide dash displays and other cabin displays including being capable to support the electrical and computer service for a hologram wind shield or screen display, i.e., like the Pontiac Grand Prix for partially and fully automated travel and to provide a work station if so desired. Drag, point and speak and other programs are detailed in the PCT/US99/00919, however, all these systems will be detailed more in this application and in all the other related applications. 960 has been reserved as an interim area to cover C.O.T.S. record storage and communication systems. GPS is included here as a data receiving communication system and the computer systems will ultimately run the software right on-board through programs like Delorme's “Street Atlas” rather than rely on a gateway control computer link like that used by many of the car manufactures monitoring and service programs (e.g., GM's OnStar program). However, this technology can marry well with any of these monitoring systems and still offer more accountable aggressive remote control enhancements to their existing systems. All these systems will ultimately be consolidated into this technology's 950 Equipment Computer Control Communication and Records unit. This 950 “ECCCR” sophisticated unit will contain the electrical guts for the most desirable protected PFN components and will have universally compatible hardware and TRAC software to create the brains of the invention in one location on each piece of automated equipment. It will be accompanied with all the described sensors and communications systems, as well as, a sensing system for these described automated motorized innovations.

With the 950 control circuits combined together with this patent application's electrical actuators a system, similar to the neuro-muscular functions in humans, can be created for most all of machine use, and it will be made completely accountable for robotics through a machine messaging network that can perform and review performance responsibly for any and all desired remote and automated functions, through TRAC system software. It is a primary goal of this technology to provide a secure electrical interface platform and containment for accountable remote-control and to established it and certify it as a standard for all the industries. So that all of its designs and uses can be regulated and written to by the appropriate governing agencies, institutions, industry associations and/organizations when they are developing their rules, laws and regulations that will control remote control and robotics activities for humanity. This is the purpose of the PFN and a major goal of this technology.

The 960 numbers have also been issued to more easily describe the 1000 series trickster circuits and specifically designed connectors and fasteners to interface these computers and all the other systems till they evolve into one hardware device and one system with more consolidated and compatible TRAC software for the 950 ECCCR. The earlier 900 numbers will be kept for all sensors and the normal auto electric devices generally in use on most all of the equipment or vehicles today. 920, the powertrain control module and/or vehicle PC or computer, ideally and ultimately be protected in the secure box or PFN and so legislated as a standard by congress with regulations from DOT, DOD, Highway Safety Commission, Law Enforcement (justice department and insurance concerns and companies, as well as, to maintain fair trade and commerce for equipment and vehicles for the life and use of these machines in society). And every effort by this technology will be made to coordinate with any standards effort for these merging technologies (i.e. control circuits, communication, data storage, environmental monitoring, remote control device for vehicles and machinery etc.) with their manufactures to commercialize the best product offerings for the public, while helping to structure their safe and legal use.

The 900 thru the 1200 series starts with the 900 series onboard devices and control systems to achieve a full interface with the off-board 1100 and 1200 control, monitoring and service systems, as referred to in U.S. Provisional patent application No. 60/032,217. The 100-900 on-board automated systems and the OEM's electrical components interfaced with all the inventions, sensors, recorders control systems and communication links will form this most ideal focal node and mobile interface platform for this technology to perform its function. This PFN function was described at some length to show the full scope of these innovations as needed elements to automate humanities machinery for responsible remote control and robotics.

The 909 sensor array assembly that is responsible for gathering a lot of video data, for recording and also responsible for retrieving distance data and receiving communication data is going to serve as an introduction to the 1000-1200 series devices and systems. This introduction is meant to accomplish two things: first, to show how these automated devices in this application will evolve in their usage with this total technology invention, and second, to give a collage description of how the devices will all interface to achieve the stated purposes of the invention and the full potential of these new innovations. This is by no means a minimal effort. It will be very descriptive and easy for one skilled in the various arts to see that the interfacing of these C.O.T.S. systems are well with in the grasp of the invention's technology and its capability and design to develop these systems commercially.

The 909 has an inexpensive camera, 910 which will be continually running, while the car is in motion. There is also auto run software to operate the camera when the vehicle is in a parked mode which will be detailed later (“Spider Eyes”). However, normal monitoring software in the invention's computer will pick up input from the distance sensors part #911 and direct external cameras to snap picture of impending contact and record data that is valued by the inventions software (application specific for a crash or traffic altercation, etc.). The computer will have certain powers to discriminate on the storage of records to save space as defined by application specific software. It will also imprint on any valued record the video camera ID location F_R_B_L which will identify the recorded view from the front, right side, back, and left side respectively thereby displaying on the video record the moment of impact and any other vehicle image as well as the angle of impact. There is also another video or digital camera system detailed in earlier related applications with only one roof mounted camera location. This drawing shows four locations for the 909 sensor array system, however not this many cameras are necessary at first or ever. FIG. 1 is descriptive of the views not the specific camera locations, however, permanent distance sensors, and the short range communication link or police targets 913 and interactive highway communication or combined antenna systems 912 also have fixed mounted locations.

For example, one modality needs only one standard (monitor or Cp) camera to be mounted on the roof (mentioned earlier). This camera is placed in an aerodynamic one-way transparent but stealthfully concealed dome, which allows it to rotate invisibly on a position plate outfitted with a contact arm that rides on an accessible variable resistor coil's windings to sense different current levels or on a sensing disk that will send a different digital electric signal that the control computer can delineate as a specific camera position. The first design is analog but the second is a digital system that can do this function as well. The computer then correlates the signal sent as a set degree of vehicle view where the camera is pointed to by comparing the distance sensors electrical signals showing the closest object and fastest moving object approaching the vehicle, which are optionally prioritized by a compare list in the application specific computer software for, e.g., auto altercations, etc. The computer then electrically operates by servo motors the camera to view this incident while recording the degree angle of impending contact. 0 angle being relative to the vehicle which will always be dead ahead or pointing to the front, perpendicular right 90 degrees, directly behind 180, and directly left 270 degrees as reference. Other reference angles may also be used.

As mentioned earlier, this data is processed through a compare list function in the TRAC and MASMP software from the position disks electrical signal as it correlates to increments of a full 360 degree circle sending different electrical signals (levels of voltage or digital pulses) as it is guided by the distance sensor signal and compared by the computer software. The more sophisticated the computer, the longer the software compare list and the more discriminatory and efficient the camera angle views and the speed they are run. The computer will record, optionally, in snapshot mode to save storage space or record in real time video movement with the computer's software determining which mode is required for the record and/or by the capability of the system on-board. Of course, recorded impacts will be prioritized by any software as reported by crash deployed protection devices or specific sensors for surveillance for the purpose to best record as long as possible all the contacts and preserve them in the inventions protected storage area, all managed by TRAC software.

The invention will employ the C.O.T.S. devices presently available, i.e., the many automated camera systems, and computer monitoring programs used for surveillance and seek to incorporate and interface with them and then consolidate and sophisticate these systems as this inventions unique use and function for these devices are developed into the most efficient and inexpensive system for the public. Also the invention will seek to combine the emergency 911 system through its telecommunications and police radio frequency companies like Lojack, On Star, and all the other supply line law enforcement suppliers with their electronic components into using the protected containment and unique interfaces to organize and combine, as well as create a mobile vehicle platform that can fully service the public without over duplicating functions and creating more unnecessary equipment cost for the providers, servers, and the individual public.

These records will be maintained until they are removed or downloaded by the proper authorization (part of TRAC protocol) and will trip a trouble code to show their presence in the PCM module or in any other appropriate control circuitry onboard and energize a light on the drivers instrument panel as well as either energize a small colored light in the exterior license plate areas and/or ultimately send a short range RF signal that is received by area police receiving nodes or interactive highway systems that might be called to respond by sending services to an accident scene or provide law enforcement. The RF signal (possibly a Lojack device or cell modem dialer) to a 911 node or non emergency police phone node a function determined by the invention software determining impact or reason for the transmission. Any communication will also give the vehicles electronic serial number modulated with it, i.e., same as a VIN # all vehicles are given through government guidelines and correlates to any specific vehicle storing possibly related records. This signal could also be retrieved by any interactive highway system or off-board monitoring service that can store for the authorities in a buffer for later review if more information is required to analyze an incident, then clear the vehicle TC (trouble code) with the information saved either in a remote location or physically recovered in a portable data storage system, all managed by the TRAC software, programs and protocols. The 1000 series on-board communications and interfaces will have a section that completely describes the racking or stacking of transmitting and receiving devices along with the refined PFN product development that combines a universal amplifying system, as well as, a combined antenna system to consolidate, conceal and save space. However once again the C.O.T.S. systems will also be described and how they will be interface and connected at varying degrees and diversity which is an advantage in the C.O.T.S. modalities, but normally means a trade off for space and time of use for these assorted devices. C.O.T.S. systems are also good for building a vehicle or machine system incrementally for specialty needs, which in some cases might be the correct choice economically and especially for retrofitting older equipment.

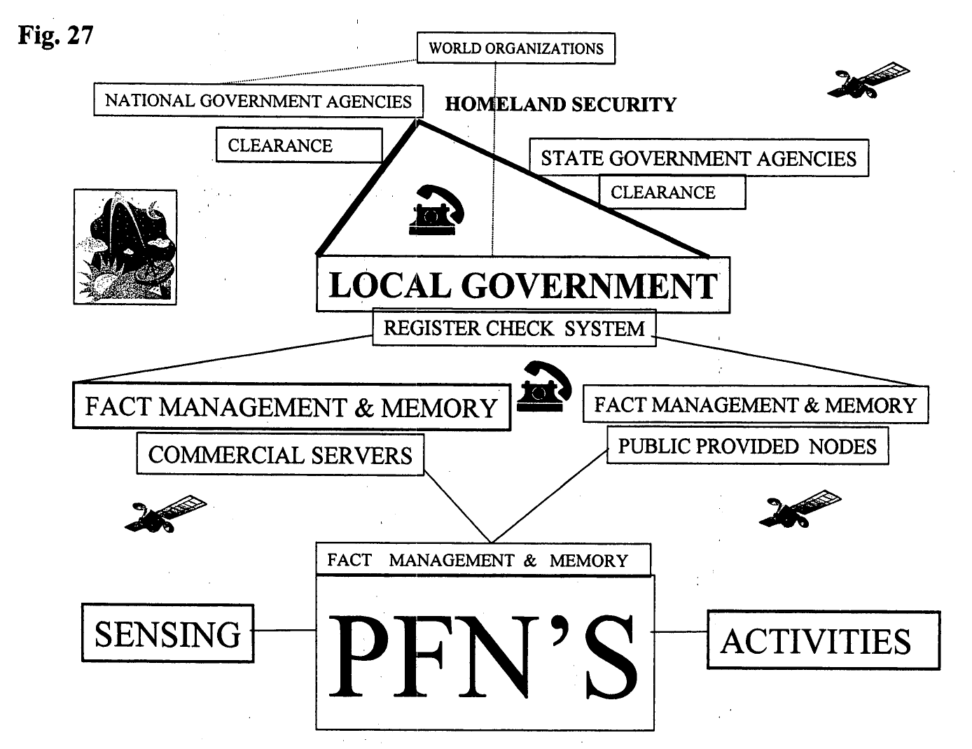

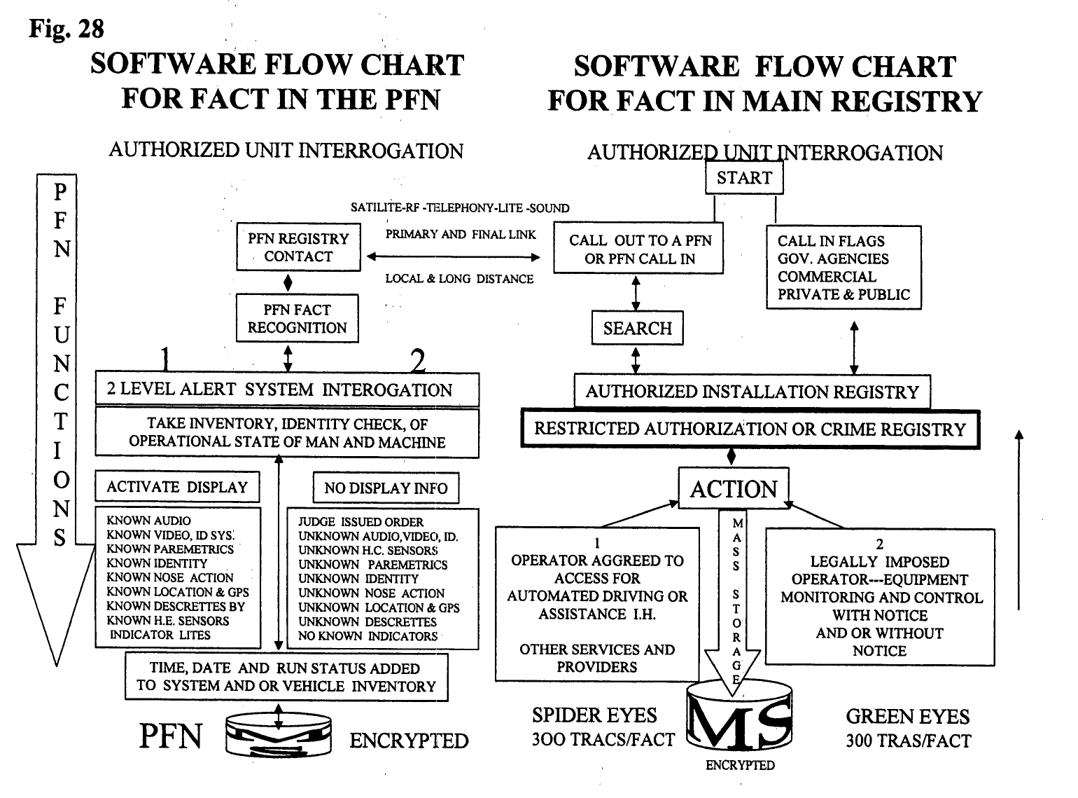

1100 series is basically the combination of the smart car devices for automated and remote control of a vehicle to interface with and communicate with other vehicles and the interactive highway's. The vehicles will be able to communicate with the Interactive highway control center through the specially protected and regulated PFN's or areas which will house at least some form of recording equipment and monitoring equipment to make all these automated devices and control devices as accountable as any driver must be for any control actions, when either any onboard and off-board control devices perform, automated vehicular control. Because this is ever so important as humanity computerizes its vehicular traffic patterns and controls that movement through these computer systems and remote control devices to achieve fully automated robotics travel as detailed in FIGS. 27 and 28 of this application as well as all the related patent applications.

With the introduction for the 1100 transportation and 1200 Public service Net or Web system to describe the 910 on-board camera system and its alternative public functions and uses, the present invention can call 911 automatically, when the vehicle has been in an accident and notify the 911 system of its location and the vehicle speed that the car was going, when it had the accident. The invention has this capability as well and it has always maintained it is capable of reporting and recording vehicle function in the event of an accident as well as preserve an on the vehicle record or report this data to preserve a record off-board though any provider and/or server system desired or authorized as a solo system or as a gateway to larger networks. This has always been an integral part of the earlier Black box system as has been described in U.S. Provisional application No. 60/032,217. Where the 911 system has been discussed as part of the public net work that would be involved in the black box and billing box vehicle units that were designed to interface and network with these commercial public servers and government provider systems. In PCT/US99/00919 and U.S. Provisional application No. 60/122,108, these companies and agencies are detailed as part of the worldwide web to handle the accountable PFN data as servers and providers for remote-control and monitoring purposes, both for individual and private applications and also for gross commercial and mass or public monitoring and control by consensus through the public provided web pages as detailed in all the related applications. All of these functions will be managed by TRAC software.

A moment will be taken presently to describe more fully the law enforcement section of the 1200 series systems, which is a network this technology calls (SPIDER EYES). This is one of the areas that will be termed a provider area, because it will be providing services for and to the public directly controlled by the government with duly appointed and/or elected agents to work collaboratively with the public to improve public safety. Throughout this technology an effort has been made to define the term “provider” as more than just a commercial service. It may well be a commercial server that provides a public service link up or interface or acts as a server for a public safety service, however, when this is done as a public safety service it should be recognized as such by society and exempt from tax and even remunerated for any operational cost by the community. This opens the door for these presently expensive communications system and commercial companies to provide highly specialized and regulated contract monitoring systems to defray the total consumer and citizen cost to provide greater public safety and remote control services. All these commercial support provider services should be commercialized at the very least like utility companies so they have to answer to the public's concerns, through periodic reviews and public board meetings or forums. These contract providers would have to be bonded licensed, and be able to meet any needs to track communications and machine messaging to maintain accountability in reporting and recording any and all transmissions (like through TRAC system software), and there would be bidding for any specific area that limits or has limits on how it can process its emergency communications (e.g., 911, etc.) so that the qualified commercial providers would have a fair and equal chance at the business. The TRAC software provides for a federal standard, which is termed FACT, Federal Authorization Control Technology.

There can be coordinated and licensed commercial servers that can supplement and expedite many services for the populous and aid in keeping government cost down and developing and improving the technologies. However, when they are handling legally sensitive and/or personal data they have to do it according to the laws of the country and any prescribed rules or regulation of the jurisdiction and/or combined jurisdictions they are being operated in. (This is a given, but an important public accountability issue.) The invention seeks to make accountable these technical developments by addressing science, technology and society as the invention's full scope and nature, as well as, deliver invented and innovative devices that can achieve this automation responsibly and accountably for humanity and be equally responsible to the earth's environment that supports humanity.

These on-board recordings and redundant reporting start in the vehicle along with the devices to communicate the data, whether they are in the vehicle as a transceiving device or transmitter and/or part of a physical or close in scanning tool invented especially for this purpose to recover the record, e.g., the invention seeks to construct with other C.O.T.S. technologies already commercially available in this field a hand held device for the police that combines radar, a close range vehicle remote control communication device, and a record scan device, that will send its data back to the vehicle cruiser computer via com port or protected transmission. These could be infrared corn ports for quick transfer and all these system options are detailed in PCT/US97/21516 and PCT/US99/00919. Also, the information could be gathered as described initially when a vehicle has an activated record ready to be reported and/or retrieved it would energize the record trip light and flag the trouble code mentioned above. This record along with the video recording will also have audio recordings inside and outside the cabin on separate tracks that are dated and give the time as well as the geographic location of their tripped state in a statement message. There will be many convenient data retrieval devices as part of the invention ability to develop new commercial enterprises and services. One such new enterprise will be certified retrieval and data transfer stations or receptacles that will be able to transfer the data to law enforcement, whereever law enforcement is unable to retrieve it or adequately store it. This will also be wirelessly reported to authorized service providers through TRAC and FACT, to be stored in mass data facilities.

1100-1200 Spider Eyes and Green Eyes programs are to be responsible and respectable public safety programs that will have great data collection capability and remote control in most all life situations. So it will be governed with the strictest rules and regulations that respect individual's right to privacy. (The highest standards of professionalism a necessity at the very least). In fact, this technology will work very diligently to help insure that the strictest penalties are in place and readily applied for those who abuse these systems and the personal rights of the individual. This is an absolute necessity for this great data collection technology to serve humanity in a democratic fashion and to maintain the most important elements of life in America, which is maximum human freedom, liberty and dignity, while providing the greatest individual public safety ever known to man. This can be done with respect, responsibility and a mature understanding of real freedom. Then this technology and all the other great data collecting technologies could truly serve humanity and possibly reduce the chance for misuse for selfish reasons. So much time is given here not only to how the technology can be built but also how it can be responsibly used.

Now, to return to the retrieval of Traffic Data or Incident crime recorded data as determined by application specific PFN software detailed in all the other related applications. To make the recovery of this data convenient for the public there will be responsibly licensed persons or commercial business, i.e., notary of the public. Most dealerships, banks, or law offices have such people in there employ. And these devices should be in there charge for this purpose or under their direction and responsibility as they have to take an oath to perform their functions in a legal manner as prescribed and licensed by the state. Other such professions that are charged by the public such as the judicial system also take oaths and could offer this commercial service, i.e., law offices can set up retrieval scan devices and forward them on to the proper law enforcement data storage centers through standard telephone data nodes in their area. Licensed insurance agents and companies could also review them. This could be done to serve a dual purpose for the insurance companies. One for adjusting rates for driver performance all within the scope of commercial accountability for the invention. And two to help lower government cost in reviewing these records for other criminal activities. So it can be earmarked for further consideration by law enforcement. These records could be filed in the same manner that the electronic tax filing is done today, where they are stored on mass data cassette like Sony Peta Systems which are described in PCT/US99/00919, and further detailed as Incident base reporting for the Justice Department.

More ways to achieve easy retrieval of such information including automated retrieval scanning machines at service stations that are connected to standard telephone land lines which transfer it to law enforcement nodes (local police, state, or the UCR, FBI and/or any instantaneous retrieval of the record reporting through cellular phone systems and all similar technologies directly from the vehicle as has been continually referenced and completely described in all of the applications. Also commercial server industries like, i.e., banks and credit card companies that want to offer these services. When remotely transmitted by wire or wireless RF equipment or telephony technology TRAC software, FACT will encryp the data.

In direct retrieval modalities, the data would be prioritized by a screening process in the TRAC vehicle software as to if it required an emergency response or if it was to be transferred over the non emergency telephone node for law enforcement review where the off-board TRAC system would process it through its automated comparing soft ware which will look for, three significant components, location, time, and the numerical characters that will comprise earth coordinates from any onboard locating device, i.e., GPS System. These latitude and longitude and date and time coordinates will be easy to run in a quick mathematical compare list algorithm software program in a gateway, or central computer or from any network data running or stored for computer access. Computers sharing this specific police report data base and/or DMV data base will be able to readily respond with warrants not only on tags and vin numbers but also give a registry of electrical serial numbers of equipment operating on-board any piece of equipment listing its command path. This will provide greater indentity information and less chance for undetected unauthorized use of vehicle and equipment. These other alpha-numeric number will be the electronic SN's and/or vehicle Fed VIN ID number of the recording vehicle. Ultimately the computers on-board a piece of equipment will synchronize its on-board clock to the time zone it is in geographically if this proves advantageous in a legal setting where a vehicle has recorded an incident in question and it has crossed a time zone in that process. The Clock updates are easily provided by any of the GPS systems on-board as well as any of the other cell phone and locating programs. Another option is the Zulu time system for all around the world. However, at this time it is important to point out that this new system HAS TO BE 2000 YEAR COMPLIANT—MILLENNIUM AT LEAST.

In summary, this application specific software would search for a recorded location that coincides with a reported crime and/or traffic altercations under investigation. The second search would be to match the date and time to the first location match from the stored law enforcement reports in the database. All this matching data would be stored somewhere in a law enforcement file or buffer or readily available mass data phone node connection which is automatically dialed if there is a high correlation flag on these factors for a prescribed period of time or forever if it witnessed or evidenced any place that was considered significant to any reported unsolved crime or capital offense. Or till the responsibly charged law enforcement individuals deemed there is no further need to preserve a record.

Once again, the recovery of this information for the law enforcement officer could be immediate and ultimately would be combined in one set of devices, i.e, the short range transmitters, remote control device combined with a radar system. Then this innovation could stop and detain a suspect vehicle while retrieving any tripped records on that vehicle and with the speed of electricity send all this data to the officers cruiser computer screen and communicate the same data back to law enforcement's data base monitoring the stop. The officer could also store this data in the cruiser's computer recording storage file system to aid in filing reports taken from the cruiser's RAM or hard drive when the shift was over. By downloading on a daily event disk along with the officers comments, this data would be downloaded at the end of the vehicles daily use or as its daily fluid checks and safety equipment checks were being performed. The officer can also bring up the file on the law enforcement's data base as it was sent instantaneously. However, to do any of these transfers or processing or to even view any record on file in any stage and/or location of this system a badge number or special ID number must be given and software approved which will be recorded as to who processed it or accessed it or simply viewed the file and from what organization along with when and at what terminal during any move or copy transfer process. This will be logged as part of its electronic paths and held in a header or footer statement. This TRAC and FACT software technology is a necessity for these records. This will be done in part to secure data in as pristine and accountable state for legal use and also for accountability for individual privacy. The goal is total accountability and quick authorized access with individual privacy maximally respected and protected. This system could either be a part of the ever growing computer system that already exists in many computerized cruisers. And this will be the first deliberate commercialization of the invention to marry these law enforcement innovative tools to the commercial companies offering technology in the law enforcement area presently.

The 1100 and 1200 series systems are not dealt with in this application because they involve the processing of data with off-board systems, and are covered in PCT/US99/00919. However, the invention has as a goal throughout all these technology applications and innovations to look for companies like Lojack, OnStar and any of the cellular phone and land based telecommunication companies, e.g., security monitoring companies, as well as, any computer companies that can work well in these areas to develop this technology in the most efficient manner to limit any needless duplication for the 1100 and 1200 systems while fulfilling and creating an integrated machine messaging set of networks with varied levels of data. The law enforcement system coupled locally and nationally will have access to the highest levels of gathered data to evaluate. They will include the UCR, IBRS, FBI, Justice Dept., etc., and local police agencies. Then this same data will be minimally screened and disseminated to provide public safety information in the public media and web pages on the WWW. The crime event databases will be interfaced with the emergency 911 phone system along with all the police band RF systems, i.e., Lojack OnStar and any others. TRAC and FACT software encryptions, protocols and interfaces will be determined by all of the above in a standard effort.

These innovative law enforcement tools provide real-time data through secure accountable devices, termed PFNs, to better organize the physical electrical components and specific technology to accomplish these specific and appropriate tasks, i.e, communication systems, or special RF frequencies needed, and all other necessary equipment onboard to provide the services for all the commercial markets available and detailed in these applications for this level of communication, monitoring and aggressive remote and automated control. The inventions focus in the vehicle is to create PFN, an individual consolidated data gathering and primary processing center as a mobile platform with the added ability to receive short range transmitted data and serve as a repeater station to report through the telecommunications systems on-board in real time, managed by TRAC software. This will be part the interactive highway and the 1200 spider eyes web. The individual driver with this primary communication and data processing system on-board their vehicle will be unencumbered and if deemed desirable even unaware of any particular automated social functions being performed by the SPIDER EYES program. This capability will be easily provided because all the devices will be utilized to create a workable and operate the interactive highways planned for, and the accountable PFN with its sensors and cameras is ideal to complete the “Spider Eyes program”. This recovered PFN data at the highest levels is to be considered high and medium security protocols, when it is recovered by governing agencies, etc., through FACT, for discrimination and dissemination. But when the data is sanctioned for public use and/or when it is sold for presentation on public media devices such as, TV, Cable, the WEB, etc., then it is considered regular everyday security and management data and information and a functions of public news, gathering, which can conceivably be individually negotiated by the owner of the vehicle\machine with the PFN and the a news agency, etc., with any and all the profits and liabilities thereby contained. However, due to the real time coverage capability the driver will be able to provide for TV news coverage, editing protocols will have to be in place for high and medium security reasons, either a time delay system or stop and divert software program and/or editing staff for any data for immediate public presentation will have to be provided prior too utilizing this technology's PFN data. This technology recognizes the need for F.C.C. and other federal regulations on these practices to develop guidelines and FACT, as well as the citizen's right to free speech and their free access to information, along, with the driving forces of free enterprise to fuel this technology and economy as the latest Milieu for humanity.

There also will be a logged access path and time records for this use by the public and government on each individual vehicle and thereby there can be an accounting to the private owners when their unit and/or vehicle is serviced or sold by prorating sale tax for example for government use, etc. This way the invention can run software in the vehicle that will prioritize the data and save needless transmission time and storage space. Also recently the 911 system land based lines are being used to notify local residents of a crime incident in their locality by automated dialing to their homes and giving public information as to specific criminal activities in their area or neighborhood, i.e., Fairfax, Va. The invention will seek to create a public service system with cell phone servers and police agencies as detailed through out the related applications. Part of this technology will be to provide reception for these same bulletins through cellular geographic announcements as part of the roam announcement functions in most cellular phones systems today. This will allow the citizen driving to be alert while triggering a preprogrammed response for the camera system to be searching for specific characteristics like an erratic speeding car in the area color and identity characteristics and the receiver section of the PFN to pick up a specific distress radio signal transmissions, etc. And with the most sophisticated equipment, in the PFN computer center to spot a suspect on foot from electronic data received from law enforcement on the individuals physical characteristics (digital snap shot picture by zoom focus with high probability and compare soft ware down loaded and sent to the PFN computer). This will be especially effective through the onboard in the cabin cameras for stolen or unauthorized vehicles, or an electronic signature either artificially sent by RF broadcast attached to the individual as in the case of an escaped or guarded or person, e.g., criminal, child or mentally disoriented individual, etc. Alternatively, the use of sophisticated sensors like the nose that can transduce odors to electrical signal and sense these odors 2000 times greater than that of the human nose may be used. The nose sensor will be on-board all vehicles through this technology at some time in the future for environmental sensing anyway, so it is conceivable that with the proper download software specific odor markers the PFN would be able to add this data to increase the correlation that the correct individual is being identified through all the other PFN sensors and cameras, etc. All of this data will be sent back in real-time, accompanied with the spotting vehicle location and time so the monitoring system can activate other PFN units in the geographic area to maintain surveillance till the appropriate officials advised and arrive on location if so needed. Also, the system could do the standard function of tracking a vehicle that is jeopardizing public safety so that the automated 911 could alert a geographic area while shutting it down.

Another device innovation, involves the microchip used in Europe to track vehicles that have had their frame or serial numbers removed physically. These chips could be installed by the manufacturer in a number of places on the vehicle and the police scanning tool or device for records would have the proper circuitry to ID the vehicle through these electronic VIN s/n number chips that are factory installed to be confirm by computer stored data as to the identity of the vehicle in an instant. These chips are used to track stolen items in Europe already. This rapid integrity check of VIN numbers can be run through a comparing encrypted software local program to see if the tags, electronic serial number and Vin numbers all match the ones displayed. This would be a guide to further investigate a suspect vehicle. However readily available would be the last known owner as all states record by the vehicle VIN number and tag, and/or assign a chip and VIN for specific circumstances (custom vehicles or off the road equipment) as this is something the states could charge to install for tax, automated tolls, or vehicle and equipment verification and tracking purposes, and check while they monitor the road worthiness of the vehicles they are registering, especially if any contact has been detected and/or any accident safety equipment has been deployed which might have tripped a trouble code to retrieve PFN data as evidence of authorized information.

SPIDER EYES crime watch will be described with another modality of onboard video systems in the experimental state but spider eyes can be used with the earlier described camera system. This function involves using the vehicle as a viewing station, and a repeater device for monitoring. When in a parked state, the vehicle sensors responsible for tampering if they are triggered by an accident contact and/or from any anti theft sensor set off; the cameras will pass through a surveillance mode and record any object and/or activate motion detected by the sensors. The computer will fix the cameras to the moving object first and second the closest objects. Most all the devices exist today as C.O.T.S. including the digital recording devices that will work in the laptop. The 1000 series devices will describe the software and hardware to combine these devices and the varied computers, i.e, 945 series and 950 series that will be on-board and interfaced, and how these easy to connect C.O.T.S. systems will in a very short time be at a level that much of the monitoring and control devices today have taken years to get to. 956 is a global positioning device, there are many different types with scores of different capabilities and in the detailing of theses C.O.T.S. products the 956-957 series of numbers will be assigned as to whether they have accompanying OEM soft ware that can be run through any of the onboard computers 945 and up or any personal computers, or future OEM consolidated equipment. Alternatively, they require report back transmission and off-board computers and software to process there satellite received coordinates and provide information back to the vehicle and/or to track the vehicle. Once again the connections and interfacing for these completed operations will be fully described and detailed in the 1000 series section.

Software comparison priority system. This is a simple basic verbal outlined description of the logic that the system would operate off of for a law enforcement retrieval and comparison investigation tool. This is covered in greater detail in PCT/US99/00919. The first flag a high correlation rating geographically for an incident area under investigation. Go to list I=unlawful incidents locator block of coordinates—then check t=the software would compare the time factor the vehicle record triggered at. Go to list tip=tip would first check time to the time frame of the location flag and, then flag in sequence other known time and location coordinates that might have investigation importance. If the appropriate conditions to review a record were met regarding an ongoing investigation, the file would be downloaded and reviewed. All files would be stored for a reasonable time to allow review for missing persons and/or crimes that are not always reported in a timely fashion. Also for the benefit of insurance companies all impact triggered recordings would be reviewable to lower and/or increase rates as to obvious driver handling. This process could allow for closer review of the recordings to report any other criminal activity that has been recorded and gone unreported to the proper authorities. This will help from overtaxing the law enforcement agencies. However, for this to happen the reviewers should be sworn in prior to taking this job not to relate any information at anytime unless in the proper legal setting and done through the advisement of their legal department. Big insurance companies should have a legal staff to oversee this process and the stiffest of penalties should be in place for any unlawful invasion of privacy, with all unrelated and inconsequential activities erased and/or destroyed immediately.

The above-mentioned software could be run in the insurance companies as they are already linked with most DMV departments in most states and with the municipalities that are sharing data bases between departments. This data exchange with law enforcement would be relatively easy to arrange.

This has been a good law enforcement practice the sharing of information so long as it is done in an accountable manner by responsible and socially mature individuals. This is all considered part of the 1200 spider eyes innovation and will develop servers and providers in a commercial business that serve with accountability for all of societies actions and interactions with its machines vehicles and equipment. This invention develops telecommunication services, insurance services, law enforcement communications and computers into an accountable network database that can report and control events in real time to better protect and serve the public.

This has only been a brief description of the 1200 series network for recording and reporting and accounting for the use of equipment, machines, and vehicles and that impact on humanity and the environment. The 1200 network systems: Green eyes, Spider Eyes, Helping Hand, and Fair Play are all described in PCT/US99/00919 and related applications.

The other camera modality that can be used with the 1200 spider eyes system and requires a little more description. There is a special mobile mount system that allows the 909 camera and sensor array system to roam to different locations to view the side wall of the wheel and wheel well areas and also to wide focus out at road surfaces and edge. This is controlled through monitoring application specific guidance software for this system. Along with all of the video or visual camera systems running on-board to pick up and record physical data (which is transduced to an analog and/or digital signal for software comparisons and/or algorithms) with other additional guidance information. Also, the off-board transmissions or data links to alert the PFN or control center computer of specific upcoming environmental and/or road conditions or hazards so that the vehicle's performance may be altered to make the appropriate guidance and speed option adjustment for the interactive highway. These will include GPS, travel advisories automated bulletins and warning systems. The control center in the PFN might be OEM computer circuits or they may be run by the inventions own preprogrammed guidance software, PAGSSS and MASMP, and hardware. GM, Lockheed Martin, other large corporations and Department of Defense (D.O.D.) in San Diego were working on a seven mile stretch of interactive highway. It is another goal of this technology to join this effort, by providing social accountability, through the TRAC software programs, to this automated personal travel as well as, physical tramming or training of vehicles (later described) to failsafe some of the existing systems and also offer many other automated enhancements to achieve responsible and aggressive remote and automated control. This is a major reason for the development of these systems.

The 909 roaming system has two modalities. The first is a pre-formed track system with a flat slotted flexible tape and motorized gear inside it that drives a trolley or truck mounted 909 through the reversing of polarity of the electric motor in either direction. As the camera sensor array is in motion the camera is angled in a protected cleaning wiper strip that accompanies the guide track so that the camera will always be deployed with a clean clear view and in the proper position. This flat belt drive system is the same as the C.O.T.S. automatic seat belt application used in some Japanese cars and domestic cars like the 93 ford Tempo today, when the door is closed and the belt is drawn up the door frame to be in the appropriate shoulder restraint position. For example, Toyota cars of the late 80's have employed such a system. Of course, there are many ways this mobility can be achieve for the roaming of the camera, e.g., another such modality for this will also be described. Still using a track system, a truck or trolley has its own motor and is energized through the flex tension wire input that will either be a part of, or impregnated in, the plastic guided flat flex tape drive thus timing the two to travel without having wire and drive entanglements jamming up their mobility. Also, the pre-formed track could be outfitted with segregated contact strips that a brush paw system could make contact with, or the electrical wires needed to service would be pre-tensed in the form of a molded coiled much like a flexible phone cord which would expand and contract with the movement of the 909 truck on the tape drive. Another service line modality will be timed reels on the drive motor side of the flex tape and guide fasteners on the tape drive will also work. Returning to the focus of this application to deal only with the automated personal, public, and commercial vehicle and machine devices, but keeping in mind in doing so it has proven necessary to describe their responsible use and potential goals.

908 in FIG. 1 is a transmission speed sensor and already mentioned 903 the Ignition control module and an important OEM component that the PCM circuitry will be interfaced with to either secure the ignition system when the automobile is stopped or to augment the timing to effect the smoothest shutdown to reduce any improper detonation of the cylinders of the traditional internal combustion power plant. This may be necessary in some engines to balance the fuel to air mixture in some of these innovative systems to slow stop and secure the vehicle as well as to ultimately kill any ignition. Also, the ignition module can alternatively be controlled though any of the engine timing sensors and/or pickups, i.e., 905, 906, 907, 904 and/or the PCM power train control module 920 as is described in these applications. All of this is accomplished through the 1000 series trickster circuits or by one of PFN computers and software programs designed to deceive the OEM circuits if so desired and as is detailed. 915 is the door switch. 14A is a seat switch that can tell if it is occupied. 914 is the seat belt switch that will indicate electrically the belt is home in the secured coupled position.

All or some of these in a series circuit this invention will use to create a dead man seat switch system first simply to determine if a driver is present in a seat behind the wheel. This is done, because, carjackers try to leave an unmanned running vehicle to make an escape. This unmanned state will be a software condition or the simple series safety switch signal for the emergency stop and secure function for the vehicle. It will set the emergency brake when a driver leaves the car and kill the cars ability to crank or run in a number of ways. This will help remedy the accidents from the unsecured vehicle of today where children can release a brake and/or shift a gear lever when the vehicle is left unattended and/or in an idling state. The inventions secured state for a no driver situation. And ultimately this system will be combined with diagnostic driver sensors and software to determine the capability of a driver.

The 1000 series circuits purpose is to create the most inexpensive universal linking of unrelated processor units and microprocessors, IC circuits and computer circuits and/or any logic circuits and not only with one another, but also with traditional electrical circuitry. And/or any and all analog circuits along with any confining soft ware and/or digital considerations even for any support circuitry to allow for the quick combining, cohabitation, and interfacing of all these C.O.T.S. systems and/or any manufactured systems and devices that have been specifically designed and/or by accident of incidence made to be and/or deliberately designed to be. The universal combining of machine technology and communication technology in an accountable way is another major goal of this innovative technology. To be a standard and a cohesive link in this automated robotics development is the prime reason for the creation of the 1000 series interface systems and circuits.

To complete this purpose the 1000 series parts and devices will comprise, e.g., connectors of all types as detailed in PCTUS99/00919, and all of the other applications innovatively configured interfaces and different devices. Communication links and/or comports not requiring hardwiring like infrared technology, simple electric circuits that can be instructed to send a specific signal to another software controlled device to allow for a quick interfacing where there is a software incompatibility and/or none commercially available, i.e., the trickster circuits 1001-1002-1002A-1003. Also in the 1000 series circuits is the many innovative sensing circuit devices, like the one used in the first embodiment and prototype for the first application to sense the vibrators activation in the pager.

This specification describes completely in many unique ways and detail all the devices to reduce a vehicle's speed and/or reduce a machines RPMs and/or stop any piece of equipment's as well as guide it if mobile through automated controls. First to slow it down, and guide it and/or control it if necessary (i.e., other pieces of equipment).

Secondly it discusses how to stop any piece of equipment completely. And thirdly, the invention secures it in a safe stationary position either entirely or any number of specific moving parts. Many of these systems are initially here described to slow, reduce speed, steer, stop and/or secure equipment functions. However, they also can be used to increase a piece of equipment's functions. In other words their variations are completely capable to serve any remote or automated controls on a vehicle in the future to provide full robotics systems, e.g., for automated transportation systems, automated manufacturing, etc., either through individually isolated remote control systems and/or interfaced with other off-board systems through communication links, gateway computers, computer networks and the world wide web for inexpensive long distance monitoring and remote control. The invention focuses on the automobile industry but as has always been maintained throughout all these applications these devices and systems are designed to control every piece of equipment. The invention includes various accountable protocols and commercial developments to control speed, brake and steering for an automobile shut down to be performed through automation to a safe controlled secured deactivated state to be considered as a basis for a standard in aggressive vehicle remote control and/or to control and guide a vehicle and/or piece of equipment through many different automated systems.

If the reader has any further questions to how the invention performs positive machine control they are referred to the whole specification here in appendix III and also in the many filings nationally and internationally filed. The following drawing is of the PFN/TRAC process designed for trusted and secure service. The circuit and flow design is used to introduce the fourth the appendix

FIG. 6

This later system circuit design is used to introduce the Forth Appendix IV however it is of the aviation wireless intranet to keep continuity with other figures in this application. The TRAC Design was used in the fourth application in the design of sub systems and intranets or for parallel systems.

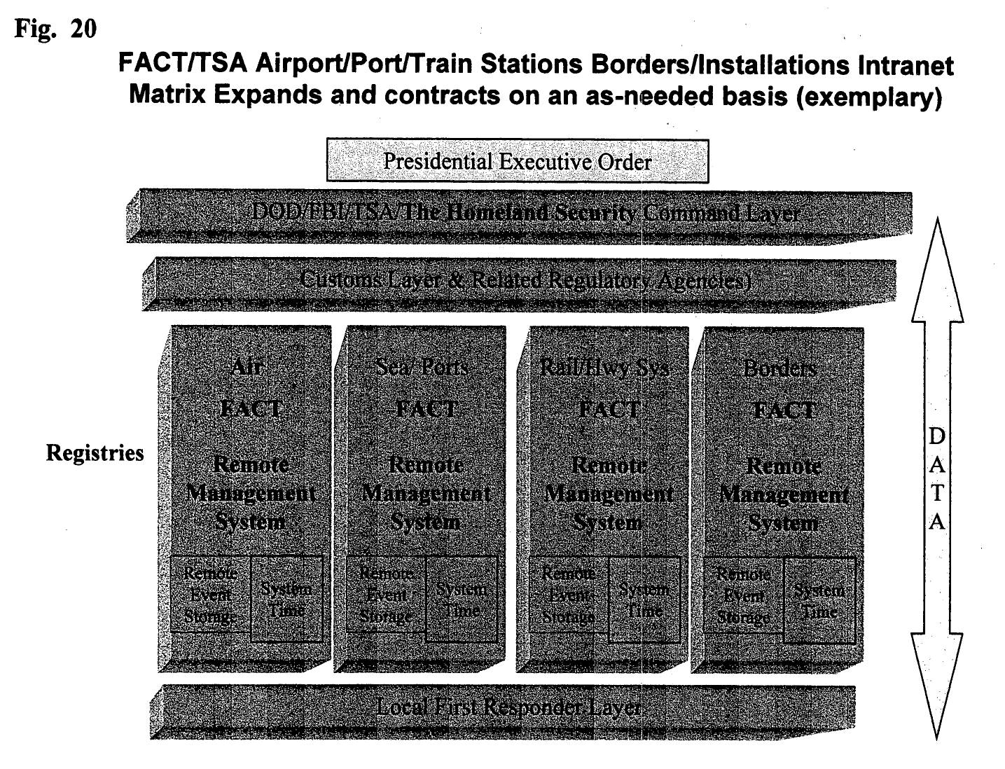

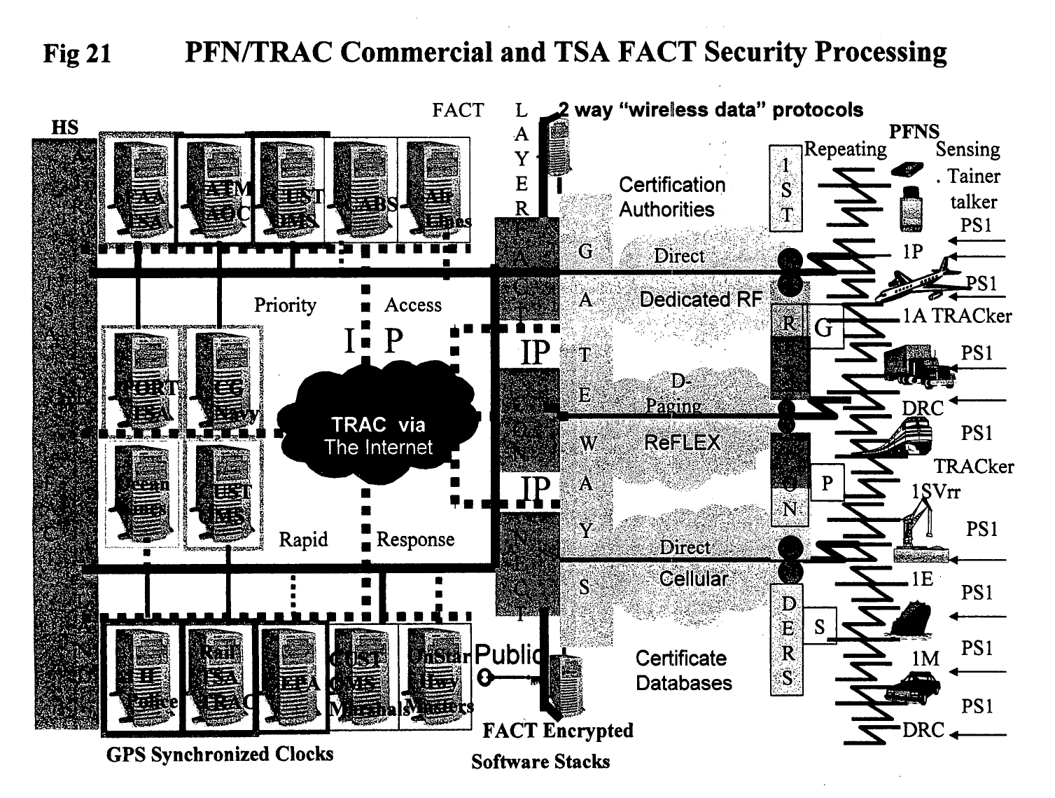

This Trusted Remote Activity control process housed in the protected node PFN on a host piece of equipment is shown with a wireless set of connections to a remote management system. The management subsystem or intranet displayed here is for air transport. In FIG. 20 the Reader can see The other four basic intranets based on pretty much on the type of wireless they use and the commonality of transportation platforms. All forms of industry and every government agency has a wide variety of transportation vehicles and stationary equipment. So these wireless gateway severs are available through preprogramming and default setting for multiple use and reliability. In FIG. 21 the TRAC and FACT messaging is detailed for IP processing via the net and direct FACT gateways. And 23 shows the Transportation matrix and government networking in general.

The Trusted Remote Activity Controller/router begins in the PFN interface and initially provides local vehicle or equipment control with event storage relative to the specific equipment it is attached to and memory storage for FACT events (to include communications and command stings). This automated process can be initiated from a local PFN that flags a FACT event via resident preprogramming that has been installed locally and physically or via IP and wireless packet downloads (All changes have to receive system integrity checks before local programming will accept installs as valid and complete programming or authorized changes). A local record for all FACT events is kept until the governing agency and or Homeland Security deletes it or recovers it and stores it in a number of ways through out the system. The recording process is redundant via reporting to the remote management system in real-time or near real time as well as recording the event locally as illustrated from the center to the right bock in the figure. The, local PFN/TRAC routing unit just discussed in figure four and interfaces any number of RF, wired or other wireless mediums to include one and or two way paging systems (like Flex, Reflex, RIM and ERMIES) to deliver data to the remote TRAC and FACT monitoring systems. Some of the more sophisticated links possible are analog and digital cellular CDMA and TDMA STDMA (aviation specific cellular) all the PCS (Personal Communication Systems) or application specific wireless RF, and DSRC RF, RFID, IrDa and acoustical technologies. These numerous communications interface at the second or third level in the present commercial cable and wireless OS routing stack for packet data and via a resident PFN translation program with algorithms to harmonize the different wireless protocols at a higher application level route signal further across a myriad of wireless options in each of the PFN/TRAC units. Routing for FACT is divers and dispersed and confirmed as a general rule to insure data delivery and is coordinated with the system clock synchronization (standardized) by LEO satellites (Like GPS). Construction of this software program is done by those skilled in the art of telecommunication with routing accomplished via programming skilled in the art using the developer kits available for each of these commercial communication protocols.

This process has been detailed through out the related filings and chosen specifically to rectify the ills and deficiencies of free marketing disparate communication technologies by incorporating these existing and legacy technologies via universal local accountable routing to provide the most rapid progression to a much needed national security system.

At the local level regular routing is determined as per the nature of the messaging. For an example; standard operational TRAC messages are handled in regular industry specific formatting that is relevant to the commercial wireless provider. Normal accounting and communication control pathways are predetermined by commercial agreements for equipment, material management and necessary human machine interfacing. However, if a local PFN FACT program flags a FACT event the communication links are direct to the first responders, and FACT specific intranets. The relevant government agencies best suited, trained and equipped to deal with the event.

Typically, a Remote Management System or specific PFN unit could initiate a TRAC or FACT function (bi-directionally locally and via the PFN/TRAC/FACT system). This might result in the unique and proprietary controlled shut down sequences (Detailed in related filings) such as; “The automated guidance control, slow, stop and secure sequence” involving terrestrial vehicles, machines, ships, material handing equipment and aircraft to the tarmac (which may occur from simple single page command delivered to a local PFN unit, or as a result of complex data processing either in a local PFN or a controlling PC or any of a number of authorized FACT system intranet terminals interfaced. The signal or command is to be received securely and encrypted then either decoded by TRAC commercial programming and or monitored by FACT and decrypted by federal access and control programming if the message has that specific encoding and encryption (e.g. radiation alert sent by the HS1 “Tainertalker” units) are a FACT event. Obviously, the slow stop and secure robotics would take into consideration where the equipment was and what the operation was. (e.g. truck and container in a tunnel or aircraft in the sky. (Another PFN SAFE Base proprietary robotics program sequence for FACT event resulting from a troubled flights).

Robotics systems generally handle the safe operation with direct remote control and the best actions would be a combination of preplanning, training preprogramming as well as, real-time RC handling of the equipment and situation (Ideally, locally monitored and managed but also with the option of greater real-time robotics and satellite RC links).

TRAC Trusted Remote Activity Control

Optionally, local displays or audio speakers may provide local status of normal TRAC and unusual/FACT functions (to be determined) as these functions are being executed, to provide a local operator feedback relative to the progress of the function. In performing the function, all activity controls are initiated by the TRAC and monitored by the TRAC from start to finish. This is normal TRAC management and why the FACT security program marries so well to the PFN/TRAC System™).

This is accomplished through feedback sensors. Additionally the TRAC interfaces with plug, play and program connectable technology to drive and system process, additional sensors and other wireless communications to include audio and video. Sensors may be electrical, mechanical, fiber optic, infrared or other technologies. Since the function being performed requires a high level of accountability and trust that the sequence was in fact executed properly, every step of the process is monitored through appropriate feedback sensors and programming to attain the reliability and trust required for system acceptance by all stake holders for normal TRAC functions but especially for FACT related activities (stakeholders; the public, private industry and government).

This positive feedback in the TRAC is the key feature which distinguishes the TRAC from other electronic or software controllers; making it a fully “trusted” system for the task being accomplished. Additionally, all events and status relative to the function are recorded locally in the local event storage. With respect to TRAC processing purely for private industry this has been optional. However, since 911 more and more movement functions are critical to FACT Security.

So this is part of the system in general. This amount of redundant memory and specialized feedback verifying activities is to make the process trusted and accountable. These requirements may be regulated and approved by local or federal law enforcement or insurance agencies, or the World Bank/banking industry, EPA, ICC, SEC, FAA, FCC FBI, DOD, DOT, TSA, DOE or any other regulatory agency. One goal for the universal PFN/TRAC unit and system is to have this protected universal routing processor and equipment remote controller standardized for these industry and government movement and communication applications as the most and required TRUSTED processor and system interface for these applications.

FACT event recordings have a permanent record until the unit is retired in an investigation and or replaced either entirely or in the secured memory portion by authorized personnel (a special service procedure documented for the law-enforcement spider eyes program of earlier related filings).

These local PFN/TRAC processors and data storage receptacles offer a means via a trusted secure accounting process to make acceptable use of remote or shared equipment controls through responsible and discrete data acquisition not normally tolerated in a free society but most necessary when joint responsibility and liability questions exist.

The Process Further Described

Identifiable data packets (wireless/IP/encrypted) generated throughout routing process/program in a TRAC unit are held in local in memory buffers and each buffer of every server in a FACT network for a time (to be determined by network engineers and per legal codes rules and or regulations). Standard processing and packet tracking for completed messages (IP) will be employed with the exception of data storage of transparent messaging being securely stored at all levels until authorized FACT termination of data directives have been received to clear buffers (this process is further discussed in related filings). A secondary backup processing program at the appropriate application level to recover data will do a near real-time integrity check on data received via other dispersed communications connected. This is to be engineered to be a very robust process for confirmation and authentication.

All real-time remote control wireless communications are dedicated and real-time sensitive by the synchronized clocking locally and systemically (GPS across the nation and around the world). There is a number of developed algorithms and software technologies being developed for this function and will be needed in TRAC Robotics and Remote Control processing of \programs to determine exact position in space and time of a vehicle/PFN/TRAC unit with respect to another known PFN/TRAC unit or other reporting object's physics/velocity. Real-time dedicated communications with local robust robotics are to be priority governed by real-time assessment programming augmented by OEM (Collision avoidance programs etc) and default to these operational backups or PFN/TRAC system sensing of the TRAC technology. These control models are to be used together with local human control to assist in the safest operation equipment control (The exact relationship and programming to be determined specific to application and any specific event with automated responses determined by those skilled in the art of safe equipment operations in each of the respective fields).

Processing Confirmation for Accountability

Interim progress of the sequence, activity or routing function may be optionally transmitted back to the remote management system through a 2-way phone, wireless, RF, or paging link etc. This may occur as the function is executing or may be programmed to occur after completion of the sequence, with accumulated data.

In the case of billing for service (data routing) will be stored locally in some cases and downloaded to wireless mass data billing centers in off hours depending on communications traffic. Or may be transmitted in real-time command string in the headers of the data packets, and directed for operational billing programs running in the commercial service provider's servers computer network. Additionally, these practices may change and will be determined by providers and their business requirements and protocols and any standards efforts rules regulations or law. In any event, local, redundant storage of both types of events is always contained within the PFN for subsequent or simultaneous retrieval of event information and proof for accountability purposes. The PFN enclosure and TRAC monitoring with tamper sensors guarantee the information has not been compromised and can be TRUSTED. These physical protections and electronic protections are detailed in related PFN/TRAC filings. Other types of information include System Function Data (SFD file), which may be stored in the TRAC local event memory for analytical or investigation recoveries.

Other Data may include digital or analog data not directly related to a function being monitored and executed by a host machine. Information gathered via authorized sensing technologies or accessories interfaced with a PFN/TRAC unit will include the wireless interfacing and repeating of HS1 sensor data. And, when recovered the PFN will add time date and geographic position to the data packet recoded locally and reported as a FACT file automatically to the FACT intranet upon the reception from the HS1.

Additionally, this may be for the purposes of evaluating and determining legal liability or be a useful tool for the collection of evidence, or to recover impact data on the environment by the machine hosting the PFN TRAC unit. The public and their legislators will determine what, how and when data can be recovered stored and used: The industry standards efforts and government agencies will adopt public policy and develop, standards, code rules and regulations. System analysts and integrators, the component engineers, the programmers and code writers will finally design the hardware software and construct the architecture, the public desires to implement. And the courts, justice department and law enforcement, specific to application (e.g. DOT/TSA) will professionally police operations to insure the will of the people is maintained in the implementation of the TRAC and application of FACT Security procedures and program.

Public Monitoring

Examples of public monitoring include road conditions via surveillance audio and/or video, bio and chemical toxins, explosive detection and radiation etc and not just on the nations highways but in every aspect of life that there is movement (Transportation). All of which can be supported via interfaces with the PFN/TRAC unit and PFN protective structure for data recovery and storage. The use and application still has to be prescribed as stated in the above process. This critical point is a most important embodiment of the technology. This security and integrity capability of the unit and whole of the PFN/TRAC system to detect tampering and access and determine the impacts of equipment actions and human use of equipment can serve to make perpetrators and misuse of the technology accountable.

Additionally, the invention and other technologies impacts on society and societies infrastructures as well as, the world's environment and resources can equally be evaluated. Any injurious practices can be stopped or augmented in programming downloads in near real-time to keep the unit and system current with threats and public policy. To complete this task monitoring and management operation must be broad and professionally accomplished with the proper respect for privacy and personal injury. This cannot be over stated if this technology is to find use in a free society like the United States and should be applied and understood by all the stakeholders and areas of interests. This is why it is threaded into the inventions specification’ and technical fabric. Part of the technology of any invention is the technique of operation and what to expect from that operation. Most invention specifications are far to irresponsible in this regard (E.g. the cloning process)

Data Handling and Storage:

Special standards efforts involving those skilled in the legal arts and constitutional law to frame issues for public deliberation on personal and statistical data acquisition, handling and storage is intricate to the invention and (La Technique). As mentioned earlier, to be trusted and accepted by society, The TRAC has to be subject to review from it's inception and continually while in use by all it's stakeholders. To include any process used to handle and store sensitive data for legal use. E.g. The legal discovery process and procedures to insure evidence is properly acquired and not compromise and kept pristine until court convenes and provided equally to the appropriate parties.

DATA Issue: Different Handling of Statistical Data and Personal or Private Data Handling.

Statistical data recovered without personal identifiers being used by the public for better public management. E.g. a 1P PFNTRAC unit, might well be a personally worn device performing biometrics tracking and telemetry. It is reporting on an individual's heart rate at the top of a long subway stair well via it's DSRC signal as the wearer passes a 1E PFN on an escalator out of service, because a research program is being run on cardiovascular research. This program may also ask for the person's age, sex, race, nationality, any weight data, and any known medical conditions or medications data stored in the 1P PFN memory or limited 1 Ps monitor unit. However, no personal identifiers like name, social security numbers health care card or insurance data, address, phone numbers or email can be accessed or delivered. Or shouldn't the wearer be able to select no transmission of data?

At the Very Least:

Shouldn't data recovered be specific to statistical research to better plan a safe and healthier environment and warn citizens at risk of over taxing conditions from a movement task in their environment (like this stair climb vs. an escalator or elevator for those cardiovascular persons compromised. The monitoring is done first to research real-life situations that might be hazardous to ones health and then warn them and others in discrete ways of the danger with general public notices and or through a earpiece attached to the 1P PFN or 1 Ps minimal units and deliver in an audio message to a particular person relevant health and safety data. A similar statistical data recovery for automobile use and highway system evaluation may be used with warnings of dangers in traffic movement. Then a 1E PFN driven sensor might pick up unusually high levels of gamma radiation and quarry all area PFNS and video attached systems with and without other radiation and explosive sensor arrays to sample data and respond.

Employing new technologies like the Noise, an odor detection technology that can detect odors at the molecular level some 2000 times greater than a human's noise. In this latter case the Local FACT event programming is initiated and personal PFNS are quarried to see who is in the area and what does the telemetry and video time synchronized images look like for the flagged radiation event being tracked. Telemetry like, what is the intensity of the radiation and what is the geographic position with audio video a list of PFN/ESN and remote control assets and human intervention assets like police special first responders all on one screen with individual screens being specifically monitored in TSA/FACT command center. Both of these scenarios are good reasons for acquiring data for public safety and national security, but how will it be used and how can we make sure the accountability of the TRAC serves the public good to protect our freedoms and does not invade them or harm us.

This is the hard part to get right the human machine and human interfaces of the technology.

Inventor's Suggestion

Obviously, Civil Liberties should weigh in early and as an on going in process through legislation and implementation and inevitably in the court system until we get it right. But this alone does not keep time with the real-time nature of the invention and other IT technologies today.

Other groups should be sot out and funded to put a permanent public review process in place to feel the publics pulse and advise law-makers to change the use of the invention as conditions warrant. Groups like The Charles F. Kettering Foundation or The National Issues Forums Institute-NIFIG. Org with their deliberative process on national issues.

Another organization is Public Agenda, they to quarry the public to help determine public policy. Additionally, local efforts that seek to gain public opinion in shaping national and community oriented public policy need to be funded and put in place. Programs run by universities and community colleges like Maryland's Montgomery College's “Center for Community Leadership Development and Public Policy with their NIF deliberative Format and other human resource services.

All portions of the public should weigh in together as much as possible on policy implemented. The invention it self can function to quarry the public on issues and even set up issue framing data from logged comments and perform initial survey programs via unit and system programming and people participating in the process. E.g. One issue could be what are acceptable levels of police video monitoring to provide national security? The Reason for this question—Is to determine the correct procedures and protocols for the use of the PFN/TRAC/FACT programming to match the national color codes and how to inform the public of their diminished rights of privacy and how they should be aware of this trade off for increased security efforts.

Important to remember is that the use of technologies like the Nose and advanced sensor technologies may take some time to develop the electronic libraries to detect the various bio and chemical hazards, especially in the PS-1 HS1 Homeland Security sensor suites. And when done so only a specific physical configuration of the technology may be used to capture a specific molecular chemistry and that may even have to be sent to a remote processing computer like a PFN/TRAC unit and on in the FACT system to completely identify anything detected out side the known and suspected hazards

(Expected and were preprogrammed for).

Implementation

TRAC implementation may be accomplished in many ways, depending on space or funding constraints and level of integration required for the system to control and to route. A PC-based system may be in the form of a desktop system, laptop, palmtop (PDA) Personal Communication unit (PCU) or (PC 104) or embedded system with a dedicated DOS or Windows based TRAC program, consisting of machine language, Basic, C, C++, Visual Basic, Visual C or C++, or other high level language which accomplishes the TRAC function through software control. Interfaces to the System Under Control (SUC) may be accomplished through appropriate I/O cards, either analog or digital, plug and play chipsets with protocols in firmware. Or PC compatible Modems or Cellular phone interfaces (or chipset) provide the interface to the Remote Management System (RMS) and for routing options. SUC and RMS interfaces may be in the form of USB, ISA, PCI, PCMCIA, VME, Compact PCI, Future Buss, or other commercial interfaces compatible with the PC-based system used. More compact and custom implementations of the TRAC may consist of dedicated state machine controller implementations in which TRAC functions are executed through embedded firmware These implementations may incorporate multi-chip (or Hybrid) solutions using EPROM or EEPROM interfaced to Arithmetic Logic Units (ALU), I/O ports and discrete memory elements. They may also be microprocessor or microcomputer based. A large variety of board level products are commercially available for such an implementation. Single chip or high-density implementations might consist of Field Programmable Gate Array (FPGA) or Application Specific Integrated Circuit (ASIC) based devices and Systems On a Chip or SOC technology. Additionally, wireless router functions and signal relaying (digit-peat) might be accomplished with the different wireless protocols in hybrid chipsets with firmware in Plug and play (PC104) interface boards or I/O cards and translation programming and interface developed from developer kits provided from the 18 most frequently used wireless telephony protocols. The same process (developer kits) would be used by the skilled in the art to write code for the universal routing software program (One Possibility is Unix). With this process accomplished for the PFN/TRAC system/FACT Security network to handle EAM messages between protocols it would be termed (TEAM translation software) and provide flexible Translation of Emergency Action Messages (or TEAM messages) for FACT Security.

Universal Communicator Program

One Modality:

This master routing/translation software package would processes same content message material between disparate wireless protocols via a universal library of specific emergency messages and repeat them through out the PFN system as preprogrammed routing dictates for such messaging. These universal messages are to be translated into all known human languages as well. This program is to have a voice recognition algorithm to identify languages spoken and a universal audio and video set of pictures to accompany these TEAM messages that are physically translated by signal.

All TRAC implementations may incorporate all sequencer, firmware, I/O and storage functions on a single device and would provide the highest level of integration with the smallest possible size. Display, Video and Audio (Auxiliary Data) for the TRAC can be in many forms and types. These may range from analog systems, in which tape or other magnetic media store the analog signal, to semi conductor or digitally burned systems in which data is stored on hard disks, EEPROM or RAM. Data format may be modulated through FM or AM, compressed and packeted or otherwise encoded for reduced bandwidth or for transmission over the Internet to include (IP packet audio and video).

The vast amount of possibilities and form for the TRAC are deliberately designed for the PFN interfaces to be application flexible with a continual effort to be as inclusive as possible of all technologies to provide versatility and universal connectivity for the public and the free market system.

Varying degrees of size and sophistication in the various PFNS and 1Ps or PS-1 HS1 sensing platforms will exist at any given point in time and this is meant to provide an inclusive system that takes advantage of all the technology past, present and future. There will be Complete PFN/TRAC units with multiple wireless interfaces and routing (Universal PFNS) to include long distant communications that will be smaller in size than the more simpler PS-1 HS1 wireless sensor platforms that sends signal to the regular PFN/TRAC units. Complete secure accountable connectivity for human and machine messaging is the goal of the PFN/TRAC System and Federal Access Control Technology to improve public safety and national security.

Hardware Implementation are to be Progressive and Flexible

Trusted Remote Activity Controller (Generally) will be COTS Based PC—Programmable Controller (PC104)—Custom Logic Sequencer μP (Micro processor) FPGA (Field Programmable Gate Array) Custom Gate Array with ASICS progressing to include Systems On a Chip or (SOC) technology, ultimately constructed with room temperature super conductors (plastic) for greater computing speeds and less current demands.

It is because of this capacity for growth and accommodation of existing COTS and legacy technology (hardware, firmware and software), that software functions are not specific in programming or detail.

The chosen teaching technique for the implementation and processing throughout developing the diverse PFN/TRAC architecture is to explain how to construct the invention the PFN/TRAC movement management system with FACT security and a communication routing process, so that those of normal skill (artisans in the specific disciplines can workup final configurations, construct and program the PFN/TRAC controller/router and network to the desires of the stakeholders (the public, industry and government). The laborious work of the programmer and code writer for the specific existing hardware configurations will be a massive but shrinking challenge as platform architectures technically become more standardized through out the different industry applications. This is demonstrated in the many prior related teachings for the separate industries to be PFN/TRAC linked.

TRAC Features

Industry Accepted and Trusted System

Uses “Industry Standard” Interfaces

Provides Accountability Requirements

Aggressive Remote Control Functions,

It is Programmable & Modular,

Scaleable

Provides Levels of Redundancy,

Event Storage,

Algorithm Type is Dependent on Application Accountability Requirements,

Resides in PFN (PFN Provides Physical Security)

Remote Management Command Authentication,

Local System Control and Event Storage, Software/Algorithms Bank/Stock Exchange

Transaction Products & Algorithms

RPV (Remotely Piloted Vehicle) Technology,

Security, Commercial: 128/64 bit Encryption PGP (Web Transactions), Military: DES (Data Encryption Standard) & all the FACT Program functions programmed in the different software protocols to operate on local hardware in the PFN/TRAC system architecture

Interfaces

Automotive Industry Standardization Efforts,

IEEE Standardization efforts,

Avionics Standardizations efforts,

Rail Standardization efforts,

Marine standardization efforts,

Electronics Standardizations Efforts,

Computer Standardizations Efforts,

H-Rel Connectors,

Actuators,

Sensors,

Signal Levels

Wireless Telephony and data interfaces

Digital Cellular, PCS,

56K Modem, Faster

RF & Pager Technology,

All the approved aviation wireless technologies,

All marine,

Interactive Highways

All DSRC,

All emergency frequencies

AIP Airline Control Protocol,

Program Considerations for Wireless Routing in Air Travel Industry for HS1 Data Packets.

Data link layer polled protocol that runs in full-duplex mode over synchronous serial (V.24) lines and uses the binary-coded decimal (BCD) character set, Airline Product Set ALPS circuit, And a communication path across a TCP connection between a host reservation system and an ASCU. When MATIP encapsulation is used on an ALPS circuit, it is equivalent to a MATIP session., ALPS Tunneling Protocol airline protocol, Generic term that refers to the airline reservation system data and the protocols, such as P1024B (ALC), P1024C (UTS), and MATIP, that transport the data between the mainframe and the ASCUs., Airline X.25

Dynamic Host Configuration Protocol (DHCP), [RFC-2131], a framework for passing configuration information to hosts on a TCP/IP network

Time of Day Protocol [RFC-868], to obtain the time of day

Data or network

Edge or access router

DSP medium

RF medium (coax, modulator/demodulator, antenna)

RF management software

Wireless Standards Effort

PFN/TRAC units will provide a less expensive, more comprehensive, secure and stable mobile platform for the development of wireless routing and interfacing with equipment, via the portable WLAN network created. The system is to start Internet data packet routing at the earliest point data is generated and apply this technology universally across the wireless spectrum.

The system will always remain diverse and need planning to insure enough of the properly programmed PFNS or more universal PFN units are present for adequate coverage of all types of wireless and to maximize the recovery of HS1 data.

Immediately by the introduction and explanation of the unique messaging in the air travel/transport industry the reader and skilled in the art of network design and engineering can rapidly see the need for the more sophisticated universal PFNS to translate and repeat to bridge the gap for inter-model transportation and machine messaging between the different vehicle platforms and industries that will handle the same PS1 HS-1 equipped packages or containers.

The process will always be an evolving one of forward and backward engineering as well. However, the flexible interfacing via Plug, play and program architecture at local routing interface (proprietary to the PFN/TRAC system) will aid immensely in this process. With more dispersed ownership and maintenance to include the individual public to lower industry cost, the PFN/TRAC System and machine messaging system for the United States can automate all machine and equipment controls in an inexpensive manner.

As standards emerge and technologies merge the specific technology will be refined and miniaturized into SOC configurations.

There is always to be a flexible plug, play and program interface capacity to grow and keep current with new technology and accommodate legacy technologies in the PFN/TRAC System and FACT security network. The FACT network via it's industry specific registries must be programmed and agency staffed and capable to recognize all new interfacing and system augmentation and provide a review process and integrity check; both at the local interface PFN/TRAC unit and system wide levels to check for alerts or anomalies. Either because of FACT programming, or to write code to flag events as FACT alerts and upload any critical data to all effected PFN./TRAC units for the most real-time preprogrammed responsiveness.

At least 18 different types of wireless are in commercial use today. Therefore, as PFN/TRAC technology becomes more prevalent, many of the applications will migrate to specific architectures and product interfaces. The different types of wireless are quite unique to each other in numerous respects, and require specific types of expertise to deploy, use, and maintain them.

A Look at the Wireless Advantage for Change.

The Pros Include:

It's much less expensive to deploy than hardwiring.

It's much quicker to deploy—.

Wireless can go in inaccessible terrain.

It involves an inherent high degree of security, and additional security layers can be added.

Wireless provides broadband mobility,

PFN/TRAC wireless link will be a fully featured router, which means that it must provide VPN, enterprise toll bypass, and MDU/MTU access services where these are not present by commercial providers and or be interfaced into local PFN/TRAC units to include with the cross protocol translation programming and routing. These PFNs will retrieve the HS1 sensor array data as a wireless gateway and deliver data to the various IP addresses. The fundamental elements remain relatively constant between the wireless providers allowing PFN/TRAC router access to translate between the protocols retrievable at Layer 2 of the wireless protocol stack for the most part with the data packets and universally synced timing. The majority of wireless vendors access the wireless stack at layer 2 and some at Layer 3 like Cisco Systems routing for cable routing. Depending on application any specific PFN/TRAC unit would have programming at least for one maybe both accesses layers to the TRA/FACT stack with unix programming at a higher application level to perform the translation algorithmic functions where packet transfer was not possible. And through out any specific TSA/FACT intranet (e.g. FACT/TSA airport terminal a PFN/TRAC unit in the matrix would have the capacity both to access long distant communication links both wired and wireless and digi-peat packet messaging from the HS1 to the appropriate IP addresses for TSA/FACT Homeland security.

A Data Handling Modality Example for Wireless PFN Machine Messaging Programming

The protocol stack implemented for TRAC/FACT could be based on the DOC SIS standards developed by the Cable Labs consortium. The principal function of the wireless portions of the TRAC unit is to transmit Internet Protocol (IP) packets transparently between TRAC controller/routers in the FACT security control matrix via direct dial ups or through wireless gateways in the FACT and commercial TRAC intranets with ISP and broad band high speed connections. Ideally, certain management functions will be impregnated via IP to include spectrum management functions (for identification, addressing, wireless accounting purposes and software downloading). Both ends of any wireless link are to be IP hosts on the network matrix, and they fully support standard IP and Logical Link Control (LLC) protocols, as defined by the IEEE 802 LAN/MAN Standards Committee standards wherever appropriate (for wireless telephony (HS1 system interfaced via PFN/TRAC units and PFN/TRAC system terminals). The commercial servers generally support the IP and Address Resolution Protocol (ARP) protocols over DIX and SNAP link layer framing.

The primary function of the wireless system is to forward packets. As such, data forwarding through the commercial servers is done with transparent bridging or network layer forwarding such as routing and IP switching. Data forwarding through the PFN/TRAC system could be accomplished with link layer transparent bridging based on IP protocols. Forwarding could be similar to [ISO/IEC10038] as per any applicable DOCSIS specifications. Both ends should then support any spanning-tree protocols to include capability to filter 802.1d bridge PDUs (BPDUs) with out loops in specific intranets and support for Internet Group Management Protocol (IGMP) multicasting. FACT and special encryption applications would be above the network layer, This transparent IP capability will be bearer for higher-layer services. Additional translation programming between protocols should run at these higher levels. Use of these services will be transparent at the unit level unless the unit is running these higher program applications by authorization and identification (e.g. DES or special TSA Homeland security programs setup as PFN/TRAC ( Possibly DET) terminals or protected and secure at the same level. In addition to the transport of user data, several network management and operation capabilities are supported at both ends of any intended messaging, to the PFN/TRAC unit platform.

The Primary Focal Node access wireless architecture as a router allows it to serve as a hub or mini relay station serving other nodes (PFN/TRAC units and the many PS-1 HS1 sensor platforms in a WLAN portable network). In the above described application. It is a point-to-multipoint architecture in the sense that the entire bandwidth on the upstream and downstream is shared among all the responsive PFN/TRAC units to the individual HS1 sensor suite if desired. The protocol stack implemented to make all this work is based on the DOCSIS standards developed by the Cable Labs consortium.

This is but one proposed modality of routing via the PFN/TRAC controller/router to construct the flexible web with current hardware and software available and the PS1 HS1 sensor platforms proposed to meet today's Homeland security threats from toxic chemicals, biohazards and nuclear waste.

PFN/TRAC Unit Characteristics in FACT TSA Air Travel Network as an Example

They have local event memory storage in protected containments;

Report to mass data management and storage centers at the airport;

They can have wireless and wired connections to sensors and sensor platfors; and,

Multiple communication technologies and protocols;

They have automated radio frequency scanning and translation between different wireless protocols.

In addition, PFN's have back up power supplies;

They provide the means to add electrical functions to legacy equipment;

Interface separate equipment and existing security systems into one management system;

Respond locally and to repeat messages and signals to and from each other as well as,

To other remote portions of a monitoring system;

They provide their physical location (GPS or recoded fixed address) with the data

They report; and can drive audio and video equipment and other data recovery devices;

They can operate automated robust actuators and equipment controls;

They perform real-time remote control with accountability;

They perform their own integrity checks and of assets interfaced and inventory with them;

They can perform self-maintenance checks and diagnostics; and affect repairs automatically and remotely;

They can detect tampering; and operate with encrypted programming PGP and DES; as well as, complete operations independently preprogrammed and robotics functions;

They can operate electronic payment industry programs and ID programs; and drive Card swipes; Explosive Detection Equipment, and all sorts of transducers, sensor arrays;

PFN/TRAC router functions—

Network data flow to the remote management system and provide local robust broad spectrum data and communications routing

Elements of A Total Management and Security Network Solution For Transportation:

Premises Networks

(PFN portable network) e.g airports, ports, rail terminals, Installations, boarders

Access Networks

E.g. primary intranet FACT/FAA/TSA terminal command center and national Air travel

Core networks DOT/FACT/TSA National Mass Data handling and storage matrix of intranets for air, land, sea, boarder customs, national security agencies home land security

Network management PFN/TRAC System and FACT program

Billing/OSS PFN/TRAC system, electronic payment industry, etc.

A fully comprehensive wireless solution must also include the issues of deployment, maintenance, legacy, migration, and value propositions. The scope of what comprises a fully comprehensive solution is addressed in this filing and the related filings.

Note: This process in aircraft is greatly complicated with a more robust three dimensional environment, the diverse air fames and the speed at which planes fly. The avionics details for the TRAC processing and progression of system under control SUC to perform robotics flight and remote control flying and landing are addressed in the two prior avionics filings. This figure is to show the general architecture of TRAC/FACT system of reporting and r message routing. The drawing explains the properties of accountable robotics, remote and shared machine controls via the TRAC design. Earlier related filings serve those skilled in the arts of electronics, wireless and computer networking to construct the various PFN/TRAC units and system with the FACT Security program. The figure displays a scalable and modular technology from local and regional wireless remote control to national and global IP management as a network of interfaced FACT Intranets.

This includes all the sub set local intranets at each of the 429 airports and hundreds of sea ports, rail stations boarder crossings and Highway check points and toll booths as part of a greater PFN/TRAC System FACT subnet architecture, which connects the above and the following via telecommunications, cable, satellite, microwave and fiber to FAA/AOC/Port authorities/customs/FBI state and local law enforcement though TSA/FACT intranet centers and 1P connections to be developed with Air Traffic Management and NORRAD air operations) in Herdon, Va. and Colorado and to include all appropriate authorities, agencies for the other terrestrial traffic management, material movement and policing operations needed to have a responsive TSA DOT Homeland Security network matrix.

E.g. A base for the FACT/TSA Aviation intranets can be created by incorporating the present 200 AOC centers and combining /TSA terminals across the nation with these FAA/AOC air operations in Herdon Center as detailed in earlier related filings. Whether for Air, land or Sea movement each terminal is responsive in the matrix of TRAC intranets for FACT security in a Homeland security network. A greater portable network that is flexibly connected to each passing aircraft across the nation for downloaded real-time transit monitoring via the 200 receiving TSA/AOC handling centers displaying PS1 HS1 sensed data from the cargo compartments containers cabin and flight deck. The same would be true for Interactive highways, waterways, railways ports and boarders with all the containers truck boxes and packages etc, not only rolling in and out of the boarders out rolling on the roads on the seas and rails. The inspection process is an ongoing real-time free moving process and never ending. Further, The TRAC acts as a mini hub for routing data and will send data packets via diverse communications determined by local routing algorithms (discussed through out the text and related filings). These software routing programs are to run in the local TRAC processor, which are stored in the protected PFN interface. The PFN TRAC units receive stable power from every piece of equipment interfaced with a PFN unit and each unit maintains an emergency power supply for (completed operations). This helps to make it reliable and trusted.

FIG. 6 and seven further describes the system architecture and gives various transportation examples for the application industry specific intranets to serve Homeland Security with FACT and also the normal TRAC operations for commerce and free movement management.

FIG. 7

FIG. 7 introduces the fifth Appendix. PCT US00/1638 & WO99/78057. This diagram illustrates the sphere of operation for security, data recovery and delivery, and machine management. It includes Smart Houses, Commercial networking, movement management and a total security package. Obviously, for the technology to work in a free democratic society it has to comply with all that the Constitution guarantees. These applications focus on these issues and the technology to make it a reality in the manner agreed upon and legislated by the democratic society that governs and the invention serves.

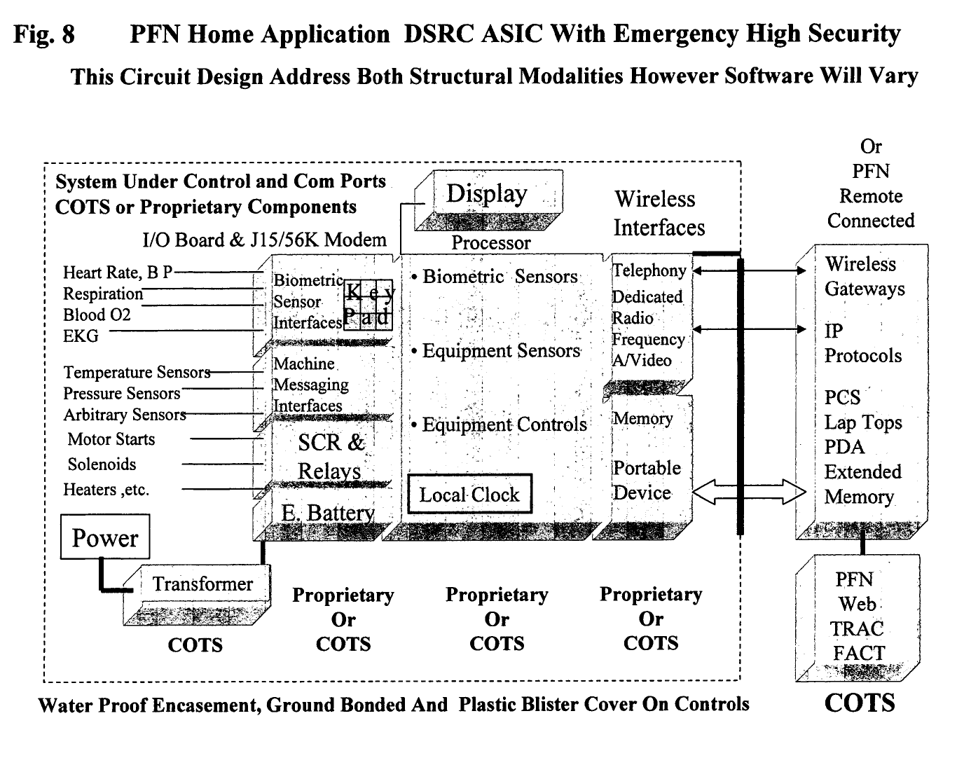

FIG. 8

PFN/TRAC System: Home Management

Attributes and Applications:

Home PFN/TRAC systems will be comprised of at least one universal Primary Focal Node (PFN) capable of communicating with machinery, computers, personal PFNS and other specific PFNS through wire or wireless means, creating an intranet and including IP protocols and Internet connections. As in all applications, the universal PFN/TRAC System provides a versatile organizational interface platform using the five basic “Ps”: Protect, Preserve, Plug, Play and Program to accountably integrate components and systems. Systems and components available to potentially integrate and connect with the PFN/TRAC System include: phone land lines, power line communication technologies, wireless telephony, wireless light communication systems, fiber-optics, security systems, satellite TV systems, cable TV systems, audio and video systems, utility management & billing systems, Internet providers and servers, radio frequency equipment and paging systems.

Commercial Potential:

Equipment Systems Include

IP appliance interface, home security system interface, house/vehicle interface for emergency power and phones, energy management and utility monitoring, Computer interfaces, transpond locator interface for home & personal assets inventory, TV and audio systems interface and supporting an IP user terminal.

Personal Systems Including:

person locating (children, skiers, swimmers, hunters, adventurers) pet tracking—identity confirmation—health care monitoring and administration

The following is an ASIC circuit for use in a home appliance or electrical device with the power considerations changed to meet host application. Further Smart Home Management, Design Lighting and Security Systems is covered in appendices II, III VIII This Application Specific Integrated Circuit can be a Commercial Off The Shelf COTS component or constructed from COTS components or be completely proprietary and manufactured in accordance with drawing five. The first block of electrical components the biometric sensor section. The sensors include, Heart Rate, Blood Pressure (BP), Respiration Per minute counter, Blood O2, Co2 sensor, EKG Recording Signals and any Arbitrary Biometric sensor capable of sign/data generation and processing by the ASIC running application software. The circuit is designed to handle machine language as detailed in implementation to be forward engineered for future biometric sensing and personal devices. All proprietary sensors with hard wire connections are to be plug and play capable with the appropriate/standard high reliable water tight connections. And additionally wireless sensors will use via Dedicated Short Range Communications DSRC (FM) communication appropriate for the application ( e.g. FCC 5. GHZ or 915 MHZ. Are some COTS possibilities). These are examples only, any frequency/signal that can accommodate the data requirements from the sensor sending to the local processor receiving and running software, or to meet remote monitoring requirements is acceptable and considered to fall within the nature and scope of the invention. The local controller unit has a lighted LCD display to read information with a keypad to prompt and query the system. A water proof clip on display and keyboard interface package is a possibility that connects either by wireless or cable to the local controller/Processor. Audio and voice command and voice recognition are other interfaces contemplated as well as digital camera and a broad enough signal band to carry the data. These interfaces would be in the machine messaging interface section and use appropriate machine language as detailed and available in COTS. Also, programming mediums like CD players, various Disk technology and MP3 storage devices would be connected by standard reliable connectors and interfaces at this same point. The drawing size does not permit for all the machine and biometric interfaces to be illustrated clearly listed so they are further detailed in the text portion.

The second machine messaging set of interfaces will vary from model to model in the connections used. These will be part of every pool purchased and rarely add on accessories. However their will be a connection block to add new equipment sensing and the manufacture will be able to reprogram the local processor via a phone line connection (J-15) connector or cellular interface if one is connected or embedded in the electrical system or by standard download mediums or DSRC. This control module will reside in a attachable plastic pouch with a clear plastic window to view the Display and entry keypad, and further be provided a water tight plastic case with o ring seal and boots for hardwire connections. Temperature sensors, water pressure, leak detection sensors even amp load sensing circuits monitoring electrical components will be some of the standard operating data generated by the electrical sensing system and processed by the programmable processor/controller. Sensors are being perfected inexpensively today for the homeland security initiatives and will be available in the future for public safety hazards as well as national security. The invention is to be forward engineered to take advantage of these developments and be able to inherent their enhancements within the nature and scope of the invention as detailed in this specification.

The dotted line indicates the circuit is to be encased and waterproof structure and properly insulated and grounded. In the containment the processor is to have its own power supply in a rechargable Ni Cad or lithium battery of sufficient capacity to pump down the pool water to a safe level if the house power is compromised. The emergency power in the containment is to control all functions

The blue processor can be configured from COTS products or specifically designed. This is detailed as implementation. The most important point is practical functionality per application and reasonable cost. A wide technology description is made in the implementation:

IMPLEMENTATION may be accomplished in many ways, depending on space or funding constraints and level of integration required for the system to control and to route. With cost in mind A micro processor/mini computer (PCU) or (PC 104) or a Systems On a Chip (SOC) evolution embedded with a dedicated DOS or Windows based program, consisting of machine language, Basic, C, C++, Visual Basic, Visual C or C++, or other high level language which accomplishes the function through software control. Interfaces to the System Under Control (SUC) may be accomplished through appropriate I/O cards, either analog or digital, plug and play chipsets with protocols in firmware and compatible connectibles.

The wireless Interfaces To include PC compatible Modems and or Cellular phone interfaces (via chipset) to provide the interface for a Remote Monitoring System (RMS). SUC and RMS interfaces may be in the form of ISA, PCI, PCMCIA, VME, Compact PCI, Future Buss, or other commercial interfaces compatible with the PC-based system used. More compact and custom implementations of the ASIC may consist of dedicated state machine controller implementations in which the functions are executed through embedded firmware. These implementations may incorporate multi-chip(or Hybrid) solutions using EPROM or EEPROM interfaced to Arithmetic Logic Units (ALU), I/O ports and discrete memory elements. They may also be microprocessor or microcomputer based. A large variety of board level products are commercially available for such an implementation. Single chip or high density implementations might consist of Field Programmable Gate Array (FPGA) or Application Specific Integrated Circuit (ASIC) based devices and Systems On a Chip or SOC technology. Additionally, the different wireless protocols can be in hybrid chipsets and firmware on Plug and play (PC104) interface boards or I/O cards and would be developed from developer kits provided from the 18 most frequently used wireless telephony protocols. All implementations may incorporate all sequencer, firmware, I/O and storage functions on a single device and would provide the highest level of integration and smallest size. Display, Video and Audio (Auxiliary Data) for the programs can be in many forms and types. These may range from analog systems, in which tape or other magnetic media store the analog signal, to digital systems in which data is stored on hard disks, EEPROM or RAM or the myriad of new storage mediums. Data format may be modulated through FM or AM, compressed, packetized or otherwise encoded for reduced bandwidth or for transmission over the Internet (packet data).

Hardware Implementation are to be progressive and flexible first COTS Based Mini computer PC—Programmable Controller (PC104)—Custom Logic Sequencer μP (Micro processor) FPGA (Field Programmable Gate Array) Custom Gate Array (ASICs) Systems On a Chip (SOC)

Features Uses “Industry Standard” Interfaces, it is Programmable & Modular, Scaleable, provides Level of Redundancy, Event Storage, Algorithm Type Software, Security, Commercial: 128/64 bit Encryption (Web Transaction), IEEE Standardization, Computer Standardization, H-Rel Connectors, Actuators, Sensors, Signal Levels

Dedicated RF and Wireless Telephony and data interfaces Short range FM, Digital Cellular, PCS, 56K Modem, RF & Pager Technology, all the approved DSRCS, a framework for passing configuration information to hosts on a TCP/IP network (application level translation from machine language to wireles protocols to IP Protocols, Time of Day Protocol [RFC], to obtain the time of day, Data or network, Edge or access routing, DSP medium, RF medium (coax, modulator/demodulator, antenna), RF management software

Remote monitoring out side the containment show the communication mediums Laptop and PCS connected either by shortrange wireless or long range wireless and telephony depending on application and need, and the further connectability of the Web to send the data to other specific addresses. The personal data and commercial augmentation software for the pool operation is to be encrypted with (PGP)

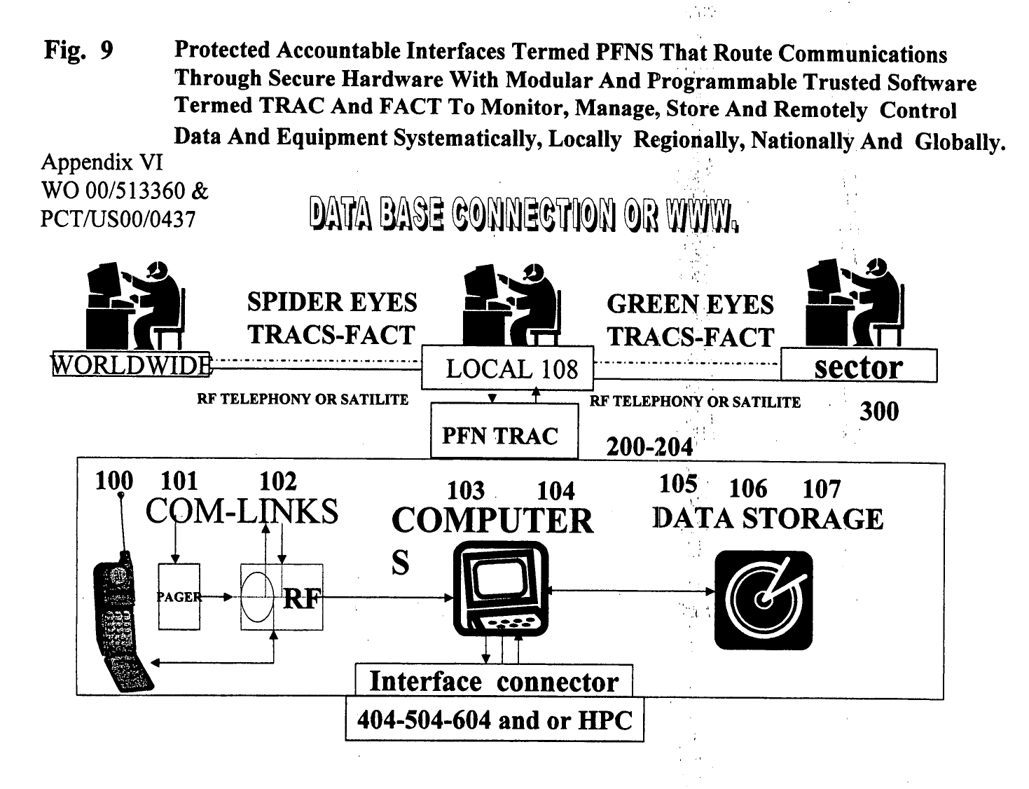

FIG. 9

This figure introduces the VI sixth relevant patent application where many existing commercial off the Shelf COTS products are interfaced into the system. Also described is the Federal Access Control Registries of equipment by electronic Serial number FACT Identifying Chips

FIG. 9 is an illustration showing the monitoring and control system and a PFN enclosure with its characteristic communication options, processor and computer capability and its accountable data storage systems, as well as, its electrical interface connector to connect with a host machine. This is in keeping with the same technology from the first patent application and the remainder of the drawings will display and describe more varied levels of capabilities and sophistication to meet the present high security requirements needed in special government and commercial applications. FACT is introduced as the Federal Access and Control Technology that will be running in all remote control capable systems governmental and civilian. It is an encrypted operational data system software that will allow for accountable access to all such systems and under proper court authorization allow for undetectable monitoring and control of any and all equipment. Fact processor chips will be in all responsive connectable components for remote control as well as in expensive electronics to keep track of their legal and illegal use through and by any PFN system running TRAC/FACT software. TRAC stands for Trusted Remote Activity Controller and is the base operating software system operating in all PFNs.

First however, is the base hardware components and systems running these programs of which TRAC. & FACT are only two of them. The components in figure one as numbered are as follows. Number 300 shows all three levels of a possible network of off board computers in which the local computer is the standard gate way, but not the only control terminal and it is not a necessity that the control communications even go through the local terminal. With the use of cellular phone technology, RF signals, and paging devices as the receivers and transmitters, signals can be sent from any terminal if so desired. (e.g. emergency situations). And also by employing the equipment identification system (ESNVIN) and or (ESN SN) or MIN protocols and personal ID devices properties and qualities detailed in all the earlier related patent application for the spider eyes program, coupled with the on board data storage devices numbered 105-106-107 in this drawing. And the off board report back data storage; provide total accountability for remote control activity which can be established through the entire system from all of the off board monitoring and control systems to each individual peripheral system attached to a PFN numbered 200-204 in this number one drawing and most especially with the incorporation of TRAC and FACT soft ware programs. The multi numbering is for the different styles of security and protective packaging of PFNs and data storage devices and systems, which are all detailed in great length in the earlier related filings.

100 is a wireless phone, either cellular, digital satellite or even cordless either as represented as a hand held COTS device that has an interface modem and/or cable to connect it up with one of the five computers detailed in the preceding related application or as an IC chip set integrated circuit and or interfaced with any of the onboard processors, programmable controllers or computer boards either by edge connectors or direct hard wiring or IEEE couplers. And 100 can also be PCMCIA card or A Complete Card@ ™ Cell phone card with antenna. (This system will be first utilized in all prototypes including high security.

101 is the standard time honored pager in this drawing showing only the reception capability of the standard COTS pager. This is done to accent that there is a real cost effective use for one-way paging in high security applications as will be completely described within this application. However, also in this document it will be equally illustrated that the new reflex paging protocols of Motorola can also serve inexpensively and offer limited two-way communication capabilities. The first related application totally details many different modalities to utilize the standard paging devices and is incorporated herein by reference. However, also through out all the related applications the incorporation of COTS paging IC. chip sets accompanying circuits and software protocols have been incorporated into PFN consolidation of circuitry and size, as referenced by the design use of Motorola=s Create-a Link™ combining communication and processing, in some limited switching functions in the protected accountable PFN system.

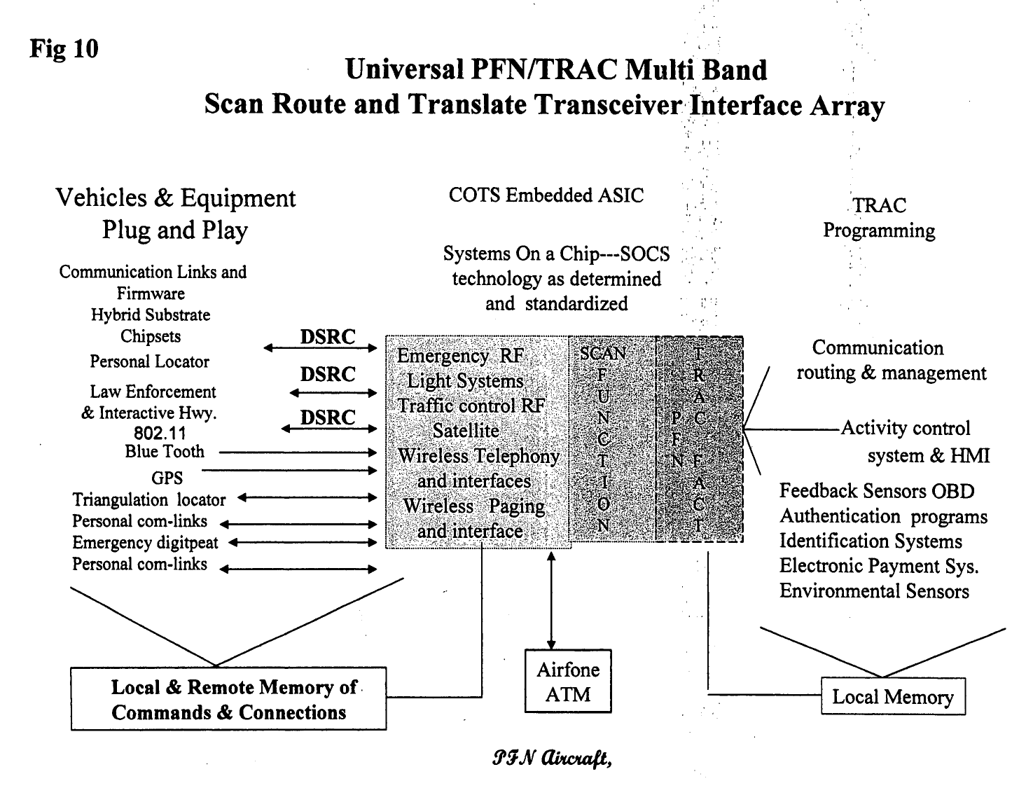

102 is any other RF frequency that can be used to send and/or receive either a guarded or unguarded signal. to a PFN device. And the following frequencies are listed in an Allocation table as FIGS. 9 and 10 of this application as they are known today. The list is in no way to be considered the only frequencies that this invention claims and in fact any and all wireless communications and hard wired communications are claimed to fall within the nature and scope of the invention when they are used in an accountable and/or protected interface for remote control.

103 refers to the proprietary Parallax computers stamp I and stamp II and 104 refers to all five of the 100 Euro-board mini computers named in the preceding application with their varying degrees of capabilities. And also in this formal application there will be a complete set of drawings detailing the prototypes to make them more resistant to EMFs and other damage from radiation for the high security and hazardous or hostile environments.

105-106-107 is the on board data storage components of the PFN. However, there is only 2 levels of memory or data storage generally planned for in the PFN. One is a re-writeable memory recording predefined data unique to equipment and or personnel. The second is priority data which is stored in a non-volatile and protected memory (determined by application specific protocols). And number 108 up in the 300 block of computers networked together illustrates at least one remote storage out of the PFN. And this will be a redundant storage of the same application specific protocol data stored permanently on board. This provides three last minute comparable records which are all timed and dated for analysis and accountability. The number 105 generally refers to embedded hardware, firmware, EEprom, and/or flash memories and 106 refers to hard drives and 107 to writeable CD and MO disks as detailed in the earlier applications. These can be part of a integrated or interfaced circuit with any of the processors and/or mini computers and/or stand as separate components interfaced through hard wires and/or physical connectors, which also has been thoroughly detailed in the earlier applications. Anyone of these data storage components can function as re-writeable data storage or as permanent storage.

108 is the off board storage and it is also detailed in earlier applications but it is safe to say that all data stored for these high security applications will have specific systems and protocols to manage any stored data. TRACS and FACT will be detailed through out this patent application as an exemplary software protocol for handling this data on and off the board.

FIG. 10

The drawing 10 illustrates a multiple receiving scan process. As stated in earlier figures a multiple of wireless protocols are interfaced to the TRAC processor in a number of ways depending on the nature of the hardware and development of the technology. Basically this scan process is the first stage of the PFN receiving wireless communications. The PFN/TRAC unit is configured with the appropriate antenna to accommodate all the wireless interfaced and in some cases a broad spectrum antenna for counting frequencies. A scan program either running in the transceiver circuit section (e.g. chipsets or TRAC processor section interfaced or integrated recognizes messages in a frequency band of one of the wireless interfaced in the PFN/TRAC unit. If the signal has a particular address not relevant to the unit ESN or ID it scans past to the next activity.

One function of the scan process is for the unit to do environmental EMF and EMW surveying for security control and management of remote control functions and to do environmental research on areas to maximize and organize transmissions and reception and to address health and safety issues regarding electromagnetic fields, presence intensity and any PFN correlated sensed facts as to their effects. This data is to be maintained in a buffer and memory storage or the TRAC PFN processor or extended memory receptacle.

Another function of the scan process involves a TEAM messages which could be received on one or more wireless technologies actively interfaced and with simultaneous signal reception one is stored in a buffer for near-real-time review while the best signal is processed immediately.

Universal Communicator Program

This master routing/translation software package running in the TRAC processor but augmented by with TEAM programming in the wireless software interfaced in any particular PFN/TRAC unit processes same content message data between disparate wireless protocols via a universal library of specific emergency messages and then routes or repeat them to another wireless interfaced to complete the translation process in and through out the PFN system. These same universal messages are to be translated into all known human languages as well and available to the appropriate persons along with public TEAM messages. This same program is to have a voice recognition algorithm to identify languages spoken and a universal audio and video set of pictures to accompany these TEAM messages.

And be delivered by these interfaced accessories

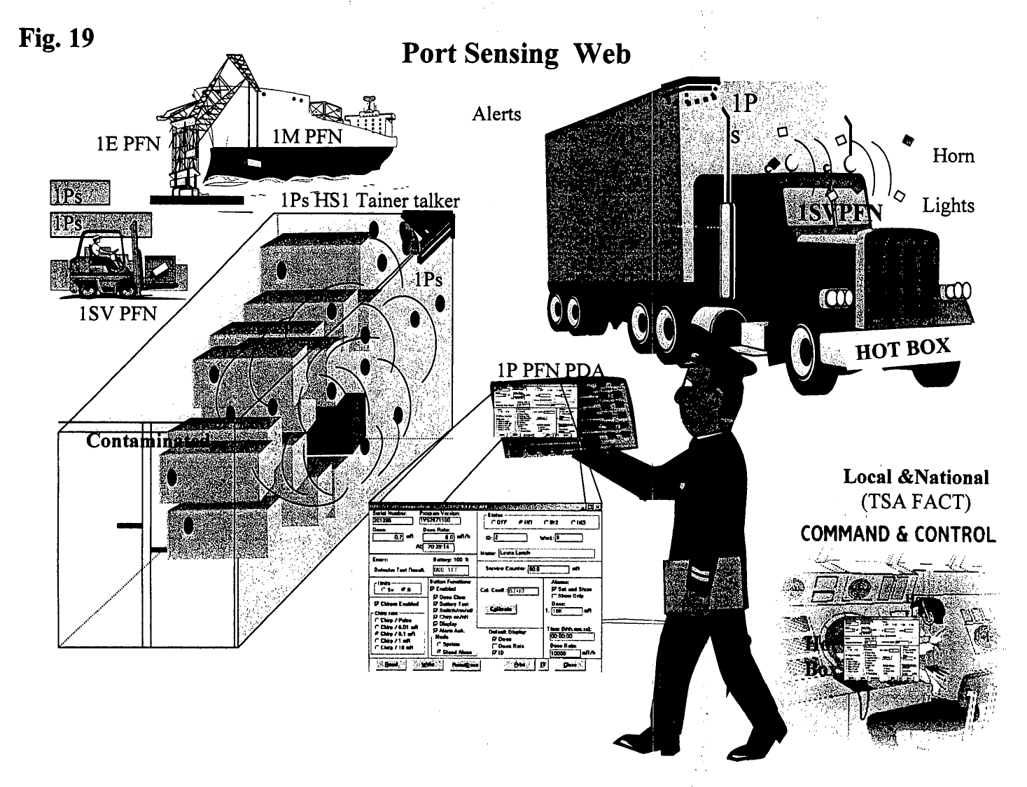

A third function is the portable network. Part of the FACT function is to inventory interfaced components and to maintaining a working inventory of associated materials. In this case the PFNs are mini repeating stations to those agency intranets in FIG. 19 support FACT registry for every electronic component that can be interfaced with a car, Plane, boat, train, machine or piece of equipment. This is true for 1Ps standalone PFNs as well. This is the basis for the traceable portable network a machine messaging matrix or web that is flexible and mobile. For example a number of materials could be transported across the country and their preprogrammed immediate communications would quarry each other to see if they were in the same area and recognize when the were not and report it back direct to the FACT control center for that intranet. This data would be re transmitted to all the intranets by IP and all intranets would up load this data to their PFN assets so when a scanning PFN identified the lost signal it would report the interrogating PFN GPS if the signal did not provide tracking e.g an RFID interface not another short range PFN.

Forth is locating program for non GPS units. The scan process would have an algorithm that recognized time reception of the same signal and strength and be able to apply it's known position history (fixed address or GPS coordinate) with other PFNs in the WLAN and determine position of the non GPS asset. (automate triangulation algorithm running in the scanner program and driven by the wireless receptions and frequencies counted.

Fifth Scanning Routine Function with FCC FACT for System Integrity and Proper Use of the Airwaves

The Federal access and control technology—specifically FACT/FCC will need to approve this PFN/TRAC scan function and empoy it. AR PFNs or TRACker routers could be configured to scan for all sorts of electromagnetic frequencies and EM wave propagations/transmissions or random oscillations as a precursor and maintenance procedure to safely perform wireless access and control of communications and machinery to protect the public's safety and national security. With terroris looking for ways to harm the united state we have to safe and protect our remote controls and airwaves. The PFN/TRAC system is all about protection and detection and this scanner function is but one electronic policemen on the job looking for unwanted and unauthorized transmissions

By design this is to be part of the FCCFACT regulatory process and their registry program for the communication commission to review data generated by their FACT program when making licensing decisions or inforcing it's regulations. PFNs could deliver clear evidence of over saturated areas with high noise and help the FCC delineate how best to license the airwaves and protect and mange this public asset

Additional Scanning Program

The Technology plans to explore the use of the deep space radio telescope signal search program to discover inteligent life in space. The average public was asked to help provide processing power (PC Based software) to run the software algorithms. For the PFN/TRAC system this would be reduce or customized with known transmissions filtered out in some cases and only looking for unauthorized or never detected occurrences(or specil FACT event anomolies).

that has a. Another processing option TRACker can employ through the hybrid sub state chip sets interfaced to the ASICs in FIG. 5 and the future FAA/TRAC unit ASIC in FIG. 7 and shown in the plane in FIG. 1 provides the communication processing to be done in the hybrid substrate or at least a portion of it. Basically application will dictate specific construction for specific airframes and aircraft.

The system is designed to be universally interface locally and systemically throughout the PFN/TRAC system and the exact prescription to that interfacing is flexible and transient with respect to the diverse commercial offering and present disparate inter agency communication and data links. By having these wireless routing nodes an aviation Intranet can be created to combine law enforcement flight operations commercial and security contractors in an umbrella for real-time security and public safety assessment in air travel.

Combing Wireless Stack for Scanning and Routing

Here is a supper cell

Have to discribe the following to scan and trans fer from long range to the broad band below

Supercell Network Design

The supercell (very large cell) network design is one that provides low coverage and low overall network capacity. However, it may be attractive for initial network rollout because of the availability of existing (tall) towers. In our supercell design, assuming that a sufficient number of MMDS channels are available, up to 18 sectors may be used. No frequency reuse is performed within the supercell, again because of sector-to-sector isolation requirements that are greater than sector antennae can provide. Each sector operates independently. Also, at least four MMDS-channels must be set aside as guard bands.

The number of sectors deployed on the supercell may be scaled as the demand for capacity grows. Because there is no frequency reuse, no special requirements are placed on the design of the sector antennae. For example, the same panel antenna used for a 3-sector supercell could also be used all the way up to 18 sectors. However, to increase RF coverage, narrower-beam antennae may be employed to increase EIRP. This will be effective as long as the supercell isn't capacity-limited (which is often the case).

The capacity of the supercell is given in Table 20-5. In this deployment model, we have not differentiated between suburban and urban deployments. The assumption is that the desire is to provide service primarily to subscribers in which LOS operation is possible.

Because macrodiversity is not possible in a supercell design, coverage becomes difficult. For example, the COST-231 Hata model predicts an 80 percent coverage at a radius of only 15 miles—much smaller than the desired cell radius. Moreover, this coverage is computed at the limits of the model's antenna heights—200 m for the HE, and 10 m for the SU over suburban terrain.

TABLE 20-5
Network Capacity for Supercell Number of Sectors
Cell Radius (Mile)
Small Businesses Served
Small Business Penetration
Households Served
Household Penetration
3
16
1,116
2%
26,856
3%
18
23
2,232
4%
53,712
7%
These capacities are based on 6-MHz downstream channels and 3-MHz upstream channels, both at the medium VOFDM-throughput setting.

If a lower availability objective were desired, the fade margin could be greatly reduced, thereby extending the cell radius. More importantly, the sector-to-sector isolation would be greatly reduced, perhaps admitting frequency reuse within the supercell. Because the cell is capacity-limited (there are many more subscribers in the cell's radio footprint than there is capacity to service), this would be a tremendous benefit.

The multipath channel from both the front (desired) antenna and the rear (undesired) antenna must be the same so that the fading from the desired and undesired antennae must be highly correlated.

The time rate-of-change of the multipath channel must be slow enough such that power control errors are very small.

The following sections present both the general functions performed by the various configuration items or building blocks segmented into transport and services products.

Transport Layer Products

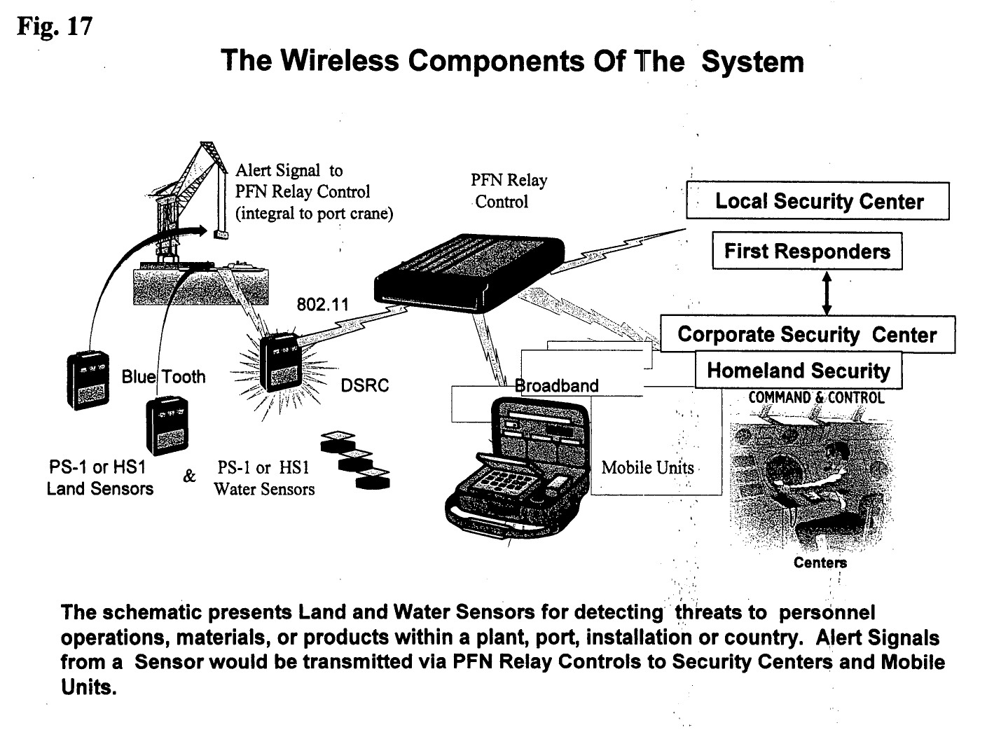

The transport layer is composed of the equipment that provides the transmission and reception of IF signals between the rooftop and router equipment and the RF signals over the air. The transport equipment is designed to work in an outdoor environment mounted on buildings or telecommunications towers. The P2MP transport layer is physically segmented into hub and terminal equipment categories, as depicted in FIGS. 20-17.

FIGS. 20-17: Hub Site Equipment (Per Sector)

P2MP Transport Equipment Element—Customer Premises

The terminal equipment consists of an integrated RF transceiver/antenna, commonly referred to as the rooftop unit (RTU). This equipment is easily installed on any customer rooftop using a standard mounting device. The RTU requires two RG-11 coaxial cables to the indoor equipment for transmit, receive, and power. The RTU operates on 12.5VDC (nominal) at the input and in standard configuration must be installed within 60 m of the network interface unit (NIU), although longer spans can be engineered and supported.

Rooftop Unit

The sole element of the P2MP transport layer at the terminal site is the RTU. The RTU is an integrated antenna and RF transceiver unit that provides wireless transmission and reception capabilities in the 5.7 GHz frequency region. Received and transmitted signals are frequency translated between the 5.7 GHz region and an intermediate frequency (IF) in the 400 MHz range to the network interface unit (NIU).

The RTU consists of an antenna (s), a down-converter/IF strip, and an up-converter/transmitter. It receives/transmits using orthogonal polarization. Selection of polarization (horizontal/vertical) occurs at installation and is dictated by the hub-sector transmitter/receiver. This selection remains fixed for the duration that service is provided to that site.

The RTU mounts on the exterior of a subscriber's building. Some alignment is required to gain line of sight (LOS) to the hub serving the RTU. Multiple RTUs can be deployed to provide path redundancy to alternate hub sites. The RTU requires dual coax cable (RG-11) runs to the NIU for signal and power. The maximum standard separation between the RTU and the NIU is 60 m. This separation can be extended via application-specific designs.

Basic Receiver

A single basic receiver is required per 90° sector, if no return-path redundancy is required. The receive module is an integrated 5.7-GHz receiver/down-converter/antenna. A collection of signals is received from customer units operating in the 5.7 GHz band and is block down-converted to an intermediate frequency signal. This signal is provided to any of the channel group types. Vertical or horizontal polarization is selectable, and a redundant receiver per sector can be deployed as an option.

High-Gain Receiver

A high-gain receiver is used in lieu of the basic receiver when higher link margin is required because of the specific geographic conditions of deployment. The high-gain receive module is intended to be matched only with the high-gain transmit module. The specifications are identical to those of the basic receive module, except for physical package and antenna gain.

Because of the modularity of the SP2200 products, there is no one standard rack or set of racks. All SP2200 elements are designed to mount in a standard 19-inch (48.3-cm) open relay rack with a standard EIA hole pattern or an equipment enclosure with 19 inches (48.3 cm) of horizontal equipment mounting space. Final assembly of the equipment into racks is accomplished on site at initial install or over time as capacity demands.

LMDS Environmental Considerations

Environmental conditions such as rain and smog must be considered when deploying RF systems that transmit at frequencies above 10 GHz because these conditions degrade the signal path and shorten the maximum range for a given data link.

LMDS data links are generally about one-fourth that of MMDS or U-NIII links and require fairly strict adherence to a line-of-sight implementation. One of the more favorable aspects of the LMDS frequency, however, is that it has exceptional frequency reuse capabilities.

Data link availability is expressed in terms of the number of nines that follow the decimal point. For example, 99.999 percent link availability means that a data link will be up and online (available) for all but 0.001 percent of the year. Link availability is dependent on a wide range of items, but these generally begin with fundamental RF system design issues such as antenna size, range between antennae, and atmospheric conditions (for LMDS band).

WLAN Standards Comparison

Table 20-6 provides a biref comparison of WLAN standards.

TABLE 20-6
A Brief Comparison of HomeRF, Bluetooth, and 802.11 WLAN Standards

| | | | |
|---|---|---|---|
| HomeRF | | | |
| Bluetooth | | | |
| 802.11 | | | |
| Physical Layer | | | |
| FHSS1 | | | |
| FHSS | | | |
| FHSS, DSSS2, IR3 | | | |
| Hop Frequency | | | |
| 50 hops per second | | | |
| 1600 hops per second | | | |
| 2.5 hops per second | | | |
| Transmitting Power | | | |
| 100 mW | | | |
| 100 mW | | | |
| 1 W | | | |
| Data Rates | | | |
| 1 or 2 Mbps | | | |
| 1 Mbps | | | |
| 11 Mbps | | | |
| Max # Devices | | | |
| Up to 127 | | | |
| Up to 26 | | | |
| Up to 26 | | | |
| Security | | | |
| Blowfish format | | | |
| 0-, 40-, and 64-bit | | | |
| 40- to 128-bit RC4 | | | |
| Range | | | |
| 150 feet | | | |
| 30 to 300 feet | | | |
| 400 feet indoors, 1000 feet LOS | | | |
| Current Version | | | |
| V1.0 | | | |
| V1.0 | | | |
| V1.0 | | | |
| 1FHSS-frequency | hopping | spread | spectrum |
| 2DSSS-direct | sequence | spread | spectrum |
| 3IR-infrared | | | |

The following should be noted in Table 20-6:
40- to 128-bit RC4 refers to very robust data security algorithms.
An 802.11 range of 1,000 feet refers to outdoor conditions. Indoor conditions are more difficult for these types of RF systems.
802.11 power output of 1 W is substantial.
The maximum number of devices supported depends on data rate per device.
The Aironet acquisition uses 802.11.

Although there are three standards in use in the United States, and an additional two are in use in Europe (HyperLAN and HyperLAN2), the FCC thinks highly of the 802.11b standard, and a close relationship exists between the FCC and the IEEE, which backs the standard.

Summary

At least 18 different types of wireless are in commercial use today. Therefore, as this technology becomes more mainstream, users will need to be increasingly specific in their reference to the term. The different types of wireless are quite unique to each other on numerous levels, and they require specific types of expertise to deploy, use, and maintain. In its state-of-the-art deployment, a wireless link emulates all the capabilities of a fully featured router, which means that a wireless link can provide VPN, enterprise toll bypass, and MDU/MTU access services. This is one of the primary differences between a Layer 2 product as provided by the majority of wireless vendors and the Layer 3 solution provided by Cisco Systems.

Regardless of the provider of a wireless system, the fundamental elements remain relatively constant:
Data or network
Edge or access router
DSP medium
RF medium (coax, modulator/demodulator, antenna)
RF management software

Like every access medium or technology, wireless has its pros and cons. The pros include these:
It's much less expensive to deploy than trenching for cabling.
It's much quicker to deploy-a link can be up in a couple of hours.
Wireless can go where cables can't, such as mountainous or inaccessible terrain.
Less red tape is involved for deployment, if roof rights or elevation access is available.
It involves an inherent high degree of security, and additional security layers can be added.
Wireless provides broadband mobility, portability that tethered access doesn't provide

The RF interfaces vary for application with commonalities per location company and purpose. This slide is further detailed in Appendix VII the appendix with the air craft on it. The airports and ports are a major focus of this PFN/TRAC FACT management Security System presented here by very few figures.

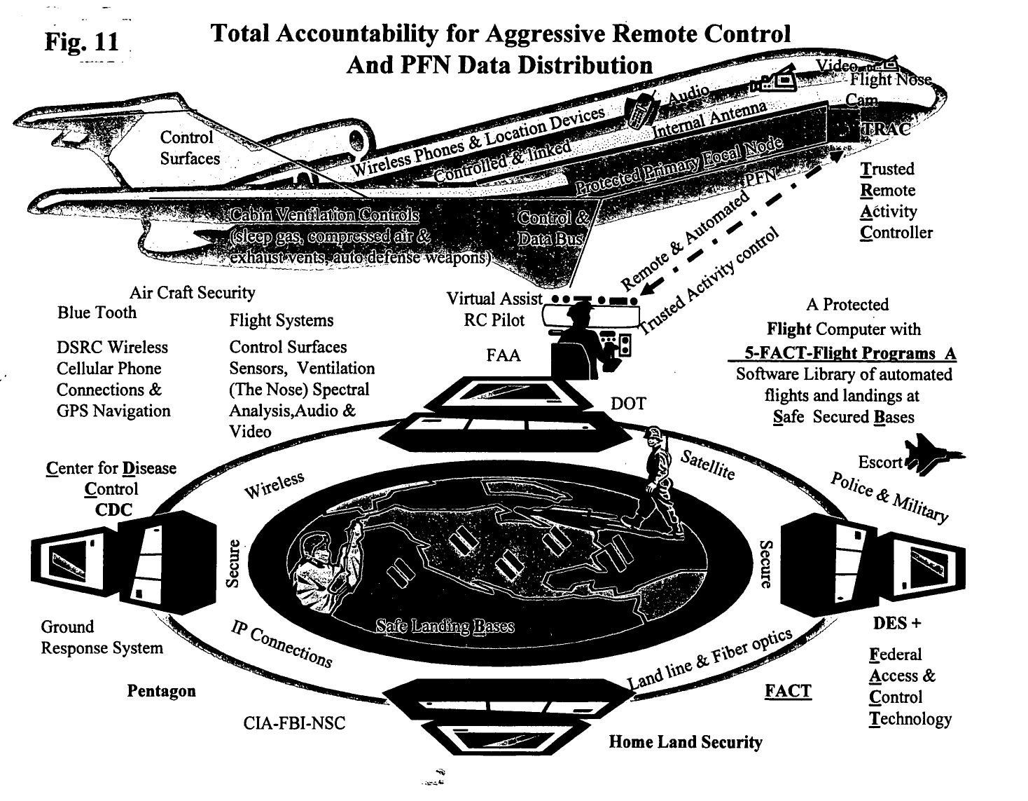

FIG. 11

FIG. 11 illustrates 2 basic divisions of the technology; the Plane and the ground control system to perform PFN/TRAC?FACT Remote Control (RC) and robotics via a pilot in the center of the figure.

FIG. 11 overview:

General

Like in FIG. 1 there are 2 basic sections to this drawing the Plane and the ground control system interfaced via the PFN/TRAC robotics unit which performs the FACT functions on board and with the Remote Control RC pilot in the center of this figure. In the lower front of the aircraft is a green lock box, the 1A PFN/TRAC unit. It is a protected interface node that cannot be compromised during flight and has the primary control over vital aircraft controls. (Any essential flight and landing component, programming and communications). This 1APFN controller and or any redundant PFN/TRAC control/routers on board are the only command and control units in connection and responsive any ground control system during a FACT event. This includes ultimate control over all voice systems. PFN units can and will be duplicated and placed wherever appropriate throughout the aircraft. They will be secluded as well as protected and interface as necessary with the aircraft's electrical bus in any fashion determined suitable to command, control all essential flight systems and security functions on board; and to back up any of those component or systems to meet standards or as determined appropriate by component and system engineers. Additionally, connected to the 1A PFN/TRAC unit or harmonized network of PFNs is any and all of the various antennas on board any aircraft. PFNs scan a necessary amount of system to receive and count frequencies to determine any and all transmission on board an aircraft. Additionally, they control all wireless communications to include hand held carryon devices such as cellular phones, personal navigational devices, other personal PFNs, mobile office units, personal computers, PDAs or palm pilots. The immediate purpose for this is to be able to terminate the use of these devices during critical flight operations at the will of authorized flight deck personnel via the PFNs, and especially, during a FACT event robotically. Additionally, the authorized pilot and trained crewmembers to include sky marshals can utilize these systems as emergency wireless links to the surface during where they respond to wireless IP gateways and data storage receptacles in an emergency.

The dominant 1A aircraft PFN operating at a any given point will be deferred to as the master controller in a control matrix that coordinates all other PFNs on board the aircraft either physically or permanently integrated and or any carried on PFN versions for a specific purpose and flight. This process will start during pilot ACARS before take off and be part of a running integrity program in all PFNs. All other PFNs and aircraft systems will be systems under control by the master 1A PFN controller. It becomes the communication router and activity controller and can use any all communication links to down load data to the surface, including special direct and indirect communication pathways that report to appropriate NENA numbers per geographic location for any specific first responders and the FAA/AOC/TSA/DOD/NORAD and any appropriate ATM commercial wireless gateway provider.

With the detection of compromised flight controls (a FACT event e.g. unauthorized aircraft activity) the 1A PFN sends an immediate Emergency Action Message EAM to AOC Air Command center in Herdon Va., NORAD/all North America military AIRCINC air defense centers and safe bases that the aircraft is departing from it's present course and has a new heading to the closest or most appropriate safe base via a preprogrammed FACT flight. At this point the pursuit and assist aircraft and personnel are scrambled and the appropriate level of Homeland security is increased to the appropriate level (Color code and how it applies to everyone for this event to be determined). Specifically, not just to all safe bases but throughout the FACT connected system servicing all of the nations transportation means and their security agencies. Operational and specific information will be processed through the system to provide the most relevant data for particular an emergency and heightened security level. General alerts from the FACT/TSA homeland command center regarding transportation security and safety will be issued in real-time or near real-time to allow for the appropriate formatting for optimum public safety responses. Other informative transportation management data will be passed to public media and websites via the inventions proprietary and protected technology, detailed in earlier related filings.

Specific

The FACT/TSA network needs to be put into parallel with the AOC centers nationwide as shown if FIG. 10 and NORAD and North American air command CINC and configured in progressive steps to achieve FACT control of all commercial and private aircraft. Additionally these FACT robotics flights have to be developed with military planners, aircraft manufacturers and security contractors to include isolated DES chipset in the 1A PFN controller to assure complete military supremacy of the FACT flight. The military are charged with homeland defense and they alone must have the sole capacity control and terminate a FACT event. All other agencies and authorities stand second to military control and the President's Executive Orders. Other essential agencies like CIA, FBI, NSA, NSC pentagon, CDC, TSA, FAA, and NTSB will be incorporated into the Homeland Security Matrix and connected via wireless and IP connections as indicated in this figure. Special government and security contractors have to develop for the procedures and protocols and code written for these specific agencies to have accountable access to this PFN/TRAC/FACT system and control matrix. All access must require agency specific and individual encoding with identification verification at each and every PFN or access terminal either wireless or hardwired to be recognized and gain access. All access will be audio, video and data monitored and recorded locally as well as, time and GPS or location stamped then sent and stored in regional and national FACT Security mass data repositories. (The special encrypted encoding to be developed and written with specific agency authorization must comply with any control procedures and specific protocols determined by DARPA and DOD software research and development operations like in Omaha and or the appropriate military and security contractors) (TS to be considered in this process are proprietary to the PFN/TRAC System invention and specifically the FACT Security program to manage the nations airways and transportation assets safety and security).

Things to do

Flight and landing program libraries for the Safe Bases SBs for the different airliners need to be written—Virtual RC pilots need to be trained for ground and the air pursuit aircraft. Five ground RC simulator stations with RC communication links need to be constructed at the five Safe Bases across the nation. The Five safe bases, the air routes/airspace have to be determined, facilities and aircraft have to be determined, arranged, secured, out fitted/supplied, and manned with trained personnel for the first to respond to a troubled fact flight.

Understanding the extent of the innovation, there has to be complete air space security for every aircraft. Commercial, general and private aircraft have to have a 1A PFN/TRAC controller in place with the aircraft responsive to the FACT Security program. This requires; all aircraft manufacturers, airlines, government agencies hardware software avionics companies to work in a collaborative manner and a progressive one to standardize this effort and to meet the specific needs to construct the 1A PFN/TRAC architecture correct for everything that flies. As part of this progressive process and until it is accomplished on each and every aircraft, human security and support operational staff will have to be trained specific and employed to fulfill any deficiencies to enforce the FACT option to fly and land at the desired NORAD/TSA/FACT conversion safe bases. The bases will precede all the aircraft converted to 1A PFN controllers, including the hybrid systems utilizing existing COTS avionics. Initially Air Marshals, pilot and crew will be assisted by the educated citizen/passengers.

However, not all security will be manual and technically deficient. Part of the PFN/TRAC progressive architecture is to provide the appropriate steps to grow from, no remote and automated controls or passive remote control only to accountable aggressive robotics, shared HMI control and full remote control. From the invention, this is accomplished in a series of PFN/TRAC System products. These products first interface via one-way wireless reception of standard aircraft data transmissions to the surface. Additionally they interface non-flight related security telemetry Audio/Video/GPS and assorted sensor functions, remote control monitoring and testing for future PFN remote control and robotics flight components and systems. These initial product ASICS are similar to the final PFN trused remote activity controller/routers for each application (e.g. 1A aircraft PFN). At least as they are projected in the current patent writings and teachings. Understanding the progressive embodiment of the invention

The reader is ask to remember that all final designs are and must be flexible in this process to complete the nature and scope of the invention due to the enormity of this management and security system, which includes all the nation's aircraft, vehicles, machines and equipment not to mention all the personal and stand alone PFN applications as well.

This same progressive development is used for all PFNs in every application. The process starts by interfacing COTS electronics and computer products to determine the basic components and programs for any specific application. Then the TRAC ASIC controller is assigned by computing requirements. This to may be of COTS origin like PC104 architecture Then further development and testing as router via an interfaced plug and play hybrid chipset platform of the desired transceivers, activity controls, sensors communication protocols software and firmware to construct a final PFN/TRAC unit as desired architecture is identified standardized and made more universal these ideal components and software and systems will be constructed and burned into a chip as SOC technology—miniaturized integrated and protected in a can or appropriate encasement to meet the PFN/TRAC System Standard as determined by industry, and government experts.

All the way through this process commercial product like the 1a TRACker (a brief case Laptop configuration) will be generated tested, accepted and used as a trusted controller/router to perform accountable remote control, robotics and communication routing via protected and secure wireless and Internet protocols.

Getting FACT in the air with TRACker for seamless security in air travel Isolated form the air operation avionics the 1a carry on brief case TRACker unit can forego the long test period to be placed on an aircraft and provide critical flight data early to all related security personnel and systems. TRACker's noninvasive recovery of critical flight operations data and security monitoring technology processed with GPS location and time data helps immensely to plan and coordinate a security response that is relevant to the threat.1a TRACker organizes translate, records locally, reports and relays data to the surface. This data is mined locally by the crew and air marshal on board with out having to converse with the flight deck or crew, Displayed on a personal DSRC PDA or special 1 P PFN display unit) Two products for PFN/TRAC unit development in aircraft

TRACker is to coordinate security efforts gate to gate in the skies with surface security/TSA and NORAD early on to develop the FACT monitoring system with present available security measures and grow the PFN/TRAC architecture. Another such versatile PFN/TRAC proprietary research and development product is the “FACT BALL” which basically gathers data and provides post analytical evaluating data in a protected storage vessel (an enhanced black box that can be set up to monitor anything without a lot of hard wiring—It also can perform as a driver interface platform to test equipment, monitor, recorder driver other devices (data gathering devices and actuators). However, this unique enclosure structure can be used to house a complete 1 S PFN/TRAC unit (a Standalone version of the 1P Personal PFN—these two types of PFNs are distinguished by requiring self contained power sources to operate them). Both the TRACker and the FACT Ball are precursors to the 1A PFN and they are further detailed in FIGS. 10, 11, 12, 13, 14, and 15.

Further discussion of FIG. 7 teachings disclose the planned development of the 1A PFN/TRAC router unit

The drawing above shows the aircraft with a more a detailed description than FIG. 1 a line on the bottom of the aircraft culminating in the exemplary 1A PFN lock box, but running to all the flight control surfaces is the aircraft control and data bus system. These are redundant and dispersed bus networks in many cases and as a result would all require interfacing (SUC) to the PFN control system on board. Additionally, another wider line running through the center of the aircraft and culminating in the 1A PFN is an antenna to communicate with dedicated short range communication systems or DSRC technologies like Blue tooth, RFID, 802.2 and many of the 5 GHZ wave links being approved for short range broad band applications by the FCC (e.g. 5.7 GHZ short range communication approved for DOT applications and interactive highway applications) However, this antenna is conceptual and any and all of the forty separate antenna on a normal passenger aircraft may well be interfaced with the conceptual 1A PFN unit (singular as in this figure for clarity—but also in number of 1A PFNs for any specific aircraft to complete a PFN FACT matrix and perform any and all of the communication control applications detailed in this specification)

All wireless devices carried onboard the aircraft and integrated in the aircraft are to be controllable via the 1A PFN on board controller/router on board the aircraft. Close circuit video as well as audio and all sorts of security sensor arrays are to be processed via the 1A PFN and relayed to surface security and air operations with time, GPS and Unit and aircraft identification. GPS receivers are generally part of any PFN architecture and this technology as well as other intelligent positioning technologies will be interfaced and used to confirm aircraft positions and flight path as one determining factor to detect unauthorized flight and will result in a programming flag triggering a FACT event and FACT robotics flight response in the 1A aircraft PFN.

The middle of the figure names the interfaced systems that will be detailed more extensively through out this specification and figures. However, from the middle of the drawing over to the right is the FACT Safe Base Remote Control Station receiving telemetry from the troubled FACT event aircraft, the five preprogrammed FACT robotics flights and the escort assist aircraft, that are all activated simultaneously in a FACT event.

The Exact Activation

and scrambling of aircraft is to be determined for most proficient use of equipment and personnel for each emergency and these procedures are to be made into protocols taught and programmed into the system where relevant. The ultimate objective is the highest public safety and national security and the least collateral damage for any and all decisions.

Commercial operation applicability risk management and insurance for FACT Events These are tough decisions at best and if proper procedures are followed responsibly; there should be no personal liabilities, even if a better methodology is determined post any event) (any and all persons genuinely performing in these FACT event procedures should be indemnified and deserve all the respect the nation can give them. Whether life or limb is at risk they will be emotionally affected more than most in a lifetime by even single event. The system and its manufactures likewise should be indemnified if their development and construction has been properly performed. Insurance and risk management plans should be developed and incorporated by government and the private insurance companies. The PFN/C/FACT system of accountable reporting should provide all commercial bidders fair but guarded access to essential data in their effort to bid for these granted policies. However, they must have secret clearance facilities, personnel and policies in place to protect any sensitive information during their evaluations even if they are not privy to the most sensitive FACT program information.

The lower half of the figure is the matrix of security computer systems and mass DATA handling and storage. That is made up from the PFN/TRAC system of PFN controller/routers and existing mass data systems. Together, this will make up FACT security program and a real-time real-life matrix for homeland defense and security. It will involve the TSA, NSA, secret service, CIA, CDC, FBI, DOD, and local first responder, just to mention a few.

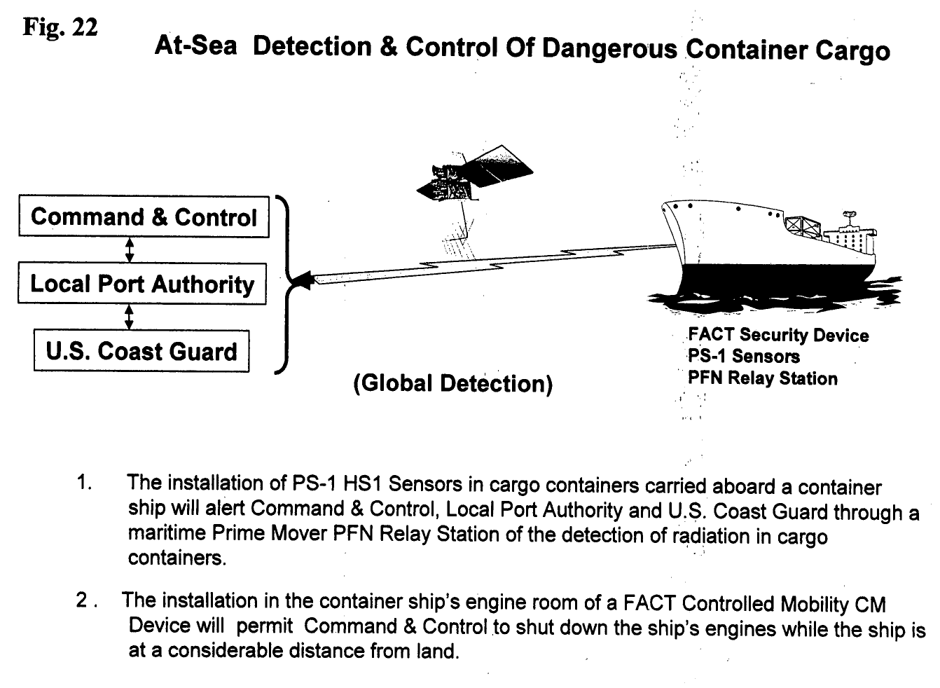

More of the PFN network and FACT security system is illustrated in a transportation matrix overview in FIG. 22 for the entire DOT network. It can and will involve all or only government agencies and or commercial industry via specific connections in real-time; and or the public with limited access and or total access to specific areas, and or, no access to specific areas; to be determined and processing determined for real-time and or near real-time reporting. But one endemic fact is that any and all access is to be totally identifiable, traceable and accountable, to include the nature of the access and use and content including quantity of data affected. (All protocols even top secret must be determined and deal with this absolute accountability process for access and use of the PFN/TRAC System and FACT Security Program (no exceptions and redundantly protected). This is what makes it a TRUSTED architecture to gain the Public's Acceptance; and it is a crucial embodiment of the invention's nature and scope.

In the bottom center of the figure surrounded by the PFN TRA/FACT 1P matrix is the globe showing five safe bases across the continental United States a CDC with a nurse and soldier in the center. This represents the five specific air bases converted to Safe bases, (these protected campuses should be 20-30,000 acres of protected space at least with the highest state of the art technical and personal security and defense possible. Additionally, all types of emergency responders should be staffed and ready to respond for any FACT flight event. Much thought as to the placement and construction of these safe bases have been done and will be held as trade secrets (TS) at this point for National security reasons. It is important to keep in mind that enough of the FACT flight program has been explained for those skilled in the arts both in government and the private sector to construct a secret program like FACT and also to claim this practice and any derived procedures and protocols proprietary to the PFN/TRAC system and this FACT security invention regarding air travel and transport for public safety and national security. Acronyms repeated that relate to FIGS. 7 and FIG. 1 for convenience

The following are basic terms and definitions used for this invention: The PFN is a Protected Primary Focal Node (an accountable controller/routing wireless interfaced unit. The PFN contains TRAC a Trusted Remote Activity Controller to perform accountable & reliable robotics and remote control. FACT stands for Federal Access and Control Technology. RC=Remote Control, WoJack=Wo War ops and Jack is taken from hi jacking.

TRUSTED for this invention means; reliable, accountable, and acceptable to all the public. (The citizens, government, and commerce all the public)

Points of Implementation

Of particular value right now, TRAC technology can be embedded into aircraft (at the design stage the 1A aircraft PFN architecture should be developed immediately so it can perform accountable functions for the purpose of gaining control and stopping the unauthorized or unsafe use of our newest aircraft. 1A PFN development for retrofitting should be initiated immediately as well for present and legacy avionics and aircraft. The 1a TRACker with the laptop or PDA processing in a brief case carryon unit should be developed immediately and this inventor has discussed this option with Boeing already. Ideally beta testing can be done in one of their test aircraft or FAA's test aircraft.

The 1A PFN Aircraft Control Challenge

In a hijacking the lack of flying skill is not the only concern: The aircraft might well be commandeered and deliberately used and guided for it's destructive potential (e.g. a human guided missile like the WTC and pentagon events). In this scenario it is necessary to restrict the local flying controls immediately.

Major Types of Controls

In the above scenario, conversion of fly by wire controls to exclude a local control on board the aircraft can be achieved far faster than those aircraft still using physical links. Total hydraulic systems and hydraulic assist systems can be converted to exclude local controls easer than physical link systems, but still more difficult than fly by wire systems. Physical lockouts on human controls and remote control automations are workshop tasks for those skilled in the art; and there is no minimization of the size and enormity of this task being inferred. However, engineers/technicians can construct a secure RC operated or robotics aircraft from existing aircraft and aircraft avionics via the specification and their knowledge base. Aircraft automation and computer controls are quite advanced today. One big jump is psychological to TRUST an automated system with the well-respected job of pilot.

However, it might prove easier to protect, make operate consistently and secure a small electrical control package in comparison to all insuring performance variables with humans and protecting the cockpit and flight controls. (Let it be well understood—there is no suggestion of a pilot-less aircraft and the inventor would not fly on one) This is an issue of pilot assist and options.

The 1A PFN TRAC aircraft package will be backed by a massive mindful machine-messaging matrix of coordinated human and artificial intelligence to help the pilot deal with any of today's emergencies. Pilots will be carrying guns to protect their position behind the yoke. These highly skilled aircraft operators are not stagecoach teamsters rocking across dusty trails at 15 to twenty miles an hour tops for a few short minutes trying to lean back and shoot at hostiles trying to hold up the coach. Pilots are flying sophisticated machines traveling at 400 knots 30,000 feet above the earth's surface.

These scenarios while quite possible today would still take eight years to get them on board functional in a commercial air craft with the current government and industry approval rate. However, their development today is essential and necessary. The TRACker has been created as a first step in this process as it does not interfere with the flight controls or interface with the aircraft. It is essential however to complete the remote control scenario for the complete invention and protocols to be understood and the objectives and goals to be appreciated

The initial goal after eliminating local control is to stabilize the planes flight path. This second objective is accomplished via local robotics for better real-time responsiveness in flying the plane a distance to a predetermined Safe Base. The TRAC processor will have five preprogrammed flight plans. TRAC is interfaced with the essential E/E bus to operate the planes flight control surfaces. Additional controls interfaced with PFN/TRAC are to be the cabin air pressure controller. TRAC can restrict any air exhausted from the cabin by either routing the air through carbon dioxide scrubbers/converters. TRAC will also add fresh air (O2-?). Removed cabin air will be compressed and canned. This un-recyclable air or waste air is then presented to a sensor array to detect biohazards and toxins. Once transducers have converted any molecular substance into an electrical signature, the signal is transmitted to TRAC. TRAC running recognition software will analyze it locally. If not identified by the local software library it is recorded and reported to the surface by any secure on board TRAC interfaced communication if the deed frequencies are compromised. The data is to be used locally for emergency in flight options and on the surface for the Safe Base system to prescribe the appropriate safe base response for the incoming troubled aircraft. Informed decisions will be made to terminate flight, bag it when it is down, sterilize it, or how to unseal it on the ground and deal with it). Also, connected to the aircrafts ventilation system will be a TRAC controlled valve with debilitating gas (sleep gas or chloroform, etc.?) that can be activated from the ground or robotically for what is termed a Woo Jack scenario or FACT protocol.

During the final approach to the designated safe base landing zone the robotics flight and glide path control gets a hand off to a Remote Control RC pilot in a surfaced based converted flight simulator receiving secure and redundant essential data streams via a protected multiple digital control channels for the greatest real-time responsiveness of aircraft. Additional control is added by a software algorithm (fuzzy logic) for a heightened and more accurate glide path; a TRAC guarding angle function. The result is an intelligent airplane with an accountable autopilot and RC pilot performing an uneventful landing with sleeping occupants. Worse case scenarios being the bad guys have their own air supply. However, their hostages will be dead weight and un-reactive to their commands terror tactics, which in some circumstances could lower collateral damage due to passenger's erratic movement when the plane is boarded by swat teams. TRAC can always change the atmosphere and revive the passengers if this proves more beneficial to a security protocol.

Abhorrent RC and Robotics Options

The 1A PFN/TRAC unit will have the ability to dump any fuel from a remote location or via preprogrammed robotics and or accountable remote control. There may be good reason to dump the fuel or release a treating agent into the fuel supply that reduces the flammable characteristics of the fuel supply. Obviously, the 1A PFN could perform many undesirable functions including the ultimate destruction of the aircraft via remote control if this was determined the best public safety alternative. A proper decision tree has to be determined for these difficult RC choices like the Wo Jack scenarios before emergency FACT software protocols can be programmed, code written and in stalled in a function 1A PFN controller/router unit. PFN/TRAC was created to improve human life and public safety in transportation.

Software Challenges

Obviously, the programming cannot and will not ever be the same throughout the PFN/TRAC system handling this FACT Security program. However the PFNs will operate on a PC platform as much as possible with windows applications for most all human interfacing components (Displays, etc.). Individual PFNs will be tested and certified when placed into service, as accessories and new programs are added and from time to time to insure they comply to a minimum processing speed and have their safeguards in place to prevent over taxing the unit's capacity to be responsive and reliable in running programs and driving essential activity controls for safe robotics and remote control. Integrity checks and continual anti virus programs will be done and down loaded from the FACT Mass data centers service and maintenance divisions as well. The unit will be isolated for service from the system and the owner notified. With each unit recording its activities locally these isolated units can be accessed and contacted by isolated wireless remotely and quarried in real-time by the FACT cyber police computer to immediately detect tampering or hacking event and any virus recognized and introduced to the unit. The physical unit will be picked up and replaced along with the access ID perpetrator or at least the ID imposter scheme will be discovered.

Governing Law on Tampering

As detailed in earlier related filings the protected PFN/TRAC unit should have especially stringent laws and severe punishment applied to anyone caught deliberately tampering with a PFN unit. This is an accountable shared control technology with humans to perform machine activities as a whole system and deliberate and malicious destruction or damage to a PFN causes great risk to the public in general. It is a great assist technology for humanity and humanity deserves this kind of protection from anyone seeking to do this kind of harm to the populous via tampering with PFNs.

Software cont.

All other languages and protocols will have translation algorithms developed and either have burnt in firmware or into plug and play chipsets to complete interfacing or have installable software and drivers for the desired accessory or device connected to include the various wireless protocols. Most all the major wireless manufacturers offer the experimenter products to construct programming for prototype projects and this will be the modality used in many cases to coordinate a translation processing done by the specific PFNs between the present wireless protocols and machine messaging. Some has already been done and some is done in PC format and wireless protocols, (automotive can bus systems j1939. j1850 and the latest automotive bus—the 429-737 air bus maintenance program for avionics, etc, but there will be the need for real collaboration to achieve the universal translation throughout the PFN/TRAC system for the FACT program to really function well.

The air travel industry is completely detailed in appendix VII and VIII. However, there is real resistance to robotics flight and remote control from pilots and from industry for commercial flight. After meeting with firms like Boeing made up of pilots and engineers the consensus appears to be Robotics and remote control UAVs is fine for the military but not for commercial flight. This will be difficult but has to done in the future and necessary for seamless security.

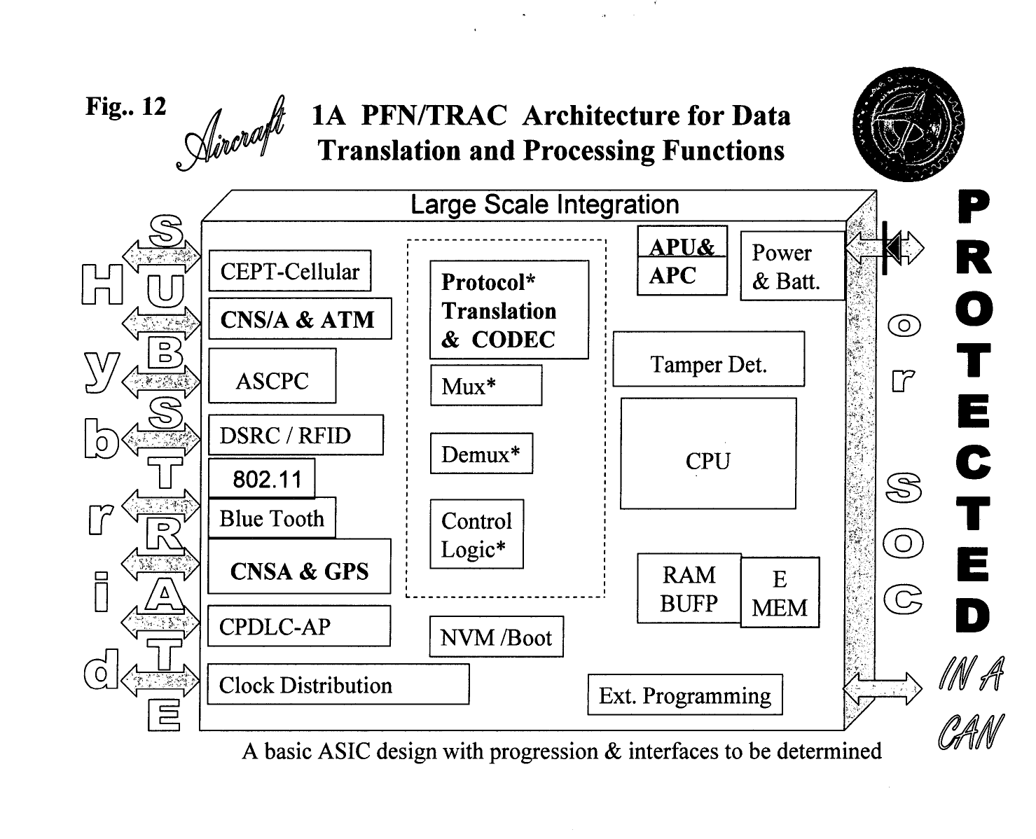

FIG. 12 Function Description for Programming

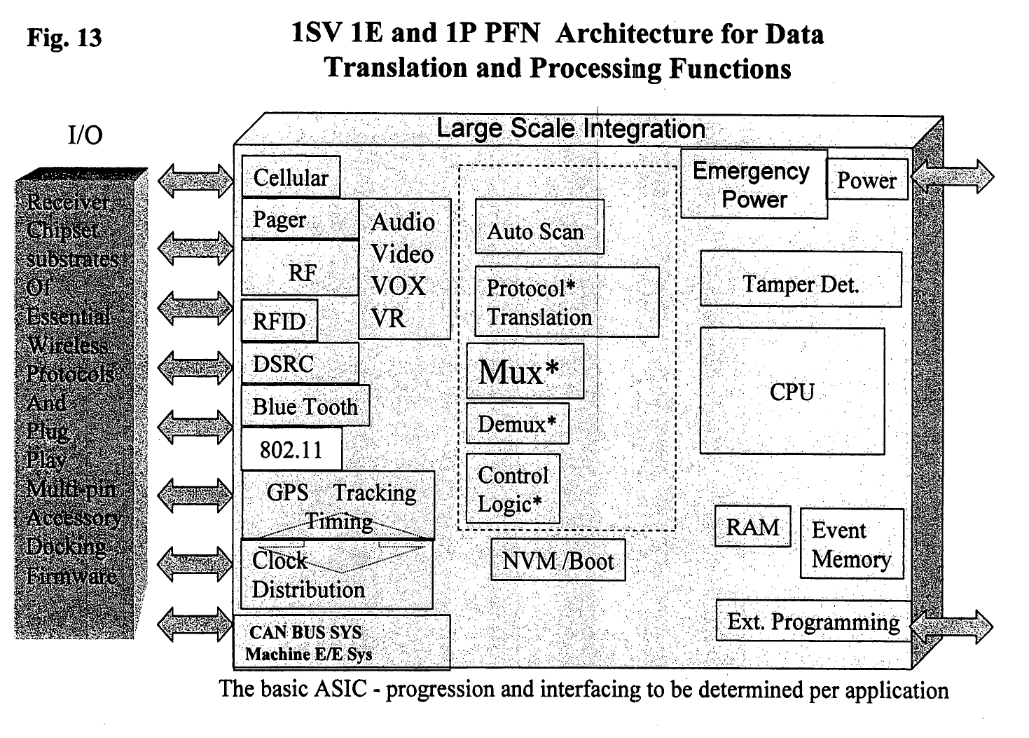

This application specific integrated circuit (ASIC) is to interface avionics with the PFN/TRAC System of wireless routing and computer networking on the surface. The circuit design is for complete robotics and remote control of an aircraft. This circuit is not just a simple record and report isolated monitoring function like another PFN product the “1a Tracker” a related embodiment of the invention, which is discussed in FIGS. 13, 14, and 15. in Appendix VII and agin in Appendix VIII. It is intended to interface into specific avionics flight control systems and data handling circuits and systems and be the functional control component during a Federal Access and Control Technology or “FACT” event.

1A PFN aircraft controllers will manage back up systems as well as primary flight systems on board. The benefits of system redundancy will be incorporated for the safest of robotics and remote control flights. In many simple and legacy aircraft the 1A PFN/TRAC controller/router may the only other system capable of performing redundant activities. The essential flight systems will be interfaced via a higher-level interface program running in the 1A Aircraft PFNs. Multiple 1A PFN/TRAC units may well be part of any specific aircraft's avionics and they will have intercommunications by wireless and hard-wired connections. These multiple PFNs will be harmonized to insure un interrupted and coordinated control of the aircraft for those authorized to manage the flight aloft and on the surface.

The architecture provides for translation programming between disparate communication protocols for universal emergency messaging. Additionally provided for, is the necessary programming for essential E/E avionics bus systems to be interfaced to harvest data and manage flight via any on board flight computers, collision avoidance systems and autopilots. Or, by direct connection with activity control components (any appropriate flight control surface actuator) via 1A PFN units or actuator specific stand alone PFNs. The robotics and remote control performed is to be a large scale PFN/TRAC unit integration with aircraft systems. It will be a progressive one with initial interfacing of current COTS dispersed systems and components into a protected processor and protected actuator architecture. Future consolidation miniaturization and reduction in weight will be accomplished through Systems On a Chip or SOC technology. Of course, all versions will have to meet current standards, rules, regulations and codes as a necessary part of FAA testing and to be in compliance with the nature and scope of invention (the PFN/TRAC System™) as detailed in related filings.

In concept this ASIC gives direction to those skilled in the arts to plan the various control scenarios involving hardware, software and firmware for each aircraft. This figure lists the basics to construct the aircraft controls to fly five pre-programmed flights and Safe base landings. Enough to operate the aircraft with the necessary real-time flexibility to flight conditions available equipment, with no flight personnel and to land at one of five specified safe bases. Obviously, this scenario will not be absolutely safe but better than no pilot or the wrong one. Later; Flight and glide paths in programmed library data bases will exist for more airports, but FACT troubled flights will still land at special bases designed to protect the public and national security, and these scenarios will never be absolutely safe).

The preprogrammed flight and landing programs can be stored on board or up loaded to an aircraft in need for automated assistance in returning to the surface. Possibly this could of aided an in experience pilot like JFK Jr. if a PFN controlled all the automated flight controls in his aircraft and he was in communication with a ground data base AOC center that could have down loaded specific programming to land at Martha's vineyard. Or had he had the opportunity and ability to download these programs before lift off.

Due to the many onboard systems and computers in present commercial avionics the PFN/TRAC System will initially and continually monitor current and future systems for failure by wireless interfacing and performing integrity checks for abnormalities and tampering. This progressive unit will be able to control any essential peripherals during a failure event via local programming and robotics while it receives remote up loads from the surface in real-time. Future generations will provide more system protection and consolidation as well as redundancy of dispersed PFN/TRAC units that communicate and operate in harmony. The first PFN generation of aggressive robotics and remote control will be thoroughly tested to insure no false activation of the system and components. This is to be the primary objective for any PFN/TRAC interface component before being offered commercially—no false activations. Then, it will be offered to the authorities and the public in general with the understanding; that it will not falsely activate. However, outcomes for authorized activations during hostile aircraft takeovers or to counter for local catastrophic flight control loss in real-time are at best just another option to a flight in trouble with no guarantees for a safe landing.

Basic for Public Understanding Concerning all FACT Activations:

When federal access and control of a piece of equipment occurs, that piece of equipment is being operated in an unauthorized or unsafe manner and any intervention is at best designed to limit the time any particular negative activity can transpire. Secondarily, exists the possibly to augment the outcome positively via genuine human effort and the proper technical options available. It is important to remember this is only a chance to improve the safety of a particular public at risk or the public in mass. There are no sure safety measures for unexpected dangerous operation of equipment, especially if it is a result of intended misuse like a terrorist event.

Sample Circuit Description

This figure is not to be considered specific or restrictive of any PFN ASIC architecture. The technical teachings of this patent for the PFN/TRAC System are discussed in an alphabetical avionics acronym list later in this application and three subsequent aviation filings. The terminology section helps organize the individual areas to progressively develop the technology via separate components and specific applications for the various aircraft. The accountable robotics and remote controls of the invention is the bases for the operating systems purpose, both in the FACT ground system and in 1A PFN aircraft avionics for flight management systems. The various events that will fag a FACT activation are discussed with the response and activity controls as they apply to the named through out the application and in this section

The boxes on the left side of the green block are used to give examples of the communication and data interfaces essential to TRAC processing and should be controlled via the PFNs in a FACT event. Top Box CEPT-Cellular is the commercial cellular frequencies approved for use in flight applications like GTE's Airfone system used in the United States aircraft for passengers to place calls from the aircraft. This system works off of LEO satellites and does not interfere across the commercial surface cellular system of towers flooding ground telecommunication systems from a dispersed signal from above. Systems will be used to send parallel data streams to TSA and security links with real-time flight operation's data, in the other 1aTRACker product and could be used by this 1A PFN ASIC to send security telemetry recovered by the 4th block labeled DSRC for dedicated short Range communications, which may driving onboard close circuit video/audio and or other sensor array security applications. The 5th box blue tooth that is a commercial Off The Shelf DSRC system for wireless carryon devices. This chipset with appropriate protocols will be interfaced as a hybrid substrate as stated to the left of these basic communication inputs on the FIG. 3 block.

A PFN/TRAC unit will be capable of controlling and using all standard carry on wireless devices and recognizing other non interfaced transmissions via It's scan function and frequency counting algorithm, that will constantly monitor an appropriate number of the 40 antennas that are on board a traditional commercial aircraft to adequately survey for an rogue or unauthorized transmissions.

The second block on the left CNS/A & ATM The Communications, Navigation, and Surveillance/Airborne system is linked by wireless hybrid transceiver/protocol chipsets. This configuration is displayed in other similar figures. The above 1A PFN/TRAC circuit recovers any data generated by the aircraft. All systems carrying voice transmissions analog or digital will have voice recognition software applied to transpose any verbal communication into digital format for transmission by other wireless protocols (e.g. airfone) interfaced and or as text to be recognized and read at the appropriate application level in any TSA, AOC, ATM monitoring terminal, either locally or from remote locations. The ATM portion of this block would be also another Hybrid Chipset for the Air Traffic Management provider like ARINC or Boeing with all the necessary receiver, protocols, codec and translation programming to receive this data locally in the 1A PFN/TRAC unit(s) and relay this data via any number of acceptable or needed wireless technologies on board the air craft or via another digital configuration and modulation within the broad band width of the ATM service provider for the specific aircraft.

The TRAC controller/Router would determine the best means to transmit any needed data and how to under any circumstances. Redundant back ups on traditional frequencies and the not so usual frequencies is all available to the 1A PFN TRAC controller/router and the FACT/TSA/CINC North American Air command. These agencies will generally be located with the AOC. But when not the agencies will be able to network with AOC and commercial ATM programs in real-time. ASCPC Air Supply and Cabin Pressure Controllers is an exemplary accessory System Under Control or SUC to 1A PFN/TRAC unit and FACT programs. or at lease certain functions will be. The air supply to the cockpit and passenger cabin is to be monitored for contaminants e.g. Bio, chemical (EDS) and physical property sensor arrays smoke detection,

Audio/Video/Thermal/radiation sensor arrays and various transducers, which send specific signals to the 1A PFN ASIC. These individual devices are operated and processed by the proper divers and programs installed in the 1A PFN and translated by conversion interface algorithms to format the signal for transmission to the surface and TSA terminals via the appropriate onboard wireless. Some such sensing capability exist on sophisticated aircraft already and these data streams would be interfaced with the PFN/TRAC units on board to harvested their data and enter it in to the 1A PFN/TRAC units monitoring program and on to the TSA system and other agencies via internet protocols and or connected via direct wireless gateways. The FACT (IP) security matrix combines national and global transportation, law enforcement and security Intranets. These security agencies are responsible for continual layers of automated and human data mining and analysis.

The 4th and 5th blocks on the left are all the short range interface protocols DSRC or stand alone PFNs with dedicated short range communications, RFID radio frequency ID products like (EZ pass) and Blue tooth another short range RF technology for wireless telephones to interface with some automotive telematics.

These are existing technologies interfaced via the PFN platform in the ASIC and would have the appropriate hybrid chip sets interfacing these technologies to track, identify and sense materials, equipment and people approaching and entering the aircraft and the aircraft's cabin and compartments. Via, these connections the 1A PFN or series of 1A PFS on board the aircraft and working in harmony will identify carryon wireless devices through ESN recognition and look for equipment alerts from FACT Security and TSA down loads to the local 1A aircraft PFN as well as manage the use or restrict any such use of the recognized cellular phone or other wireless carryon device as determined best for flight safety security by the legitimate flight crew or the 1A PFN/TRAC unit. This connectivity via Blue tooth or 802.11 DSRC to standard commercial cellular phones will be used as an emergency-communication asset to the surface.

RFID

Mentioned above the RFID Tag technology is a short-range identification system that also can be interfaced into the PFN/TRAC interface platform's to repeat or digipeat as a report function to FACT and TSA terminals and deliver data to distant remote mass data repositories. The PFN would supply plug in connection for RFID transceiver chipsets to drive their special antenna or magnetic transceiver portion of the RFID architecture. Then the EZ pass tag could pass through the antenna array and be identified. Antenna hardware could be concealed in the air fame passageways and compartments. The gathered data would be passed on via PFN interfaced—long distance wireless technologies—either wireless telephony or other RF depending on the application. Additionally, the mined data from the tag's flash memory would be redundantly stored locally by the Primary Focal Node's Trusted Remote Activity Controller/Router's extended memory for accountability and accounting purposes with a flagged event. Or to compared to any boarding list of known materials that was checked in and tagged with RFID technology for transported to a particular aircraft that matched a specific passenger' travel plans and movement for example. Or the recognition of suspect packages being tracked by law enforcement and was matched in the PFN processor from downloaded data from FACT/TSA or other agencies in the national security matrix tracking material movements. This technology can be used to identify and track mobile inventory for security and for commercial applications and billing applications, etc and communicated in real-time via the PFN machine-messaging network.

However, to step it up a notch the use of the stand alone PFN a version of the 1 P personal PFN will provide sensing data of the material being moved and the state it is in and transmit this data to the 1A PFN and other equipment and vehicle PFN units like the 1E equipment and 1SV surface vehicle controller router which rebroadcast this data to FACT TSA centers. These units and their ASICs are detailed in other drawings with the defining difference being they have limited in power and distance and ability to handle high current applications, otherwise they can give the same telemetry as the equipment PFNs and more telemetry than the RFID technology (basically jus an ID tracking technology.

Scanning is another interfaced technology in all the PFNs. Scanning like Bar codes and the PFN/TRAC's own Bag sign where the 1A PFN ASIC via the proper chipsets and drivers (hybrid substrate) will recover identifying images from personal bags, in this case of the PFN/TRAC bag sign product the passengers own signature which is placed on the bag by the passenger via invisible signatures made with special markers detected only by ultraviolet light and a hooded video scanning device. The images are converted to a distinct digital signal and are checked via a comparison handwriting algorithm in the PFN to confirm Bag and passenger match and location via video Iris or other personal ID recognition technology in real-time through out the air travel/transport experience. Through the airport and gate to gate through the skies

RFID tag technology is an example of a technology that would be enhanced by a PFN interface. PFN/TRAC System increases RFID technology track and deliver more real time data to many 1P systems for monitoring and management of material movement both for commercial purposes and security reasons. This technology is an excellent Commercial Off The Shelf Technology example of COTS interfacing being enhanced via the wireless PFN interface connection. The PFN/TRAC unit and System becomes a flexible security sensing matrix with these types of technologies interfaced and is likewise enhanced in it's capacity. Additionally, much more relevant data can be added to the RFID tag data during PFN processing such as PFN GPS or fixed address and time and passed on to command centers and first responders dial ups to NENA numbers or wireless gateways to 1P protocols DES/DET/TSA and homeland defense and security—if applicable as well. PFN diverse utilization of commercial wireless communications like Blue tooth as part of this invention's nature and scope networks these DSRC wireless through the Systems Under Command as SUC technologies. A translation program is written of interfacing code to use all interfaced protocols immediately to transfer PFN/FACT directives and data via any cellular service they were resident with in the same wireless device. These telephony providers would be part of a priority emergency action messages EAMs network that delivered this packet data to the surface IP/TSA gateways and dialups for FACT's homeland security matrix. The troubled aircraft would provide a continual down load of identifiable data packets and information to surface receivers or satellite in route for further data resources in real-time to critical assist agencies and for later analysis. Special arrangements with these providers to support secure gateways into this IP security matrix of FACT/TSA security and other agencies would have to be arranged and constructed. These providers would use their existing peta mass data handling and storage systems with special FACT/TSA security storage programming and storage, or they would be out fitted with special PFN/TRAC/FACT Memory repositories to capture all local down loaded data as part of a FACT equipment register system described in later figures and earlier related filings

A By Product Advantage to Local Interfacing-System Connected

While the invention uses existing technologies and better coordinates their use in cross environmental applications it also manages the host equipment more efficiently by coordinating movement of vehicles on or near the earths surface with the data processed. The technology does not infringe on existing art, it is enhancing it by interfacing it into the PFN/TRAC architecture where it enjoys a wider market base of applications. It is important for the reader or reviewer to keep in mind that the above wireless technologies are examples and this group of interfaces will change per aircraft and later in the terrestrial ASIC designs by application. The invention was not design to compete with existing technologies or infringe on prior art. It has always been conceived as an interface platform to coordinate these dispersed and disparate technologies and commercially work with these technologies to better manage equipment and route data for an improved the quality of life for humanity.

CNSA & GPS along with CRZ cruise tracking technologies are other inputs interfaced with the PFN via any necessary protocol chipsets. Exact flight path data will be gathered from onboard smart determination technologies and ground surveillance and communication systems and compared to preprogrammed flight plans. All in flight changes will be verified by surface and aircraft data telemetry and unauthorized flight will be FACT flagged and immediately result in a Safe Base flight plan via FACT event protocols. Constant communications with the aircraft and the order for escort and assist aircraft for any troubled FACT flight will be a part of this immediate response and directed by DOD homeland air defense CINC AIR COMMAND/NORAD.

CPDLC-AP The cockpit data link and auto pilot box in the figure are the direct and primary data inputs and flight controls feed back. During a FACT event they will be SUC to the 1A PFN or group of 1A PFNs or Trusted Remote Activity controller/communication routers (this is a TRAC ASIC above—the terrestrial PFN/TRAC ASICs are in subsequent figures), along with any sub specific application PFN ASICs which operate any necessary dispersed actuators to control flight control surfaces over any of these systems if they can not be secured from human control while the aircraft is in flight.

Avionics Translations

It is important to remember that the system under control has to translate avionics bus activity controls in digital format to the PFN operating program so along with all the hybrid chip sets there will be one to synthesize protocols like the 429 maintenance interface does for 737 to convert froth the avionics digital signal messaging to a PC platform and windows applications for maintenance. This is not specifically shown here in this ASIC because of the space in this figure. But this is the type of translation programming that will occur in the CPU with the codecs stored and conversion programming stored in memory.

Other figures and the other related patent applications describe direct from the PFN separate actuators as well that are part of the technology's protected operations. The skilled in the art have to construct functionally appropriate designs to meet any code and specifications known in the industry for the specific airframes. Acceptance of the PFN/TRAC system architecture in general must be a process by the appropriate industry and government experts to test accept and standardize these constructions.

Many analog systems and physically controlled aircraft to day will see its first automated fight controls via PFN/TRAC unit avionics and actuator components. Actuator controls are covered in earlier related filings.

Basically, the 1A PFN and PFN/TRAC network of units if so needed in any particular airframe will operate to form a seamless connectivity of flight controls from first existing systems like the flight computer, collision avoidance systems, forward seeking radar, weather radar and any autopilot controls. These systems will be interfaced and use to fly the plane un interrupted and appropriately with current robotics However, in the event that the plane is not responding as it should the assist remote control pilot in an escort plane and or the ground RC pilot in the simulator station or the 1A PFN TRAC Unit onboard will be deferred to-to control the aircraft via PFN robotics and via the network of specific PFN ASIC flight control actuator circuits. (Either wireless and encrypted or wired and with encrypted commands from protected PFN robotics or remote command).

Clock distribution. Is coordinated in each PFN by LEO satellites or the GPS interfaced or other wireless communications with redundant systems and local clock updates to keep all moving and stationary objects placed in synchronized time and space for movement management on and near the earths surface. This will be tied into collision avoidance programming and be used by the FACT program TSA and homeland defense/DOD to control robotics flights and coordinate and control movement in the air and on the ground. This clocking will be the bases for programmers to write algorithms to account for signal trans mission times and conditions to obtain the optimum performance for near real-time control of any aircraft under remote control. It will also provide 1A PFN/TRAC unit benchmarks for preprogrammed and timed responses performed by robotics in conjunction with ground controls. It is to be system wide synchronized timing and is augmented by geographic position coordinates and updated by consistent redundant sources. This process is part of the FACT construct program running in the 1A PFN to determine if a flight is positioned on time in the exact place and the correct altitude at a particular second in space and time. It is the electronic equipment placement police for an aircraft in the sky with a connected system partner on the ground all the way. The ATM and AOC as well as the TSA are linked nation wide and would include the areas of free flight west of the Mississippi

Protocol Translation & CODEC

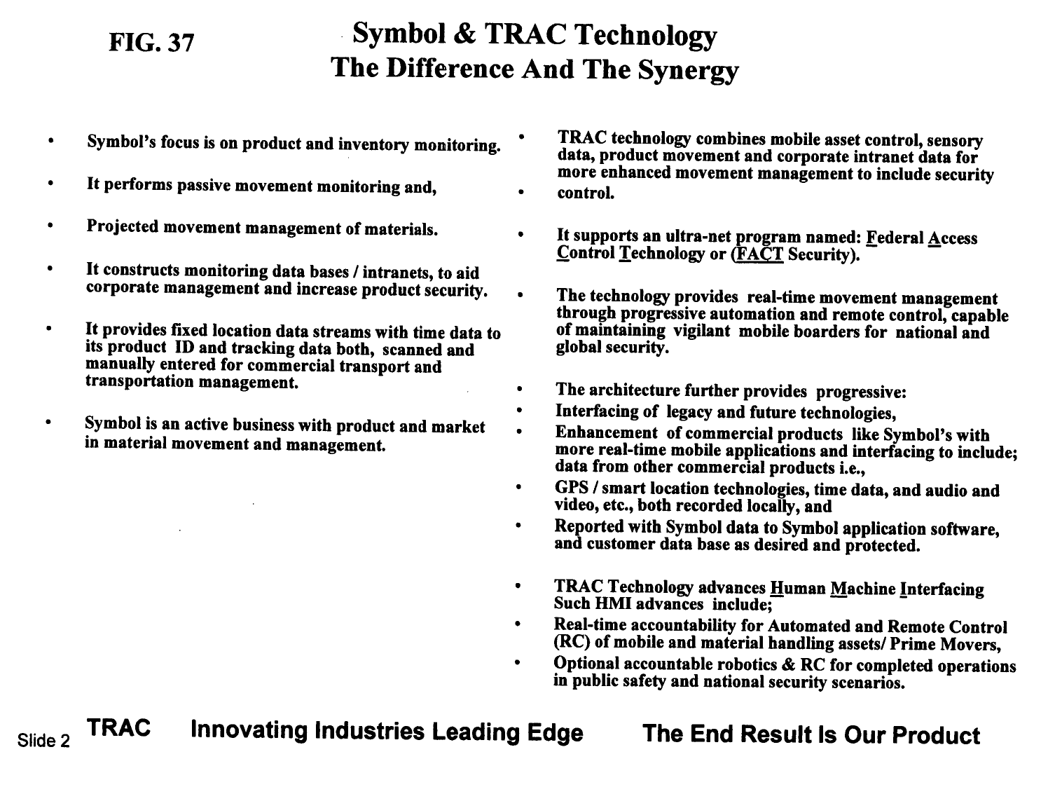

APU & APC APU Auxiliary Power Unit will be specially protected for the first generation of PFNs and also for PFN additional APUs or emergency power packs, which inherently reside in special protected compartments for the 1A PFN/TRAC unit and any FACT interface components to fly the aircraft (as detailed in earlier related patents). The APC the auto Pilot computer is listed in this block for the initial 1A PFNs to incorporate as much as possible the auto flight systems with secured power supplies and increase their protection to make them impregnable. Separate maintained power sources are inherent to PFN/TRAC system to insure the trusted remote activity controllers operation and essential for the activity components as well. These emergency power sources are of the highest quality lithium batteries and are maintained at full power by the aircraft generators and the airframe's electrical bus. The charging current is regulated and surge protected as well as one directional and can not be shorted externally to discharge or damage the emergency battery or negatively affect it's normal life (detailed in related filings). The standard self-contained PFN emergency battery self monitors and reports to the 1A PFN the battery condition. All PFN units and flight critical components are self-powered in an emergency. All actuator PFN circuits, control circuits like the 1A PFN ASIC or trusted remote activity controller and any of the connectable are protected physically, and employ secured data links, wired and wireless with redundancy, and have individual service current available locally to complete their specific tasks form authorized signals. Additionally, to integrate as part of the PFN/TRAC system performing FACT security programming, all other APUs on board must be configured to report their condition via regular integrity checks conducted by the 1A PFN unit. These regular system checks and PFN system data then downloads will to authorized service and maintenance centers for the APUs and PFN emergency power packs. All aircraft components essential to flight and PFN/TRAC/FACT operations will have these service integrity checks run on their performance, and these downloads will also go to manufactures. There is a FACT system auditor/inventory program locally run on the aircraft via the PFNs and a system wide redundant backup program done nationally/globally for everything that flies in commercial and general aviation via the FACT Registry discussed in FIGS. 37, 38, 39, 40. This portion of the FACT registry is operated by the FAA, TSA.

Preliminary FACT FAA Tracking Registry Program

Basically, the FACT registry tracks the use of electrically interfaced components and any equipment desired inventoried on the aircraft PFN file (e.g. tires type lot number) as a quality assurance program, and quick security and safety comparison check. A running program in each 1A PFN aircraft checks all known components to be on board with no alerts downloaded from FACT AOC/TSA registry during pilot ACARS, during any service of components and periodically. New item recognition is flagged data and routed to the specific center for analysis.

For example, a suspect piece of baggage is evaluated through the airport terminal FACT flow data base and appropriately responded to, while an aircraft circuit or new transmission is processed through the FACT FAA central registry and compared to known inventory and assigned RF equipment) In this respect It can be used to counter terrorism, antitheft and monitor the sale and resale or reuse of aircraft and components, much as the FACT registry is used for terrestrial PFN/TRAC units for automotive marine and rail vehicles and products. Additionally required are specially qualified service personnel and controlled progressive program with security clearance for all work perform, as authorized service will have to be in place for service on any PFN/TRAC units and their responsive components operating in any. FACT portion of the system. Ultimately, all PFNs will be operating in conjunction with the FACT system for national security in a transportation matrix.

The APU/APC are Separate Interfaces

APC is the Autopilot Computer and it must be protected with an uninterrupted power supply to be part of any PFN/TRAC/FACT system so it can carry out the preprogrammed FACT flights. Whatever augmentation is needed to complete this protective task to qualify the APC for PFN/TRAC technology must be made to perform to make it an accountable robust robotics flight and remote control component or a Trusted Remote Activity Control portion of any PFN/TRAC/FACT system. Progressive use of existing components and technology are encouraged for rapid development of secured robotics and remote controlled flight, but it has to be securable and protect able to qualify or it must be SUC to 1A PFNs on board. If employed the APC will be used to handle the 5 safe base fights initially and continually, but there will be self powered back up actuator controllers via dispersed PFNs operating in a harmonious matrix to provide ultimate control to the authorized authority, even if that authority is artificial intelligence (Al on board robotics in a 1A PFN) periodically.

Regardless, of 1A PFN overrides, the autopilot must be impregnable to unauthorized personnel during flight (standard to be determined and application specific).

Personnel identification is accomplished via the communication systems and data transfer systems interfaced with the 1A PFN controller. They would include smart card swipes, finger print and Iris scanning, voice recognition, thermal sensing, blood pressure readers and even EKGs via hand sensors and finger thaws on the yoke and instrument panel swipes as well as full biometrics transmitted via DSRC systems or 1P personal PFNS with body sensing harness belts, bracelets, watch type bands, or sensing clothing worn by the pilot and flight crew and interfaced. Individual biometrics can be used to identify a capable pilot in real-time via automated algorithms with pre-logged personal data in both the local monitoring program in the 1A aircraft and also in the AOC/TSA centers on the surface for real-time comparison and response.

This Robotics flight guardian program will maintain the approved flight plan via monitoring aircraft systems and progress with respect to authorized activity and conditions and continually check the pilots condition and flight crew if desired. This approval process can clear any legitimate pilot and provide proper access to the controls of the aircraft in emergencies by having all qualified personnel in the FACT registry. Local 1A PFNs will be updated with this list. However, an alert flag will be sent to FAA FACT/TSA/NORAD/AOC where final tracking and override is maintained. In absence of such an alternative the already flagged FACT flight will be programmed to the appropriate SB safe base via robotics and flight assist RC needed via the 1A PFN TRAC unit on board.

Most other portions of this ASIC are self explanatory to those skilled in the art of avionics, electrical engineering and computer processing. However, there will be sections in this specification and related filings that further define out functions performed by the specific components of this sample circuit. Additionally, there are similar circuit designs that further the reader's concept of this PFN Trusted Remote Activity Controller/Router unit and it's application as a primary Focal Node (PFN local connection point) to perform universal accountable interfacing with stable wireless connectivity and equipment control.

Obviously airframes, and terrestrial vehicles have different electronics and disparate properties that can hinder any effort to coordinate them. This is one main reason for the Primary Focal Node (PFN controller/router) being placed as a receiving PC processing platform in vehicles and machines where they have access to stable power sources; they then can perform wireless translation, and relaying or routing functions for the various forms of wireless communications, as well as, store pertinent data locally and remotely for commercial billing and accountability for commands delivered and resulting in remote control of the machines they are attached too. This creates a matrix of machine messaging and management that is coordinated and useable in real-time and can also be socially and commercially acceptable. Data is locally harvested/stored and or sent on via the appropriate wireless and IP applications with encryption to the appropriate systems terminals and application programming for decryption and use.

General Function Summary of the 1A PFN/TRAC/FACT ASIC Unit

It is important to remember that the essential controls and communications will be determined by the security agencies, the FCC and FAA and industry standards efforts. The remote control communications will be ded or dedicated digital channels for individual activity controls for flight surfaces. Probably on special military (possibly DES communication channels) that will be used form aircraft to aircraft and for close to (SB) landing applications. (Safe bases (SB). Otherwise robotics flight will be employed to maintain the highest level of real-time responsiveness for aircraft performance in relation to the real-time flying environment. This is proprietary to the FACT programming and this sequence of activities is part of what defines a FACT event. Unless a local assist aircraft is accompanying a troubled flight, the PFN/TRAC unit will fly with robotics when activated to one of the 5 preprogrammed FACT flight paths that are stored in the PFN software library (or memory storage) to the pre arranged Safe Bases (SB) determined by location of the aircraft via (GPS and or other smart location determining technologies on board) and or the nature of the emergency that has been flagged as a FACT event flight (for Federal Access and Control Intervention).

To insure absolute maximum redundancy in communication from the plane to the surface, blue tooth, or 802 wireless or any applicable DSRC interfaced will provide contact from any and all of their air travel carryon devices that interface with other long range communications so that any wireless device can be used by the 1A PFNTRAC processor(s) and the FACT system. PFN/TRAC must have the capacity to activate any such devices and call NENA/FACT numbers in route for first responders and for direct downloads to the FAA homeland security's hot operations center (e.g. Herdon Va. With TSA/AOC) or flight Command Controller air operation center(s) (NORAD, TSA, AOC AIR CINC) and download all data that is recovered on board by the 1a PFN/TRAC unit. More than one 1A PFN/TRAC unit can be interfaced in the aircraft and to an aircrafts various electrical bus systems with each having a separate FACT ESN or electronic address and communication protocol to coordinate any flexible master slave relation ship and to insure continual service via protected secure controls of the plane via the various non accessible and secluded units. All automated flight control systems will have a slave relation ship to the 1A PFN/TRAC process on board the aircraft. These systems will be subsystems or Systems Under Control or SUC. to the PFN/TRAC units and any network. Many automated controls (auto pilots, flight computers flight and voice recorders sub system controllers exist in a distributed architecture in present and legacy aircraft. These systems are reliable trusted and well engineered and there is no real need to eliminate or replace them. The first goal and basic modality of the invention is to progressively create the PFN/TRAC System with an organized accountable interface platform via a progressive architecture to increase security and pilot back up for human controls in commercial aircraft to improve public safety and national security. This can be accomplished in a number of ways with all the various aircraft.

The properties and Qualities of the 1A PFN unit

First generation PFN/TRAC units will link and control hardware and software to robotically fly the plane to designated safe zones and landing bases with special security and support services to handle most all imaginable emergencies aloft and on the surface.

There will be the capability to eliminate local flight controls.

There will be the capability to land the plane at designated safe bases via remote control flying.

There will be the ability for multiple communications with the aircraft and continual tracking. There will be the capability to dump the fuel remotely and robotically.

There will be a means to incapacitate passengers and crew.

There will be real-time audio and video to ground and escort aircraft.

There will be isolation capability for cabin air.

There will be the capability to treat the breathable air in the aircraft.

Because realistically the invention's development and deployment will be varied and progressive earlier generations retrofits and legacy aircraft will not have all the functions desirable. Those not obtainable through hardware and software integration and interfacing will be obtained through well-trained and security-cleared personnel until such systems are available or as standard operations for specific aircraft. For this reason FIG. 3 is going to change over time and for specific aircraft.

There will be a capability to terminate the flight if the need arises. This technology is designed to be timeless, because it will evolve and become more consolidated integrated and protected. The ASIC translator and processor will be interfaced with IC hybrid substrate chipsets for the varied communication protocols. The chosen systems as standards will inevitably be converted to system on a chip or SOC technology and housed in cans or specialized containments that have electronic security packaging and tamper detection. Most importantly present manufacturers have direction to move forward in cross-environmental applications via the PFN/TRAC system and better coordinate their product's use with others. Additionally, their markets are expanded and their negative cross-environmental impact can be managed. Allowing them to freely produce their special products to an organized structure in place that is compatible to their industry, business, and government regulatory concerns, which will also improve public safety and national security.

The Aggressive response question for the public and government-this is always done for the Trusted Remote Activity controller/router to be trusted and accepted technology standard. It is a basic and unique element of the PFN/TRAC technology. In all the patent applications the invention address the social and constitutional issues and impacts it will makes as an advanced Human Machine Interface Technology. The following is a major issue for the People of United States to understand and accept as well as any peoples globally that will use the invention in the following manner.

Issue

In a hostile take over of an aircraft a disabling aerosols could be released into the ventilation system of an aircraft if this is determined advantage. The 1 A PFN controller could be programmed to control a responsive solenoid valve (wired or wireless on compressed gas containers and release this gas to sedate all occupants; if robotics flight and remote controlled landing proved the most ideal scenario for a portion or all of the public's safety. The data recovered and the course of action taken along with the geographic location and condition of the aircraft and occupants could be the determining factors in writing the software for the robotics flights and or remote controlled landings as well as the human responses, and procedures taken both aloft or on the surface. Personal 1P PFNs could monitor the known medically compromised passengers and regular crew for any near fatal results for this aggressive remote control action as well as, cabin and cockpit video systems Adjustments could be made robotically or remotely by medical staff in the TSA centers or on the surface. As outlandish as it sounds even to this inventor these might be necessary options to insure the greater public safety and national security against terrorist events like the 9.11.01 terrorist act.

In keeping with the nature and scope of the invention, the employment of this function and similar ones involving the PFN/TRAC system and these FACT security system possibilities need to be known and the publics voice heard. And, not just government agencies and the public and legislative branches of government, but all the public. These are decisions that can have dire consequences and first deliberated on by the public and then developed into acceptable standards, standard actions, regulations, procedures and or protocols with respect to this aspect of the invention or any other public issue of the invention. Programming must reflect how a democratic society has decided to employ the invention for public good, safety and national security.

The inventor suggests objective reviewers like the Kettering Institute and their National Issues forum and Civil Liberties to objectively frames the issues and quarry the public and report to the public wishes to government. The hardest of issues might well be served with a public polling during stand elections. With the public pulse on these issues incorporated before standard groups meet and or legislative committees take up planning and make regulations, laws, procedures and protocols; the software code writers and programmers can construct these sensitive programs of the invention in an acceptable and trusted manner. One that has the trust of the public and can serve as invented.

Industrial Applicability, Commercial Progress and Component Review

1A PFN series) Aircraft Controllers is the first of a number of related aviation PFN/TRAC products with FACT Security that make up this management and security invention for air travel and transport.

Commercial efforts are underway seeking government support and assistance to include funding, aircraft, and technical transfers in an effort to partner up with major aircraft, manufacturers and avionics companies to develop the 1A PFN/TRAC unit a protected equipment control technology. Informal discussion with Boeing's ATM people pointed to a long process to physically interface the 1 A ASIC with commercial aircraft. This aggressive of a control system on board an aircraft has its proponent and opponents. But Boeing and others did not dismiss the possibility, nor the need for more technical options to poor human flight control when it is taking place. Most would rather stay focused on pilot assist systems for as long as this has the least reactionary approach.

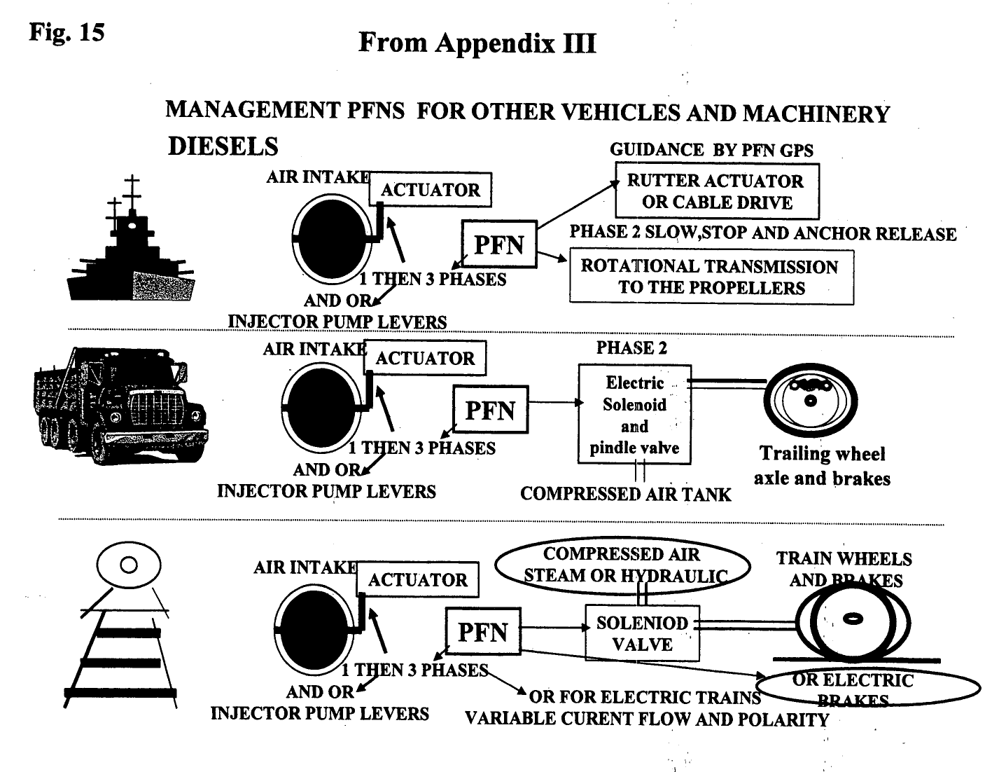

More initial interest has been shown for the fist progressive stage the of the PFN/TRAC technology. The “1a TRACker” which is a carryon brief case air marshal connection to ground security and TSA is not interfaced directly to the aircraft's electrical system. It begins by recording and reporting via an isolated wireless communication system. This la TRACker laptop design and the 1b “Tracker) which has the same circuit design as 1A PFN/TRAC units in FIG. 3 is also listed and defined later in this application as FIG. 15 and considered a progressive step for the PFN/TRAC System and FACT security system into the Aviation Industry. The 1a carryon TRACker evolutions discussed later will be the first product to market. The TRACker ASIC (FIG. 15 Appendix VII) is similar to this proposed integrated 1A aircraft TRAC circuit. The 1a carryon TRACker brief case series will be responsible for final and specific 1A PFN ASIC in FIG. 3 for the robotics flight and the remote control interface configurations via appropriate testing in real-life passive use. This is to be as a tool to design PFN/TRAC interface avionics for retrofitting and legacy aircraft and new design as well. It is a perfect example of the progressive aspects of the invention to uniquely employ existing technology and refine any design for future PFN/TRAC unit's ASICS and related accessories.

Regardless of this associated first commercialization the 1A PFN/TRAC aircraft unit will be prototyped at the earliest opportunity as the market is so diverse in airframes no work rendered in this area will go unused or be fruitless. So in summary the invention in every aspect has industrial applicability.

The (FACT) security program of in the PFN/TRAC System of controllers remotely controls specifically to counter the unauthorized or unsafe use of all equipment. Boeing and others, TRW have shown strong interest and a willingness to help the inventor and the companies commercializing this invention to include “TRAC Aviation Inc.” get into the right programs and with the correct manufacturers to develop the terrestrial sections of the invention as well for the nations air transport system and airports. They also have strong interest and are willing to help develop the portable PFN tracking and telemetry network provided by the relay function of the PFN for short-range communications to longer-range communication links to maintain a mobile inventory for materials and baggage in transit. Other applications will be discussed latter.

The next FIG. 13 is of the same basic ASIC but it is set up for ground equipment (mobile and stationary). For FACT security or a national security TSA program to have seamless security from the skies through the terminal and onto America streets the ground system has to talk to all individuals and equipment or the prime movers of people and materials.

FIG. 13

This diagram has been used in all the PFN/TRAC filings to show the basic circuit design. It shows the standard wireless interfaces for all the surface applications to include 1SV PFN for surface vehicles, the progressive direction of the DRCPFN interface program with present vehicle Telematics, the I E equipment for stationary machines and 1Ps PFN 1P for the personal PFN processors. Even a I Ps standalone unit could be as sophisticated and support as many multiple wireless technologies and route between them as desired. They could range from very simple tracking operations and ID telemetry to extremely sophisticated robotics processing and communication routing. However in this application these ASICs are the supporting substations and repeaters for the 1Ps Tainer talker.

It system can include whatever wireless is privately chosen or agreed upon as a standard.

The ASIC in FIG. 13 may appear the same in wireless interface but differs by machine application and control function. Additionally it is different in how it derives power as well. With BE PFN/TRAC being energized by AC house or building current which is transformed to computer control voltages and service current to drive silicon relays, motor starts and high low voltage solenoids or as interfaced with a host machines E/E system to perform remote and automated activities controls on that host piece of equipment. These 1 E PFN controller routers are used on stationary equipment applications in and around the airport pot, station to interface and control conveyor belts, cranes, escalators, elevators, scales, scanners, metal detectors, baggage handling systems, automated ramps, pumps, grain, spice, powders or dry good vacumn systems, lighting systems, video units, digital and analog and also receive weaker signals or other PFN signals and repeat them as per programming either TRAC programming or FACT high security. These PFN/TRAC applications are will documented in the 10 prior PFN related patent filings. The circuits and the specific control function on the equipment are detailed more extensively in these earlier filings.

The figure has a darker shaded squares and cubes and a lighter shaded larger area from the center to the left generally. This in actuality is because the darker areas are actually deep red in color and the lighter shade is a powder blue. This is to emulate a secure communications characteristic much like that used for military high security encryption or DES meaning Data Encrypted Standard. DES circuits ar what they call orange and blue or red and blue. The red is generally an isolated circuit (hardware and with encrypted software) and the blue is of less secure data and may have PGP pretty good protection or none at all. The actual security sophistication must be determined however this teaching and the eleven related filings lays out the options and the innovative embodiments to implement any choice. The discussion will be towards the most sophisticated and the progression to get there to implement FACT communication links for rapid sensing and to deliver rapid accountable commands back to the Prime mover PFNs. Not to much time is spent on what automated response are possible as these have been well documented in other related filings. As explained earlier this circuit may be completely created or just in part for an application specific purpose to complete the portable sensing web or network. It could be on any kind of prime mover or piece of stationary equipment. A prime mover is a vehicle,boat, plane person, animal object or stationary piece of equipment, that is self powered to provide a stable energy source for the protected PFN/TRAC/router unit to operate as a relay substation as well as a primary focal node to control a machine's electrical and electronic systems. Any combination of wireless technologies may be employed in any number of configurations of PFN/TRAC units with Translation programming between the wireless protocols. Obviously as the PFN/TRAC system and unit architecture becomes more accepted as a interface platform to improve movement management and security the machine messaging will be more refined and defined into standards. The purpose of the architecture is to create the mechanism to evaluate and progressively achieve this universal messaging from cross application and cross environmental wireless products in an effort to coordinate safe and secure movement of machines and people on or near the earth's surface. Because this basic ASIC design is the guide to fuse and merge these technologies it will be referred to in the various application and configurations to describe the interactive role the architecture is to perform. The absence or lack to mention any application is in no way to limit the reader from understanding the total and complete inclusiveness of the sensing, 165 Richard C Walker monitoring messaging, and machine management and control of the PFN/TRAC System as all with in the nature and scope of the invention.

With That Stated

E.g. ISV PFN will have all the same wireless for in and around the airport as the 1 P personal PFN PDA or 1P PFN Belts or 1E Metal detector PFN. The wireless interfaces could be the same as for the port or harbor. Especially if both like Kennedy air port and the harbor are run by the same management authority like the New York port authority. At least for the security and police wireless. The great part of the PFN/TRAC unit is they do not have to be and in the beginning will not. Additionally the multi-pin connector or interface to connect up to the automobile CAN bus system and or drive direct connections to actuators and service power control circuits for activity controls on a vehicle will not be the same as the E/E system and current requirements for solenoids on a electromagnetic winch. These will be the modular connecting components that will change post the multipin docking of basic processing and hybrid chip set connections with firmware protocols for system recognition and interfacing between the various wireless Also, power requirements different source, type, and transformation are to energize the processor and recharge the emergency power, which is inherent in all PFN/TRAC units to provide the stable relaying platform that makes the portable routing network possible for FACT. For vehicles alone, the power to be transformed ranges in DC current from 12 volts DC to 48 DC volts DC as a general rule to operate the PFN/TRAC processor at electronics at computer voltage levels.

The circuit concept is the same for the 1P and 1PS but the level of complexity varies immensely and is explained throughout the filing.

The six squares to the left in the ASIC (darker or in RED) represent the interface protocols from the various wireless communication technologies that could be connected in a plug in hybrid substrate chip set and can be changed to meet the application specific need of any specific primary focal node or PFN application. This drawing is exemplary and as just stated should not limit the reviewer or reader's perception to the amount or types of interfacing possible.

This ASIC shows a CAN Bus interfacing if used for automotive to include J1850, 1939 ISO and any of the other new LAN Vehicle Bus systems. Local clock time is updated by the GPS-Satellite or communication technologies. Tamper detection is an earlier FACT integrity check procedure detailed as a security process protocol in earlier related filings. Most all is self explanatory in the circuit design. It is understood that systems will be consolidated via SOC technology and this event is within the nature and scope of the invention

Many types of encryption are available today (PGP, DES, the wireless payment industry has more as well. FACT is to be a security program format that code will have to be written too and the types of codecs and encryption standards for high security and commercial and private security communications as well as public statistical information protocols have to de determined legally first as well as the frequencies. They will also have to be approved by FAA and FCC and law enforcement agencies. As stated, the technology is to be constructed as a multitude of modular configurations to support the necessary options for interoperability of normally disparate wireless communications and refine and define the best combinations of these technologies for specific applications to achieve efficient movement management that is safe and secure. A Most important characteristic of the technology is the capacity of the technology to interface with present, legacy and future systems and to consolidate combine and linked circuits and systems into SOC technology or systems on a Chip for future applications miniaturized. When this proves beneficial and a worthy as an advancement. The real life COTS to SOC testing and immediate accountable use is another important implementation characteristic in the inventions design

Continuation of Exemplary Interfacing in FIG. 4

RFID radio frequency ID program (EZ pass) and Blue tooth a short range RF technology for wireless telephones to interface with and some automotive telematics are shown and they would have either appropriate antenna configuration and reader components with the appropriate chipsets. All these technologies wish to advance there application and there for offer experimenter kit or prototyper kits for those skilled in the art make use the appropriate hard ware is available to write translation algorithms between the messaging protocols (Some already exist and wireless Packet data and 1P data packaging is a well known computer engineering skill) These existing technologies are provided a universal interface platform via the PFN ASIC. Added to the programming and implement via appropriate interfacing chip sets is a traceable routing message headed and command IS string to track, identify the routing for accounting (wireless billing and accountability for the sensing material and equipment condition and movement and people. (e.g. aircraft and luggage in the compartments or containers on rail cars, ships and trucks.

FIG. 13 shows a I/O input Output block darker shaded if colored, this is to be a 20 multipin docking station (exemplary

Total Page and Reflex Write up name Developer kits the possibility of container talker but mo

Blocks Short Range Communication Functions

Each PFN/TRAC unit on any machine, vehicle/aircraft and or equipment will be master and control all other carryon wireless by design, via programming and DSRC of some sort, e.g. 802.11 or Blue tooth,

The exception is the carryon 1P PFN Belts or PDAs operated by authorized operators, drivers, pilots, sea captains, police sky marshal, customs boarder patrol etc. These authorized Personal 1 P PFNs can control local wireless and communicate with all the equipment PFNs with special real-time authorization procedures otherwise the control defaults to local robotics and TSA/FACT Intranet control/Homeland security Command and control under specific protocols

The PFN or series of PFNS on board a piece of equipment vehicle/aircraft, vessel would work in harmony to identify the carryon device's via (ESN recognition and look for alerts) as well as manage their use or restrict any such use to include cellular phones and other so equipped carryon wireless as determined best for flight safety. As part of this invention's nature and scope these SUC technologies and system's engineers would write code into their software programming to immediately transfer all PFN/FACT directives via access through any cellular service that the cellular phone service was part of for emergency action messages or EAM message delivery into the surface IP/TSA FACT gateways as illustrated in figure five with further FACT routing shown in 6 and seven. E.g. in an aircraft this could give a continual down feed of identifiable data packets and information for a troubled flight to surface receivers/event memory receptacles or satellite connected to data receivers and data repositories for further data resources in real-time and for later analysis via the TSAFACT intranet mass data handling and registry storage system. Special arrangements with the wireless providers to support secure gateways into this 1P security matrix with TSA/FACT and other security agency software will have to be arranged to construct the FACT system as shown in FIGS. 20 and especially 21

FIG. 14

This diagram shows two basic variations to terrestrial PFNs. The 1SV PFN/TRAC controller/router shown here for the air travel industry and the DRC PFN/TRAC unit for the automotive industry development. The 1SV PFN and DRC unit in the illustration is universally discussed for future versions of both and to better explain the progression and entire set of innovations applied in this figure. As sections are discussed the progressive development to this protected robust robotics and remote controller/router for all land vehicles will unfold. For regular automotive applications the PFN has been termed the DRC meaning Driver Resource Center. DRC PFNs in cars and trucks have a little different commercial progression than the industrial ISV PFNs (like for an airport intranet or local matrix). They also may have different wireless technologies interfaced. The first discussion will be about the regular automotive DRC PFNs first generation DRC 1. And specifically how the regular car is going to be first interfaced into the federal access and control technology TSA FACT command center at the airport.

Before the 911 incident telematics in vehicles was beginning to be developed through programs like GMs Onstar, Chrysler Daimler's TeleAid and Ford's “Wingcast” program with sprint wireless for private cars. Additionally, for a number of years GPS truck tracking has been developing as private intranets interfacing cellular telephony and GPS in some cased and other wireless location reporting technologies like Lojack. And some of these networks (Intranets) are run by major freight companies and delivery companies like Highway Masters, UPS, FEDEX, etc. The first generation DRC PFN would interface these existing systems (PFN their wireless units) and interface their wireless protocols to immediately provide the net work fabric and platform for the TSA FACT command centers; at the airports, terminals, ports, along boarders, toll booths weigh stations and inspection stations. This would be a direct access connection through these vehicles wireless technologies when these vehicles were in a certain range of let say an airport facility. Additionally there would be certain FACT software that would be downloaded to these units. (Pre-programmed or real-time updates) In time hardware sensing in these vehicles would be increased (EDS, etc) and the diverse types of equipment and dispersed system architecture would evolve into a more universal protected DRC. A primary focal node with a TRAC processor to support all the interfacing necessary with flexibility to be commercially viable and applicable at all times. During this progressive process the vehicle controls will become more automated with collision avoidance and driver assist systems and require accountable machine messaging and remote commands to be acceptable to society. All the PFN/TRAC system companies will push to set standards in vehicle controls and advance HMI to reduce driver workload with the DRC or protected PFN/TRAC local architecture.

The 1SV PFN for industry will interface legacy vehicle electronics in much of the material handling, mobile baggage transport for the airport facility equipment and be the most sophisticated electronics on these vehicles. The other major difference is the types of wireless technologies interfaced. However, early on in the development of the DRC PFN and the 1P PFN they will have plug and play multi-pin docking to accept different wireless by installing chipset with the appropriate protocols in an accommodating transceiver board (universal with an automated scan function). The ASIC in all the application figures sustains the architecture desired for routing SEAM, TEAM and EAM messaging in all local PFNTRAC routers.

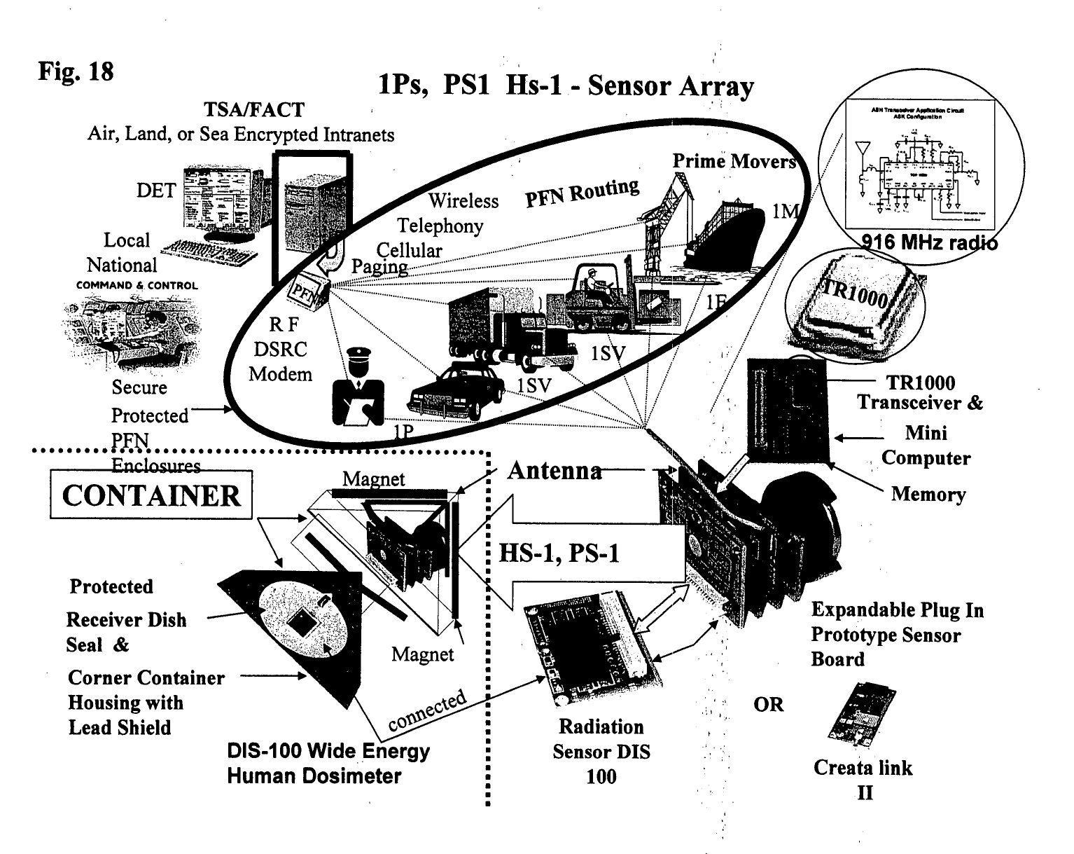

The progressive integration of all the automotive telematics intranets begin with an IP systems connection to the larger Rail and highway TRAC/FACT/TSA registry which intern delivers data to the highest security command layer(center(s) in FIG. 18. DOD and DOT will be the lead agencies in development and implementation of this critical national infrastructure. And they need to be funded well and staffed with some real doers. DOD/DARPA and the national security and law enforcement agencies will be responsible for developing the hardware standards and software procedures and protocols and the writing of the operating FACT program to identify agency/user access and for the FACT registries.

DOT will be responsible for structuring the transportation FACT registries via all their departments and sub agencies like National Highway Traffic and Safety Administration NHTSA and the FMC Federal Motor Carriers just to mention a few. It is important to mention that DOT monitors transportation and writes regulations specific to vehicle platforms. This is how the agencies and divisions are structured. These vehicle frames have different electrical/electronics E/E system and bus architecture. They require different monitoring and reporting as well as law and regulation enforcement, so the different intranets that track theirs assets geographically already will have their sensing and telemetry increased for TSA and homeland security immediately. These intranets would also have IP connections to the specific agencies monitoring portions of their commercial activities e.g. EPA/Colorado watching for Blue smoke from diesel trucks could receive data from the DRC PFN via interfaced vehicle sensors in the exhaust stack and this data would then intern be routed to ICC the state police/EPA/hazmat officials locally where the truck was operating. This and passive reporting through the registries will be ongoing and near real-time unless a FACT event flag occurs. Then the system can respond another way in emergencies—via direct dial in or dial out with FACT/TSA command centers. PFN/DRC units responsiveness is different during a FACT event where explosives are sensed on a vehicle on an interstate that is not suppose to be carrying them.

FACT implementation and commercial development will request the wireless intranets to be discussed to station one of their control hubs at each of the 429 airports across the nation and link them to TSA/FACT command center servers. Or arrange for their technology to be interfaced and integrated into the FACT/wireless gateway router at airports. PFN/TRAC TSA FACT wireless router (WR) is illustrated in the bottom left corner of drawing 22. TSA/FACT with the (WR) is to be a giant protected Primary Foal Node mass data handling, routing and storage center for critical FACT data at the airport. A physically protected facility (Capacity and protocols interfaced to be determined) This air terminal TSA FACT hub/router transceiver unit (WR) would be vaulted and protected with a versatile docking structure to interface the above intranets wireless and the above telematics wireless protocols. As a base or center to link these present systems directly to FACT security at the terminal to provide immediate local responsiveness via the local PFN units.

The top third of the page is the TSA/FACT airport terminal command center communicating with all mobile objects via the various PFN/TRAC wireless interface router functions. All the PFNs on all the above transportation platforms are receiving GPS data from the above array of geo-synchronized orbit satellites illustrated by the satellite in the upper right corner. Additionally each PFN/TRAC circuit clock is updated and synchronized via software (firmware) in the TRAC ASIC directing the use of this data received form the GPS/NEMA data packets (or another stable wireless time providing technology) to locally plot movement harmony for any portion of the mobile matrix of 1SV and DRC PFNs.

No. 1 the car in the right is communicating with the little car to the left via DSRC and specific vehicle identifiers (ESN PFN DRC, etc). However, all the vehicles and people having PFNs are passing through a sea of communications all the time. It is the recognition and use capacity to retrieve this critical information and precipitate it's use into appropriate movement that is unique and creates the PFN/TRAC traffic management system and base construct program for a TSA FACT robust security matrix.

In the figure the two cars, the bus left of the terminal and the women riding the bicycle are all part of an instantaneous interactive portable network that performs a mixture of robotics and remote control (RC). Positioning software is running in each PFN unit monitoring and demarking certain distances from other objects relative to all objects velocity (speed and direction or signals from a stationary object via—a fixed 1E PFN beacon or beacon signal program running in an unattended parked vehicles DRC PFN or 1SV PFN).

All of the above vehicles are in communication with each other and the TSA FACT local command center at the airport. This allows the left car's DRC to be aware of the cyclist No. 3 and the driver is warned of the bikers location (via 1P PFN or RFID tag etc). Secondly the car would not be able to turn towards the curb to park as a result of this remote telemetry and robotics. If any of the drivers were not paying attention and there was going to collision their car would automatically adjust in micro seconds and warn the driver by audio message or stop the car if the algorithm in the movement program was satisfied via rear sensors (radar) there was no vehicle detected closing distance from the rear. The satisfied safe condition algorithm is that at all times no two known objects can be projected by velocity to occupy the same geo-space and time coordinates. If this state is factored—parameters in the software are to warn the operator and eliminate the condition without colliding with any other known asset identified in the local environment.

Additionally, as an advanced HMI assist system, an operational evaluation program is always running in the DRC to sense over steering, slow braking, slow acceleration slow relexes, etc. and archive a personal driving history of the identified authorized driver's necessary skill to operate the vehicle proficiently. Using this assessment program the DRC automated collision avoidance programming is to override operator control and effect the collision avoidance option. There are more and more collision avoidance technologies being developed and these are to be systems under control SUC to the DRC PFN. Additionally driver performance can be transferred by smart cards or data transfer devices so that each PFN recognizes upon energizing a host vehicle for authorized use (like a personal key). The new vehicle would be given performance parameters for the known driver and the driver assist programs would be there to assist all the way up to full robotics driving in real time for those situations that required it. Providing more freedom for the physical and mentally challenged.

Initially, PFN/TRAC programming for this function can be initiated from the GPS commercial off the shelf products, that can follow a vehicles movement now and provide vocal instructions to a driver for the next change in direction. Or the software algorithm can be written from any number of intelligent positioning technologies and their software programs. These technologies have developer kits and PC software kits to write code from to develop assist verbal warning and base RPV programming and algorithms as desired for these applications. The goal is total vehicle robotics via first incorporating driver assist systems and not to stop human driving but to continue freedom of safe movement for more people—people age—However, “we all know we are perfect driversJ”. The level of driver assist and robotics will be real-time variable—just for those times we just might not be perfect. Another reason is cellular phones and driver distraction. Other existing commercial off the shelf technologies need a safe cross environmental interface to manage their use and the vehicle while in transit-the DRC PFN is a total management system for this purpose and the progression to full vehicle robotics through assist driving technologies will increase public safety and national security via insuring authorized healthy and real-time capable operators and operation of vehicles equipment, machines and aircraft

Other collision avoidance data on the newer cars (e.g. proximity detectors, forward radar, and infrared night vision would have their data streams processed to interface into the movement management software, which will be the base program for automated guidance of a vehicle via direct connection to crucial actuators or via vehicle bus system interfacing as detailed in the center section of this figure and throughout all the PFN/TRAC System filings since 1996.

If the PFN or DRC has a specific preprogrammed travel plan the portable network will better be able to plot and direct movement both at the local PFN level and systemically from this exemplary TSA/FACT Command center at the nation's 429 airports. DSRC frequencies have been granted to the DOT by the FCC—(5.7 GHZ ). Presently, standards efforts for the use of this broad band frequency or other suitable bandwidth (FCC approved and dedicated) have to get underway immediately with FAA/AOC/TSA and the automotive electronic and avionics wireless device manufacturers for cross environmental application standards, procedures and protocols. Their focus is to develop an agreed upon messaging and directives protocol for optimum movement on and near the earth's surface. A three dimensional road map and operator manual/operations program for terrestrial vehicle platforms on the roads and in and out of air ports (inter modal communications and recognition protocols to be tied into aircraft traversing the tarmac with service vehicles—both vehicle 1SV PFN possibly DRC local police cruiser and aircraft TRACker unit need to have the proper wireless chipsets to be cross tied into their collision avoidance systems and TSA FACT's seamless security for contact or near contact with any aircraft).

Automated movement algorithms must process the movement data universally, but specific to individual vehicle, time, place and surroundings in PFN/RPV programming to remote piloted vehicles with robotics. (RPV is the major embodiment of the local TRAC processor, preprogrammed robotics for reliability and responsiveness is another portion so software has to be written for this condition as well. Robotics algorithms will determine the safest commands to respond, to, to include; local human, RC commands or auto-determined movement alternatives. (procedures and protocols to be determined for these preprogram situations)

The satellite above also symbolizes that low earth orbit or LEO satellites used in the PFN/TRAC system for wireless communications and include Air Traffic Management ATM and wireless telephony as other possible near earth communications interfaced in local PFNs and to link the intranets.

The vehicle platforms and airframe above the airport's TSA FACT command center are mostly all 1SV PFN specific to the airport intranet with all the appropriate wireless interfaced through the PFN for TEAM messaging. Many of these units could be capable of SEAM messaging (to be determined).

Used as an example of cross environmental telemetry, the airport police cruiser in the upper left is a good example of a vehicle applications that could and should carry a full complement of wireless protocols to both function outside the airport in any TSA/FACT Interactive Highway application of the PFN/TRAC system and also with the

TSA/FACT/FAA/AOC Intranet as part of seamless security. This has a dual function as well as a dual purpose. First seamless reporting is accomplished to follow a FACT event and second to have accountable remote management and control capability with intranet demarcation and cross environmental integration. Example of purpose, a local police pursuit that has entered the airport facility should have immediate FACT programming responsiveness in each PFN with command center integration so a real time authorized officer recognized via his 1P PFN-ESN, etc. confirming his or her personal ID then can use his/her command interfaced pad or voice to activate automated gates, baggage handling equipment and vehicles and or stop their unauthorized use providing seamless security. (Procedures and protocols to be determined) This accountable machine messaging network creates a security matrix of redundant human and automated monitoring with real-time accountable remote control to manage safe secure and efficient movement at airports and can build public confidence in air travel.

Initial Commercial Cooperation Needed

FACT control will have a real-time placement on calibrated mapping displays of all moving assets on the airport campus (monitoring procedures and response protocols to be determined). This will be a unique security advantage and main reason for requesting commercial cooperation in constructing a multiple access local wireless routing hub of all known wireless protocols at each airport. And for combining it with the PFN/TRAC automated frequency counting scan program to identify unwanted and unauthorized transmissions in the airport vicinity. This is how TSA can be really responsive via a FACT sensory and command control center at each of the 429 national commercial airport terminals. A security system that is based on good efficient management of vehicle movement. One, that can identify exact location time and space and directly issue remote commands for reliable accountable interdiction by using interfaced automated equipment, that is locally coordinated with human security at the air port.

In the center of the drawing a sample of the Systems Under Control SUC in the vehicle are illustrated to perform wireless routing, Robotics RC and RPV for the vehicle. As stated earlier this can be accomplished via direct connection to the DRC or via interfacing with the CAN Bus. These various modalities are well documented in earlier filings and therefore basically listed in this figure. To instruct those in the arts what accessories must be connected or constructed to effect RC and robotics activity as a result of the programming functions detailed for each application and to include the progressive teachings to complete the integration for the local PFN and the PFN/TRAC system.

In the figure left and center on the E/E CAN Bus are the vehicle displays and alerts. They would be PFN constructed or if OEM in place, they would be used to deliver messages, TEAM, SEAM and or emergency action messages for the general public—public service messages termed EAM messages).

Data provided to the instrument panel critical to vehicle operations would also be basic I/O interfaced via the vehicle CPU or retrieved from the bus redundantly. Driver controls would be PFN automated and or interfaced with newer drive by wire technologies or connected by traditional can bus interfacing. Ultimately every E/E connection critical to vehicle operation and or designated or regulated by government as a TSA FACT Security concern must be priority routed and protected consistent with PFN/TRAC System technology. If these specifications are deemed necessary an result in any standards or regulation or are improved on by any government agency or standards effort they are still considered to be within the nature, scope and purpose of the invention if to provide reliable accountable remote control and FACT security for TSA and the Department of Homeland Security.

Public Safety in Driving

Items 4 and 5 in the center show wireless carryon devices into a car. These devices are a great asset to the traveler but they also cause driver distraction. In earlier filings the interfacing of these carryon units is well discussed technically and also for their cross environmental impact and causing driver distraction. For this reason they have been interfaced through the DRC PFN to have there use and vehicle operation optimized while maintaining the safest vehicle movement. The DRC can be a real-time assistant or auto/Co-pilot to the operator, either distracted, over taxed, tired, ill, intoxicated, or bored with driving and desiring to do something else while traveling. The actuators would be attached to the activity controls listed left of number 6. Number 7 is the DRC PFN and contains the plug and play wireless interfaces to sere as a router in a specific intranet as well as retrieve dedicated short range communications.

A specific universal DSRC frequency and protocol should be determined for a universal chipset connectivity through all PFNs and across all wireless devices to create the portable flexible integration network of messaging described. It must be broad band and all PFNs have to receive it. It must be standardized or each PFN must carry all the various DSRC transceiver/protocols with specific device identifiers (ESN) and special routing instructions for the receiving PFN.

To the center right shows all the vehicle sensing audio and video to include any infrared, laser, heat imaging data, distance sensors, sound, locating systems, Lojack, GPS, Lorenz etc. lane highway detector, DSRC beacons edge sensors optical lane sensors that are; light, reflective, magnetic, optical to video signal recovery with software algorithm to follow, lines, oil dis-colorization or vehicle discharge during regular use on the highway. The communications are 5.7, DOT DSRC, or they could be any DSRC determined necessary and having a large enough data pipe.

The earlier mentioned FACT ball or 1Ps stand alone data orbs that supply critical highway environmental data and conditions either preprogrammed or real-time sensed to the PFN DRC, and or COTS RFID technology used in a reverse application-Specifically the TAGS passive and active would be imbedded into the road and placed along the road system as data suppositories and deliver critical data instructions from firmware on the driving environment to the receiver antenna portion or reader of the RFID technology connected to the vehicles DRC PFN.

This application of RFID technology or other such applications or technologies used and interfaced to create a portable sensing network and a data atmosphere for RC and robot Other DSRC are Blue Tooth and 802.11 DSRC to deliver data, etc).

This sea of detectable data is delivered to all the PRIMARY FOCAL NODES PFNs for processing by TRAC, the TRUSTED REMOTE ACTIVITY CONTROLLER/communication router. A PFN or PFN DRC is a machine brain—A. I. artificial intelligence for mindful machinery to perform trusted RC and robotics.

As these protected and secure PFNS pass through an atmosphere or ether of environmental information they can sense and process the environment, and equipment movement much like a person does when walking or driving. In time these mindful machines linked locally in a machine messaging matrix (PFN/TRAC System) will operate vehicles more accurately and move people and materials more safely with better coordination.

OBD Sensors I, II, III, J1850, J1939, ISO all the automotive CAN bus networks to include the latest DSRC ether nets, single wire digital transmissions, fiber optics vehicle or equipment E/E systems are all to be systems interfaced and under control by the local PFN or DRC PFN. This is necessary to perform TRUSTED RC,RPV and robotics, socially, commercially and governmentally with large scale integration and accountability.

Through out the PFN filings all type of ID technologies can be interfaced with the TRAC processors, iris scans, face scans (video), finger scan, voice recognition ID programs, Smart card or chip technologies, biometrics from 1P personal PFNs via DSRC, or the earlier RFID tags worn or implanted as with the PFN SOC ID and biometrics implants, or non invasive DNA acquisition transducers processing sample cells recovered and converted into a digital signal or (DAC or ADC as necessary in the sensor or the PFN), and the identification technology list could go on and on with new ID technologies developed and interfaced with the PFN/TRAC units and system for the FACT Security.

Number 9 card swipes in cars and on 1SV PFNs or DRCs. Obviously as stated earlier this can be used to recover identity information. But it is also part of creating a new economic tool for the nation and world to develop management and controls over the dispersed and hard to track energy use by equipment using alternative power sources. The PFN provides a stable data recovery mechanism for appropriate taxing for the impact of this equipment on the environment and societies infrastructures to include smooth interfacing with our oil based economy now. It also allows for flexible transition between the different energy sources to maintain a stable economy and hopefully to help some with world politics (a human responsibility we all share) by providing a good socioeconomic mechanism for stable cross investment with all the energy sources.

With this in mind the PFNS will run electronic payment industry software protocols and be physically protected and electronically secure to be better trusted for these activities. The PFN can also have the capacity to read credit cards/smart cards as stated in the figure.

At the airport rental cars and real time purchase of accessories and services for those vehicles are made easy to effect via the PFN (cellular phone service wireless IP connection for laptop computers, sending video back to home computers, receiving real time directions, best routes, activate robotics driving, etc). Card swipes in cabs receiving fairs rather than cash are a safer economic tool than the dollar bill. It makes the accounting and management of assets and use of those assets respect to revenue returns easier to track for the cab companies (or for all fleets). Also cabs, limos, airport shuttles, light rail subways, buses, delivery companies and any services entering the airport facility have to have all their wireless intranets supported locally to the FAA/FACT command center Transceiver router. TSA FACT command control is immediately contacted by all arriving and departing vehicles with wireless as well as, all wireless devices carried by persons via DSRC to stationary perimeter PFNS (either stand alone or with solar or other power sources to include any of the application specific PFNS

At the bottom left is the airport TSA/FACT airport command center and directly above it the wireless router WR that has the correct antennae tower and satellite reception capacity to feed the TSA FACT router with all known wireless protocols interfaced. This tower receives data from every know wireless transmitting and the router processes data to the address recognized in the data packets via special routing protocols (COTS) or by signal recognition or identifier modulated in an analog propagation. The router is a serviceable link or wireless gateway to land, lines and fiber optics to also provide rapid message delivery to all the deired FACT/TSA related operations and national command center and NORAD Homeland security (as appropriate—e.g. TEAM and SEAM messages). Also shown connected via the PFN/TRAC System are other intranets via IP connections land line and satellite. These other intranets may be provided data in real or near real-time as TRAC system reporting e.g. (accounting operations will be processed second to SEAM and TEAM messaging at the routing level. Some broad band and broad spectrum routing is done today and protocols are becoming more universal and standard for wireless and cable transmissions, They still are not interrelated will enough to form one flexible roaming web for all the wireless, this is what is a unique function of the PFN/TRAC system. Many are still to proprietary and application specific.

CISCO systems/Motorola and Simens are some of the existing corporations that will be contacted to collaborate and construct the PFN/TRAC TSA/FACT Command center wireless router through COTS interfacing and TRAC architecture with their products and others COTS routing products. All wireless must be known to operate legally at the airport and the automated frequency scanning program running in local PFNS create a sensing fabric to eliminate authorized transmissions and triangulate on unauthorized propagations for analysis and investigations.

A Responsible Modality to Achieve the Invention in Every Application (La Technique)

The progression always starts with existing COTS and then continues to develop the PFN/TRAC unit and system to support FACT security for better public safety, national defense and Home land security and then to improve and refine the technology. Money and backing are essential for such a large undertaking. This is the reason the technology is explained with application use and impacts. Issues and use have to always be at the forefront of any system or unit design, programming and implementation. This is a Science Technology and Society (STS) utility teaching for patent. It is meant to maintain a thinking process with all the public as each skilled individual embarks on their respective task to realize the impact that they are responsible for and act professionally and with respect for their fellow citizens in the development and use of the invention. Cooperation and collaboration is sought for the development from all stakeholders.

TRAC Aviation will seek government support and assistance to include fumding, technical expertise, and technical transfers in an effort to partner up with major vehicle and equipment manufacturers to develop (vehicle PFNS).

FIG. 15 In FIG. 15, for ships and boats, the final slow down and stopping for part of phase two and part of phase three is accomplished by reversing engines and/or changing the rotation of the propeller (s) through any transmission. This may already be an electrically controlled system and in this case the controls would be interfaced and coupled direct to the PFN and supported with the compatible components and connectors. Or it may be a mechanical system with linkage and/or cables and any of the already detailed devices for the automobile could also be employed for these applications and managed and/or controlled by the PFN. However, in the large truck and buses, this technology will automate the application of air to the rear brakes in the PASSS shutdown through electric solenoid valves, fuel valve with an additional pinde valve to give an nice smooth and gradual application of the service brake side. Once the vehicle is stationary, determined by wheel or transmission sensors, the PFN TRAC system will release air pressure for the maxi can and apply the maxi brakes to hold the truck in a stationary position. There are, of course, many slow down modalities already detailed by this technology to slow vehicles down including the entire power train and braking systems, however these are the prototype systems, so therefore, they are detailed a little more.

Truck guidance will be accomplished through the same modalities detailed for cars with servo motors and stepper motors, ect. and/or the direct application of hydraulic fluid in the appropriate systems. PAGSSS will provide a great service as a backup systems for compromised drivers, fatigue, ect.

For the trucking industry PFNs of varying levels will be on every vehicle section. They will be on the truck and the trailer eventually and the accountable TRAC software will provide service readiness data to the tractor pulling on its systems, and any number of trailers attached to it. These checks will be able to determine the throw in the slack adjusters to apply a brake sense wheel seal leaks, report malfunctioning lights and/or wiring through current sensing algorithms in the firmware, adjust tandem positions while sensing the load for ride and handling, report tire pressures and report on location through the PFN/TRAC system, if so desired. This will allow for the tracking of loads by trucking firm's customers through the trucking company's web page or the PFN can be sent a command to notify the customer automatically as it approaches their destination. Of course, all is maintained in a protected environment and also capable of supplying trusted accountable data.

When PASSS or PAGSSS is activated in a truck or bus, the diesel power plant has its acceleration eliminated most probably at the injection pump levers, or by solenoid valves that restrict fuel flow, either OEM or this technology's priority valve, or through the air horn and/or duct. Then the PFN applies the air to the service side of the brakes in the rear most axle as determined by the PFNs establishing the presence of any trailers. These PFNs can be configured to communicate through their wireless systems if they are two-way but most generally they will be coupled with their light connections.

Trains and rail systems already are well set with monitoring and control systems, however, the PFN/TRAC system will ultimately couple all machinery equipment and vehicles and keep track of their movements if they are mobile. This is primarily done for managing traffic patterns and avoiding altercations in conflicting paths. Better movement of vehicles trucks and ships can be achieved on the surface of the earth through this technology's “Trip Controllers” as part of any interactive highway and/or emerging automated traffic control systems and/or interfaced with this technology's A Spider Eyes and “Green Eye” protocols. These management and control systems with their mass data and data storage automated and manned will provide many more jobs for not just managing traffic but also for giving health care, policing the community, ect. However, the Trip Controller will keep track of vehicles, trucks, trains and shipping and ultimately provide three dimensional car plane travel and air craft coordination.

And finally for the trains' solenoid valves are planned for the braking of the rail cars and the coordinated PFNs can be interfaced physically or by wireless. Most trans are built by companies like General Electric and are diesel over electric powered so the diesel motor controls are triplicated here however the PFN/TRAC system will interface with the processors and current controls for the electric drive motors and the same for the trams and trains applying brakes electrically whether they be shoes or disks.

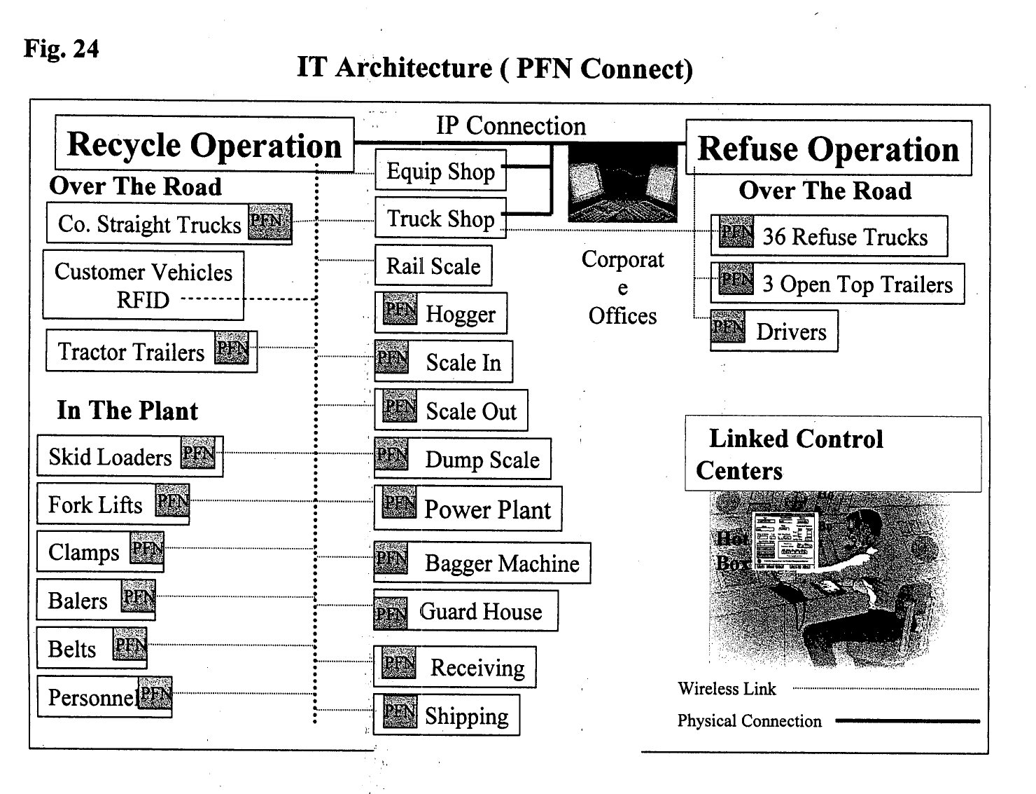

These are the functions that would be targeted by FACT's CM or controlled mobility components as displayed in FIGS. 22, 34, and 35 via the technology taught in Appendix I, appendix II and exemplified simply in FIGS. 23, 24.

The next Figure gives an exemplary convergence screen for a FACT/TSA local Monitoring at the Airport This slide is also the introduction slide for Appendix VIII

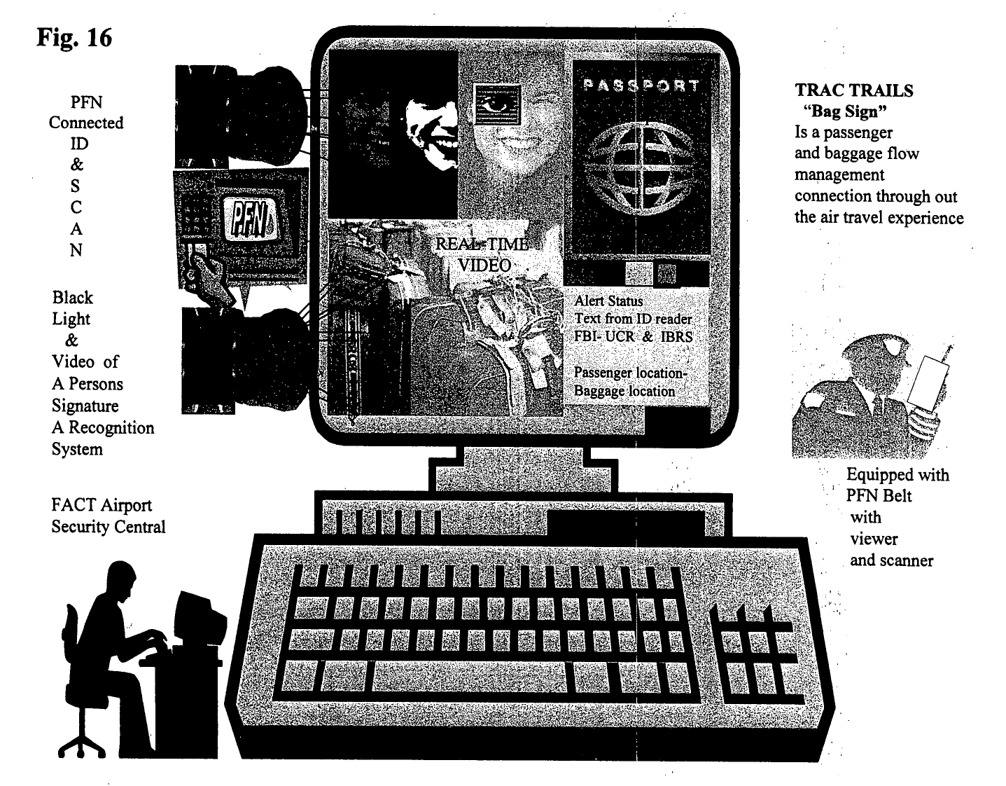

FIG. 16

FIG. 16 is the FACT terminal display. The entire FACT event will be viewable on a wall size screen in the TSA/FACT Airport command center at the airport with separate monitors breaking up specific data to present it for specific handling by trained professionals. For example, all the known ID data on the suspect women's passport is checked possibly by INS, while the FBI is running the face scan/iris scan data and recorded smart chip data from the pass port against all known records for a match. The first database is links to terrorism because her bag lower left of the monitor screen has triggered a flag alert as it passed an explosion detection sensor EDS connected to a PFN/TRAC equipment PFN on the baggage conveyor. The special ultraviolet light motorized video reader read her invisible to the eye signature on her bags and pulled up her travel file which was telecommunicated to all the airports on her ticket (this process could have started overseas and all relevant TSA FACT Security Airport intranets would have been preloaded via telecommunications and IP protocols to track her and her luggage identifiers by her projected flight plan, traceable technologies could include; RFID this proprietary Bag sign product or a 1P PFN combination of traceable ESNs and data sensing minimal telemetry product applications. Bar code readers and tags can be interfaced and read. The PFN PC platform is set up to run most every sensor software and drivers or to interface via the device controller and E/E bus to recover the data for the FACT Security System

Once a FACT event is initiated the entire system is quarried to locate all components of the suspect transport party, any persons, their separate luggage and any groups traveling together should be identified if possible and in the appropriate manner. In the upper left corner of FIG. 37 is the woman who owns the bag that triggered the PFN EDS sensor on the luggage conveyor. The video cam at the airport exit doors captured her image and is running a face scan algorithm and an iris scan for a positive match with the luggage Travel file data recovered on her when she and her baggage entered the Air trans port intranet. Additionally, a TSA officer in the airport parking area visually sees her and confirms her image on his PDA/PFN or PDA display plugged into his 1P PFN utility belt and moves to detain her with backup already on the way. Her identity was also discovered at the airport exit when she passed her travel card with magnetic strip or her passport smart card or chip through the card reader (left center of FIG. 37). Or her RFID tag impregnated into her passport delivered her ID telemetry to a RFID reader antenna in the door jam which is interfaced with the 1E PFN in the card reader or responsively connected to the 1 E PFN in the automated doors for remote control and locking of the exit door. But in this scenario just recorded her exit microseconds before the FACT Flag from the conveyor initiated the process, so instantly searches the loop memory storage and notifies all TSA FACT security of her exit alerting the TSA officer to look up at the exit and spot the women.

If the conveyor flag hadn't gone up by the EDS sensor that Exit procedure would have quarried the materials registry of the airport air intranet for a travel file on her anyway And if the exit telemetry indicated she was going to leave the airport, while here luggage was still in the terminal and in this case booked on flight SD333 to San Diego through from Yemen to Heathrow and she was exiting the Kennedy Airport FACT flag would have been issued at this point.

Mean while the suspect bag has been removed via automated discharge actuators that have placed it into a mobile robotics explosive containment chamber via RC and robotics. The bag is whisked away in an underground conduit to a containment vault with chain-linked ceiling and rupture-able membrane that empties into a containment tank (bladder) that intern is pumped down under vacuum. Then robotics opens the bag and if it explodes or has toxins in it they are read by sensor arrays protected first during the opening procedure and exposed after the bag is opened the bladder like wise has sensor arrays to include radioactive, Bio or chemical toxins and also the “Nose” sensing technology is a good choice for this application. Obviously the containment chamber would be closed before the bag opening procedure was initiated.

Back to FIG. 37, the national alert classification is shown on the screen and the local alert level appears on the computer monitor as well and in this case National Home land security is at orange “high threat” and local alert with the bag incident has jumped to RED “Severe”.

With the women detained and all her traveling assets located quarantined within ten minutes and during TSA questioning the rest of the traveling public continues to their known location with no delay or in some case any knowledge of the event.

This is all hypothetical, but the PFN/TRAC units set up an easy way to organize and link many disparate data generating technologies and isolated security devices with out a lot of hard wiring. It enhances their service to provide robust federal access and control defense for a free traveling public Additionally, when 1100 FACT-FAA/TSA Security project industrial applicability report.

Commercial efforts are underway with government (DOD) in an effort to partner up with major military and security contractors initially for national air space defense. Other efforts are underway with commercial wireless technology providers, sensor technologies, computer/software manufacturers and system integrators to develop the appropriate wireless to IP interface gateways, servers and connections to construct the TSA FACT Security network for the nation and to write code to the determined programs.

In slide 18 there is a technical diagram of the PS1 and HS1 wireless sensor arrays to be repeated through the PFNs on a DSRC 916 MHZ RF. While this is another RF Signal that would be interfaced it is not the only one. All RF or Telephony fall within the nature and scope of the invention to interface communications locally via a PFN and repeat the signal via more powerful wireless technology. This may be made of all proprietary components in one location to include all types of other C.O.T.S products and components somewhere else, and surely will. This invention has been designed as a cooperative effort wherever commercially possible, not as a competitive one.

FIG. 17

This figure shows the active relay components of the PFN/TRAC system for monitoring. The wireless sensors PS1 and HS1 to be detailed next are also shown in this figure. PS1 commercial sensing units and HS1 homeland security and in some cases military sensor arrays, which will have an MS classification if specific. The importance of this illustration is to simply show how the system works. Both wireless commercial Data networks can serve government use and government sensing can deliver data first hand to commercial gateways for the greatest amount of advanced warning. Obviously preprogrammed response will be developed and written into code and programmed through out the interfaced systems as is explained in FIG. 21.

The schematic presents Land and Water Sensors for detecting threats to personnel operations, materials, or products within a plant, port, installation or country. Alert Signals from a Sensor would be transmitted via PFN Relay Controls to Security Centers and Mobile Units. And of course first responders and national security as completely described

FIG. 18

FIG. 18 displays the most immediate embodiment and working prototype of a 1Ps or PS1, HS1 stand alone radiation sensing node. This is to be a scaleable and expanded duty design to which greater sensing, more computing power and memory storage and communication technologies can be added or substituted as desired and or needed. 1Ps units can be simple remote wireless sensors with FACT event memory or they can be complete PFN Trusted Remote Activity Controllers as stand alone PFN/TRAC units. The figure uses a radiation sensor example for dirty bombs in containers and packages. The design is such that electronic bio sensors can be added to the radiation sensor array as well as electronic chemical and explosive detection sensors and or theft and tamper detection. This would call for different configurations and power requirements and all is with in the nature and scope of the PFN/TRAC invention and the flexible 1Ps Tainer talkers.

This prototype described with a single RF transmitter is done as a practical product development to inexpensively place into service as many radiation detectors into as many containers and additionally set up more sensing environments at more ports, airports and boarder crossings in the shortest possible time to detect “dirty bombs” that are a real threat to the United States public safety. The design will be constructed with modular multipin connect ability to in crease the sensor array and provide versatile communication links to be universally used around the world. The product will evolve to systems on a chip (SOC) technology to increase the amount and sophistication of the-unit but also to reduce size and price. Presently sensors exist that can detect odors better than 2000 times that of the human nose down to a molecular level. One such sensor is “The Nose” used by NASSA in space shuttle missions.

However, the cost of developing the software library of electrical signals and the size reduction, operational power requirements and computing power have to be refined for the specific tasks to detect bio hazards like, Anthrax, tifus Eboli, Botchelism, Saminnela and chemical hazards nitrates etc for explosive detection. With such chemical detection all sorts of contraband and dangerous materials cam more quickly be identified monitored and managed during trans port. This is a unique benefit to the modular scalable design of the PFN/TRAC System architecture

The communication interfaces start with one dedicated shortrange communication transceiver like the monolitic TR1000 916 MHz, TR1004,TR1100 radios. However, a second wireless technology is planned for. It is the Motorola reflex technology for a number of good reasons. First it is becoming widely accepted around the world and is present in all the major cities where all the 429 commercial airports exist and sea ports as well as truck depots, major highways and rail stations and containers storrage takes place. This wireless technology has always been a primary part of the PFN/TRAC system so it's inclusion into the 1Ps Tainer talker products are a natural evolution. Additionally it is extremely reliable to deliver remote control commands to preprogrammed responses from the PFNs. The reasons for dedicated short range and the not just a pager is for local responsiveness to authorized personnel and not having the need for an entire communication system, also local back up and finally when at sea to communicate to the 1M PFN and the satellite phone systems. And this is why the prototype will first be built and beta tested with the DSRC TR1000 radio. It also does not require the paging services agreement right away and allows them to see the application in service and decide how they wish to participate in this machine messaging application. This detection device needs to be commercialized as soon as possible

The process involves monitoring and telemetry through a port Intranet into the TSA FACT network. In the center of the figure is shown the PFN equipped prime movers basic to seaports in a big black circle. These are the people and machines linked by the more powerful PFN/TRAC units (or Primary Focal Nodes). These are the units that initially receive the dedicated short range local alert signals from inside the a shipping container and route the data to local and national TSA FACT intranet terminals and or if appropriate relay this data to other agencies or commercial intranets as shown in FIG. 5.

The upper right hand corner shows a schematic of a a TR1000-916 MHz radio transceiver in a CAN. Progressing down the right of the page is a mini prototype circuit board where the TR1000 is mounted with a mini computer (a possible prototype candidate is the Parallax Stamp I or II chip computer) (This transmitter and processor combination on a board in this application could be replaced with Motorola's Reflex Creat a link II chipset package with an extension antenna shown right of the TR 1000 transceiver in the figure. There is to be an event memory that the DIS 100 human dosimeter chip can down load flagged radiation events and transmit it to a remote location either by the Monolithics TR1000 transceiver. The DIS 100 chip has memory and this additional flash memory is planned for in the Sony 4-8 Mbt Memory stick. It is to be a redundant protected record and as a purge for a full DIS 100 memory. Directly below is the protected power source a Panasonic CR2354 560 mAh (lithium). This power source will change by power requirements of sensor interfaces and applications.

Regardless, the power source must provide long term service for all that is interfaced and a power evaluation circuit or sensor to the processor to in sure timely replacement and early warning of failure to the FACT system. Additionally the unit should have a redundant power source in parallel protected and isolated until service is required due to initial battery failure.

Below the TR1000 transceiver and mini computer board is the whole assembly with battery housing antenna and a expandable prototype board for more sensor interfacing with chipsets. These are COTS prototype products. To the right shows the primary power source and battery holder. The yellow stick on the top right corner of the circuit boards is a wire antenna that can protrude in one direction or two as shown in the triangle magnetic block housing to the left for the Hot box sensor array prototype Tainertalker product.

Prototype Project

TR1000 Packet Radio Signaling

TR1000, is a hybrid transceiver, designed for short-range wireless data applications. The TR1000 employs RFM's amplifier-sequenced hybrid (ASH) architecture and for a time, was one of the few complete RF transceiver multi-chip modules available on the market. The device consumes an average of 18 m Watts of power with bit rates up to 115 kbps with amplitude shift keying (ASK) and 19.2 kbps with on-off keying (OOK).

The transceiver will operate with a carrier frequency of 916.5 MHz, and use OOK modulation. The TR1000 supports the radio link only and did not specify a base band or link layer like Bluetooth. The base band layer is to be implemented through the Atmel MCU.

To maximize SNR in the receiver, RF Monolithics recommends DC balancing the RF signal. DC balancing means sending a roughly equal number of high bits as low bits. As seen, a “1” representation is a high bit followed by a low bit, and a “0” representation is a low bit followed by a high bit. Manchester encoding could be implemented on top of the raw data bit stream. Manchester is inherently DC balanced signal should aid implementation and should be effective in addressing this concern.

A packet protocol training sequence of alternating high and low bits should equalize the DC balance of the receiver. The beginning of the packet protocol will need to be signaled by a flag byte. The flag byte I chose was somewhat arbitrary. This flag byte differentiate itself from the training sequence. The first byte after the flag byte specifies the total data bytes in the packet. The following bytes then are the data bytes. Followed by, CRC (cyclic-redundancy check) to indicate if the integrity of the data packet has been compromised. Block encoding can provide tighter data compression with the cost of additional processing.

The pager RF transceiver and microprocessor, with LED and audio chirper will weigh approximately 3.8 grams with out an enclosure and power source for the (a) alert configuration. It could be activated up to 50 meters away. For low power consumption, the Microchip PIC12C509 can be used, it will run at 32.768 KHz where most instructions can be executed in 4 clock cycles, allowing 8192 instructions per second or the simple programming being considered for the prototype. This makes for slow computations but the MCU consumed is equally low 15 mA at 3 Volts. The MCU's main function is to maintain real time clock and listen for signals coming in from the transceiver TR1000. When only receiving the, power consumption should only be 1.2 mA of current, figuring the receiving function is turned on for only 50 ms every 5 seconds to conserve power.

The TR1000 or (RX1310 receiver, solo application) receives modulated signals based on OOK. The MCU's job should 1st) detect a bit strean 2) synchronize with the bit stream, and 3) capture the first 16 bits, if the MCU runs at 8196 instructions per second with a software need of 6 instructions per bit to capture data, for throughput of the receiver when set at 8192/6 bps or 1365 bps.

How ever other modulation scheme and components are possible to include produces made by Tigertronics and Kantronics and processed vi the Stamp min computer. These are progressive components to drive the LCD display and alpha numeric messaging shown in FIG. 3. With the data in Packet form and the use of developer kits the conversion algorithm and appropriate software commands would be written to retransmit the signal alert and data packets to the windows application fpr application posting in the remote monitors

The 1Ps container unit can be turned on individually, requiring a unique code assigned to each container unit. Should the code match that of the unit in the container, its RAD sensor would turn on. E.g. A simple two byte code chosen for each ID, for the prototype demonstration is chosen. But, the total number of possible codes: will be limited based on this minimal receiver specifications for the experiment. Additionally the DC signal needs to be balanced (i.e. a roughly equal number of ones as zeros). To ensure transitions in the bit streams, the ID code will have no more than 3 continuous zeros or ones for this feasibility prototype processor and programming to be determined for this minimal experiment. And the the receiving function will stay on only long enough to capture the 16 bits of information, regardless of when the transmitter starts sending data.

The Tainer talker transmitter is planed to send out a two byte unique ID when the MCU processes a e.g. 3 RAD reading on the DIS100 sensor. Transceiver/Receivers on prime movers will be run continuously. On the receiving end, the PFN/TRAC unit or the 1ps pager MCU container reader unit circularly rotate the captured bits 16 times, each time looking for the ID or a matching ID and signal for an alert in this minimal receiving unit or connected Prime mover interface

Since each unique code had to be circularly permuted, no two ID codes could be circular permutations of one another. For this limited application a balanced DC signal is required to ensure a quick recognition of the unique ID codes. There are only 350 unique ID codes possible for a two byte code. For these first generation 1ps container units, each will send only two unique ID commands: 1) condition red and 2) condition green and only for 5 seconds every 15 seconds to conserve power; unless a signal is received and identified by the PFN/TRAC unit or TSAFACT system link or programming the specific require other broadcast timing for a threat or a safe condition. Additionally the system programming can provide the command to continue or cease (this can be automatic or manual and used to check sensor activation accuracy). Thus, a total of 350/2=175 unique ID container units are possible under this configuration for the beta prototype test. Of course increased length of unique ID code will increase the total number of codes and units. This is just to teach the concept.

This first program is just go no go on a container ship or search for nuclear material and to deliver the signal through outh the system Further progression is detailed the soft ware named and steps to develop the unit and system detailed

The architecture found in the autonomous 1 Ps tainer talker array begins with the Atmel AT90LS8535, an RF Monolithics 916 MHz transceiver set, 1 sensor and an option for six more (Planned chemical and biological odor detections and heat and smoke detection, other sensing is possible as well ). A single 3-V lithium coin cell battery powers the mote, sustaining either five days of continuous operation or 1.5 years at 1% duty cycling.

Since the transceivers operate at a single carrier frequency, 916 MHz, only one device can transmit at a time. If two devices transmit, collisions can occur causing the data to become unreadable. Additionally, especially in noisy environments, packets of data can be corrupted during transmission. While there is no protocol in place for re-transmitting lost data packets, cyclic redundancy check (CRC) can be implemented to check packet integrity. basically these early units will be inactive and less an alert flage is triggered for transmission so the CRC provides a simple solutions for transmitting data with relatively few collisions possible anyway.

### Special use Antenna Embodiments

1. One antenna configuration is obtained by drilling a hole in the upper right hand corner of the container and pass the wire through the hole and position the triangle or wedge up in the upper right corner of the container so that the strong magnets on it's back side adhere the triangle sensor block to ceiling of the container with the sensor array facing down and to the center of the container. The con cave receiver dish and wedge for the most part are planned for this type of attachment or installation, however the magnetic plates allow the sensor block to be quickly installed at anytime during loading anywhere there is a ferrous metal surface to attach it to. For non ferrous metal applications like a fiberglass D11 aviation containers or aluminum compartment sides adhesive tape and adhesive Velcro attached to the back of the wedge and adhered to the receiving could be employed. With this configuration the antenna external the container would be adhered by a suitable adhesive to partially meld with the antenna coating and ad here to a cleaned porting of the corner wall or attached with fasteners appropriate tape or corner beading fanning out in one or at right angles in two directions to the ideal or appropriate length for the desired signal.
1. The second antenna embodiment allows for the possibility that even the shortest of broadcast may not be desirable in an environment of thousands of containers and th contact of the unit is what is most desirous to retrieve the sensed data from inside the container. In this application the tip of the antenna covering is bare and a portion of the containers paint inside is scraped off so that the bare tip of the wire is held fast to the bare surface of the metal under the pressure of the strong magnet's attraction to the container wall. This keeps the signal retained to the metal from of the container and when a prime mover configured the same with an insolated power source for this sensing application the primovers chassis contact will receive the signal clearly. This may prove to be an advantageous configuration with the metal frames making contact on board ship through the crane cables or the forks of a forklift or the metal fram of a truck or rail car receivng this direct contact signal.
2. The third is the use of the direct contact to chassis signal propagations with firmware to switch to a complete antenna mode outside the container if the container has a recognized FACT event and no prim mover contact. These are all mentioned here and real life testing will determine the most effective and desirous embodiment, applications and physical configurations.

In the lower middle of the drawing on the expandable prototype sensor board with the DIS100 wide energy human Dosimeter connected into the 1Ps Tain talker circuit to be responsive to firmware commands programmed into the 1Ps processor to retreived sensed data, to include time, date unit serial number container serial number al programmed at the point of debarkation an inserted into the unit with a proprietary locking mechanism detailed in earlier PFN/TRAC filings or via direct wireless connections and encrypted coding. The DS 100 sensor is also shown in the concave center oval of the triangle

The dotted box to the lower left symbolizes a rear end view into a container with the Tainer talker sensor up in the right front portion of the container. The yellow antenna is transmitting to the black circle of powerful PFN/TRAC transceiver/translating routers that are delivering the packet data to the proper intranet via longer range wireless, either cellular phones paging technologies or stronger RF systems. These PFN prime movers will also have plug and play circuit boards for wireless protocol chipsets and this is well documented throughout the PFN/TRAC system. Along with this capacity barcode reading magnetic antenna or RFID readers will be interfaced as well any necessary IrDa transceiver or ultra sound if employed. This flexibility the PFN/TRAC Architecture provides via the prime mover PFN mini routing stations allows for immediate universal incorporation of existing technology and the flexibility for forward and backward engineering to enhance all security and management systems.

The black ring means that all the Prime mover PFN/TRAC units are protected physically and electronically and secure with encryption. This is well detailed in earlier related PFN/TRAC filings Above the Black circle and to the left is a computer terminal display and this could be a local TSA/FACT at the port or even a pier of air port terminal. A large display will be used for big campuses with maps and building lay outs showing GPS coordinate of all prime movers including people and or positions in a building boat plain or train etc. For this reason even though FACT events will respond via much automated programming to recognized or flagged threats, there will be numerous manned monitoring and management stations through out the intranets detailed in Appendix IX and X.

FIG. 19

FIG. 19 uses a port-shipping container as an example. The container with this inventions wireless sensor array called the PS-1/HS1 “Tainer talker” communicates the dangerous nature of it's cargo. A sensor has fired off a signal at a preprogrammed hazard level to public safety and national security. This could be a biohazard, chemical/explosive or a nuclear radiation hazard detected. On every piece of equipment there is a PFN. A PFN specialized to serve with or as an equipment controller. It is a protected interface for vehicle electronics and a routing unit hosting multiple wireless technologies to include GPS, so that the unit and the system reported to knows the exact position of the operating equipment. The many various PFNs use the equipment's electrical/electronics or E/E system to provide stable power for the PFN to perform consistent repeater/routing functions and reliable remote controller. These PFNS are Trusted Remote Activity Controllers/Routers or PFN/TRAC units on every transportation platform also referred to as prime movers.

The boat in the upper left hand corner, the spreader or crane and the forklift all have different PFN trusted remote activity controller/router units. The boat has a 1M PFN marine unit that has all the necessary marine wireless frequencies (named in earlier filings to include, satellite hook ups and smart position technologies like GPS, and or Lorenz) and will ultimately be connected to perform automated piloting with collision avoidance systems for vessels at sea (FACT Security device) to interdict for the unsafe or unauthorized use of the vessel e.g a FACT event is sensed by a (PS-1′HS-1 sensor array) detecting are radioactive sea container on board (more detail on PFN/TRAC/FACT processing and control devices in prior applications and further elaborated on in this filing)

The 1M PFN/TRAC Unit on the vessel has a dedicated short ranged communication transceiver that is in communication with every container and shipping package on board the boat. The dedicated short range communication technology in each container may or could vary. To include light/infra red (IrDA), sound/ultrasonic/acoustical, radio frequency RF, RFID or physical contact/conductance with these technologies being interfaced and supported for processing by plug and play transducers and or firmware chipsets for RF via I/O multi pin connection boards on the PFNASIC shown in FIG. 4 (Configurations will evolve from PC104 and custom circuits to systems on a chip or SOC technology as ideal application determine improved hardware configurations).

The obvious benefit to having the PFN architecture is that it provides an interface for all these short range wireless to deliver digital data and or analog systems to have their data processed and translated to longer range wireless and more remote locations for faster distribution of real-time data. All the wireless technologies interfaced in PFN/TRAC units have been discussed in the ten prior filings. For this reason this application will focus on the dedicated short range wireless Monolitics TR1000 series RF products or comparables and a special modulated packet data protocol and translation process to include Reflex pager protocols interfaced with the PFN/TRAC units for terrestrial land and sea repeating and data routing applications. These same DSRC TR1000 data packets will translate to satellite and telephony protocols for ocean transport and airborne applications.

This filing specifically teaches a prototype configuration for the PS-1 HS1 sensing platform using the DIS100 Dosimeter to sense dangerous levels of radiation to meet the nation's immediate need to detect terrorist dirty bomb material. Although this first prototype is for radiation detection the future interface platform is designed to add sensing technology for biological and chemical hazards as these sensors are miniaturized and signals are generated. First the best sensitivity and electronic libraries need to be developed. This process is discussed completely along with the progressive processes to implement them through out the teachings and is constantly evolving with better detection technologies. Included recently for possible use in the PS1 and HS-1 sensor suites if the inventors and assignees are agreeable to such use, is a Cesium Iodide crystal sensor invented at Stanford University by a father and son team Dr. Jarvoslav Varva Varva and Paul Varva. The HS-1 and PS-1 sensor arrays are minimal current applications and remain in a sleeper mode except for periodic checks for elements they are specifically configured to detect When detection occurs they send out alert signals to the more powerful PFN repeating stations interfaced with transportation Prime movers. These stations/controllers do further processing of the signal/data. The additionally assign GPS or position data and time data as well as apply a RF identity string and send it on to the appropriate networks that have application specific software to process and display the data to the appropriate officials and industry experts to include first responders for FACT Alert Signals.

The types of wireless are not limited. Other wireless translation processing between different protocols are also possible and within the nature and scope of the invention. Some will be discussed in this application and others have been addressed in the ten related PFN/TRAC System applications with FACT security.

It is possible for all vehicle platforms to communicate with a contaminated container and all will have numerous long and short range wireless technologies to perform this function. If a communication cannot be established with a container via the programmed encrypted electronic handshake the container is to be isolated for further investigation.

Figure one could be an airport with airport type containers and PS-1s, HS1 “Tainertalker” sensor units would have appropriate mounting for these applications (as detailed in other related filings). Figure one can be the shipping yard as shown in the figure, or any commercial facility, military base, embassy, installation boarder crossing or compound, where specific commercial and security wireless systems exist and computer itranets are established. The DSRC for the transport industry should have standards applied (possible 5.7 GHZ approved by the FCC for DOT applications) with special encryption and routing command strings to the regulating agencies for the industry specific materials in transport). The frequency/frequencies must be standardized for inter-modal transportation platforms. So the various PFN/TRAC units running FACT security programming can recognize and communicate with the materials and containers as they are carried by different prime movers.

The existing communication technologies/systems can be incorporated into the PFN/TRAC unit or local interface via hybrid substrate chipsets (first progressive step for the PFN/TRAC/FACT conversion to include legacy systems) and deliver wireless data to the same IP gateways for the present agency and industry intranets and also to handle more immediate remote links and create the most necessary robust government inter operability for the FACT Security program (homeland security). As depicted in figure one these PFN track units work as a flexible web, creating a sensing matrix of security and checkpoints, where sensed data can be recovered via wireless and entered into the FACT system.

Whether at the port, airport, or boarder a unique attribute of the PFN/TRAC technology is that the inspection process, shipment monitoring, and equipment management does not have to result in a transport chokepoint. Flow is continual with rapid response capability in place as inspections continue. The inspection process never ends. It continues into the country and it begin far out side the country's boarders, which provides greater security and freedom of movement for man, machine and material. Not only will there be PFNS on the boats, but also on the spreader crane 1E PFNs unloading cargo in the figure and the 1SV PFNs on the forklift, but are also hand held units like the one the port inspector is holding a (1P PDA PFN). This hand held display package is also part of the product development for the 1P personal PFN interface belts for authorized workers and inspectors (detailed in a prior related filing). Basically the IP personal PFNS are personal wireless interfaces to the PFN/TRAC System and are equipment in proximity to the worker or person. This provides for the moving equipment to detect where people are and the people the ability to control the equipment in an emergency, to include shutting it down or turning it off as part of the sensing and communication PFN/TRAC matrix or web. Additionally, the truck carrying the container to the right has a DRC Driver Resource Center or 1SV Surface vehicle PFN interfaced to the tractor, which connects to the vehicles electrical system in this case a CAN J1939 truck bus.

The transparent shipping container to the left is an illustration of a container that has gone hot with a radiation leak that is hazardous to public health. The smaller wireless PS-1/HS1 “Tainer talker” unit has a radiation DIS100 dosimeter sensor in the upper right hand corner of the container and has just fired off an alert (or FACT Alert Signal).

The dosimeter is a present COTS product for rapid deployment. The sensing component is taken from a personally worn device for individuals working around alpha, beta and gamma radiation and has been converted to deliver it's electronic signal via the PS1/HS1 “Tainer talker's processor to the PFN/TRAC units on the surrounding transportation prime movers. The RAD sensitivity is adjusted to a predetermined acceptable safe limit. Any RAD signal generated higher either energizes the input pin or delivers a digital pulse to the micro processor for the PS-1/HS1 “Tainer talker”—( the little black triangle) in the upper right hand corner of the shaded transparent trailer left.

The mini PS-1/HS1 “Tainer talker” unit is capable of recording the event and reporting this signal via the interface of the TR1000 transceiver to any of the prime mover PFN/TRAC unit's that have a DSRC/TR1000 transceiver chipset interfaced.

Note: The other radiation detector's electrical signal will be Processed by the HS1 or PS1 sensor suite and delivered in the same way but the process to develop that signal is protected by signed NDAS with the respective inventors and will not be detailed here.

Private Industry/Freight Forwarder's, truck transport/delivery services etc. their transport vehicles and material handling equipment will also have a long range repeating capability to all relevant government monitoring intranets to include FAA TSA/FACT networks in the airports, customs, port authorities, border patrols, local law enforcement intranets, and rail security as described and detailed in FIGS. 6 and 7. But only for FACT related alerts, all other data commercial data and material tracking will be protected, confidential and encrypted to the private commercial intranet.

In the more powerful PFN/TRAC units longer range transmissions are used to send this critical data to port authorities, or airport officials if the FACT event occurs at the airport, customs agents, local Police/fire, first responders, state hazmat, EPA, local TSA/FACT command and control centers at the airport or port and the nation's TSA/FACT command center, intelligence agencies and national law enforcement will make up the matrix of government agencies needed for an inter-operative homeland security.

It appears that these government agencies are having the same turf wars that plagued the military for years until JTA Joint Technical architecture forced an improved inter-operability with in the services for Joint Tactical operations. For this reason the rapid delivery of FACT Security data provided equally via the PFN/TRAC System to the intelligence community of government agencies CIA, FBI, NSC, Secrete Service and law enforcement in general should improve cooperation on the FACT Security data. The recorded delivery of data will provide accountability for the agencies to justify their service to the nation automatically. Hopefully, this will reduce the financial turf wars to justify individual government budgets with real cooperative service responses recorded in real-time. It will also improve operational efficiency in general. Individual agencies can still have their own encryption and security protocols for internal communications/operations to protect their special duty and purview of governance, but with more lateral cooperation at various agency levels FACT translation software can avail further agency specific processing to all agencies for more complete and rapid analysis of a particular security threat. Workers and systems will function together more.

In the center of figure one is a Custom's Agent viewing a read out from the PS-1 Tainerstalker's second generation unit, a direct progressive improvement from the first simple Alert Signal function that is delivered locally to a driver or worker pager as detailed in figure three. As seen in the exploded view in the forefront of the figure the DIS100 dosimeter's has a capability to generate a cumulative data log stored in memory by the firmware in the micro processor of the HS1/PS1 over a period of time that the unit is in service, for time to time downloads. The PS-1/HS1 normally delivers the data via a chip reader to a PC. In the invention this is made possible in real-time by remote activation of the memory chip to harvest the data stored via the PC operating program in firmware residing in the PS-1/HS1 “Tainer talker”. Data packets are sent the micro processor and the TR1000 transceiver to the 1P PFN PDA of the custom agent, which also has a TR100 transceiver interface. The 1P PFN PDA processor has been loaded with a customized dosimeter application program to drive the 1 P PFN PDA display to view the data in real-time, regarding any alert status or the contents general radiation reading from a historical archival record stored in the PS1/HS1 local event memory for months during transport and or storage of the container to look for anomalies to the load manifest.

Here the inspector can receive the archive file showing radiation exposure and exact time and location of any radiation event transpiring during transport, including all other data access who have inspected the container before electronically or physically. Additionally, remote intranets are receiving the same information via 2 way reflex paging. FIG. 9 shows a PDA so equipped with 2 way paging and a DSRC TR1000 transceiver. By using and converting the dosimeter product to deliver its electrical signal via modulated packet data on the DSRC RF or other communication mediums earlier mentioned, involve identifying the exact sensor arrays (HS1/PS1) electronic serial number. It is encoded into the data packet header, which identifies the transceiver by it's ESN. The exact data and back ground radiation reading at the point of installation and transmitted through out the FACT system aids to detect tampering with the unit. Obviously, any container not producing a signal or a bogus one is suspect and pulled from the normal material handling flow for further inspection with different security protocols taking for the unusual event (malfunction etc.).

In the lower right hand corner is a command and control center. Both, at the port or airport and at the nation's FACT command and control center; or any number of TSA or FACT government agency intranets necessary to support the various responsibilities for a particular event. The flexible FACT web is an accountable communication matrix of real-time responsiveness by every agency to include first responders in remote locations. The national government agencies are available to aid local first responder with the best and most accurate information and data to handle emergency situations and to provide more support resources quickly and determine greater threat to the nation. Via the PFN/TRAC system this is achievable for a TSA, FACT Homeland Security approach no mater if the agencies are dispersed or centralized (further discussed are represented in FIG. 5, 6, 7).

Inventor Note:

The inventor feels strongly that the nation would be wise to develop the DOT/TSA Transportation Security Agency as a lead first responder and law enforcement agency utilizing the FACT security and the PFN/TRAC movement management system for all modes of transportation to provide seamless security and push back the nations borders, not just for the FAA. But this new agency needs much more work and a serious effort on the part of the congress and the executive branch to make this happen. The agency should be made up of a combination of existing law enforcement agencies as well.

In the upper right corner of figure one is a prime mover truck receiving the signal from PS-1/HS1 “Tainertalker” unit located in the corner of the container on the truck. The horns of the truck could be activated via an electric solenoid air valve on the horns and the lights would flash to indicate the truck is in an emergency mode and an electronic sign with lites, light emitting diodes or led s in the bumper (or elsewhere) could provide an informative message as to the nature of the emergency or FACT event. The truck's PFN (DRC 1SV PFN) could receive commands not to display a local emergency information and just report data and vehicle GPS location to a TSA or FACT center(s).

Figure one uses a port-shipping container as an example. The container with this inventions wireless sensor array called the PS-1/HS1 “Tainer talker” communicates the dangerous nature of it's cargo. A sensor has fired off a signal at a preprogrammed hazard level to public safety and national security. This could be a biohazard, chemical/explosive or a nuclear radiation hazard detected. On every piece of equipment there is a PFN. A PFN specialized to serve with or as an equipment controller. It is a protected interface for vehicle electronics and a routing unit hosting multiple wireless technologies to include GPS, so that the unit and the system reported to knows the exact position of the operating equipment. The many various PFNs use the equipment's electrical/electronics or E/E system to provide stable power for the PFN to perform consistent repeater/routing functions and reliable remote controller. These PFNS are Trusted Remote Activity Controllers/Routers or PFN/TRAC units on every transportation platform also referred to as prime movers.

The boat in the upper left hand corner, the spreader or crane and the forklift all have different PFN trusted remote activity controller/router units. The boat has a 1M PFN marine unit that has all the necessary marine wireless frequencies (named in earlier filings to include, satellite hook ups and smart position technologies like GPS, and or Lorenz) and will ultimately be connected to perform automated piloting with collision avoidance systems for vessels at sea (FACT Security device) to interdict for the unsafe or unauthorized use of the vessel e.g a FACT event is sensed by a (PS-1′HS-1 sensor array) detecting are radioactive sea container on board (more detail on PFN/TRAC/FACT processing and control devices in prior applications and further elaborated on in this filing)

The 1M PFN/TRAC Unit on the vessel has a dedicated short ranged communication transceiver that is in communication with every container and shipping package on board the boat. The dedicated short range communication technology in each container may or could vary. To include light/infra red (IrDA), sound/ultrasonic/acoustical, radio frequency RF, RFID or physical contact/conductance with these technologies being interfaced and supported for processing by plug and play transducers and or firmware chipsets for RF via I/O multi pin connection boards on the PFNASIC shown in FIG. 4 (Configurations will evolve from PC104 and custom circuits to systems on a chip or SOC technology as ideal application determine improved hardware configurations).

The obvious benefit to having the PFN architecture is that it provides an interface for all these short range wireless to deliver digital data and or analog systems to have their data processed and translated to longer range wireless and more remote locations for faster distribution of real-time data. All the wireless technologies interfaced in PFN/TRAC units have been discussed in the ten prior filings. For this reason this application will focus on the dedicated short range wireless Monolitics TR1000 series RF products or comparables and a special modulated packet data protocol and translation process to include Reflex pager protocols interfaced with the PFN/TRAC units for terrestrial land and sea repeating and data routing applications. These same DSRC TR1000 data packets will translate to satellite and telephony protocols for ocean transport and airborne applications.

This filing specifically teaches a prototype configuration for the PS-1 HS1 sensing platform using the DIS100 Dosimeter to sense dangerous levels of radiation to meet the nation's immediate need to detect terrorist dirty bomb material. Although this first prototype is for radiation detection the future interface platform is designed to add sensing technology for biological and chemical hazards as these sensors are miniaturized and signals are generated. First the best sensitivity and electronic libraries need to be developed. This process is discussed completely along with the progressive processes to implement them through out the teachings and is constantly evolving with better detection technologies. Included recently for possible use in the PS1 and HS-1 sensor suites if the inventors and assignees are agreeable to such use, is a CIC sensor invented at Stanford University by a father and son team Dr. Jarvoslav Varva Varva and Paul Varva. The HS-1 and PS-1 sensor arrays are minimal current applications and remain in a sleeper mode except for periodic checks for elements they are specifically configured to detect. When detection occurs they send out alert signals to the more powerful PFN repeating stations interfaced with transportation Prime movers. These stations/controllers do further processing of the signal/data. The additionally assign GPS or position data and time data as well as apply a RF identity string and send it on to the appropriate networks that have application specific software to process and display the data to the appropriate officials and industry experts to include first responders for FACT Alert Signals.

The types of wireless are not limited. Other wireless translation processing between different protocols are also possible and within the nature and scope of the invention. Some will be discussed in this application and others have been addressed in the ten related PFN/TRAC System applications with FACT security.

It is possible for all vehicle platforms to communicate with a contaminated container and all will have numerous long and short range wireless technologies to perform this function. If a communication cannot be established with a container via the programmed encrypted electronic handshake the container is to be isolated for further investigation.

Figure one could be an airport with airport type containers and PS-1s, HS1 “Tainertalker” sensor units would have appropriate mounting for these applications (as detailed in other related filings). Figure one can be the shipping yard as shown in the figure, or any commercial facility, military base, embassy, installation boarder crossing or compound, where specific commercial and security wireless systems exist and computer intranets are established. The DSRC for the transport industry should have standards applied (possible 5.7 GHZ approved by the FCC for DOT applications) with special encryption and routing command strings to the regulating agencies for the industry specific materials in transport). The frequency/frequencies must be standardized for inter-modal transportation platforms. So the various PFN/TRAC units running FACT security programming can recognize and communicate with the materials and containers as they are carried by different prime movers. The existing communication technologies/systems can be incorporated into the PFN/TRAC unit or local interface via hybrid substrate chipsets (first progressive step for the PFN/TRAC/FACT conversion to include legacy systems) and deliver wireless data to the same IP gateways for the present agency and industry intranets and also to handle more immediate remote links and create the most necessary robust government inter operability for the FACT Security program (homeland security). As depicted in figure one these PFN track units work as a flexible web, creating a sensing matrix of security and checkpoints, where sensed data can be recovered via wireless and entered into the FACT system.

Whether at the port, airport, or boarder a unique attribute of the PFN/TRAC technology is that the inspection process, shipment monitoring, and equipment management does not have to result in a transport chokepoint. Flow is continual with rapid response capability in place as inspections continue. The inspection process never ends. It continues into the country and it begin far out side the country's boarders, which provides greater security and freedom of movement for man, machine and material. Not only will there be PFNS on the boats, but also on the spreader crane 1E PFNs unloading cargo in the figure and the 1SV PFNs on the forklift, but are also hand held units like the one the port inspector is holding a (1P PDA PFN). This hand held display package is also part of the product development for the 1P personal PFN interface belts for authorized workers and inspectors (detailed in a prior related filing). Basically the IP personal PFNS are personal wireless interfaces to the PFN/TRAC System and are equipment in proximity to the worker or person. This provides for the moving equipment to detect where people are and the people the ability to control the equipment in an emergency, to include shutting it down or turning it off as part of the sensing and communication PFN/TRAC matrix or web. Additionally, the truck carrying the container to the right has a DRC Driver Resource Center or 1SV Surface vehicle PFN interfaced to the tractor, which connects to the vehicles electrical system in this case a CAN J1939 truck bus.

The transparent shipping container to the left is an illustration of a container that has gone hot with a radiation leak that is hazardous to public health. The smaller wireless PS-1/HS1 “Tainer talker” unit has a radiation DIS100 dosimeter sensor in the upper right hand corner of the container and has just fired off an alert (or FACT Alert Signal).

The dosimeter is a present COTS product for rapid deployment. The sensing component is taken from a personally worn device for individuals working around alpha, beta and gamma radiation and has been converted to deliver it's electronic signal via the PS1/HS1 “Tainer talker's processor to the PFN/TRAC units on the suronding transportation prime movers. The RAD sensitivity is adjusted to a predetermined acceptable safe limit. Any RAD signal generated higher either energizes the input pin or delivers a digital pulse to the micro processor for the PS-1/HS1 “Tainer talker”—( the little black triangle) in the upper right hand corner of the shaded transparent trailer left.

The mini PS-1/HS1 “Tainer talker” unit is capable of recording the event and reporting this signal via the interface of the TR1000 transceiver to any of the prime mover PFN/TRAC unit's that have a DSRC/TR1000 transceiver chipset interfaced.

Note: The other radiation detector's electrical signal will be Processed by the HS1 or PS1 sensor suite and delivered in the same way but the process to develop that signal is protected by signed NDAS with the respective inventors and will not be detailed here.

Private Industry/Freight Forwarder's, truck transport/delivery services etc. their transport vehicles and material handling equipment will also have a long range repeating capability to all relevant government monitoring intranets to include FAA TSA/FACT networks in the airports, customs, port authorities, border patrols, local law enforcement intranets, and rail security as described and detailed in FIGS. 6 and 7. But only for FACT related alerts, all other data commercial data and material tracking will be protected, confidential and encrypted to the private commercial intranet.

In the more powerful PFN/TRAC units longer range transmissions are used to send this critical data to port authorities, or airport officials if the FACT event occurs at the airport, customs agents, local Police/fire, first responders, state hazmat, EPA, local TSA/FACT command and control centers at the airport or port and the nation's TSA/FACT command center, intelligence agencies and national law enforcement will make up the matrix of government agencies needed for an inter-operative homeland security.

It appears that these government agencies are having the same turf wars that plagued the military for years until JTA Joint Technical architecture forced an improved inter-operability with in the services for Joint Tactical operations. For this reason the rapid delivery of FACT Security data provided equally via the PFN/TRAC System to the intelligence community of government agencies CIA, FBI, NSC, Secrete Service and law enforcement in general should improve cooperation on the FACT Security data. The recorded delivery of data will provide accountability for the agencies to justify their service to the nation automatically. Hopefully, this will reduce the financial turf wars to justify individual government budgets with real cooperative service responses recorded in real-time. It will also improve operational efficiency in general. Individual agencies can still have their own encryption and security protocols for internal communications/operations to protect their special duty and purview of governance, but with more lateral cooperation at various agency levels FACT translation software can avail further agency specific processing to all agencies for more complete and rapid analysis of a particular security threat. Workers and systems will function together more.

In the center of figure one is a Custom's Agent viewing a read out from the PS-1 Tainer talker's second generation unit, a direct progressive improvement from the first simple Alert Signal function that is delivered locally to a driver or worker pager as detailed in figure three. As seen in the exploded view in the forefront of the figure the DIS100 dosimeter's has a capability to generate a cumulative data log stored in memory by the firmware in the micro processor of the HS1/PS1 over a period of time that the unit is in service, for time to time downloads. The PS-1/HS1 normally delivers the data via a chip reader to a PC. In the invention this is made possible in real-time by remote activation of the memory chip to harvest the data stored via the PC operating program in firmware residing in the PS-1/HS1 “Tainer talker”. Data packets are sent the micro processor and the TR1000 transceiver to the 1P PFN PDA of the custom agent, which also has a TR100 transceiver interface. The 1P PFN PDA processor has been loaded with a customized dosimeter application program to drive the 1 P PFN PDA display to view the data in real-time, regarding any alert status or the contents general radiation reading from a historical archival record stored in the PS1/HS1 local event memory for months during transport and or storage of the container to look for anomalies to the load manifest.

Here the inspector can receive the archive file showing radiation exposure and exact time and location of any radiation event transpiring during transport, including all other data access who have inspected the container before electronically or physically. Additionally, remote intranets are receiving the same information via 2 way reflex paging. FIG. 9 shows a PDA so equipped with 2 way paging and a DSRC TR1000 transceiver. By using and converting the dosimeter product to deliver its electrical signal via modulated packet data on the DSRC RF or other communication mediums earlier mentioned, involve identifying the exact sensor arrays (HS1/PS1) electronic serial number. It is encoded into the data packet header, which identifies the transceiver by it's ESN. The exact data and back ground radiation reading at the point of installation and transmitted through out the FACT system aids to detect tampering with the unit. Obviously, any container not producing a signal or a bogus one is suspect and pulled from the normal material handling flow for further inspection with different security protocols taking for the unusual event (malfunction etc.).

In the lower right hand corner is a command and control center. Both, at the port or airport and at the nation's FACT command and control center; or any number of TSA or FACT government agency intranets necessary to support the various responsibilities for a particular event. The flexible FACT web is an accountable communication matrix of real-time responsiveness by every agency to include first responders in remote locations. The national government agencies are available to aid local first responder with the best and most accurate information and data to handle emergency situations and to provide more support resources quickly and determine greater threat to the nation. Via the PFN/TRAC system this is achievable for a TSA, FACT Homeland Security approach no mater if the agencies are dispersed or centralized (further discussed are represented in FIG. 5, 6, 7) in Appendix VIII.

Inventor Note:

The inventor feels strongly that the nation would be wise to develop the DOT/TSA Transportation Security Agency as a lead first responder and law enforcement agency utilizing the FACT security and the PFN/TRAC movement management system for all modes of transportation to provide seamless security and push back the nations borders, not just for the FAA. But this new agency needs much more work and a serious effort on the part of the congress and the executive branch to make this happen. The agency should be made up of a combination of existing law enforcement agencies as well.

In the upper right corner of FIG. 19 is a prime mover truck receiving the signal from PS-1/HS1 “Tainer talker” unit located in the corner of the container on the truck. The horns of the truck could be activated via an electric solenoid air valve on the horns and the lights would flash to indicate the truck is in an emergency mode and an electronic sign with lights, light emitting diodes or led s in the bumper (or elsewhere) could provide an informative message as to the nature of the emergency or FACT event. The truck's PFN (DRC 1SV PFN) could receive commands not to display a local emergency information and just report data and vehicle GPS location to a TSA or FACT center(s).

FIG. 20

In FIG. 20 the FACT Security Program is to have layers of redundant reporting from multiple pathways that are time and geographic synchronized as well as, identifiable in nature, origin and communication path through out a homeland defense/security matrix. The very top bock is only exemplary of the security agencies network via IP at this level. The list is long to include NSC, NSA, Secret Service, CIA and the special security responsible components of the three branches of Government Executive, Legislative and Judicial. (possibly a new judicial function into the procedures and protocols for an interactive accountable use of the FACT security program). At This highest level procedures, will need to be determined and agreed upon to maintain the balance of powers and protect the public's interest.

Accountability

Personal and agency identifiers with traceable data telemetry for system access, use and commands will be reported and recorded through out the entire system to include this the highest national security FACT Command level. The access to this data will be denied and transparent—system wide when classified Secret, Top secret and or to include any of the appropriate terms used for classified data. Application viewing and access to data can be controlled via personal ID clearance and Data Encrypted PFN/TRAC interface Terminal protocol (to be determined and approved by each security agency for agency specific data as a data handling software directive and added to the data packets).

SEAM

This message program is to provide guarded mobile and flexible access to the highest level of security from almost anywhere. This program messages will be termed SEAM messages for Security Emergency Action message. They of course will be transparent in the system and use compatible wireless transfer and translations to maintain accurate and complete content delivery when messages are passed through different wireless protocols. No transcribing through the universal TEAM language libraries, here. However, there will always be real-time total access to the universal communication program if security command agencies require this to complete operations

Generally, the plan is for a central homeland security command, but this could be modular and or transferable to different locations as well as the master control staff changed. E.g. Enchelon, NORAD combined with TSA AOC and Emergency response Center or dispersed. Procedures and protocols need to be determined and these protocols need to remain top secret as well as be altered with all the necessary encryption algorithms for coded commands from time to time and done with integrity checks before activation of any changes. (integrity check protocols will need to be determined as well) TRAC/FACT is all about accountability to be trusted and respected by the public. National Security has to act responsible to that ideology and way of life, both, professionally and respectfully as a member of that public. With that said the individuals performing these tasks deserve the highest respect and appreciation in their efforts to protect the public/the nation.

Freedom of Information or FOIA is a special attention issue for the release of any data that could be used to place judgment on the individuals serving the nation and the public at all levels of the FACT program. Improprieties (e.g. negligence, deliberate intrusion of privacy with out cause or for personal reason will be intolerable and criminal, but risk management studies must be conducted to determine the liability/insurance issues and indemnity policy for personal performance for these inherent tough decisions. Additionally rational limits for damages have to be determined and standardized for real-life accidents and unforeseen equipment failures.

The second block termed “Customs” layer is an example of all the individual government agencies law enforcement and security departments interface Layer. The flow is interactive and multidirectional throughout all the layers and all the directions through all that is interface. However, there are responsibilities, procedures and protocols to be determined for this interaction.

The four big blocks below the second layer are the basis of the TSA matrix to monitor movement and mange that movement. These intranets for the FACT Security matrix are only indicative of all the intranets public and private that will someday be interfaced. Transportation applications have been chosen because the management of movement is basic to security to push back our borders and internally continue to enforce our border policies. This is a flexible and doable architecture for Homeland Security. The concept being good efficient traffic management in all transportation platforms and their choke points frees up movement (helps the economy and provides the infrastructure to support seamless security throughout the nation.

All agencies/department intranets responsive in the FACT security matrix will support a FACT registry operation applicable to the to their appropriate regulatory duties. The four intranets shown in FIG. 18 are displayed here for illustration purpose not to be considered a final inclusive design. DOT alone with FAA, NTSB AOC, etc would be just some of the agencies for the AIR FACT intranet displayed in FIG. 18. All these separate agencies or responding sub set intranets would have message capacity to the other agencies in the other blocks. Additionally, these areas are also chosen for their basic commercial and industrial design to be the basis of support for the hardware interface platforms (PFN/TRAC router unit) at the component level

The local first responder bar or bottom block is part of this local WLAN or portable network that is receiving automated FACT event alerts do to Preprogramming in the individual PFNs. They are also receiving data from FACT TSA Security command. Specific scenarios and responses have to be projected an determined in an on going process to develop the most optimum and consistent results and use of the PFN/TRAC system and FACT Security program.

FIG. 21

In viewing FIG. 21 from the far right column the wireless Tainer talker sensor and any 1Ps stand alone sensors are represented as transmitting their data to the various PFNs (left) for repeating gathered data and alerts into the PFN/TRAC machine messaging system and FACT security matrix of communication networks. Even though communications down to the wireless s1Ps sensors can be two way to instruct the unit to rerun a systems check and cycle any sensor array one way little blue and rd arrows are used to show first system notification or the monitoring embodiment and have a platform to describe the accountable robust management FACT can provide.

Data is retrieved by the 1Ps and the regular PFNs and with respect to the application and the wireless technology employed by the user programmed to go to one of the normal gate ways vie the wireless service (either RF. Reflex paging or cellular for the most part) These are represented by the network clouds left. From the PFN units in the prime mover recognizing a FACT alert and providing their exact GPS position and ESN data to the FACT software layer in each or any of the different wireless providers the signal can be cycled to the appropriate first responders and the appropriate TSA intranet Land, Sea, Air and sub networks and agencies as well as, appropriated commercial and public communication medias (to be determined in procedure and protocols. The solid lines and the color red is used to symbolize FACT two way links. The other broken and lighter colored lines represent normal pathways of wireless and IP service and PFN/TRAC's general machine messaging to deliver data during regular operation and management of machinery. All intranets have a FACT security layer and are responsive to data being processed application specific and can flag a FACT event and upload or download processed data as a FACT alert emergency action message or EAM message.

Data Messages have all the ESN and GPS or address information in headers for how the data packet was handled and allows for the immediate link to a specific PFN asset in any of the responsive intranets from any of the TSAFACT command and control centers via the direct FACT access via the involved communication provider. For an example if a DRC PFN from the tractor trailer hauling the container reported a Tainer talker radioactive hot box condition the initial wireless link would be direct it to the land TSA intranet the Interactive highway, police EPA NRC and the first responders but also OnStar or Highway Masters server would respond via the resident FACT security program recognizing the FACT alert and delivering critical data on the Prime mover and all the electronic equipment and capacity available via the DRC PFN unit on board the tractor. If private networks operate their own wireless hardware or network cloud they must have a FACT layer for this application and be connected. (*In the case of OnStar they are already connected to the 911 first responders however the complete FACT SECURITY MATRIX IS ESSENTUAL TO DETERMINE THE COMPLETE PUBLIC SAFETY THREAT with regards to national security. This commercial link is shown as a lighter dotted line delivering the essential command string software for TSA/TRAC land intranet station in homeland security or the first responders to take a handoff and perform accountable remote control and retrieve real-time data directly fact direct Connect (any OEM Key codes for this siNgle machine or all GPS placed relevant equipment are downloaded to FACT immediately for federal access and control of traffic management and remote control (Onstar control is out of the loop—this is better for insurance and liability reasons as well). On star would continue to provide commercial service to these same vehicles in this area but default to FACT control as required.

Dedicated cellular and or reflex paging is planned for long distance remote control—commands will be in a progressive relationship with OEM collision avoidance and PFN/TRAC robotics. PFN/TRAC system will initially develop the Reflex paging technology in it's architecture for the great power to deliver a signal deep inside a building and the capacity of the PFN to support extensive programming in the sophisticated mini computer. This is the asset of having a Trusted remote Activity Controller and router geographically spread out and all timed together by GPS. Limited data streams need to be transmitted for greater local processing (more robotics less RC). However multiple wireless are employed for redundancy to increase reliability and because the architecture can support them and provide better commercial routing options for EAMs. With each wireless protocol stack having a FACT layer each end can process the EAMs or RC machine message commands in their fact layer no matter how their sent immediately in a isolated IP GPS synchronized timed connection (FACT encrypted of course)

Note: The development of FACT commands have to be developed by DARPA, ARL and security electronics contractors. This is stated and out lined in other PFN/TRAC filings. Government agencies will ultimately provide FACT registries that keep a current track of all operating electronics on every machine vehicle aircraft and piece of equipment. Some of this will be done by the Telematics service companies like Onstar as well as the programs they are selling, but this is to be a national mass data handling and storage process. The reason for this is to control the risk factor of bogus electronic parts interfaced to the PFNS and used to violate Homeland security and public safety with this nations own equipment. To accomplish this, the key codes for all the software/Firware (software imbedded hardware will be developed at the highest level of national security and a process for for programming authorizing a component, part or product for use will be accomplished in final assembly check plants in each nation by nationals that are authorized. This will help provide local jobs with global free enterprise.

As earlier stated the United States government will be responsible for overseeing the commercial development of this tracking and component identification programming and the checking process is to be a customs operation funded by the importers and buying public as well as a portion of the resale tax automatically collected via the products identification established with the new owner for the life of the component. Additionally the coding will be agency specific to Identify the product to the governing agency and their registry as well as identify their access and quarries. This process is also done at the local level in the PFN itself and is the initial check point for system integrity checks for the life of a machine or vehicle. On every start up periodically and for the installment of a new component the Part ESN has to be checked and or approved via the remote governing agency registry before service of the component is permitted. A Fagged event can occur from a registry down load to the local PFN (e.g. radio reported stolen from another vehicle's DRC PFN to DOT/FBI UCR for stolen cars and parts program) or because the component has not bee given a legitimate FACT code to operated in the United states from the United States Custom's agency. Proprietary to the PFN/TRAC system is the incorporation of GPS receiver chipsets being installed in all new imported and domestic vehicles and a firmware program switch that turns off the car within 20 miles of the nations boarder and only the customs agency can give command to the vehicle to operate.

It should be apparent to the reader that Telematics could easily be used a s a weapon against the United States and the PFN/TRAC system is full remote control and robotics and there fore must lead the way is safe manageable and accountable wireless machine messaging. This is why the unit is protected in an encasement that is tamper resistant and detective

Returning to the drawling; the red bar to the right is Homeland security (HS) TSA/FACT TSA/FACT matrix bus of DOT networks for Air, land and sea transportation. FACT applies to all government agencies and they are to be integrated with in the FACT network as applicable, but this DOT security matrix is quint essential to national security today and exemplary of how the PFN/TRAC system operates. The top TSA FACT intranet is Air and to the right are the individual servers, some are agencies and some are commercial servers. They all have FACT interfacing and the commercial entities enjoy a slave relationship to TSA/Fact directives.

Normally, IP protocols and internet connections are doing regular PFN/TRAC management business helping to recover portions of lost shipment between freight forwarders, delivery companies, haulers, port authorities, rail systems via the interactive 1 Ps tracking aan telemetry sensing portable network of PFN/TRAC units. At all times data is recovered and run through automated assessment programs looking for public safety and national security fags through out he entire FACT network. The PFN/TRAC system is a developing movement management system with individual clock synchronized via the GPS updating of GPS coordinate packets. This can be done for stationary assets as well to determine fixed locations. The 1Ps devices or minute wireless units will have their positions identified via an automated triangulation algorithm using multiple confirmed GPS readings for Larger PFN/TRAC units.

FIG. 22

This figure is used to show the application of the PS1 commercial sensor or the HS1 homeland security sensor. If a sensor is activated by radiation energy, the sleeping system is energized inside the container and it's self contained storage battery energizes the TR1000 mini transceiver as directed by the micro processor and it's firmware to transmit an Alert Signal with critical data to the M-PFN marine Primary focal Node interfaced with the ships E/E system, and informs the ship's crew and the rest of the world by repeating the signal to Satellite communications using ships power locally interfaced as a protected transceiver (PFN) to be repeated. The signal is addressed to the wireless FACT Sea gateway/server and is distributed to all relevant agencies and interests and or directly to preprogrammed responders, locally. The same is true in aircraft and terrestrial vehicles providing real-time global monitoring with real-time electronic interdiction through the Control mobility devices.

For the development of the Marine PFNs all the frequencies are provided in Appendix IV, however the FCC has much work to do in the standardization of emergency frequency use to assign band width to all the applications. Much is done but there is more to do. With this in mind the first marine PFN prototype would be developed by using INMARSAT. It would be the most likely candidate for the initial or proof-of-concept development, due to its commercial availability. DOD applications would follow after the proof of concept with this commercial system. Development of top level requirements would be included as part of any initially funded effort, along with device level specifications, and ICDs that would fully specify the specific electrical and software interfaces. This development effort would include several phases; 1) Development of Requirements, including B2 specifications and other top level requirements documents; 2) Architecture development based on phase 1 requirements; 3) Concept review; 4) Detailed hardware and software development; 4) Implementation Review; 5) Fabrication of the system, and integration and test with the target platform (INMARSAT). Sea to land communications—In Mar Sat planned for the proof of concept

If PGP encryption is ok the system will service ASTM international and US standards or ITRAP the Illicit trafficking of Radiation if not DES

Then probably DOD applications

Develop top level requirements

Interface Connection Document need to be determined

PFN relay will be developed on a PC 104 platform—unix software—terminals PC with The HMI will be a windows application except on limited LCD displays in the personally carried pagers—which will be in a sequence of windows

All of which there are product developer kits from computer and software manufacturers, however it is intended for the FACT security system to incorporate Army military code writers in Oklahoma to write the national operational code for the highest level of security interface and operation.

Much of the application Figures have their technology already defined in the related Appendices

FIG. 23

FIG. 23 This illustration is taken from earlier related patent filings Appendix V and VI and shows the Transportation machine matrix with a world of machines having PFN/TRAC units communicating with wireless intranets and being connected to a TRANSPORTATON MACHINE MESSAGING network including the FAA. This was planned for long before 911 and government has been very slow to look a systems wide approach to networking. Even this one that allowed each network to function independently, but with coordination at the first responder and at the national level in real-time.

These intra nets provide for greater equipment management and traffic movement as well as improve the data acquisition for government agencies. The system provides greater government service to the public, quicker Public safety notices, quicker government response for emergency services.

Greater coordination between government agencies and tighter communication and understanding between industry and government is a doable fact of life for the next century. The world can not afford another century of warring over limited fossil fuels to enrich the greedy and perpetuate the paranoid who would hoard and profit. Reasonable fear has to be replaced by individual knowledge and understanding that develops into healthy respect and joint cooperation between people, cultures, different beliefs and nations.

Accountability and respect for an individuals freedom and rights to include privacy is incorporated in the procedures and protocols to implement this technology in a democratic Society like the United States, but no matter how technically easy it is to individually participate—the individual still has to have the courage to be with others and participate. The good news is the technology exists to help most all with the exception of a few sociopaths.

However, a nation that allows itself to be entertained solely by Reality Games on TV is like the Romans of OLD watching gladiators in the arena, and the fixation of wealth accumulation for power and control as a successful life model in the United States is the paranoid playing on every individual's fears. Hamiltonian Economics was forced to deal with more limitations in the nation's beginning economy to jump start it, and Jefferson and others warned against the effect it would have on the individual out of check from a good and fair value system.

The US needs more knowledge and individual minds working to cut the bonds of the oil addiction that has been the most active force in every war for the last century. This invention goes a long way to getting there. Through expanding the economy and increasing employment to developing known reusable energy sources and keeping critical awareness of how the process is going to make mid course adjustments.

This figures operation is explained in FIGS. 20 and 21 in detail and through out the specifications appendices. The next figure introduces a waste recovery and recycling patent filing Appendix X using the commercial PFNTRAC System.

FIG. 24

This figure is from the tenth Appendix showing the PFN/TRAC Management with FACT Security used in the waste industry. It is exemplary of most all industries and how significantly they can be connected into a local and national system. Here every piece of equipment is reporting to this industry operational center in windows format. In a FACT event or emergency not only would the corporate notification be in effect but the specific FACT intranets in FIG. 20 would receive direct data from the PFN and also via internet IP connections with data systems as detailed in FIG. 21

Returning to the Figure

This figure displays all the equipment interfaced with PFN Relay controllers both in the recycle company and in the Trash or refuse operation. The recycle over the road vehicles include straight trucks picking up straight loads of paper from printers low security offices via laundry carts, boxes and gay lords. This also includes; Office Destruction recovery and recyclables, where in one modality mobile shredders shred on location, lock down and carry back to the center, with an electronic file generated of all the waste disposal truck entries. A certificate of destruction and transfer is printed on the truck for each customer and the responsibility for material handling is transferred to the recovery center vehicle or trash hauler servicing both the customer and recovery center. Further with locked office containers and a secure personnel program to retrieve either locally pre-shredded or undestroyed sensitive waste in bulk from office space and load that waste into a secure hydraulic compactor container monitored and controlled by a 1P/E PFN unit controlling an electronic locking and sequence door, which also requires operator identity conformation and provides video surveillance as well as, generates a certificate for the secure handling to the recovery center. This way the most sensitive documentation can be handled by standard waste trucks doing normal pick ups and routes. In some cases other bagged garbage can be handled in the same container if the space is available. The recovery center is a licensed Office destruction center bonded and certified to handle the waste in the legal and appropriate manner.

Retuning the PFN/TRAC System monitor management screen tractor trailers both bring paper from big waste paper generating companies like printers and they deliver waste paper fiber to mills for the recycling operation or company, shown as a 180 degree operation through the plant in FIG. 2. These vehicles are equipped with the 1 SV PFNs that are interfaced with the trucks electrical CAN bus system (J1939 or later edition) and additionally supports various sensor arrays, plug and play scanners, wireless communications and vehicle controls. The trailer has a 1P Wireless sensor suite with its own Identity (ESN) and data storage record for loads. Entered electronically or manually by equipment operators via their personal PFN key pads their equipment PFN key pads or a connectable or wireless key pad/PDA(all of which are detailed in related PFN/TRAC filings. The PFN Trailer sensor suite has its own battery back up but also can be recharged by the trail's electrical bus.

The drivers also have an audio edit capability with the PFN and these PFNs communicate via cellular and wireless telephony to the PFN/TRAC system computer network (Any computer network set up with wireless responsiveness for secure and safe material via monitoring and automated handling is an direct infringement on the invention and its nature and scope). Truck drivers are wearing wireless biometric monitor systems responsive to their 1P personal PFN units and the surrounding data redundant repository files stored in the larger equipment PFN processors and data storage components. Emergency Action Messages and software flags can be sent system wide to all responding PFN units to download and respond for past present and future events. A system wide search can query all units or per an reply request sent out for information the individual PFNs can respond by sending data back to the requestor and the systems secure communications data bank in the center.

The personal PFNs monitor driver alertness and allow the driver communicate with his rig and the computer network tracking his progress. The drivers of the straight trucks can be equally equipped personally and to the right the Trash company or refuse operation are so equipped allowing for the rapid rerouting of vehicles to recover paper fiber more efficiently out of the waste stream. The open top tractor trailers are equipped the same way and the drivers are listed at the bottom. The Drivers are set up like the clamp operator where if they leave their seat and are more than the safe distance from their truck the vehicle shut down sequence will activate. This will occur with out an authorized operator at the controls.

(Full detail of each of the PFNs and PS1 sensor arrays are contained with in the specification and related patents. The use of the PFN TRAC system is restricted specifically to this recovery center application and also requires further licensing from Richard Walker).

In The Plant

In the plant the skid loader, forklifts, clamp trucks all have 1SV PFNS. These are automotive relay controls and wireless repeater stations and are defined in earlier related applications. The ASIC shown and defined in this filing (FIG. 19). The balers, belts, scales hogger, pallet shredder, wood chipper, power plant, bagger machinery will employ equipment controllers like Westinghouse 1100, Brady Allen etc; they all have 1E PFNs interfaced with their factory controller and they have the same circuit as the ASIC in FIG. 19 which can be connected to, to perform new and or isolated functions on the host machine. The first vehicle units will use PC104 architecture and progressively develop to a minimal set of chips and finally to SOC technology or systems on a chip. All equipment is linked to the control center for their respective operations as well as IP linked in the desired network and for FACT Security if either standardized and or deemed mandatory for national security.

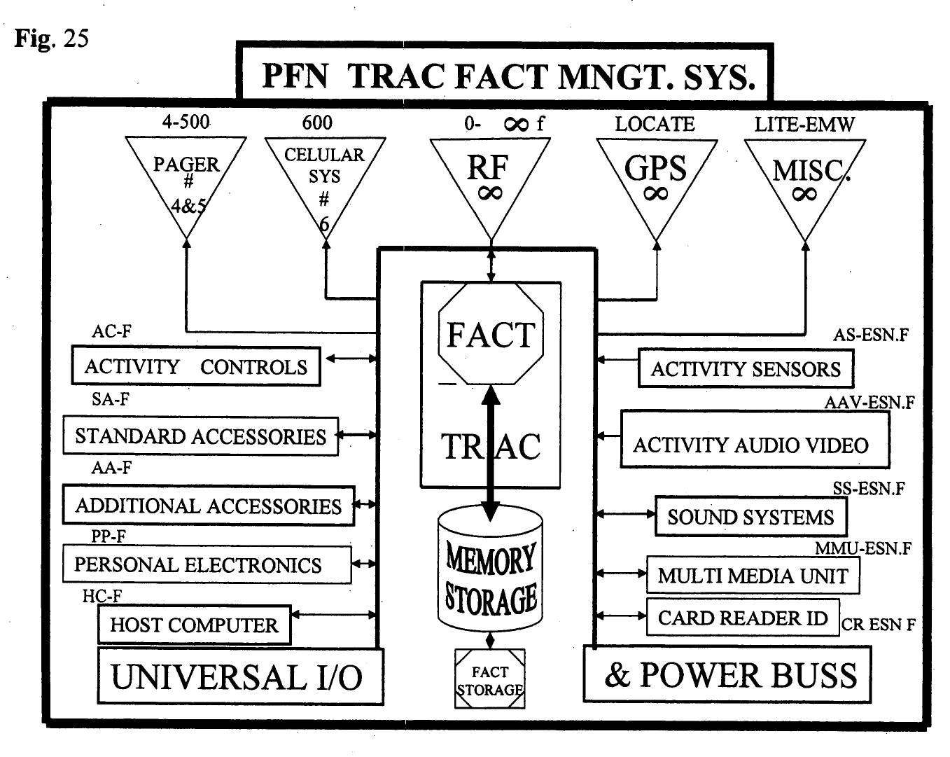

FIG. 25

FIG. 25 first appears in appendix V and VI but has been placed here to show how all electronic wireless devices can be kept track of. This is especially important as they will be sharing machine controls with individuals and the major reason for System accountability.

From Appendix VII Aviation FAA Registry would function as follows:

Regular system checks and PFN system data downloads are performed by authorized service and maintenance centers for the APUs and PFN emergency power packs. All aircraft components essential to flight and PFN/TRAC/FACT operations will have these service integrity checks run on their performance, and these downloads will also go to manufactures. There is a FACT system auditor/inventory program locally run on the aircraft via the PFNs and a system wide redundant backup program done nationally/globally for everything that flies in commercial and general aviation via the FACT Registry discussed in figures, 38, 39, 40, 41, 42, 43, 44, 45. This portion of the FACT registry is to be operated by FAA,TS.

Preliminary FACT FAA Tracking Registry Program.

Basically, the FACT registry tracks the use of electrically interfaced components and any equipment desired inventoried on the aircraft PFN file (e.g tires type lot number) as a quality assurance program, and quick security and safety comparison check. A running program in each IA PFN aircraft checks all known components to be on board with no alerts downloaded from FACT AOC/TSA registry during pilot ACARS, during any service of components and periodically. New item recognition is flagged data and routed to the specific center for analysis.

For example, a suspect piece of baggage is evaluated through the airport terminal FACT flow data base and appropriately responded to, while an aircraft circuit or new transmission is processed through the FACT FAA central registry and compared to known inventory and assigned RF equipment) In this respect It can be used to counter terrorism, antitheft and monitor the sale and resale or reuse of aircraft and components, much as the FACT registry is used for terrestrial PFN/TRAC units for automotive marine and rail vehicles and products. Additionally required are specially qualified service personnel and controlled progressive program with security clearance for all work perform as authorized service will have to be in place for service on any PFN/TRAC units and their responsive components operating in any FACT portion of the system. Ultimately, all PFNs will be operate in conjunction with the FACT system for national security in a transportation matrix.

This is a general flow chart of a self contained PFN TRAC/FACT management system that will be utilized by every piece of equipment. PFN=s may have all the listed components or any number of them; however no mater what is electrically interfaced it will have to be approved and registered as it is activated or deactivated. The very first triangle at the top numbered 4-500 refers to the one and two-way pager systems detailed in the FIGS. 4 and 5 of an earlier patent application detailing the pager interfaces like reflex I and II discussed in this application. These pagers as is true with all components will ultimately be provided FACT software to identify their activity and especially for those technologies that are responsible for providing communication data for remote control activities.

The second triangle is for cellular phone systems more sophisticated communication systems and capable of handling and delivering very good data signal but narrow band Good enough for video, etc. The 3rd triangle 0-infinity frequency refers to any and all kinds of Radio Frequency equipment including DSRC

The 4th triangle with the word locate can be either cellular phone proximity tracking, GPS, Lorands, LoJack or part of any interactive highway control system or master surface transportation net work and system receiver and/or transceiver. Along with this locate system triangle the 5th triangle is a miscellaneous communication receiver and/or transceiver that is responsive to light, sound or any discernable electromagnetic wave or transmission.

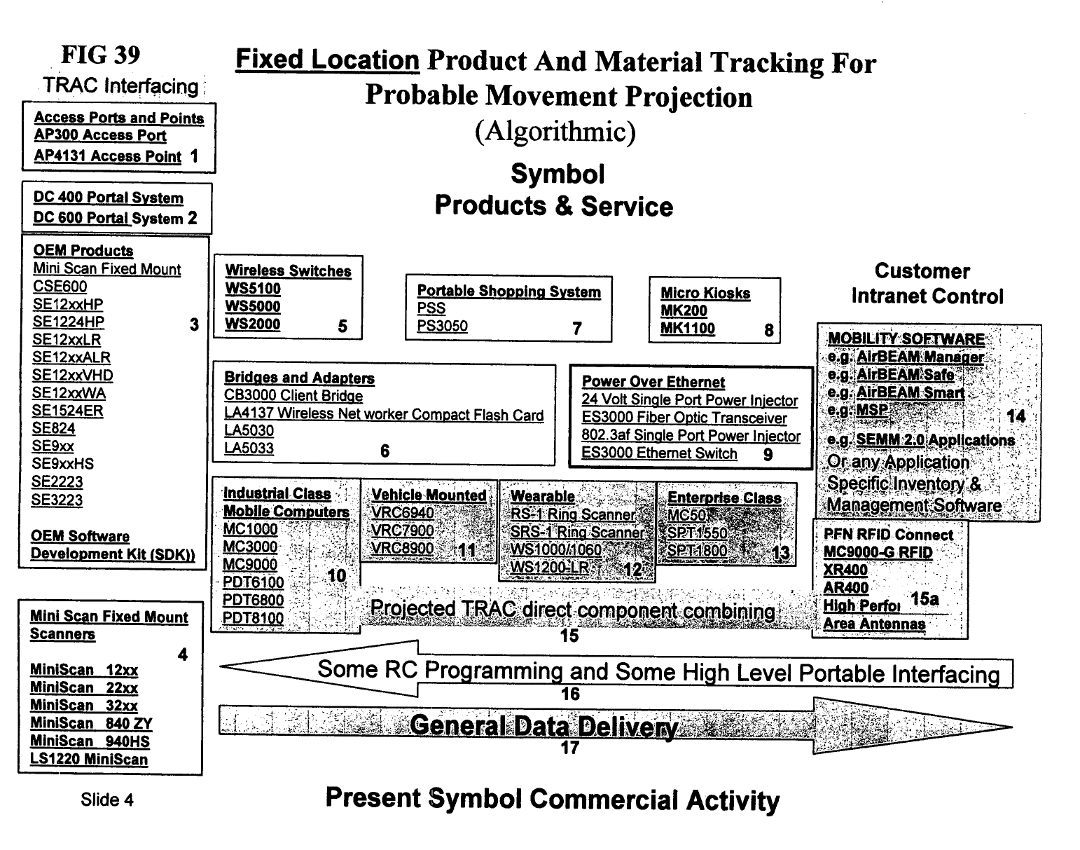

All of these PFN communication triangles devices or modalities shown as upside down triangles are not shown in FIG. 39 as having a FACT chip but they would also be provided with FACT software to report their activation and any specific role played in any remote controlled event as either as a receiver and/or any type of transmitting device. As is displayed in the drawing they are connected to the uni-bus connector O/I/it could be a plug and play multi-pin docking station for hybrid chipsets with a modem and transceiver circuit etc. Any interface components that connect to the circuit are recognized by the unit and ultimately the entire FACT registry system via inventory integrity checks run locally and systemically. This first happen as the interfaced components connect to the PFN/TRAC controller/router and accompanying memory storage units. There is software with the resident FACT program to compare interfaced component electronic ID signals upon install, boot up and periodically. This local fact program can be updated and the TRAC is capable of storing and retrieving data back from its accompanying data storage. As detailed through out earlier related applications these PFN control circuits are sophisticated mini computers with extremely efficient processors like the various PC 104 boards. (from earlier filing). The TRAC processors are explained in all the technologies and are subject to the Improved capability and speed in processors is in the major reason for maintaining a flexible pug and play capacity to insure flexible updating for future and legacy technology. TRAC has a modular based programming of which FACT the Federal Access and control Technology plays an intricate and unique role in recognizing and reporting new interfacing. These programs are run by the PFN min-computers and they send their commands and direct the data received by the uni buss to the appropriate data storage. Either a hard drive or the specially preserved non-volatile FACT memory that can either be down loaded or physically removed to be used in a court of law in the proper manner as determined by any rule regulations or laws governing evidence and its acquisition, preparation and presentation for a society.

Both on the left side and right side of the uni-buss is all the interfaced controls. Accessories, personal items and electronic possessions and alternative data communication devices. These devices are coded in the upper corners with the initials or first letter of the words that describe their boxes as examples of connectable interfaces employing the individual FACT Chip. This becomes more evident in FIG. 39 where the bottom of the page supplies numerous octagon stop sign shapes filled with these same initials indicating FACT applications and tracking. Also before leaving FIG. 39 it is important to remember that in the ram memory of the mini computer the Fact ESN will be stored for all memory devices and the memory will always require the processors ESN or any comparable ID technology for any further or final review by the appropriate authorities or to comply with any legal proceeding.

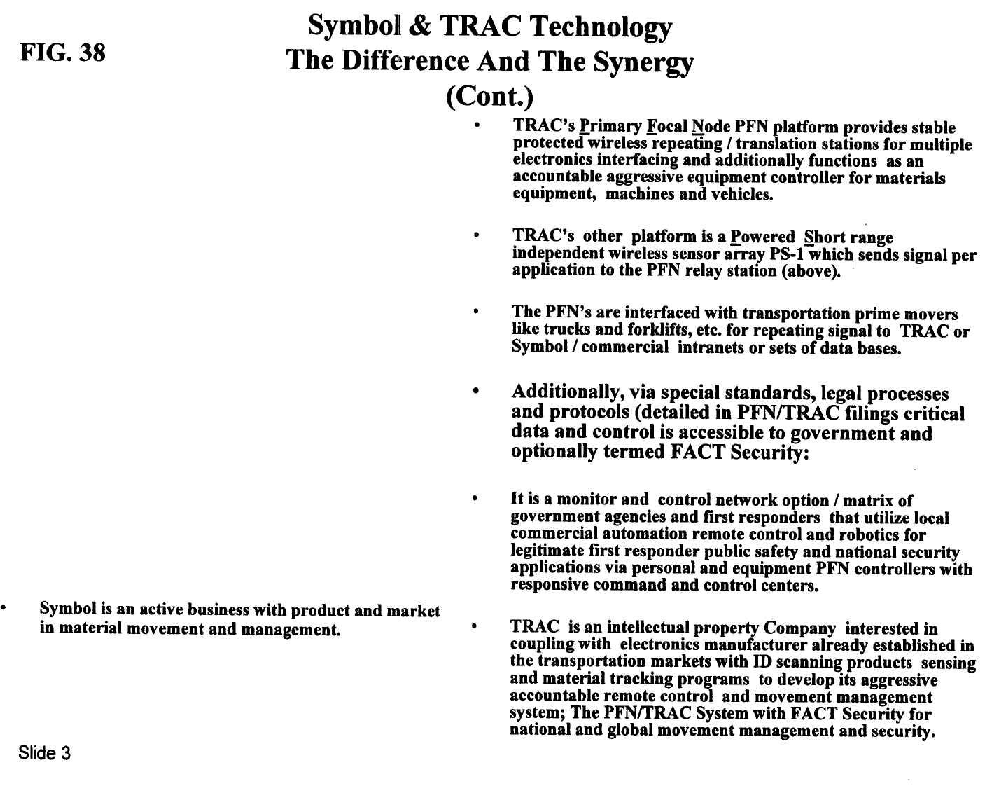

It should be also understood that this universal Buss can extend outside any protected area with the immediate electronic protected capability to recognize and protect against any deliberate shorting or questionable interface. At the bottom of FIG. 38 the universal buss illustrates its capability to handle power as well as in put and output control transmissions. It is also important to make clear that this involves a universal secluded antenna buss or reception will be provided for by certain types of physical structural elements in the PFN=s structure to allow for patch antennas or physically small profile antenna structure to function with in any standard regulation or legally prescribed manner.

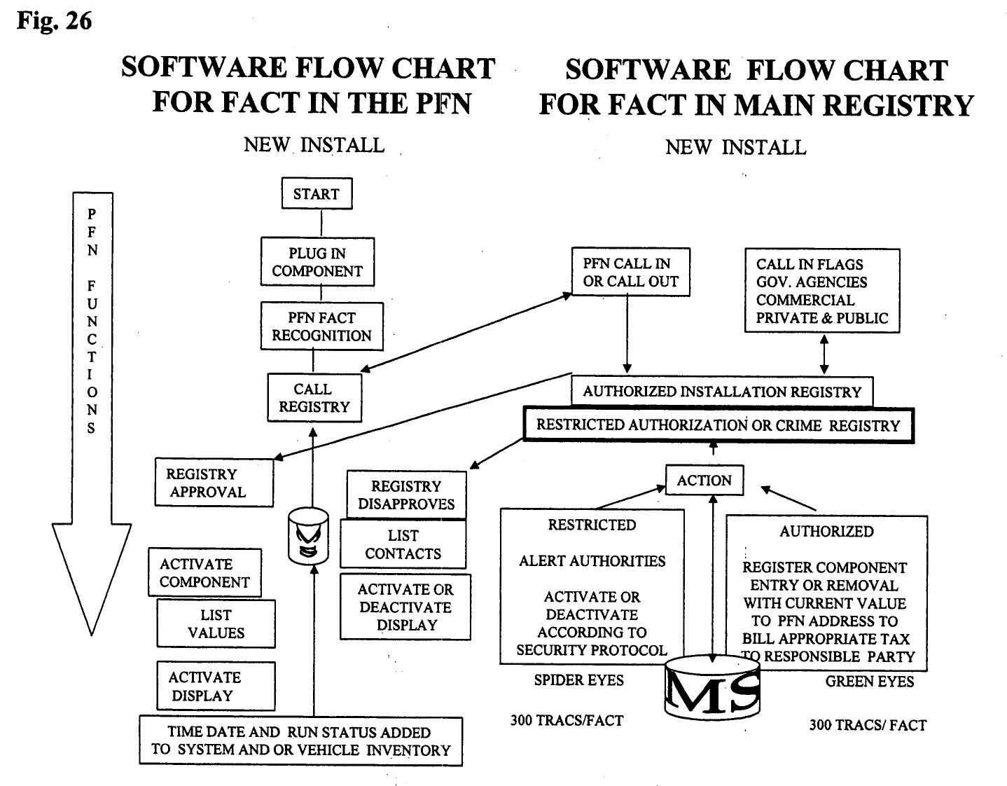

FIG. 26

This is a flow chart to detail FACT software in the PFN on a host piece of equipment and also the interaction with agency FACT software programming in the main registry. For a new install the process is started by plugging the component via one of the discussed interface connections (Refer to Appendix VII, IX). As illustrated by the second block down the PFN/TRAC/FACT software recognizes the Components Fact chip and calls a predetermined number. The call in number can be a commercial server or a public provided node that access the specific agency national registry (either locally first or vice versa or simultaneously as detailed earlier. The right half of the page is exemplary of FACT operational software in the main registry system. This is at both the national and state government registry system which do clocked data updates to maintain uniform integrity throughout the system. The call received by the PFN data generated from the new component check process compares the ESN and manufacture data to OEM supplied registry lists and known crimes of stolen property entered in the registry by citizens and the automated UCR and IBRS programs converting voice recognition recordings generated in the onsite police investigation into a digital signal and text if desired from a DRCPFN repeater in the responding police cruisers. UCR and IBRS are FBI justice department crime reporting programs in existence. Their forms and format would be automated as a bases for their report operating program. The data would be dispersed at the local level by the crime coding already established to reduce over loading the system. FACT event data would be proprietary and statistical would be assimilated in local accounting programs and passed on in data bundles at off times.

If all is clear the registry approval is given and transmitted back to an approved registration program in the PFN. The component is listed as its appraised value is taxed and shown on the display for the operator and/or owner of the host piece of equipment. The same redundant data is sent to the appropriate governing revenue agency intranet and a tax bill is prepared, unless the operator decides to pay in real-time with either a credit card or bank debit card in the card reader on the PFN. In which case the electronic payment is sent to the cash receivables database in the Bank for the state treasury and National IRS if appropriate. In any event the entire transaction is timed dated and the run status is added to the inventory list of the vehicle or piece of equipment. If hard copies of the transaction are required a return E-mail address can be sent to a home unit for printing or memory storage or printed on location from the PFN or downloaded to a laptop or portable printer. If a component is flagged with an alert it will be accompanied with specific software commands or additional alerts depending on the severity of the situation. A simple theft protocol might activate the unit normally with out notifying the user and alert the appropriate local authorities to the location of the stolen property and then regain custody of the stolen property and inquire as to how the person in possession received that property. If there is a Terrorist alert to a particular component as soon as the person installs the unit the alarms will be activated in all emergency responding agencies and even kill all power to the PFN and/or set off alarms and warnings. (if this procedure and protocol are determined desirable) This depends on the nature of the emergency and will allow for on the spot real-time commands to augment any response. As mentioned earlier FACT can provide a stealth eves dropping mode so that operator owner and occupants can not tell that they are being monitored and/or recorded but this access mode will require a signed judges order and his personal real-time access codes derived from a synchronized pin number generator to electronically sign the writ or search. Once again any miss use or abuse will of this access activity will be accountably recorded and encrypted locally and in remote locations and abuse should meet with the most serious criminal and civil penalties. This activity is for FACT Homeland Security or severe public safety threats from known dangerous criminals. Freedom of information act will apply to any legal own of their PFN controlled equipment and they will be able to down load their individual memory that will show a complete access and use of their system coded with the agencies ID (local and national as well as for commercial access) (In light of 911 these exact applications and use have to be review but the nature of any abuse should not be minimized and the most profession use should always prevail

The Exception is the court/FACT-ordered stealth surveillance: All normal government contact with personal or private DRC PFNS or other commercial contacts must first announce their access, to be recognized by the own/occupant and agree to the open communication process or it must be a time of national emergency, marshal law or a crime in progress. In any event all will be recorded and accountability will be part of any process to use or not use the PFN record as evidence in a court of law. The exact use of recordings and the preceding announcements or Miranda rights will be part of a legal standards effort. Also a redundant record will be kept in a remote location either in a licensed commercial FACT server or in government mass storage. These systems are detailed in earlier related patents. As the spider eyes and green eye software programs. These are the law enforcement (spider eyes) and environmental analysis programs (Green eyes) of the FACT Security program detained in earlier related patents. The Fact program will basically be operated with the Justice Department the FBI IBSR incident base Reporting system and The UCR the Uniform Crime Reporting system and it will be part of this technologies Spider Eyes system and will be totally accessible to local law enforcement and even the general public through national state and local agency editing as justified and presentation on the web or for public media notifications (PEAM and EAM messages).

However, all crime activity will be given ID=s either IBSR-UCR or local and all data can be retrieved from the mass data in any discovery to make everyone accountable for all decisions and use of data including editing from the public.—MS is the mass storage in the TRACS/FACT system. Basically this drawing is self explanatory and I have outlined in writing what would be incorporated in any software algorithm as well as how humanity will be able to legally use this technology in a constitutional way. The deliberative process with the public should be fully engaged and the extent of personal privacy invasion should be closely monitored known by all and mirror The homeland Security threat codes. Red Severe, Orange High, Yellow Elevated, Blue Guarded, and Green low.

Obviously what actions are warranted for which level of threat requires further exploration with those skilled in public safety and national security and a good hard look and understanding by the public at large—This security portion of the technology is all about trade offs and freedoms and responsibility. With, that said this inventor joins responsibly with his fellow citizens to make the hard choices and work hard to minimize the negative impacts on our freedoms and rights.

FIG. 27

This figure will detail the registry system in general. At the very top of the page is a small box that says World Organizations. This is the present state of World affairs with the national government agencies in control of the data involving any and all mechanized civil and industrial uses of equipment and any impact data specific to national sovereignty. Ultimately the PFN TRAC system can help to develop trust and fair play in the use of the worlds resources and equipment as well as free humanity in an efficient manner. When humanity matures past present survival fears and accompanying paranoia to address only the real fears of peaceful co-existing the PFN management system will serve its greatest function. However, now it is best used and developed in the individual nations to reach this point of world peace. As communication and understanding is increased the natural sharing of data will take place and is already transpiring on the Internet. For the present all government agencies will serve to clear all PFN data that is earmarked for their attention through the National Registry and be responsible for its dissemination worldwide. The Departments of Defense and Homeland security will have control over all questionable data for final release at the highest FACT Command level. This is to include the National security agencies the President and (any congressional national security committee advisement group?). (this is regularly an Executive Branch operation and function of government)

This is why the big black triangle ends up with National Government Agencies for security. Additionally, taxation can be performed directly from every PFN (Sale and/or use tax) for the state and National government as has been described and addressed in earlier applications. Also credits can be applied back to the user or citizen for any community service performed by their equipment via the accurate accounting in place Also aid can be applied with re-education programs carried out through PFN terminals for industries going through retooling wear old job skills resulted in lay offs. These attributes and commercial products and new industries are detailed in related filings. The bottom of the triangle has LOCAL GOVERNMENT in big bold letters. This is done for two reasons. First the local node (Subset of intranets with gateways and servers will keep cost down for Registry networking. The great advantage to the PFN/TRAC system supporting the FACT registries is that the PS base of Processors and at each level allows for data and processing to remain locally responsive from the PFN to the mass data systems to service the existing dispersed networks immediately. And second regional state and local government is the agencies that impact the individual in most cases. As has been detailed in earlier filings all the government agencies are now maintaining web pages and data phone nodes and through basic routing using ISDN and high speed fiber optics (Cisco routing Systems) the capability for these agencies to process data and network efficiently is excellent. Data management for local regional and national Data base connectivity allows for fast local discrimination of data as well as provide much more data storage locally making the general availability of data in the intra nets much more responsive to web information products for the public or through the media while separating the sensitive data from the local PFN and through out the system. Below the local government registry are the FACT Management & Memory for commercial servers. And to the right side the same FACT Management but provided by public provider nodes. The difference being that individual commercial servers will be providing more fee for services from emergency service to computer down loads and the public nodes basically will be for government services FACT operations. Basically the PFN will use both systems commercial and public. It will do it automatically at the local PFN level via pre programming. An important note is that both these systems TRAC and FACT will provide accountable memory as does the PFN at the very bottom of the page which is responsible for activities performed and authenticating the activities. As shown and discussed in FIG. 39 via land line wireless and satellite communications.

FIG. 28

This figure is from an earlier related filing. It provides an example of Software flow between a National FACT registry for governing agencies and an individual vehicle or equipment PFN (PFN locally routed regulatory specific). Understandably many more interactions between the PFN and any linked data bases for Homeland Security are possible and predicted as part of any national registry will develop. The processing result for homeland security will determine the agreed upon proper procedures/protocols with respect to National security and individual rights to automate actions to nation's alert system. This process will result in standard responses, programming and code writing by those skilled in the art to match our civil rights with automated legal response and use of the technology for public safety.

This inventor strongly urges his fellow citizens (and will do so personally) to monitor the use of the system and technology (and other similar technologies) to see if the technology use meets with security needs and or current public safety risk to protect and preserve the nation and our most valuable assets “The People their US Bill of Rights and the U.S. Constitution”.

In this figure and others MS or memory storage (for accountability) is part of the PFN/TRAC System and PFN application specific circuit. PFNS are dispersed locally and the registry is to have transaction memory as well in the mass data bases of the registry matrix. This is for accountability and for freedom of Information. This design element is stressed to keep the technology in check with The Bill of Rights and US Constitution in near real-time. Reducing the need for any presiding war powers act like the Patriot Act (in the future and keeping congress also in the cat bird seat in any real-time loop of war making to help any president with difficult decisions. This way decision making in terrorist wars is still a democratic mandate that is under constant review by the people and their representatives. It is not fair for us as free responsible US citizens to stress the limited capacities of any one individual to make such grave decisions that effect the entire nation and world when we have the technology to participate rapidly, rationally, individually and though our representatives as planned for. Our forefathers recognized the limited capabilities of the individual to continually see democratically and therefore provided for the separation of powers in the constitution and by installing a bill of rights to protect us from each others—self absorbed mentality. The PFN/TRAC System has been designed to provide awareness for most all command and control decisions and to incorporate the public voice in the process.

Early in 1995 The inventor realized the merging of technologies communications and computers would result in greater remote control and robotics and has been hell bent on ensuring that accountable management is in place for national security and public safety. Already envisioned was the dangers from sabotage and terrorism for a more automated transportation system with wireless controls. This is the main reason for the PFN/TRAC System to allow for professional and respectful use of data mining and ultimate equipment and vehicle control over communications and transportation.

The inventor attended TRB conventions and DOT meetings and pushed for acceptance of an accountable remote monitoring and control via PFNS locally linked to existing intranets (just six years prior to 911). This drawing is from one of the earlier filings and calls for the recognition and integrity checks between PFN units and the PFN/TRAC registry system. Basically the figure deals with how to track, detect and ultimately (via remote commands) thwart un safe, unauthorized or illegal acts to in include high-tech terrorism.

Above shows the install of a FACT programmed device reporting it's PFN interface location and use for a system wide integrity check. Each PFN locally reviews it's running inventory of interfaces and equipment and periodically performs integrity checks with the national system. e.g. detecting vehicle component interchange and or theft of component use. But more importantly in the application against terrorism provides the means to recognize altered communication and processor components as well as perform better data mining for professional and respectful authority to use.

The registry identifies all functioning components locally and through the network matrix of registry

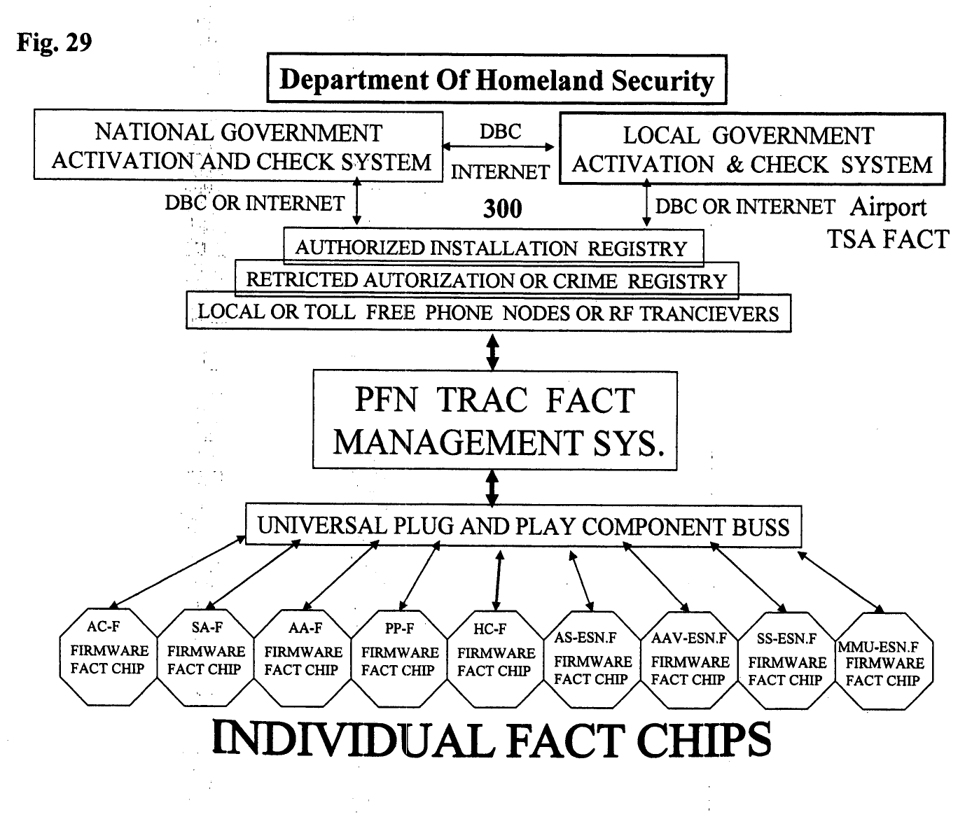

FIG. 29

At the top of FIG. 29 there is a box to the left called the National Government Activation and Check System. From there—there is an arrow showing a Data Base Connection (DBC) or a world wide web Internet connection (encrypted if applicable) with the number 300 above indicative of any local and regional network as is evident between the left national box and the box on the right side of FIG. 38 which is termed Local Government Activation and check System. These most generally are the primary sources to PFN supplied data and/or to act on any SEAM, TEAM EAM and or PEAM messaging data received that involves National security. However, simultaneously data is delivered to the National Homeland Security FACT command center if FACT fagged an event in the local PFN or at the regional level. Otherwise the data is delivered to the specific intranet operating the specific FACT regulatory registry for registration/activation and integrity check clearance for use of a component or piece of equipment with a FACT identifier chip or registry requirement before registration.

The National Registry will be a large routing system for mass management with a FACT alert data share processing and storage protocol in each system server/computing center, PC terminal and PFN/TRAC unit. All responsive levels of processing will handle data in a prescribed and secured manner through the 6 transparent IP layers to the appropriate seventh FACT application layer (or hybrid higher layer to be determined) where it is transposed by the specific agency intranet codecs and tracking software applications to include special encryption with agency specific message coding and personal identifiers (pin codes) for secure but accountable access to private and or sensitive national security data to maintain professional processing and storage in every data base. This will be the same for all forms of communications wired and wireless as they are processed through their respective communication centers to IP gateways via the licensed wireless and IP data providers and servers, through the landlines, fiber optic cable systems or land cable systems from the PFNS in the field to the individual databases. First for accounting and billing but most importantly to serve the and provide the management of the agencies Intranets FACT registries and services to the new to be formed Department of Homeland security

The center three blocks are the technical connections and primary functions of the national and local registries to provide the specific government service Intranets, to develop security for the nation and provide better public safety and build trust within the populous, as a result accountability, fairness and just policies and practices. This is a safe guard system for man and machine messaging that should be review able by all of society.

As stated earlier Internet dialog and media awareness for mass and individual input will spawn a much more involved individual citizen and functional democracy. Obviously some critical FACT event data will be maintained at the highest of security levels and may never be shared with the general public. However there should be a review process in place that protects the publics interest and involves the balance of powers to determine if nation a particular issue withheld is a National Security Risk.

Note—The inventor also suggests that one man and one women should be randomly chosen by the social security computer, per issue to serve with an Executive branch representative, legislative branch representative, a representative from the supreme court, and the two random citizens for a total of five. These FOIA issues forums can be called by the populous petitioning for it on a regular ballot during regular elections or any of the three branches calling for a FACT event issue to be disclosed and at one branch refuses to comply. Of course procedures and protocols need to be developed. Back to the Figure

The first center block is termed AUTHORIZED INSTALLATION REGISTRY. This may be a network of secured computers in different locations or it might be one system in one location( at first it will be dispersed and it might well stay that way by the serving agencies responsive to FACT Homeland security but not housed under the same roof so to speak. The inherent account in system allows each agency to prove their involvement and participation and yet maintain sovereignty for the duties they were created fore. The inventions purpose is to create a realistic functional modality that can create this national and local registry progressively and in the best configuration and to maintain a level of flexibility and redundancy to protect and secure and safe public government and continual service. Specifically for the Transportation industries to insure good and safe movement. The Actual structure of course will be part of a large standards and on going effort and civil legislative effort.

Total purpose goal: The base system is to create a national directory of all products sold and re-sold in a country to better track their impact on economy, resources, environment, health and infrastructure all around the world and at the same time to allow nations to have a FAIR frame work to develop and use imported products, which are needed. The PFN system can help to develop trust to insure an accountable answer to all of Societies legitimate concerns first for individual survival and then to be part of a mutually healthy co-existence with all of humanity. The Authorization Installation Registry function is to record and make available by request and/or to recognize any PFN use of an electrical device in conjunction with the PFN and first run a compare function to any and all legally known produced, and legitimately marketed products in a legitimate sovereign locality through local and/or toll free telephony or RF or MISC. communications technology employing isolated network connection and/or the Internet (IP). To agency specific intranet registries.

The authorization installation will require a complete OEM specification and description that can be used to specifically identify individual devices and/or components. Requirements to be determined by the sovereign nations. This data will provide depreciating value levels and integrity checks that will be beneficial in tracking use and varying performance for securing public safety. Also the depreciation schedule will enjoy a diminished cost of operational tax relevant to the products prior use and/or time of use. This provides a use tax not a sales tax for governing structures to apply to real time use. These generated fees are fair and just and help defer the revenue generated by fuel taxes to lessen the economic need for a gallon of gas or barrel of oil. This frees the Internet to trade and free communication for general transactions and allows for the legitimate taxing structure for actual impact on society=s infrastructure and environment by machines and the work they do.

Shaping the Economy for Greater Security

These are some of the transition mechanisms in the PFN/TRAC System It is to function as a economic tool to provide commercial feasibility and opportunity to exploit alternative energy sources and not just continue to pay 41 cents a gallon of gas in tax to support our road system. The invention provides a quality of life and an opportunity for the oil invested money to peacefully reinvest in other PFN measurable commercial energy technologies. This single event would do more to bring peace to the middle east and stop humanities 100 year wars over “who owned the oil economy” (and Power). Now that would be a security system, and the best use of the invention in the mind of the inventor. And we could fly planes on hydrogen converted from water (H20 in real-time) and the WTC 911 event would have been reduced to a crash with a splash and 10% of the losses.

Then again we might have the same relationship with the oil rich countries that help delude the minds of the 4 substitute pilots on 911 either Security sounds better already. There is no doubt good, fair and just management of the world's resources, and environment is the best security. And management that shares knowledge and opportunity for an improved quality of life can sell and be the best export product we have.

Back to 29 upper center the second block is the Restricted Authorization or Crime Registry. Once again this data is supplied by everyone and anyone but primarily cleared and reviewed by the national and state or regional governing agencies maintaining their intranets and servers. The really great part of this section of the system is that the private individual can in real-time participate in a personal injury theft by telephony with scan data or through personal contact with law enforcement agencies. With total accountability all parties will have to face their own actions in the proper legal settings. And basically there will be no use or miss-use of stolen property.

Basically, the stolen parts or components when interfaced with a new vehicle or piece of equipments E/E system are recognized by the local PFN or DRC, etc specifically mass contacted by the governing industry registries that are always uploading missing material data that is in turn down loaded in to the specific PFNS that always runs a system integrity check on parts inventoried or installed to the unit and or interfaced with it. This also allows the FACT System a base to analyze the equipment that is being used in the country and be on the look out for anomies or FACT event Flags, for an example; the Department of Home land security has a bus blown up do to a specific type of wireless device attached to the DRC PFN carryon device. The DRC PFN protected memory recorded the DSRC blue tooth program contact with the cellular device and the apha-numeric signal sent to trigger the explosion. This recovered data and all similar ESN devices would locate and check automatically the total ownership and recent sales along with suspected perpetrators and dispatch this information to first responders as well as kill the services of all suspect wireless and retrieve them from all known locations if this was deemed appropriate. Additionally, manufacturers will be encouraged to install in their firmware an integrity program that FACT alerts the unit if there is tampering detected. The third center block deals with the communication capability. Ideally this will be accomplished by toll free telephony or RF nodes for the public in using the publics=privately owned equipment and PFN link ups as a hospitable commercial service with all other gained accessible service options and provided free by government or public providers for the tax and public interest provisions. The 4th block in the center of FIG. 39 is the Protected Primary Focal Node or PFN created as a protected electrical interface platform to merge, focus all host equipment=s, accessories and component=s power and control circuits into one local accountable control and communication center. This PFN on every vehicle or piece of equipment is then linked, coordinated and managed with all other machine use and activities by a greater mass communication and management set of computer network systems (through RF, telephony and nodes or gateways) either for surface (land and sea) coordination and/or for aviation and for TSA and homeland security all inclusive.

However in this figure we are concerned with developing an understanding of the FACT software in the PFN and/or possibly individual CHIPs that are at the bottom of the page as octagons or (mini-stop signs). Once again these might well be in the form of physical hard ware and read only firm ware or they might be integrated software programs interlaced and inter-reliant on the PFN/TRAC/FACT security encryption both in the PFN and in the National Registry systems. What is nice with the PFN/TRAC unit and system is that a multiple wireless routing translation station is coupled to computer terminal to have the same versatile receiving and transmitting power and capacity on both ends of the network. This forgiving architecture provides the opportunity for incredible versatility interfacing of all sorts of electronic technologies and with the traceable links reporting and recording function totally accountable a real deterrent for hackers.

Through out this entire drawing, FIG. 39 there is descriptive of two-way communication form the individual chips or FACT programs to the national government activation and check process. However, the PFN gives the commands to the individual chips via the universal plug and play buss. And retrieves their essential operational data e.g. ESN, and/or MIN and production Identification and seventh layer application security instructions in the ISO OSI networking Model. If for example a stolen audio or sound unit is connected to the uni-buss of a vehicle. The PFN computer will signal or request information from the individual FACT chip in the sound system (SS-ESN-F). This can either be sent by isolated control hardware (wires, etc.) or by sending a modulated digital signal on one of the power legs or it can be accomplished by short range transmissions if this modality is employed in future wireless vehicle and equipment control systems to ease plug and play capability and reduce the need for so much hard wiring. No mater the means the PFN will inquire for an individual fact chip as soon as it senses current draw. If there is a change in current from a normal operational level the PFN will request and/or review vehicle conformations for any trouble codes logged in the charging system or any battery draws or charging problems. This is performed by a TRAC software algorithm and standard current sensing micro chips in the uni-buss and in the host equipment=s electrical system, which can generate either analog or digital signal that the PFN/processor can receive and recognize through any of the above in vehicle communication modalities. This current sensing system is part of an anti-tamper system of the PFN. It will give driver alerts to the abnormal draw unless an individual component FACT chip sends an ESN and data signal that is recognized for a specific authorization or security protocol. At the very least all components can be individually judged for their current draw and reported to the display or checked against their OEM manufactured specifications (Data delivered by the individual FACT CHIP to increase security that a component has not been altered after manufacturing. Even a individual resister chip like that used in the present vehicle keys could be installed secluded in the board with the FACT Chip to add even greater security and integrity checks. While this idea is creative and new the technology to make these combined innovation are available as electrical components and any one who is skilled in the art could from reading this section create the necessary circuitry to complete these security tasks. All the components are listed through out my related patent applications for the trickster circuits and the security seal activation switch. The universal plug and play Buss as always stated will have to be a standardized effort for the most optimum development. The little octagon stop sign FACT chips at the Bottom f the page have letters on the top of the sign like AC-F which means (Activity controls—function). These correspond to FIG. 38 left and right blocks. Once again all the components operating in or though the PFN will have to have FACT chip identity capability, communication processors, data storage as well as all these listed that access the uni-buss. The RFID technology can be imbedded into a circuit board and maintain a component memory function for the life of the component reporting to the DRC PFN directly or via any other device interface or other PFN or as quarried by an RFID reader capable PFN. (These applications of RFID and other COTS tags and smart chips used to track component use if done for an organized theft detection of electronic devices and parts self reporting to a computer network or security registry as described is considered proprietary to this technology and within the nature and scope of the invention. (All applications outside Commercial air travel and air transport industry require additional licensing and coding for accounting and billing by the prior related PFN filings)

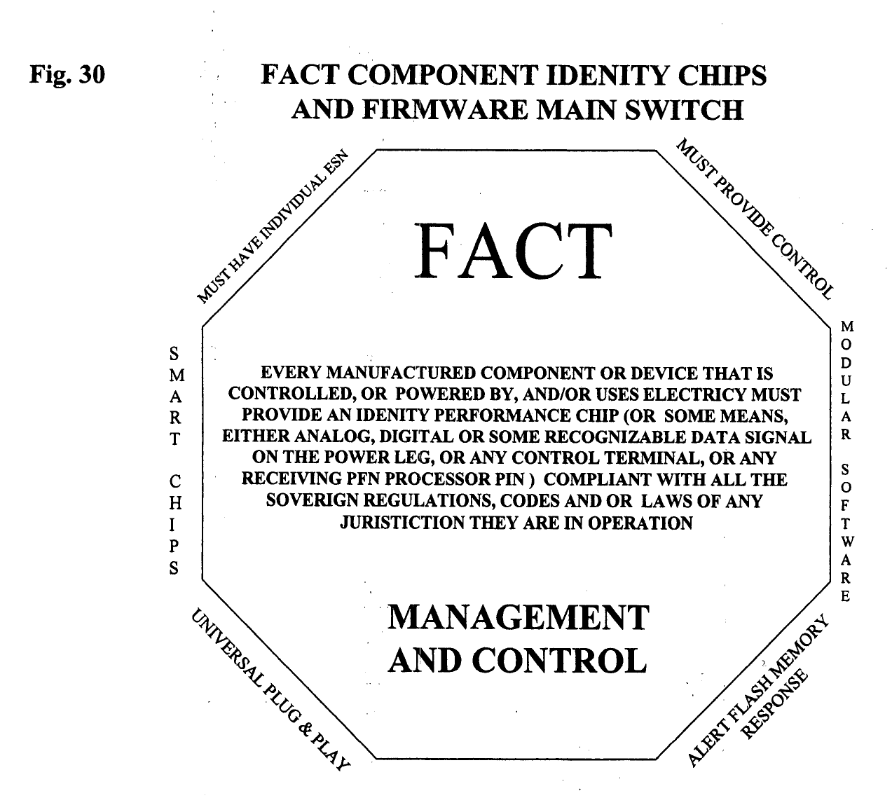

FIG. 30

PFN/TRAC/FACT/ESN Operation Basic to the concept of operations of the TRAC and PFN, is a unique Electronic Serial Number or ESN, which maybe either installed by a device at the manufacturer, or programmed at the point of sale. Every component, device or subsystem within the accountability matrix (Local PFN) has an electronic identifier and in some cases a secure electronic power or processor cut off for FACT function. The ESN allows each element within the matrix to be securely and accurately tracked, inventoried or controlled, either through a local control loop or remotely, by an authorized FACT application or agency. An example of a remote application might be local law enforcement personnel disabling a vehicle being chased by police officers. In many ESN applications, proper security measures would obviously need to be taken to prevent replication or copying of device or system ESNs for the purposes of fraud, unauthorized control or interception of data, or other criminal or terrorist activity. The FACT ESNs would also be the basis for digital encryption of information passed between the PFN device and the controlling entity (A National set of agency Intranets for a complete FACT Registry) with local network processing nodes through public communications channels such as the phone lines or Internet initiated in many cases wirelessly from mobile PFNs accompanied by their Mobile Identification Number (MIN). This technology is nearly equivalent to that used in today=s wireless systems and will incorporate many of the COTS encrypted security systems at the application level. Therefore it will require little research and development to implement; only modification of currently used commercial technology is needed to expand these applications of ESN/encryption technology to other areas (components, devices, equipment) interfaced through the PFNs. The adoption of standards that allow multiple vendors to inter operate is of primary importance and should be pursued in appropriate standards organizations such as the American National Standards Institute (ANSI), International Standards Organization (ISO) or others such as the Institute for Electrical and Electronics Engineers (IEEE) Electronic Industry Association (EIA) and Consumer Electronics Manufacture Association (CEMA). As well as all the industry specific manufacturers and their associations e.g. for Automobiles.

The PFN provides for flexible interfacing during this process but agreed upon standards to further refine and define the variables is essential The importance of security in these systems cannot be under emphasized. While communications privacy within the PFN matrix is a concern, it pales beside the threat of spoofing of such systems. Digital has virtually ended spoofing as was experienced with analog system. And PFN accountability will system hackers NEW FACT CHIP General purpose possible modality to prove feasibility Component FACT chips are a micro-controller chip and/or smart chip that is integrated and/or interfaced with a silicon switching relay in every power regulating circuit or send the necessary data signal for any and every electronically controlled piece of equipment, devices and/or commercially available circuit. The FACT system will be able to interface into any control circuit and restrict operation through a chip or software and direct all input signals to a designated onboard memory that is also provided time, date, location and the author of command (pin finger print ID or iris eye) as well as the command strings and all responses there to; be they automated or due to human activities.

The individual software will be capable through PFN interface communications to provide their stored data (firmware or flash memory to the National Registry upon a new installations and will be able to immediately in real-time report this data. Once the data is receive and processed it will be checked to see if it has tripped any alert flags. If there is no criminal or suspect security flags the registry will record the new FACT component installation with accompanying (PFN operating inventory)to the appropriate PFN file in the main registry and apply the appropriate taxes and fees for the product installation. This will be accomplished through a publicly provided registry phone none or a licensed and bonded commercial server that is registered and periodically inspected and reviewed to have and provide a secure Data Base Connection or encrypted Web connection with the appropriate government agencies (the National Registry, FCC, FBI etc.). This is all part of the Trusted Remote Activity Controller System. This FACT program will provide a secure command string and access path from the origination to any mass memory storage system that is search-able from the National Registry by any appropriate authority or agency. Some failsafe security for the system is provided by the component software of FACT at the application level establishing a handshake with local memory in the PFN and legitimate remote registry equipment and a secondary integrity check from prior legitimate registry contact data. (possibly a Random code number established in the last contact with the PFN and Registry.

The registry will provide all public providers and commercial servers with the alert flag data so any receiving system will be able to inform the PFN of national security alerts for potentially dangerous devices (terrorist altered components that could be used to activate explosives, chemical, or bacterial or viral microbes contaminants) through the commercial (PFN) remote and management control systems. Of course the appropriate authorities would be alerted to any of the national security high risk installation attempts in real-time. The immediate action could be performed by either predetermined automated protocols or by real-time commands handled directly by the appropriate authorities. Because, the exact piece of equipment can be ID by its FACT chip along with all its Original Equipment Manufacture OEM=s firmware (Lot No. and any security codes, etc.) and of course this would be updated by any additional or subsequent use such as re-sales, retrofits or re-installments. An accurate record shall be provided with in the chips firm ware or flash memory and in the national registry (mass storage to be either provided by public government or commercial servers licensed).

This process will be readily supported to provide tracking for commercial trading of legitimate products (new and used) giving government the economic taxing tool for real transactions and real-time product use for new and used devices components products and total equipment packages such as (cars). This will also allow for immediate component analysis for any criminal activity and a clear record of component ownership and use through PFN/TRAC/TRACS/FACT programming. TRACS/FACT programming will be issuing Stolen alert bulletins, and/or any security alert flag at periodic times for PFN=s to do internal integrity and security tests as this information is reported or becomes available. Otherwise, any device, system and/or component will be assessed for its legitimacy and real-time use at the time date location of installation along with the PFN ESN and whatever other data is determined to be applicable. At this time it will be appraised and billed to the responsible party for its use and impact on society, its infrastructure and the environment. Obviously it is necessary to identify the host piece of equipment, and, any and all components the new installation is interacting with, as well as, all interactions from communication devices, control circuits, actuators, and responsible monitors, control an or management centers all of which is recorded in the PFN secure memory (recording devices) for (accountability) and in at least one remote mass storage facility for accountability.

The primary purpose of this singular identity component chip is to track any and all use of the attached device and/or component that it has been incorporated into and to report any and all data in a complete and integral fashion, as prescribed by any code, regulation, law, and/or standard decreed by any sovereign or governing authorities. Number 2 in FIG. 16 is the SMART CHIPS and/or a magnetic strip can be provided as part of the components unit packaging and/or a bar code so that an immediate check of the component can be search either by a OCR scanner or a hand held magnetic strip reader. With the more extensive amount of data handled by smart cards and chips this is another inexpensive modality that will help in tracking and reporting stolen materials. A hard or plastic card would be issued to the purchaser of any TRACS/FACT device so that they could scan their stolen property data to the National Registry.

Number 3 is the universal plug and play buss inside the PFN containment that create the electrical interface platform for all the components. This buss will carry the appropriate power connection and control connections from the PFN/TRAC/FACT controller to activate, deactivate or specifically control any and all components. Power can be cut off to a specific component through the BUSS or it can instruct the individual components FACT CHIP to intercept power (power input or regulator circuit. All the electrical connections in vehicles and equipment are need of standardization and I have written to this in all my previous applications and these are areas that will be a standardization effort in each industry and/or application specific use of accountable remote and automated control. I have addressed how to complete these functions with present hardware connections firmware and software and have created some new modalities to interface all the present devices. However as shown in FIG. 6a the components and technologies are merging and this universal plug and play BUSS in the PFN is an ideal way to make compatible this electrical interface platform #4 of 16 is just pointing out that the individual component FACT CHIPS must provide firm ware or stored data of identity, OEM data, last application, etc. to comply with any standard or regulation developed for a national registry or any such security system. Because FACT is a major part of the main operating system in TRAC its software is also modular and can be in any form or hardware application. The hardware chips and firmware modality detailed in this application should in no way be considered the only modality to create a nation wide security and management that is capable of real-time control of individual components, devices, and equipment.

However, any other modality should be considered within the nature and scope of this invention. And this is area #6 of FIG. 16. The chip also can perform activation and deactivation of the component and that is what is meant by saying it A must provide control

Note: In the description of the FACT component in this invention as described as a chip, does not have to be in every case, It can be as firmware in a chip or software programs loaded. That way the best form of security for data management is open to each individual manufacturer=s best options with their particular products to provide this function so long as it is approved by any governing standards for this use. It is obvious that a physical chip could be replaced or compromised in its firmware so additional means will be utilized to insure security. Such as the random code exchange discussed above at the last legitimate contact or string of contacts with the Registry allowing only appropriate one-way communication at the time for the PFN compare list or component compare list is running to validate a legitimate registry contact or vice versa for the registry computers being accessed by a new PFN component application.

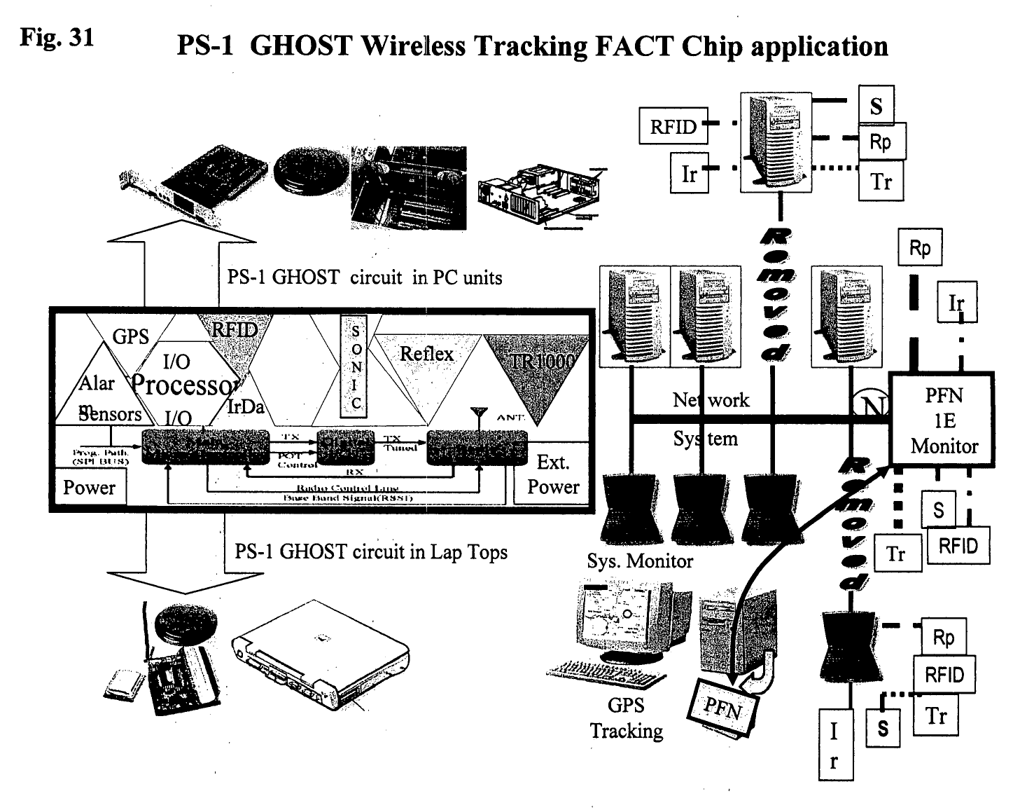

FIG. 31

One FACT chip application is the wireless GHOST Tracking circuit or auto reporting circuit of which the following is a technical description. The full technology is Appendix—patent application 125 and—and is included in this specification to support the system management claims of the PFN/TRAC System as an economic tool, environmental monitor, machine and equipment controller, transportation controller, material controller and proactive security system.

GHOST Wireless Tracking units are 1PS stand alone mini PFN units similar to the PS1 HS1 wireless sensor platforms. These tracking and telemetry transceiver units can be placed into any electronic device and provide GPS data to the unit with a number of wireless technology communication options. The center left rectangle in the figure shows a GPS chipset with miscellaneous sensors and local alarm functions interfaced (lights buzzer, beeper etc) in a triangle that interfaces with the Hexagon processor in the center. Earlier the types of processors are discussed and their will be some variation depending on the interfaces and applications desired. Below is a block and line drawing showing the interface with the CPU buss of the computer or laptop that the GHOST circuit is interfaced with. The sensor is monitoring the computer buss to detect the removal of the unit from the intranet shown right and termed the Network System.

The hexagon symbol for the processor has a GPS chipset interfaced RFID active or passive interface (Custom or in parallel). The possibility of an infrared transceiver interface exists if the host equipment is so equipped and an acoustical wireless communication technology is not used. All these wireless technologies are displayed as they are COTS technology in place to day. Another technology is the Barracuda and this technology could be used in parallel if desired as well.

To the right in the center rectangle are the two main wireless communications the 1Ps platform utilizes the most and include the, Reflex paging and or the DSRC TR1000 short range radio frequency technology discussed through out this application. The TR1000 is activated immediately when the unit detects it is no longer connected to the system and the GPS chip has detected a change in location (Additional motion sensing can be interfaced to initiate or confirm this occurrence). If the change is authorized and known the system can still track the unit on a calibrated map shown on the system monitor to the lower right in FIG. 13. In actuality any of the computer terminals or PFNS with displays interfaced in the system network and running the calibrated FACT tracking map programs with GPS and (APRS) and PFN/TRAC automated triangulation can place on the displays the removed computer's movement and real-time location (RF triangulation discussed in earlier related filings. Like in earlier applications the GPS data is sent as packet data that can be processed by either the Reflex Paging protocols via a chip set or modulated on to the TR1000 916 MGHz signal. The pager signaling becomes the dominate position and telemetry transmission technology out side the immediate material handling facility (i.e. port, freight forwarder, station, airport, boarder crossing, DOT weighing station, etc. with the exception of law enforcement or authorities performing spot checks or confirming checks for an Alert Signal on the road side or rail bed or rail yard etc.

However, the TR1000 can be used for close in recognition responsiveness to read the GHOST ESN and ISP for a lost computer located in the field. Other wireless telephony can be employed as well as, other wireless and the nature and scope of the 1Ps platform has been defined and described through out all the related patents this way. In the rectangle are shown squares for power on either end of the rectangle. And both above and below the rectangle are shown two applications for the circuit, which can be used to track and restrict the unauthorized use of electronic devices (in this case a Laptop and or Desk Top Computer). Above displays a desk top PC with the standard PC expansion boards and in this case the unit is configured as an expansion board with an edge connector. With this connection the circuit receives power for normal operations and maintains the rechargeable lithium emergency or backup power cells. The ghost circuit also delivers its identifiers to the network system via this connections and the firmware in the unit, which communicates to the protected network. PFN/TRAC unit is shown right center of the figure as a small square (right middle). This is a self-powered unit that communicates with all the units either via hard wire and closed common bus connections, whether the host unit is powered up or not or by the various wireless that are responsive to the universal PFN unit. Simpler less secure units can rely on the other computer units interfaced having tracking programs and registering the removal of one unit and the immediate alert for a tracking mode.

Obviously, a person desirous of defeating the system may chose to remove the board shown up top left and run out with the unit. Tamper detection and local alerts are employed as well as a protected power supply and mechanical compartment locks. More sophisticated electrical plastic heat seal and explosive die pack can be used to mark and detect a perpetrator and are detailed in earlier related filings.

Below shows the miniaturized GHOST circuit that is concealed in the case. Like all the PFNS and 1Ps units the amount of interfaces vary in quantity and type. However, the secluded Laptop unit will plug into the I/O connector and also derive charging emergency for the additional emergency back up batteries and connect with the computer buss to deliver to the system electronic identifiers. The resident software program in the computer will be conditioned to the specific interface and presence of the 1 Ps Ghost Circuit and will recognize if the unit is not performing correctly, like if the emergency battery is depleted. It reports this condition to the system via intranet and this GHOST software program at the first opportunity, to scheule the appropriate maintenance. Below shows the mini circuit GPS board, battery and transceiver. Wireless interfaces that exist either PCMCIA or Complete Card™ serial/plug and play chipsets etc are detailed in earlier PFN filings and these connections could be made, to drive and interface the GHOST units if so desired.

Concentrating on the right side of the drawing the intranet or network system is displayed connected to the protected 1 E equipment PFN/TRAC unit a bank of computer towers and a number of o laptops below. With a closer look one computer and one lap-top is disconnected from the network hard wire connection. As part of FACT or general PFN/TRAC security the PFN or any of the computers can run a systems integrity check via their Ghost Program and as a result discover that two ISPs are not present and that no signal can be detected in proximity. Immediately, there is an alert sounded and the paging company is given the specific electronic address and the GPS is initiated. Directly, below the laptop line in the drawing is the system monitor and a calibrated map to display the location of the GPS coordinates. As stated earlier the 1 E PFN can interface the DSRC TR100, the Reflex Paging, The RFID the Sonic/Acoustical or sound technology, the Infrared IrDA technology and any number of application specific wireless and telephony. This is shown by the differing dotted lines in frequency and form to symbolize the different digital or wireless pathways.

These separate technologies displayed in the five little boxes are around the removed computer tower the Laptop computer and the home base 1E PFN network unit if employed this way. This figure shows six avenues of communication with the removed piece of equipment via the GHOST circuit.

Obviously, some of these technologies exist today and some are used in computer theft applications, but not all are used nor is there the proper cross use to progressively employ greater security. The PFN/TRAC system FACT Security program is a progressive program. This 1Ps Ghost platform allows for the continual increase in security coverage over electronic devices for companies and government to keep better track over the use and movement of sensitive electronics and computer products.

Finally, the hard drives may well be the ultimate target of an unauthorized violation. Employing an earlier discussed FACT tracking technology, where space makes it difficult to install a ghost circuit a unique digital signal will be programmed into the drive permanently that instructs the receiving computer unit to contact FACT tracking and report host computer ISP and known location. However every effort will be to develop and install and or integrate a GHOST wireless SOC unit into the Hard Drive.

Further Technical Specifications

### Progressive Development of the of the PFN/TRAC System™ and FACT Security Embodiments

Through the PFN/TRAC writings a progressive development from Commercial Off The Shelf COTS products integrated and miniaturized as SOC technology is well documented. Added to this progression is the advent of super conducting plastics operation at room temperature as a hard ware evolution to be incorporated in the PFN/TRAC System in a number of ways. One is as a processor component to increase circuit performance and computing speeds; another as a power storage component functioning as a regulated current storage capacitor replacing traditional power sources like batteries, and to increase wireless transmissions and antenna propagations. Along with circuit function enhancement they will be used in high/low current relay scenarios to improve switching on present SCR technology.

Additionally, PFN technology for 1Ps personal PFN implants have been designed to be energized via the human body having voltage potential from contrasting metals of different current values set up by conductance through the body's fluids as an electrolyte and the body acting like a battery. The supper conductors at different conducting levels would create a much greater potential for electron flow and more energy. Also, planed is to use the implants to identify an electronic body signature as an identification system in an individuals body and form electronic libraries of individuals both from the implants ESN and from any unique signal generated and recognized from the implanted power components interfacing with an individuals body.

Tamper Proof Protection for Plug and Play

Plug and play interface feature: The TRAC monitors system current level and will recognize new COTS install and quarry the system through the E/E bus of I/O for any new signal to produce a digital handshake and record any received identifiers, drivers and software downloads from device firmware or display the need for such software or information to any possible operator. No response would signify a bogus interface or a trouble code and trigger the local FACT tampering/defected message back to TSA FACT PORT Command center, which is a sub intranet to the TSA FACT matrix for the Department of Homeland Security. The Port Authority would send security and maintenance to investigate the power anomaly on the PFN units E/E system, but a count of the trouble code would be monitored through out the entire TSA FACT Intranet. This is part of the automated tampering and anti hacking deterrent program Localized accountability and system wide integrity. Wireless communication to machine messaging from the PFN to Primary Mover for FACT issues is addressed by the specific patent applications and vehicle platforms. Initially it is performed with a FACT translation program called EAM Emergency Action Messages. In the family of EAM messages There is SEAM Security Action messages, Translated Action Message TEAM, and PEAM Public Action Messaging.

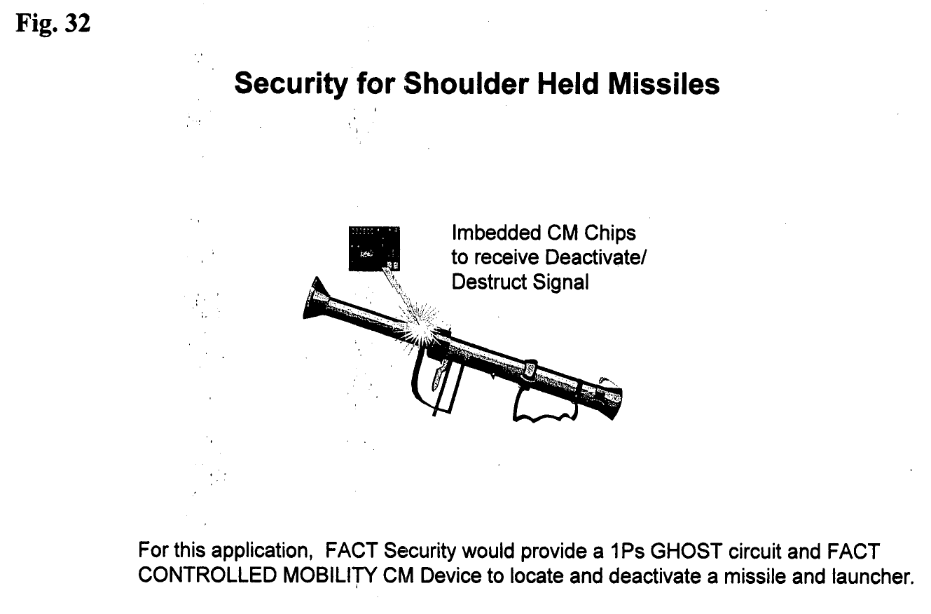

FIG. 32

Obviously, the use of military equipment in the hands of US Soldiers has to be fool proof and reliable. But if it falls into the hands of a terrorist it has to be deactivated as quickly as possible so it can not to be used against the United States or a civilian target. GHOST and FACT control mobility circuits could be the answer for this problem. This figure is supported in the Appendices already patented or pending, and the specifics to disguise and impregnate the technology is to sensitive to discuss further. However, the ability to locate and deactivate a military threat has wide reaching possibilities, and especially in the private agenda world that exists today.

Presently RFID is being used to track such devices for the JTC and their logistical branch the Military Transport Command, which relies heavily on commercial transport to get the job done. With a PFN/TRAC system in place with FACT security a complete portable sensing network through out the nation and around the globe the system will locate dangerous contraband, lost shipments and or stolen property.

FIG. 33

This figure was created for the presentation to control military equipment using Appendix I patent, Appendix III patent It is a simple to understand slide and used to relay the bases of machine control

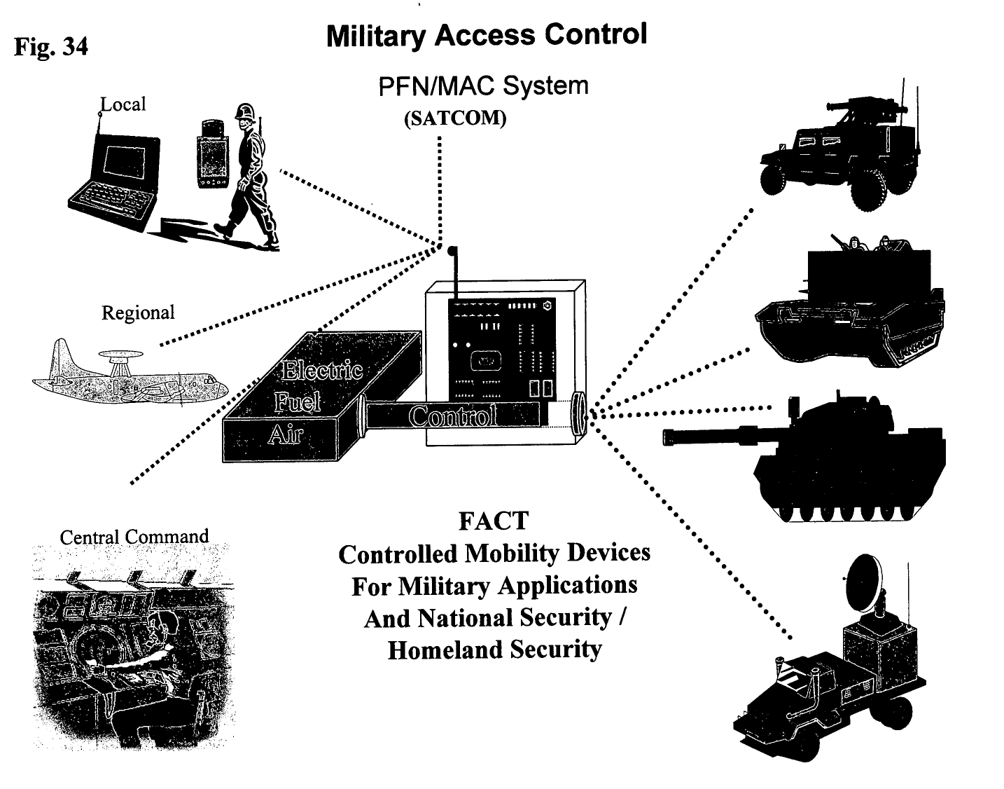

FIG. 34

This diagram was part of the presentation as is the next one. This diagram illustrates the termination of the air Fuel or electrical system by a signal sent by command and control or by the soldier protecting a military park in transit to the theater of operations. In a tactical setting the is removed or in disconnect mode. The protected circuit is much like a mini PFN.

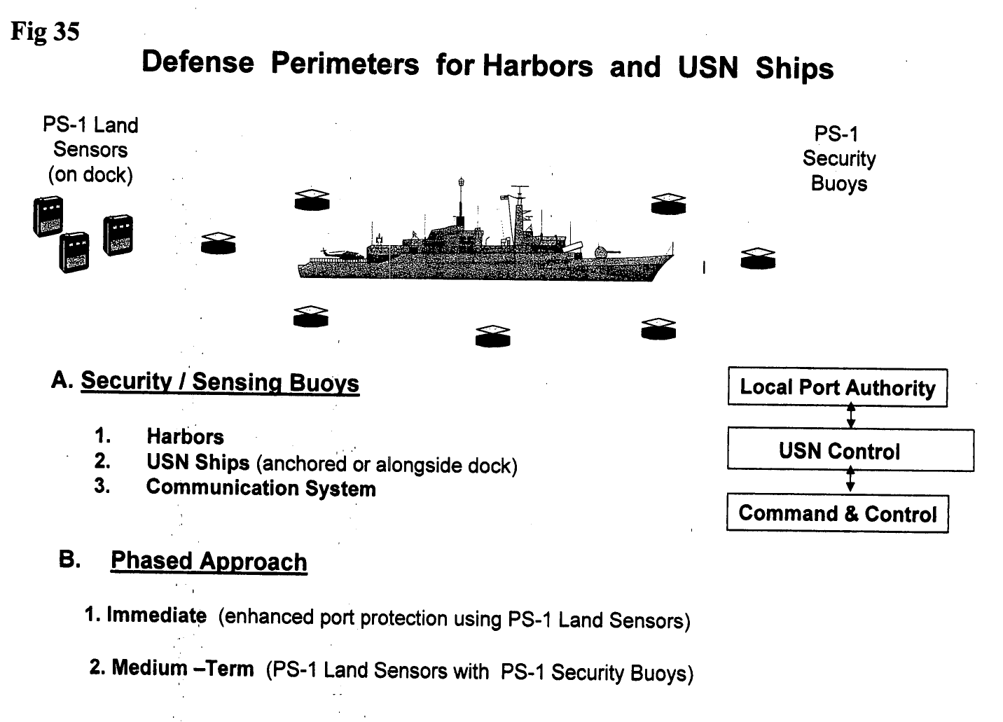

FIG. 35

This figure shows employing PS1 land sensors and sea Buoys and the technology for the PS1 is well documented in Appendix VII, VIII, IX and IX. These perimeters are shown here for a Navy vessel anchored alone in a foreign port, however the sensing and reporting can take place over a myriad of approved security networks for home land security if desired. This could add thousands of the correct eyes to a security event for the homeland. Remember this is not integral to the arm forces network JTC or Materiel Command and their use of data unless they so authorized that and the data developed from a specific ships set of sensors could be coded or given a command to transmit in a specific encryption for that ship or specific reception.

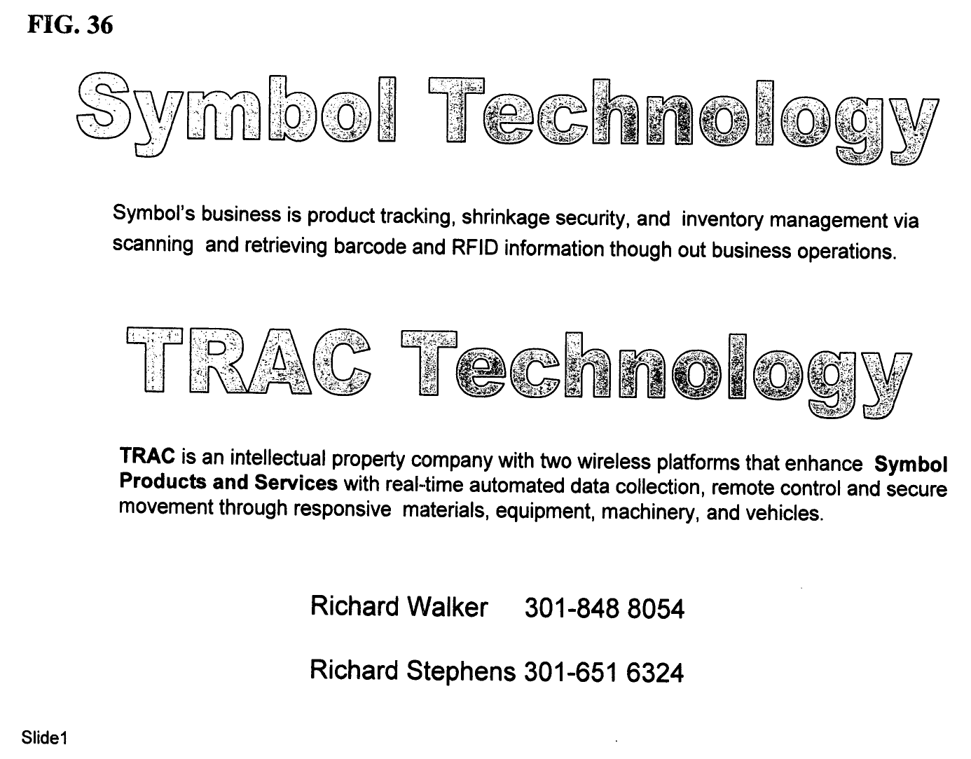

FIG. 36

These 10 slides are being added to this filing with no new material added. They just further the RFID interface that is under commercial exploration and development with Symbol and their associate company Mauru Benni. There are many companies making RFID and bar code products and TRAC Aviation seeks out all those companies in the market place to interface as such products as possible to track and sense people, products and materials and report or provide telemetry on their state/condition and movement for local and national/global control/security and management.

This figure/slide and the next 10 slides teach the interface of Symbol products in the PFN TRAC System Architecture to provide an efficient movement management System public Safety and National/Global Security for the homeland and abroad. This slide introduces the two companies TRAC Aviation and the PFN/TRAC Technology and Symbol Technology and products.

FIG. 37-38

These figures, slide 2 and slide 3 or FIG. 38 are a continuation of Symbol and TRAC technology differences and synergistic potential. The left side of both figures lists Symbols current attributes and the right side lists TRAC's attributes and synergistic interfacing to provide greater networking and use of data recovered via Symbol products linked through TRAC PFN Relay Stations for commercial and security applications locally, nationally and globally.

Symbol's attributes:
Symbol's focus is on product and inventory monitoring.
It performs passive movement monitoring and,
Projected movement management of materials.
It constructs monitoring data bases/intranets, to aid corporate management and increase product security.
It provides fixed location data streams with time data to its product ID and tracking data both, scanned and manually entered for commercial transport and transportation management.
Symbol is an active business with product and market in material movement and management.
Symbol is an active business with product and market in material movement and management.

And TRAC's Attributes:
TRAC's Primary Focal Node PFN platform provides stable protected wireless repeating/translation stations for multiple electronics interfacing and additionally functions as an accountable aggressive equipment controller for materials equipment, machines and vehicles.
TRAC's other platform is a Powered Short range independent wireless sensor array PS-1 which sends signal per application to the PFN relay station (above).
The PFN's are interfaced with transportation prime movers like trucks and forklifts, etc. for repeating signal to TRAC or Symbol/commercial intranets or sets of data bases.
Additionally, via special standards, legal processes and protocols (detailed in PFN/TRAC filings critical data and control is accessible to government and optionally termed FACT Security:
It is a monitor and control network option/matrix of government agencies and first responders that utilize local commercial automation remote control and robotics for legitimate first responder public safety and national security applications via personal and equipment PFN controllers with responsive command and control centers.
TRAC is an intellectual property Company interested in coupling with electronics manufacturer already established in the transportation markets with ID scanning products sensing and material tracking programs to develop its aggressive accountable remote control and movement management system; The PFN/TRAC System with FACT Security for national and global movement management and security.
TRAC's Primary Focal Node PFN platform provides stable protected wireless repeating/translation stations for multiple electronics interfacing and additionally functions as an accountable aggressive equipment controller for materials equipment, machines and vehicles.
TRAC's other platform is a Powered Short range independent wireless sensor array PS-1 which sends signal per application to the PFN relay station (above).
The PFN's are interfaced with transportation prime movers like trucks and forklifts, etc. for repeating signal to TRAC or Symbol/commercial intranets or sets of data bases.
Additionally, via special standards, legal processes and protocols (detailed in PFN/TRAC filings critical data and control is accessible to government and optionally termed FACT Security:
It is a monitor and control network option/matrix of government agencies and first responders that utilize local commercial automation remote control and robotics for legitimate first responder public safety and national security applications via personal and equipment PFN controllers with responsive command and control centers.
TRAC is an intellectual property Company interested in coupling with electronics manufacturer already established in the transportation markets with ID scanning products sensing and material tracking programs to develop its aggressive accountable remote control and movement management system; The PFN/TRAC System with FACT Security for national and global movement management and security.

FIG. 39

Or, slide 4 of the TRAC Aviation Presentation prepared for symbol showing the interface through the TRAC processor and system is completely detailed out for those skilled in the art and those concerned with movement management of man, machine and material for commercial efficiency, public safety and national security. This figure contains 17 points of interest as to the unique application Symbol products can perform within the architecture provided by TRAC processing. There are other manufacturers of wireless tracking and telemetry technology for people, animals, machines materials and objects that can interface into this same TRAC architecture and have been detailed in earlier filings. Always this technology remains open to interface as many manufacturer's products as desirable via processing their data/protocols locally in the PFN or PS-1 HS-1 platforms to the desired electronic addresses desired.

As stated earlier Symbol products like most all the other tracking and telemetry products today rely on fixed location scanning either manual or automated on belts to record package or item movement. They do not have real-time reporting of movement progress of the object through the transport process. Some software has been developed for this application that projects what the real-time placement of the transport object in the form of software algorithms. Companies employing this type of approach are UPS with their reporting Diad, FEDEX, and other large and small shippers. However, for public safety and national security this is inadequate. Real-time reporting of specific objects shipped to include certain individual's movements are a mandatory requirement for national security.

The Trusted Remote Activity Controller or TRAC processor accomplishes this and incorporates past, present and future products or Commercial Off the Shelf Products C.O.T.S. Products to make it real now and keep it current and progressive. FIG. 39 shows first Symbols Products and their interface with the TRAC System both for interfacing and in the shaded area for the combined hardware configuration.

In the figure in the upper left corner below the shaded subtitle “TRAC Interfacing”

Box 1

Low-Cost Next-Generation Access Point for Powerful Enterprise-Level Wireless LAN Manageability and Scalability

Symbol's AP300 delivers rich 802.11a/b/g connectivity, working in conjunction Symbol's wireless switches as the point of connection between your mobile devices and your wireless LAN. This thin next-generation access point is a low-cost device that is centrally and remotely managed through a Symbol wireless switch. Rapid configuration and the ability to quickly and easily upgrade the devices to support new functionality, features and security protocols substantially reduces the cost of deploying, implementing and managing your wireless LAN, while significantly increasing features, functionality and security of your wireless LAN infrastructure.

Deliver Robust Interoperability with Wi-Fi Wireless Networking and Support for Demanding Wireless Voice and Data Applications

Symbol's AP4131 Access Point delivers robust 802.11b wireless networking for your laptops, handheld computers and other mobile devices. With speeds up to 11 Mbps, the AP4131 provides robust support for voice and data applications, as well as interoperability with any Wi-Fi certified device. Scaling to accommodate additional capacity and coverage is as easy as adding additional access points. And a comprehensive suite of security options, combined with the ability to detect unauthorized access points protects your network, mobile devices and users against hackers and attacks.

Box 2,

Increase Inventory Visibility at Primary Read Zones

The DC400 Portal System allows you to accurately track every asset passing through primary read zones, and provides the necessary components to field a fully assembled radio frequency identification (RFID) read zone, including RFID readers and high-performance antennas. The DC400 is well suited for a number of applications, including placement at dock doors, security gates and custom-designed portals on conveyor manufacturing lines. And because the DC400 is rugged and IP54-certified, you know it will handle the usage and workload typically found in busy warehouses or large backroom environments.

Business Challenge: You need to quickly deploy an RFID solution to meet customer mandates.

Solution: With the DC400, you'll execute standard, repeatable installations with a plug-and-play portal package designed to speed implementation

Business Challenge: You need a quick and easy way to ensure you're able to read the RFID tags on products entering and leaving through all of your dock doors

Solution: The DC400's dual-sided RFID coverage feature enables you to easily install readers between your dock doors and includes integrated visual and audible alerts and alarms to report accurate reads to users

Business Challenge: Forklifts and assembly lines, integral to your manufacturing process, impose harsh conditions on antennas, readers and computers

Solution: You'll increase uptime (and reduce maintenance and support costs) with the DC400, because its rugged framework is built for industrial activities and resists damage from dust and water

Enhance Inventory Visibility in Small Warehouse and Back-Office Operations

The turnkey, enterprise-class DC600 Portal System offers you the ability to quickly gain visibility into your inventory through easy-to-deploy radio frequency identification (RFID) technology. It enables the real-time capture and update of RFID tag information into your enterprise systems while simultaneously allowing business process change through real-time alerting and alarms. In addition, the DC600's light footprint, flush wall mounting and ergonomic properties make it a good fit for multiple locations, including space-constrained environments.

Business Challenge: You need to quickly deploy an RFID solution to meet customer requirements.

Solution: With the DC600, you have a plug-and-play portal package designed to speed installation

Business Challenge: You want an RFID solution able to work in environments where a high volume of assets are being moved.

Solution: The DC600 provides sensor-controlled operational capabilities, which activate and deactivate readers to reduce RF interference and increase system accuracy

Business Challenge: You don't want to have to spend a lot of time or money managing your RFID systems

Solution: The DC600 offers remote management tools to allow you to monitor, control and manage your system elements from a central location

Business Challenge: You want to increase your responsiveness to inventory disposition by being able to make decisions about inventory the moment it enters your dock doors

Solution: With the DC600, you're able to configure its alert and alarm features to notify you when specific items such as high-demand, low-inventory or promotional stock enters your facility, or when certain events occur, such as incomplete or incorrect shipments.

Box 3

Mini Scan Fixed Mount

Provide Bar Code Scanning and Decoding with any of Your Mobile Devices

Increase the value of your mobile offerings with the CSE600. An OEM miniature, decoded bar code reader with an LED aiming system, the CSE600 is designed for entry-level, non scan-intensive applications. With this lightweight, low-power Scan Engine, you'll be able to easily add bar code scanning and decoding functionality to any mobile device, including phones, PDAs, pagers, attachments and plug-in modules.

Features: Small, lightweight form factor

Benefits: Enables easy integration into small mobile devices

Features: Low power requirements

Benefits: Minimizes impact on mobile devices' power budget

Features: Aiming LED

Benefits: Ensures intuitive operation even by untrained users

Features: Embedded decoder

Benefits: Provides you with a self-contained device for your products

Features: Easy-to-program, simple serial interface (SSI)

Benefits: Provides powerful and easy communication between scanner and host with advanced features and functionality

Build High-Performance One-Dimensional (1D) Scanning into OEM Devices

The SE12xx-HP is the perfect choice for your OEM design. It brings the benefits of bar code laser scanning to all types of OEM devices, allowing handheld computers, kiosks, medical instruments, diagnostic equipment, lottery terminals, vending machines, robotics, and countless other applications to be equipped with Symbol's industry-leading, reliable scanning technology. The entire SE12xx Scan Engine Series—including the High Performance (HP), Advanced Long Range (ALR), Long Range (LR), Wide Angle (WA) and Very High Density (VHD) models—has been designed to provide the highest scanning performance in the smallest package possible. For added versatility, each engine is identical in size, allowing for fast, cost-effective interchangeability when upgrading or modifying your OEM device for specialized applications

Features: High-performance scan engine

Benefits: Provides excellent scanning performance on all types of 1D bar codes including poorly printed and low-contrast symbols

Features: Compact, interchangeable form factor

Benefits: Ensures quick and easy integration

Features: Zinc chassis offers industry's highest shock rating for commercial, industrial or retail applications

Benefits: Provides minimum weight and maximum durability

Features: Supports 3.0-5.5 VDC

Benefits: Minimizes power consumption to extend life of portable applications

Features: Easy-to-program, simple serial interface (SSI)

Benefits: Provides fast interface communication with advanced features and functionality between scanner and host

Deliver Premium Performance to Your Customers

Integrate high-performance one-dimensional (1D) scanning into your product with the SE1224-HP. The SE1224-HP incorporates fuzzy logic for premium scanning performance on all 1D bar codes including poorly printed and low-contrast symbols. Designed for all types of 1D symbols, including reduced space symbology (RSS) bar codes, the SE1224-HP is ideal for any environment and is able to support a number of demanding applications in industries such as warehousing, shipping and receiving, clinical diagnostics, retail and manufacturing.

Enhance Long-Range Scanning Accuracy

With its long working range, the SE12xx-LR will help increase speed and accuracy in environments where getting close to bar codes may be difficult. The Scan Engine comes with a bright scan line to make distance scanning easy and intuitive. Its unique aim mode allows users to accurately target bar codes and capture data from bar codes up close and as far away as 20 feet (6.1 meters) across the floor or on raised warehouse pallets. In addition, its tolerance for a wide range of temperatures and its durable, shock-resistant design ensure the rugged SE-12xxLR is able to provide reliable scanning in the most demanding environments

Features: Working range up to 20 feet (6.1 meters

Benefits: Provides high-performance long-range scanning for OEM devices

Features: Compact size packs high performance in the smallest form factor

Benefits: Maximizes the ergonomic design of portable terminals

Features: Aim mode

Benefits: Helps make scanning from a distance easy and intuitive

Features: 650 nm bright laser diode

Benefits: Supports outdoor applications with an easy-to-see scan line

Features: Wide temperature range, immunity to ambient light and durable design

Benefits: Ensures premium scanning performance in demanding environments

Maximize the Long-Range Scanning Capabilities of Your Products

With the longest working range available in this small compact size, the SE12xx-ALR reads bar codes up to 30 feet (9.1 meters) away. The scan engine is specifically designed for the easy targeting and capture of bar codes over a wide working range such as in multi-level warehouses, helping to increase your productivity in environments where employees aren't able to get close to the items they need to scan. Its wide temperature range, aim mode, and immunity to ambient light makes the SE12xx-ALR the perfect solution for portable OEM devices designed for long-range scanning applications, as often needed in warehouses.

Features: Working range up to 30 feet (9.1 meters) for 100 millimeter reflective symbols

Benefits: Provides high-performance long-range scanning for warehouse applications

Features: Compact, ergonomic form factor (1.15 cubic inches/2.92 cubic centimeters)

Benefits: Enables long-range scanning without compromising your design

Features: Special aim mode

Benefits: Helps make scanning from a distance easy and intuitive

Features: 650 nm bright laser diode

Benefits: Supports long-distance scanning with an easy-to-see scan line

Benefit from Outstanding Scanning Performance on High-Density Bar Codes

This very high-density scan engine is optimized for symbols with element widths as narrow as 3 to 5 millimeters, and provides performance so accurate that it even delivers reliable scanning performance on symbols as small as 2 millimeters. The SE12xx-VHD is a great fit for applications associated with circuit-board manufacturing, small item retail and pharmaceutical marking.

Features: Optimized for high-density bar codes between 2 and 5 millimeters

Benefits: Read printed symbols with the narrowest element widths

Features: Compact, ergonomic form factor (1.15 cubic inches/2.92 cubic centimeters)

Benefits: Ensures easy integration into handheld or fixed mount OEM devices

Features: Easy-to-program, simple serial interface (SSI)

Benefits: Provides fast interface communication with advanced features and functionality between scanner and host

Increase the Speed of Your Near-Contact Scanning Applications

With its wide scan angle, the SE12xx-WA is the right scan engine for your high-volume contact and near-contact scanning applications. Its blink mode automatically triggers the scan engine for fast and reliable data capture, while its compact design allows the SE12xx-WA to be easily integrated into both portable and fixed mount devices

Features: Wide scan angle (53°) allows the user to read broad bar codes at or near contact

Benefits: Supports high-volume, near-contact scanning applications

Features: Compact, ergonomic form factor (1.15 cubic inches/2.92 cubic centimeters)

Benefits: Ensures easy integration into portable and fixed mount OEM devices

Features: Blink mode for intelligent bar code sensing

Benefits: Provides fast and reliable data capture by automatically triggering the scan engine

Features: Reduced laser output power

Benefits: Meets the needs of OEM designs requiring IEC Class I certification

Enable Long- and Short-Range Scanning all in one Product

The SE1525-ER all-range scan engine provides the best working range in the industry, with the ability to scan 7.5 millimeter bar codes 2 to 22 inches (5.08 to 55.88 centimeters) from the target, and 100 millimeter reflective labels from over 45 feet (13.7 meters). Never before has there been a long-range scan engine with this amount of versatility. In addition, Symbol's state-of-the-art optical technology and fuzzy logic capability add to the extended working range and provide reliability, durability and ease of use. The SE1524-ER is designed specifically for the easy targeting and capture of bar codes at great distances, such as in multi-level warehouse environments

Features: Extensive working range: 45 feet (13.7) on 100 millimeter reflective labels and as close as 2 inches (5.08 centimeters) on 7.5 millimeter symbologies

Benefits: Adds versatility to your portable terminal

Features: High-performance all-range scan engine with fuzzy logic technology

Benefits: Provides excellent scanning performance across the entire reading range

Features: Special aim mode

Benefits: Helps make scanning from a distance easy and intuitive

Features: Supports 3.3V

Benefits: Minimizes power consumption to extend life of portable applications

Bring Large-Scale Performance to Your Small-Scale Devices without the Size

Add scanning value to your PDAs, portable terminals, medical instruments, clinical diagnostic equipment or kiosks with the SE824-HP Scan Engine. Boasting a working range of 40 inches (101.6 centimeters), this small but powerful scan engine offers premium scanning performance in a small package. Its fuzzy logic technology ensures your devices are able to scan accurately and efficiently—even with damaged or poorly printed bar codes—while its retro-collective optical design enables data collection in full sunlight for outdoor operations, such as on a loading dock. And with its programmable parameters, which users are able to configure via the serial interface or by scanning bar code menus, the SE824-HP is a flexible solution for a variety of industries

Features: High-performance scan engine with fuzzy logic technology

Benefits: Provides excellent scanning performance on all types of bar codes including poorly printed and low-contrast symbols

Features: Flexible decode range of 40 inches (101 centimeters

Benefits: Maximizes scanning accuracy and efficiency

Features: Compact single board design measures just 0.24 cubic inch (0.61 cubic centimeter)

Benefits: Ensures easy integration into portable and fixed mount OEM devices

Features: Operates at 3.3 VDC

Benefits: Minimizes power consumption to extend life of portable applications

Features: ° and 35° Configurable scan angle of 46.5

Benefits: Enables reading of bar code menus and pick lists

Features: Versatile decode capability supports reading of all major one-dimensional (1D) symbols including reduced space symbology (RSS) bar codes

Benefits: Improves productivity by allowing devices to realize high first-time read rates

Features: Easy-to-program, simple serial interface (SSI

Benefits: Provides fast interface communication with advanced features and functionality between scanner and host

Add High-Speed One-Dimensional (1D) Scanning to Your Products

The SE9xx-HS provides the ability to add rapid 1D and two-dimensional (2D) bar code scanning capabilities to even small handheld and fixed mount devices. With a 200-scans-per-second rate and small form factor, the scan engine is a perfect fit for both portable terminals and fixed mount conveyor and robotics applications, while its working range of 2 to 23 inches (5.08 to 58.4 centimeters) provides plenty of flexibility for your applications.

Features: Miniature, high-speed scan engine with a scan rate of 200 scans per second

Benefits: Allows you to add 1D and 2D scanning capabilities to PDAs and handheld terminals without compromising their form factor

Features: Operates at 3.3 VDC

Benefits: Minimizes power consumption to extend life of portable applications

Features: Versatile decode capability supports reading of all major 1D symbols including reduced space symbology (RSS) bar codes

Benefits: Improves productivity by allowing devices to realize high first-time read rates

Features: Easy-to-program, simple serial interface (SSI)

Benefits: Provides fast interface communication with advanced features and functionality between scanner and host

Benefit from Big Features in a Small Package

The SE2223 scan engine is an adaptive, multi-pattern scan engine packing power and performance into the smallest package available. The high-performance scan engine features a high-speed (640 scans per second) read rate and smart raster scan pattern optimized for aggressive performance on two-dimensional (2D) bar codes such as PDF417. The high scan rate ensures the fast and reliable capture of one-dimensional (1D) and 2D bar codes while delivering excellent performance even on poorly printed symbologies. Available in standard and high-density configurations, the SE2223 offers the perfect solution for applications such as clinical diagnostics and medical equipment, gas pumps, manufacturing and warehouse devices and situations in which identification verification is required.

Features: High-speed scan rate of 640 scans per second

Benefits: Ensures aggressive performance on high-density 2D symbologies such as PDF417 as well as 1D bar codes

Features: Smart raster pattern that automatically tailors the scan pattern to the height of the PDF417 symbol

Benefits: Maximizes scanning speed and efficiency

Features: Compact size

Benefits: Provides excellent scanning performance in a small package

Features: Aim mode

Benefits: Helps make scanning easy and intuitive

Benefits: from a range of possibilities

The high-performance and user-friendly SE3223 offers a high-speed, omni-directional scan pattern to provide aggressive performance on one-dimensional (1D) symbols from any angle, eliminating the need to orient the bar code in the field of view. The SE3223 also features a smart raster scan pattern for high-performance two-dimensional (2D) bar code reading, while several scan pattern options provides you with the opportunity to select the best scan pattern for your application. The SE3223 is an excellent choice for applications such as kiosks, ATMs, listening stations, lottery machines, vending machines and more.

Features: High-speed omni-directional scanning

Benefits: Allows you to ensure that even the most novice users are able to scan items quickly and accurately with your device

Features: Generates four different scan patterns: omni-directional, semi-omni-directional, 2D raster and single line scan patterns

Benefits: Enables you to select the best scan pattern for your application

Features: Compact size

Benefits: Minimizes the overall size of your final product

Features: Versatile decode capability supports reading of all 1D and 2D symbols including PDF417, reduced space symbology (RSS) and composite bar codes

Benefits: Improves productivity by allowing devices to realize high first-time read rates in any environment

Features: Easy-to-program, simple serial interface (SSI)

Benefits: Provides fast interface communication with advanced features and functionality between scanner and host

Box 4.

Benefit from Big Performance in a Small Package for OEM or Fixed Mount Applications

The MS12xx Series from Symbol is a family of compact, durable, industrial fixed mount scanners available in fuzzy (FZY) or wide angle (WA) versions for maximum versatility. The MS12xx-FZY features fuzzy logic technology for premium scanning on one-dimensional (1D) bar codes including poorly printed and low-contrast symbols, while the MS12xx-WA allows you to read wide bar codes at or near contact.

The MS12xx Series of fixed mount scanners are ideal for OEM applications such as diagnostic equipment, medical instruments, kiosks, robotic equipment, lottery terminals and many more. When used as a fixed mount scanner, the MS12xx-FZY modules are ideal for manufacturing, warehousing and shipping, conveyer belts, assembly lines, library systems and countless other applications needing reliable unattended scanning.

Features: Compact, rugged, durable housing with integrated beeper, mounting holes, LEDs, decoder and a variety of interfaces

Benefits: Provides plug-and-play installation functionality to reduce development time and speed time to market

Features: High-performance fixed mount scanner with fuzzy logic technology

Benefits: Offers premium scanning for all 1D bar codes including poorly printed and low-contrast bar codes

Features: Extensive working range from near contact to over 60 in./152 cm (MS122xx-FZY only)

Benefits: Delivers a flexible decode range for maximum flexibility and productivity

Features: 60° scan angle (MS1207-WA only)

Benefits: Accommodates wide bar codes at or near contact in high-volume scanning applications

Features: Sealed to IP54 standards

Benefits: Protects against water and dust to ensure reliable performance in rough conditions or where cleaning is required

Features: Easy-to-program, simple serial interface (SSI)

Benefits: Provides fast, simple interface communications with advanced features and functionality between scanner and host

Features: Optional Software Developer's Kit (SDK

Benefits: Enables creation of applications using Windows 98, 2000 and XP platforms

Features: Multiple mounting options

Benefits: Increases development flexibility

MS22xx update on line

Optimize High-Speed Application Performance

The MS22xx Series from Symbol is a family of compact, durable industrial fixed mount scanners designed to provide fast, aggressive performance on a full range of one-dimensional (1D) and two-dimensional (2D) symbologies including PDF417, reduced space symbology (RSS) and composite codes. Available in a standard version as well as a very high density (VHD) model that supports the reading of high-density bar codes, the MS22xx offers a smart raster pattern optimized for 2D symbols and poorly printed 1D bar codes. Featuring a high scan rate, the MS22xx Series is ideal for unattended, high-speed scanning applications, such as conveyor belts and assembly lines in manufacturing and warehouse environments. With its ability to read PDF417 bar codes, it also offers an ideal solution for applications requiring the reading of driver licenses for security identification. The MS22xx is the right choice for OEM devices requiring accurate unattended automated data entry.

Features: Smart raster pattern specifically designed to read PDF417 bar codes

Benefits: Allows you to ensure that even the most novice users are able to scan items quickly and accurately with your device

Features: Compact durable housing with mounting holes, integrated beeper, LEDs and a variety of interfaces including RS-232, USB and Synapse

Benefits: Provides plug-and-play installation functionality to reduce development time and speed time to market

Features: Sealed to IP54 standards to protect against water and dust

Benefits: Ensures reliable performance in rough conditions

Features: Four different scan patterns: 1D linear, PDF raster, 1D omni-directional and 1D semi-omni for truncated 1D codes

Benefits: Allows you to customize your application with multiple triggering methods

Features: Easy-to-program, simple serial interface (SSI)

Benefits: Provides fast, simple interface communication with advanced features and functionality between scanner and host

Features: Multiple mounting options

Benefits: Increases development flexibility

Make Sure Your Kiosks are Easy to Use

The MS32XX is a high-performance, fixed mount scanner offering a unique high-speed omni-directional scan pattern to read bar codes quickly and accurately, minimizing the need for precise positioning of linear one-dimensional (1D) bar codes. It provides an easy, cost-effective way to enhance existing OEM devices with 1D and two-dimensional (2D) scanning. The small form factor, combined with high-speed omni-directional scanning, provides the perfect solution for any application requiring fast, accurate scanning, such as kiosks, ATMs, assembly lines and point-of-sale devices

Features: High-speed omni-directional scanning

Benefits: Allows you to ensure that even the most novice users are able to scan items quickly and accurately with your device

Features: Generates four different scan patterns: omni-directional, semi-omni-directional, 2D raster and single line

Benefits: Enables you to select the best scan pattern for your application

Features: Compact size and multiple mounting options

Benefits: Provides significant flexibility in the design of your product

Features: A rugged, durable housing with integrated beeper, LEDs and a variety of interfaces including RS-232, USB and Synapse

Benefits: Provides plug-and-play installation functionality to reduce development time and speed time to market

Features: Sealed to IP54 standards to protect against water and dust

Benefits: Ensures reliable performance in rough conditions

Features: Reads 1D and 2D symbols including PDF417, reduced space symbology (RSS) and composite bar codes

Benefits: Offers versatile bar code data capture in any environment

Features: Offers versatile bar code data capture in any environment

Benefits: Provides powerful and easy communication between scanner and host with advanced features and functionality

Benefit from Big Performance in a Small Package for OEM or Fixed Mount Applications

The MS804-FZY is one of the smallest high-performance fixed mount scanners available today. This small but powerful fixed mount scanner incorporates fuzzy logic for premium scanning performance on all types of one-dimensional (1D) bar codes. The MS804-FZY has an excellent working range from contact to beyond 40 inches (101.6 centimeters). In addition, the flexible mounting options and ease of programming ensure quick and easy integration. The MS804-FZY is intended for applications with space constraints, such as clinical diagnostic equipment, kiosks, medical instruments, turnstiles and robotic devices.

Features: High-performance scan engine with fuzzy logic technology

Benefits: Offers excellent scanning performance on all types of bar codes including those that are poorly printed and low contrast

Features: Able to read all major 1D bar codes Including reduced space symbology (RSS)

Benefits: Optimizes productivity with a versatile decode capability that ensures high first-time read rates

Features: Flexible decode range of over 40 inches (101.6 centimeters

Benefits: Maximizes scanning flexibility and efficiency

Features: Compact size (2.13 inches long×1.9 inches wide×1 inch high/5.41 centimeters long×4.83 centimeters wide×2.54 centimeters high)

Benefits: Enables easy integration into space-constrained products such as clinical diagnostics equipment and assembly line devices

Features: ) Configurable scan angle (46.5° and 35°

Benefits: Lets you change the scan angle to meet the demands of your application

Features: Easy-to-program, simple serial interface (SSI)

Benefits: Provides powerful and easy communication between scanner and host with advanced features and functionality

Make the Most of Your Smallest Devices

The MS904-HS provides great one-dimensional (1D) scanning performance in a small package. The high-speed scanner is optimized for the rapid reading of 1D bar codes quickly and accurately, while its small size ensures optimal ergonomic design of OEM devices such as clinical diagnostic equipment, medical instruments, data storage systems, conveyer belts, assembly lines and more.

Features: High-performance fixed mount scanner with a scan rate of 200 scans per second

Benefits: Provides excellent scanning performance on 1D bar codes

Features: Compact size (2.13 inches long×1.9 inches wide×1 inch high/5.41 centimeters long×4.83 centimeters wide×2.54 centimeters high)

Benefits: Enables easy integration into space-constrained applications such as clinical diagnostics equipment and assembly line devices

Features: Flexible decode range of over 23 inches (58.42 centimeters)

Benefits: Maximizes scanning accuracy and efficiency

Features: A compact, rugged, durable housing with mounting holes, LEDs and RS-232 interface

Benefits: Enables plug-and-play installation to reduce development time and speed time to market

Features: Easy-to-program, simple serial interface (SSI)

Benefits: Provides powerful and easy communication between scanner and host with advanced features and functionality

Build Reliability into Your Offerings

Ensure your products are capable of withstanding tough conditions with the LS 1220 Series, which combines durable construction with proven scanning technology. Built with a die-cast metal housing, the LS 1200 is ideal for OEM devices requiring accurate unattended data capture. With three models to choose from—standard (LS1220-HP), wide angle (LS1220-WA) and very high density (LS1220-VHD)—the LS1220 offers flexibility to your design

Features: ) easily accommodates wide bar codes at or near contact°Wide scan angle (60

Benefits: Supports high-volume scanning applications requiring contact scanning, such as kiosks or assembly lines

Features: Aggressive scanning performance

Benefits: Assures the highest first-time read rate and accuracy, even on damaged or poorly printed symbols

Features: Compact, rugged industrial-class housing

Benefits: Ensures easy integration into fixed mount or OEM applications

Features: Available in standard, wide angle, or very high density versions

Benefits: Provides flexible scanning performance to match your application's requirements

Box 5,

Maximum Capacity Next-Generation Wireless Networking for Large Enterprises

The WS5100 Wireless Switch builds on the power of Symbol's award-winning next-generation WS5000 wireless switch, adding ten times more throughput and capacity to support the largest organizations. Ideal for healthcare, educational and retail industries, the WS5100 delivers the same superior security, functionality, scalability, performance, and manageability, and supports Symbol's family of thin Access Ports—next generation low-cost upgradeable access points

Features: Your company is growing, and so are the number of WLAN users—and applications. Your current wireless LAN is unable to handle the demand, impacting wireless network performance and availability—and employee productivity.

Benefits: The WS5100 is designed specifically to meet the needs of the largest enterprises, supplying ten times the throughput of Symbol's WS5000 wireless switch to support growing numbers of employees as well as the bandwidth demands of new processing-intensive applications

Features: You are looking for an affordable wireless networking solution to deliver robust connectivity to an extremely large number of users

Benefits: The WS5100 is a high-performance enterprise-class wireless LAN with the centralized intelligence and management capabilities you need to easily and cost-effectively manage a very large mobile workforce

Get Enterprise-Class Wireless Networking Functionality, Security and Scalability at a Lower Cost with the Power of Centralized Intelligence

The first wireless switch on the market, Symbol's WS5000 offers an award-winning next-generation architecture that delivers the power of centralized intelligence. End-to-end layered security protects your perimeter, network, servers and client devices. Centralized management dramatically reduces the cost and time required to manage your wireless network by eliminating the need to physically configure and manage each access port (first generation wireless networking). The ability to scale as your enterprise grows and your needs change ensures that you have the capacity to meet your needs today as well as in the future. And the ability to upgrade to support the latest features, functionality and new security mechanisms eliminates the need for forklift upgrades, delivering outstanding investment protection. WS5000: powerful wireless LAN networking that costs less, delivers more functionality—at a lower total cost of ownership.

Features: Your IT staff is already at maximum capacity, and your present wireless LAN is adding to the strain: it is difficult and costly to manage

Benefits: The WS5000 offers the power of centralized management, a single point of control for your entire wireless LAN, eliminating the need to physically configure and manage each wireless network device

Features: You have been considering implementing a wireless LAN for some time. The benefits are enticing, but the rapid pace of development leaves you unsure of when to buy—you don't want to purchase technology that is instantly outdated

Benefits: Instead of access points, the WS5000 works with low-cost thin access ports. These next-generation access points are “thin”—the intelligence is located in the wireless switch and distributed to the access ports, enabling new features, functionality and security mechanisms to be added quickly and easily. The need for a forklift upgrade is eliminated, providing outstanding investment protection as well as return on investment.

Features: Your enterprise is large, with multiple locations and thousands of employees. You are looking for a wireless LAN that can scale easily and cost-effectively whenever you want to deploy additional applications, as well as support a large and growing mobile workforce

Benefits: The WS5000 offers simple and cost-effective scalability. Adding new capacity is as simple as adding additional WS5000 wireless switches—each WS5000 supports up to 30 access ports. And since access ports are low-cost zero-configuration devices and are ready to install right out of the box, you can quickly, easily and cost-effectively expand your wireless network.

Meet the Needs of Your Smaller Office with this Next-Generation Integrated Wireless and Wired Switch

The WS2000 Wireless Switch extends the benefits of Symbol's award-winning next-generation wireless architecture, designed and priced to meet the needs of small to midsize enterprises and branch offices. In addition to enterprise-class wireless networking, the WS2000 offers integrated support for wired networking, including a firewall and a virtual private network (VPN) for secure communications with corporate headquarters. Management for smaller sites that often have little or no onsite IT support or expertise is greatly simplified with a single point of control, and the costs associated with purchasing, deploying and managing additional wired networking equipment is eliminated. The WS2000—cost-effective simplified enterprise-class wireless and wired networking for the smaller site

Features: You would like to use the power of mobility at numerous small branch offices to increase productivity—you are looking for a wireless LAN that will provide the robust functionality found in large enterprises, priced for a larger environment

Benefits: The WS2000 provides all the features, functionality and security of Symbol's enterprise class WS5000 wireless switch, scaled and priced for smaller environments.

Features: Your small retail store would greatly benefit from the use of mobile devices, delivering increased productivity on the sales floor as well as improved customer service. But without in-house IT expertise, you are overwhelmed at the thought of purchasing and managing both wired and wireless networking equipment.

Benefits: The WS2000 is an integrated wired and wireless networking solution that eliminates the need to purchase and manage two disparate types of networking equipment. Management is simplified—and your networking costs are reduced.

Box 6,

Wireless Infrastructure

Bridges and Adapters

Give Your Desktop and Laptop Computers, PDAs, Printers, Cash Registers and More the Power of Wireless Connectivity

With Symbol's robust family of client bridges and adapters, you can quickly and easily provide a wireless connection to your network for nearly any device. Connect notebook computers and PDAs to give your mobile workforce the power of anywhere, anytime network access. And eliminate the expense of wiring to connect stationary devices, such as desktop PCs, printers and cash registers Extend affordable and secure 802.11a/b/g wireless connectivity to multiple Ethernet devices—including cash registers, scales, time clocks and more

CB3000 Client Bridge provides affordable and reliable wireless connectivity for Ethernet devices that do not have a PC or PCI card slot. Connect everything from printers, scales and medical equipment, to manufacturing machinery, bar code readers, time clocks, cash registers and other data collection devices via an RJ-45 port. This cost-efficient connection point can support up to 16 wireless clients via an Ethernet hub. And advanced security capabilities protect your traffic from being deciphered and your network from unauthorized access.

CB3000 Client Bridge provides affordable and reliable wireless connectivity for Ethernet devices that do not have a PC or PCI card slot. Connect everything from printers, scales and medical equipment, to manufacturing machinery, bar code readers, time clocks, cash registers and other data collection devices via an RJ45 port

Features: You need to connect your cash registers to your network, but the need to move the registers throughout the year to accommodate seasonal needs will result in high wiring costs.

Benefits: Quickly and easily extend cost-effective wireless connectivity for up to 16 cash registers with a single CB3000. And when you need to move your registers to better serve holiday buyers, or for an improved floor plan, just simply relocate the CB3000 with the devices to maintain wireless connectivity—without incurring the expense and time of wiring and re-wiring

Features: You have an application that will deliver competitive advantage, but it requires the capture real time data from some of your larger equipment. Since the equipment does not have a PC or PCI card slot, you cannot establish the wireless connectivity you need

Benefits: The CB3000 extends wireless connectivity to equipment that typically would not be able to establish a wireless connection via the RJ45 port. Ideal for connecting printers, scales, time clocks, point-of-sale and more to your wireless network

Extend Ethernet-Speed, High-Performance Wireless Connectivity to any Device with a CompactFlash Card Slot

The Wireless Networker Compact Flash card delivers the power of 802.11b wireless connectivity to today's most popular mobile computers and PDAs, as well as notebook computers with a CF-to-PC card adapter. Users remain productive and connected to the corporate network, the Internet, e-mail and critical business applications with Wi-Fi interoperability, which provides instant connectivity to any available 802.11b network—at the office, home, or in public hot spots such as the airport or a coffee shop. Battery life is extended with advanced power management, which delivers low power consumption. And your data transmission rate is automatically adjusted as wireless signal strength decreases, enabling maximum roaming range without losing connectivity.

LA4137 Wireless Networker Compact Flash Card

Provide Plug-and-Play High-Performance 802.11b Wireless Connectivity for any Device with a Compact Flash Card Slot

Business Challenge: Your employees use e-mail heavily for critical communications. But the workday takes many employees away from their desk and e-mail as they move throughout the large campus environment—unable to respond quickly to situations and information requests from co-workers, impacting productivity across the board. You want to provide fast and easy anytime, anywhere e-mail access to keep your mobile workers connected and available

Solution: The Wireless Networker CompactFlash card allows employees to use their PDAs for fast always-on e-mail connectivity as they move throughout your buildings. Special mobility features provide robust roaming, automatically adjusting transmission speeds as signal strength decreases to eliminating performance and connection issues.

Empower Your Mobile Devices with the Flexibility of 802.11a/b/g Enterprise-Class Wireless Performance

The LA5030 provides enterprise-class high-bandwidth connectivity for any device with a CardBus slot. This plug-and-play adapter delivers maximum flexibility and simplicity, seamlessly allowing users to access wireless switch or access point-based wireless 802.11a/b/g networks. Operating at approximately four to six times the speed of the average PCMCIA card, the LA5030 delivers the speed required for processing-intensive applications, such as video or Internet access. Low-power operation and built-in power management maximize device battery life. And support for 802.11i security mechanisms provides maximum protection for your data and mobile devices.

LA5030

Provide Plug-and-Play Enterprise Class 802.11a/b/g Wireless Connectivity for any Device with a CardBus Slot

Features: As employees travel between offices, your heterogeneous wireless networking environment adds a level of complexity to obtaining wireless connectivity for their laptop computers.

Benefits: The LA5030 provides connectivity to any 802.11a/b/g network, allowing employees to easily and seamlessly provide network access for traveling employees regardless of the type of wireless networking installed

Features: You have several new wireless applications that are in development that will be deployed on your 802.11b wireless LAN. The applications will require intensive processing and high bandwidth—and the current PCMCIA cards in use in your laptops will not provide the level of performance required

Benefits: The LA5030 provides approximately four to six times the processing speed of your current 802.11b PCMCIA counterparts, providing robust performance for the new applications. In addition, LA5030 provides maximum battery life through low-power operation and built-in power management capabilities that minimize the drain on battery power that is common in processing-intensive environments

Empower any Mobile Device with a PCI Slot with the Flexibility of 802.11a/b/g Enterprise-Class Wireless Performance

The LA5033 provides enterprise-class high-bandwidth connectivity for any device with a PCI slot. This plug-and-play adapter delivers maximum flexibility, allowing you to easily connect desktop computers, cash registers, scales, kiosks and more to your wireless switch or access point based wireless 802.1a/b/g networks. Operating at approximately four to six times the speed of the average PCMCIA card, the LA5030 delivers the speed required for processing-intensive applications, such as video or Internet access. And support for 802.11i security mechanisms provides maximum protection for your data and mobile devices.

LA5033

Provide Plug-and-Play Enterprise Class 802.11a/b/g Wireless Connectivity for any Device with a PCI Slot

Features: Rapid growth of your company has translated into the regular hiring of fairly large groups of new employees. In addition, this steady growth is also rippling into fairly regular re-organization of the office space. You need a means to provide cost-effective network connectivity to the new hires, and eliminate the high costs of wiring and re-wiring to accommodate moves and changes

Benefits: With the LA5030, you can instantly connect your desktop users to your wireless LAN with speeds capable of handing the most demanding applications. And the tri-radio provides the flexibility to accommodate your 802.11b network today—and the 802.11g upgrade planned for next year.

Features: The new customer kiosks you are planning to implement throughout your retail operation require network connectivity. You are hesitant to spend the budget to hardwire them into your network since you know the marketing plans call for seasonal, merchandising and special promotional plans that will require different floor plans—and more wiring.

Benefits: The LA5030 provides instant network connectivity for your kiosks, while delivering the flexibility to maintain that connection no matter where you need to move them to support strategic marketing plans. And tri-radio 802.11a/b/g compatibility provides access to high-bandwidth wireless networks to support the high processing requirements of your graphics—and transaction-intensive customer-facing applications.

Box 7

Mobile Computers

Portable Shopping System

To retain customers and increase sales in retail environments, you must make the shopping experience a positive one—an experience that values the customer's time, gives them relevant information to make buying decisions and streamlines the checkout process. By giving shoppers more control and convenient access to information, the Portable Shopping System from Symbol encourages repeat business. And, by providing opportunities to create targeted messaging, it helps you achieve higher per-basket revenue in retail operations. You are also able to observe customer behavior to further optimize the shopping experience. With its simple-to-use interface, accurate scanning capabilities and high fun factor, your shopping, gift registry and checkout applications in retail environments are enhanced with the Portable Shopping System.

The Portable Shopping System is one of a full range of Symbol devices enabling you to capture data to better serve your customers. Our consumer systems enable you to better meet your customers' needs and generate compelling upsell and cross-sell opportunities. Symbol's shopping systems, together with its wireless infrastructure, industry-leading partner applications and management software products, provide the foundation you need to realize the benefits of being an organization on the move. Because all parts of the solution work together—and with your other networks and information systems—you are able to cost-effectively build and adapt your mobile enterprise to meet your customer's evolving expectations.

PSS

Provide Retail Customers a Unique, Informative In-Store Experience with a Handheld Scanning and Marketing Device to Improve Service and Increase Sales.

PS3050

Designed for tough shopping environments, the PS3050 helps you create customized experiences.

Box 8.

Increase Sales and Efficiency with Better Access to Information

With the MK2000 Micro Kiosk™, you give customers an exceptional and personalized shopping experience without the expense of a dedicated sales associate. Designed for eye-catching informational applications in retail environments, the space-saving, interactive MK2000 enables you to provide information at strategic locations to increase sales and save customer and employee time. Using the multimedia capabilities of the MK2000, you're able to attract your customers quickly to the information they need with sophisticated, interactive applications that enhance the transaction experience, and increase basket size and customer satisfaction at the same time. You also improve data accuracy and operational efficiency when your employees use the device for SKU management, clock-in/clock-out and other in-store tasks.

Features: Your customers want targeted information to help them make purchasing decisions, and your employees need in-aisle access to critical information to complete tasks

Benefits: The MK2000 supports customer- and employee-facing interactive applications including those using digital signage, bar code scanning, price verification, audio and video.

Features: You must present information where your users are—not just where there is a network connection available.

Benefits: The MK2000 attaches to your network with a wireless or wired Ethernet connection

Features: It is critical for you to reduce the costs of developing and deploying new applications.

Benefits: The open standards-based Microsoft Windows CE NET operating system has broad support and a range of tools to help compress your development cycle's time and costs.

Features: You want a faster return on your investment

Benefits: The Software Developer Kit includes the Kiosk Software Suite, a demonstration application with source code to get you up and running quickly. And, the easy-to-use Configuration Utility automates the device setup and deployment process

Increase Sales and Efficiency with Better Access to Information

Designed for informational applications in retail environments, the space-saving, interactive MK100 Micro Kiosk enables you to provide information at strategic locations to increase sales and save customer and employee time. Offering the right information at the point of purchase can increase basket size and customer satisfaction at the same time. You also improve data accuracy and operational efficiency when your employees use the device for SKU management, clock-in/clock-out and other in-store tasks. With the MK1100, you give customers an exceptional and personalized shopping experience—without the expense of a dedicated sales associate.

Features: Your customers want targeted information to help them make purchasing decisions, and your employees need in-aisle access to critical information to complete tasks

Benefits: The MK1100 supports customer- and employee-facing interactive applications, including those that use digital signage, bar code scanning and price verification, allowing you to present a variety of information to meet diverse user demands

Features: You must present information where your users are—not just where there is a network connection available.

Benefits: The MK1100 attaches to your network with a wireless or wired Ethernet connection.

Features: It is critical for you to reduce the costs of developing and deploying new applications.

Benefits: The open standards-based Microsoft Windows CE NET operating system has broad support and a range of tools to help compress your development cycle's time and costs

Features: You want a faster return on your investment

Benefits: The Software Developer Kit includes the Kiosk Software Suite, a demonstration application with source code to get you up and running quickly. And, the easy-to-use Configuration Utility automates the device setup and deployment process.

Box 9,

Wireless Infrastructure

Power Over Ethernet

Provide Cost-Effective Power for your Access Points and Access Ports—without the Expense of Running Cabling and Installing Outlets

Symbol's family of Power-over-Ethernet (PoE) products eliminates the need to run expensive cabling and install outlets to provide power to your access points and access ports. With PoE products, you have the flexibility to design your network for maximum performance—without adding to your installation costs. PoE is also ideal for hard-to-reach locations—for example, in ceilings or on the warehouse or factory floor, or to support a change in network layout, driven by a change in your floor plan. Your wireless LAN is deployed faster—and less expensively.

Deliver Cost-Effective Power to Symbol Access Points with this Single Port Solution

The 24-Volt Single Port Power Injector provides cost-effective power for individual Spectrum24 High Rate Access Points without the need—or associated expense—for cabling and power outlets. Designed for smaller sites with fewer than six access points, 24 Volt Single Port Power Injector is easy to use and manage, and easily integrates with your current wireless LAN infrastructure. This device provides smaller offices with a cost-effective way to power a single access point, allowing Power-over-Ethernet functionality to be purchased as required. The need to purchase expensive and more complex hubs with unneeded capacity is eliminated.

24 Volt Single Port Power Injector

Power Your Individual Spectrum24 High Rate Access Point quickly, Easily and Cost-Effectively—without the Need for Cabling and Outlets

Business Challenge: Your wireless network site design calls for five Spectrum24 Access Points, but two are in locations where power does not exist. The cost to rim cabling and install outlets is cost-prohibitive—but if you redesign the network to move the access points near an existing outlet, your network performance will be affected. You are looking for a way to deliver needed power more cost-effectively.

Solution: The 24-Volt Single Port Power Injector provides very affordable Power-over-Ethernet functionality for a single device at the same per-port cost as hubs with larger capacities, eliminating the need to purchase more capacity than required.

Connect Your ES3000 Ethernet Switch to your Distributed Network with High-Quality, Affordable Fiber Optic Gigabit Ethernet Connectivity

The ES3000 Fiber Optic Transceiver connects your Symbol ES3000 Ethernet Switches to your core network switches and routers with high-quality, affordable Gigabit Ethernet speed and the superior transmission quality of fiber optics. This hot-pluggable, easy-to-install Gigabit Ethernet Interface Converter (GBIC) delivers the speed you need to support high-bandwidth applications, such as voice and video. Based on standards, the ES3000 Fiber Optic Transceiver is easy to deploy, integrating easily and seamlessly in your current network environment

ES3000 Fiber Optic Transceiver

Empower Your ES3000 Ethernet Switches with High-Quality, Affordable Fiber Optic Gigabit Ethernet Connectivity.

Business Challenge: You have selected Symbol's ES3000 Ethernet Switches for the Ethernet connectivity and robust wireless features and functionality you need to support your wireless LAN. The environment for your corporate LAN is distributed—you want to maximize the connection between your ES3000 Wireless Switches and your core switches and routers to eliminate any bottlenecks

Solution: The affordable ES3000 Fiber Optic Transceiver provides a robust connection between your ES3000 Wireless Switches and your LAN switches and routers, delivering the superior transmission quality of fiber optics and the speed you need to support the most demanding applications.

Deliver Cost-Effective Power to Symbol Access Ports with this Single Port Solution

The 802.3af Single Port Power Injector provides cost-effective power for individual Symbol's family of Access Ports without the need—or associated expense—for cabling and power outlets. Designed for smaller sites with fewer than six access points, the 802.3af Single Port Power Injector is easy to use and manage, and easily integrates with your current wireless LAN infrastructure. This device provides smaller offices with a cost-effective way to power a single access port, allowing Power-over-Ethernet functionality to be purchased as required. The need to purchase expensive and more complex hubs with unneeded capacity is eliminated

802.3af Single Port Power Injector

Power Your Individual Symbol Access Ports Quickly, Easily and Cost-Effectively—without the Need for Cabling and Outlets.

Business Challenge: Your wireless network site design calls for five Symbol Access Ports, but two are in locations where power does not exist. The cost to run cabling and install outlets is cost-prohibitive—but if you redesign the network to move the access points near an existing outlet, your network performance will be affected. You are looking for a way to deliver needed power more cost-effectively.

Solution: The 802.3af Single Port Power Injector provides very affordable Power-over-Ethernet functionality for a single device at the same per-port cost as hubs with larger capacities, eliminating the need to purchase more capacity than required

The Ethernet Switch Designed for Wireless Networking, Complete with 802.3af Power-over-Ethernet

Traditional Ethernet switches are designed for Ethernet connectivity. But since every wireless LAN requires Ethernet connectivity, Symbol designed the ES3000 to provide the best of both worlds: the Ethernet functionality you need with robust wireless networking support. The result is single device simplicity with the features and functionality you need to achieve optimal performance and operational efficiency in your wireless network. With Power-over-Ethernet (PoE), you can provide cost-effective power for up to 24 access ports/points—without the need to install costly cabling or outlets. Centralized remote management for PoE-powered devices reduces your operational costs. PoE-powered devices can be reset remotely for rapid troubleshooting, or powered down after operating hours for complete network security. And dynamically power allocation based on actual usage ensures adequate power for access ports and points carrying the most critical traffic.

Combined with mobility features, such as virtual LAN (VLAN) and Quality of Service (QoS), the ES3000 is the ideal Ethernet switch for your wireless LAN.

Business Challenge: The ideal wireless LAN design will require an extensive budget to run cabling and install outlets to provide power to access ports and access points. You need to either re-work the plan, or find a way to reduce installation costs.

Solution: The ES3000 provides robust Power-over-Ethernet functionality for up to 24 access ports or access points, eliminating the need—and associated costs—for cabling and outlet installation.

Business Challenge: You are implementing a wireless switch-based wireless network.

You would prefer not to have to purchase and manage an additional device to provide the necessary Ethernet connectivity.

Solution: The ES3000 is designed to provide the features you need for Ethernet connectivity as well as optimal wireless network performance and operational efficiency—in a single device

Box 10,

Maximize Mobility Investments with an Affordable, Versatile Mobile Computer

In one simple package combining data entry and bar code scanning capabilities, the rugged MC1000 handheld computer from Symbol Technologies meets the demands of your budget and your environment. Designed for batch processing applications in light industrial, retail, government or warehousing and distribution centers, the MC1000 tracks your inventory more efficiently and accurately—increasing the speed of your operations and improving response to customers. The simple-to-use design and rugged durability reduce training and maintenance costs while improving user satisfaction and productivity. And, the open standards-based architecture protects your investments, enabling you to adapt and expand the device to meet your changing business needs.

Features: Your scanning and data capture applications need accurate input in order to maximize efficiency and provide trusted insights into your operations.

Benefits: You get more accurate data collection—increasing your operational efficiency—with the high-quality 1D laser scanner and the large keypad design of the MC1000.

Features: To enhance productivity, your employees need to safely and accurately scan and capture data for long periods of time.

Benefits: Employees are able to operate the MC1000 with one hand due to its lightweight, ergonomic form factor. Its large monochrome display also reduces user fatigue throughout a full work shift.

Features: You need to scan and capture data without interruption to increase productivity and lower your IT support costs.

Benefits: Extremely durable and capable of continuous operation in harsh conditions, the MC1000's impact-tolerant design and IP54-rated seal protection ensure reliable operation and long life.

Features: You can't afford to develop mobile systems and applications that won't adapt as your business needs evolve.

Benefits: The Microsoft Windows CE 4.2 operating system has broad development support, enabling your developers to more quickly and easily develop new applications and port existing applications.

Achieve Higher Productivity in Scan-Intensive Environments

Symbol's MC3000 mobile computer is small, lightweight and rugged for applications requiring high-quality data capture and high-performance real-time computing. By delivering superior data capture and exchange, the MC3000 helps speed response throughout your supply chain—from field sales to the shop floor. Because you are able customize the MC3000 to the specific demands of individual jobs, your employees are able to complete their work faster and with better results. Your employees will utilize the MC3000 for bar code scanning and wireless mobile computing inside retail stores or in warehouses, on loading docks, on postal routes and in any location demanding application performance and ruggedness.

Features: To lower your IT management costs, you'd prefer to deploy a single device; but your employees need different device capabilities based on their individual tasks.

Benefits: The display, connectivity, and keypad options of the MC3000 enable you to easily and cost-effectively tailor—and maintain—the mobile device for specific tasks throughout your enterprise

Features: Your inventory management employees often have to work in cramped conditions and reach up or down to scan items on shelves, in bins and on pallets.

Benefits: The adjustable left, right and forward scanning positions of the MC3000 scan head give your employees a safe, comfortable grip, allowing accurate scans on first pass.

Features: Some areas of your manufacturing operation are not covered by your wireless network, but your plant employees still need to collect data from these areas

Benefits: Wireless connectivity options give you real-time access to information when employees are onsite. And when they travel offsite, the large data storage capacity and batch processing capabilities of the MC3000 let them store information until they can download it to a host system.

Features: Items are dropped when conducting inventory in retail environments; you need a scanning mobile computer able to take the punishment

Benefits: The MC3000's impact-tolerant design ensures inventory counts won't be lost if the device is dropped, so your retail aisle and stockroom employees are more productive.

Features: Employee training is a significant, ongoing cost in your retail operation.

Benefits: Retail employees require less training and are more productive quicker with the familiar interface of the Microsoft Windows CE operating system.

Handheld

MC9000 Series

Mobile Computers: Industrial Class: MC9000 Series

Speed response with ready access to the most current enterprise information Used in retail, manufacturing, logistics and industrial environments, the rugged MC9000 mobile computers speed response by giving your employees timely access to the information they need to do their jobs faster and better. You gain overall operational efficiencies and reduce the costs and quality issues associated with data input errors. Rugged designs and comfortable form factors enhance both device and employee productivity and protect your investments in mobile technology. Ease of deployment and management reduces your IT costs and increases return on investment

MC9000-G

Speed the capture and exchange of accurate data in scan-intensive applications with a pistol-grip, variable-range scanning mobile computer.

MC9000-G RFID

Arm your mobile team for maximum efficiency with a rugged multi-protocol, multi-mode handheld RFID reader.

MC9000-K

Create the best device for your needs with a modular handheld computer offering multiple configuration options.

MC9000-S

Collect data and manage transactions with speed and accuracy wirelessly from the field with a rugged handheld computer.

MC9060 Voice-Directed Solution

Improve your warehouse picking productivity and other warehouse operations with our rugged, wearable voice-directed solution.

Operate Efficiently and Cost-Effectively with an Ergonomic Wireless Handheld

The PDT6100 gives your workers a basic tool for collecting and exchanging the information they need to complete tasks quickly. With scanning and data entry capabilities in the palm of their hands, your employees will price, put away, audit, track, control, pick, move, assemble and package products with greater efficiency and accuracy. And you'll make more informed, responsive decisions about inventories, asset routing and sales efforts with near real-time batch processing capabilities and real-time data exchange provided through integrated wireless capabilities. The Symbol PDT6100 is offered in standard and rugged designs with three keypad layout choices and two LCD display options, allowing you to create the optimal devices for use in your retail, transportation and logistics or light industrial operations

Features: To make strategic decisions about managing inventory, serving customers and allocating resources, your supply chain managers need to see both the big picture and the little details.

Benefits: With wireless data exchange capabilities of the PDT6100 your supply chain managers are able to better track projects, processes, even individual products, enabling them to quickly make decisions that generate revenue

Features: You need timely exchange of business data, but you don't want to incur the high costs of implementing wireless technology

Benefits: Your supply chain employees economically capture data and exchange data with host systems in near real time using the batch processing and large data storage capacity of the PDT6100, so you are able to delay investment in wireless systems.

Features: Your mobile workers need a device they are able to use comfortably for a full eight-hour shift.

Benefits: The ergonomic design, choice of left- or right-hand orientation and rotating scan head of the PDT6100 enables workers to scan over long periods with less fatigue, improving productivity and reducing risk of repetitive motion injuries.

Features: You don't want your shop floor and warehouse personnel scrolling through needless details in order to get the information they need to perform their scanning and data entry jobs.

Benefits: An 8-line or 16-line LCD character display focuses your employees' attention on the information they need, letting them get to work quickly and reducing your device costs

Streamline Your Supply Chain with Accurate Data Capture

In scan-intensive environments, your employees need accurate and easy-to-use handheld computers. The forward-scanning, pistol grip design of the PDT6800 gives employees a powerful data capture tool to increase task speed and accuracy. Ideal for retail, warehousing and manufacturing applications, the DOS-based PDT6800 helps your employees perform inventory counts, pricing audits and other time-sensitive data capture tasks with greater speed and precision. Optional wireless networking capabilities support real-time data exchange. The PDT6800 delivers accurate, high-volume performance when your employees need to efficiently manage your supply chain—in the retail aisle, in the warehouse or on the shop floor

Features: Your workers need to scan bar codes at high volume with a high degree of accuracy for long periods of time in shelving and bin environments.

Benefits: The forward-facing PDT6800 pistol grip enables workers to scan over long periods with less fatigue and greater accuracy

Features: Your supply chain workers need to quickly and efficiently scan data from multiple data sources to support smart supply chain decisions.

Benefits: The PDT6800 is designed to capture both one-dimensional (1D) bar codes and 2D images with a single device, making more efficient use of employees' time and saving money on mobile devices.

Features: Existing DOS applications continue to provide value in your supply chain operations, yet you need the performance enhancements of newer device technologies.

Benefits: The PDT6800 uses the latest advances in processing and networking performance, yet it runs on the DOS operating system, extending your investments in DOS technology and applications and reducing your IT operating costs.

Features: Troubleshooting and repairing mobile devices is not an effective use of your limited IT staff time.

Benefits: Extremely durable and capable of continuous operation in harsh conditions, the PDT6800's impact-tolerant design and IP54-rated seal protection ensure reliable operation and long life

Maximize Your Investments in Mobility with Maximum Device Versatility

Your mobile workforce is able to do more, quickly and efficiently, with the versatile functionality of the PDT8100 mobile computer. Employees engaged in route accounting, retail customer service and line busting, healthcare patient service and other jobs requiring real-time information are better able to deliver the quality service and rapid response your customers expect. The rugged PDT8100, coupled with communication options that include batch, wireless local area network (WLAN) and wireless wide area network (WWAN) connectivity, offers high-performance bar code scanning, image capture capabilities and infrared connectivity, as well as multiple input options including a touch screen. With a range of features and available accessories, you are able to easily match the PDT8100 to your specific industry applications—maximizing business process efficiency. And, the device is expandable to grow with your business, so you get the greatest return from your technology investment.

Business Challenge: Your route accounting employees need accurate pricing, inventory, contracts and credit terms and other crucial information to close sales and give customers accurate, responsive service.

Solution: The infrared technologies of the PDT8100 give your sales and route management employees uninterrupted access to your enterprise applications and the information needed to generate revenue.

Business Challenge: To lower your IT management costs, you'd prefer to deploy a single mobile computing device, but your employees need different device capabilities based on their tasks.

Solution: The multiple PDT8100 keypad configurations and ability to capture data using a touch screen or bar code scanner enable you to easily and cost-effectively tailor—and maintain—the device for specific tasks throughout your enterprise

Business Challenge: Your manufacturing and warehouse facilities have varied lighting conditions making it difficult for workers to accurately read displays

Solution: The choice of either a monochrome or color display for the PDT8100 lets you deploy a device optimized for specific environments, reducing eye strain and fatigue.

Business Challenge: You need a mobile device able to adapt and grow with your business

Solution: The expandable data storage capacity of the PDT8100 allows you to support data-intensive applications without upgrading to a different device

Box 11,

The VRC6940 vehicle-mounted computer from Symbol attaches directly to forklifts, trucks and other vehicles, enabling operators to collect and transmit data to host systems from warehouses, shop floors, shipping docks and other demanding environments. The VRC6940 withstands dusty and damp conditions and temperature extremes, and it handles the impacts bound to occur with heavily used industrial vehicles. Wireless LAN connectivity connects your VRC6940 with back-office data systems, giving you greater insights into processes and allowing operators to make informed decisions. The DOS operating system of the VRC6940 offers dependable, cost-effective application performance and extends the value of your existing investments in DOS technology

Business Challenge: You want to fit your warehouse vehicles with computers, but you're still using DOS applications and are not yet ready to upgrade.

Solution: The VRC6940's stable, dependable DOS operating system eliminates the need for new application development, reducing your application maintenance costs and allowing you to continue deriving value from your investment in DOS

Business Challenge: Forklifts and heavy equipment, crucial to your warehousing operations, are tough on mobile computers.

Solution: The VRC6940 has a rugged housing and a high shock-resistance rating to withstand continuous operation in pounding, jarring conditions, so your operators have uninterrupted access to the information they need, and you keep IT equipment maintenance costs under control

Business Challenge: To eliminate waste, you must be able to track the flow of raw materials, work-in-process and finished goods inventories with pinpoint accuracy.

Solution: You keep inventories lean using up-to-the-minute tracking information provided by the wireless capabilities of the VRC6940

Business Challenge: You use powered trucks, forklifts, vertical lifts and other vehicles in your manufacturing operations to move production materials and finished products.

Solution: A range of power options—12 to 60 VDC or 12v to 24v automotive—gives you the flexibility to put a computer in any industrial vehicle. And you are able to upgrade your vehicles without upgrading the computer

Extend Accurate Enterprise Information into the Toughest of Industrial Environments

The VRC7900 is designed for mounting on the wide variety of industrial equipment used in loading docks, warehouses and manufacturing operations. Using a combination of wireless connectivity and the full QWERTY keyboard of the VRC7900, your industrial environment employees are able to input detailed information to your critical business applications in real time. And the Microsoft Windows CE platform gives you the power to create applications to meet your current and future needs. With application and device versatility, you are able to access the information you need to make timely decisions about inventories, shipping and receiving and manufacturing production, even in the most extreme conditions.

Business Challenge: Your logistics and warehouse management software applications require heavy text typing input from your industrial equipment operators

Solution: Using the VRC7900's 65-key QWERTY keyboard and up to 24 function keys, your industrial equipment employees quickly enter data for multiple applications, including terminal emulation.

Business Challenge: To eliminate waste, you must be able to track the flow of raw materials, work-in-process and finished goods inventories with pinpoint accuracy.

Solution: You keep inventories lean using up-to-the-minute tracking information provided by the wireless capabilities of the VRC7900

Business Challenge: In noisy, dimly lit and potentially dangerous industrial environments, your employees need clear presentation of information.

Solution: A bright color LCD display and touch-screen functionality allow workers to quickly and accurately read and enter data, increasing the accuracy of the data and ensuring safe working conditions.

Business Challenge: It is critical for you to reduce the costs of developing and deploying new mobile computing applications, which integrate with your existing systems

Solution: With the Windows CE operating system, your application developers have a broad range of development tools and industry support for creating cost-effective applications specific to your needs.

Business Challenge: Your industrial vehicles operate in freezing conditions.

Solution: An optional cold store heater supports efficient operation of the VRC7900 in temperatures as low as −22° F. (−30° C.).

Exchange Enterprise Data Reliably on Your Vehicle in the Toughest Conditions

The VRC8900 vehicle-mounted mobile computer is a rugged device for use on heavy equipment, especially forklifts. Designed for distribution centers, factory floors and warehouses, the VRC8900 supports real-time receiving, tracking, put-away, picking and shipping applications. The industry-standard Windows CE operating system and full-screen color display reduce training and development costs and increase employee productivity. Sealed to IP65 standards for protection against dust and water and shock-tested to 24 G, the VRC8900 offers reliable performance in the most extreme temperatures and environmental conditions. It tolerates sub-zero freezers, as well as the vibration and pounding of forklift operations, increasing the reach of your enterprise mobility solution.

Business Challenge: Your manufacturing and warehouse facilities have dimly lit areas, making it difficult for workers to read displays.

Solution: Even in varied lighting conditions, your employees can easily read and accurately enter information on the VRC8900's large VGA touch screen, reducing costly process errors.

Business Challenge: If your vehicle-mounted mobile computer isn't functional, neither is your vehicle or your equipment operator.

Solution: The VRC8900 has a rugged housing and a high shock-resistance rating to ensure the uninterrupted productivity of your employees, heavy equipment and processes.

Business Challenge: Your forklift operator needs only minimal data entry capabilities to perform assigned tasks

Solution: The VRC8900's touch screen enables your operators to accurately input data, even while wearing gloves.

Business Challenge: Without protection, wireless networks in industrial environments are just as vulnerable to hacking as corporate wireless networks

Solution: The Kerberos network authentication protocol used to encrypt data traffic to and from the VRC8900 protects your data transmission from unauthorized access.

Box 12

Point to Scan for Fast, Convenient Data Capture

Worn on the left or right index finger and activated by the thumb, the RS-1 Ring Scanner is designed for comfortable, fatigue-free scanning use by employees in inventory and package handling applications. The RS-1 is rugged enough for industrial use, yet it has safety features to protect the user from injuries. The ring scanner is an integral component of Symbol wearable scanning systems, and is also compatible with other Symbol scanning devices

Business Challenge: You have employees scanning inventory all day, every day and they need their hands free to handle materials, goods and packages.

Solution: The wearable RS-1 has a low profile and adjustable strap, which allows convenient scanning without getting in the way of picking and sorting activities. It also weighs only 1.7 ounces (48 grams), reducing fatigue and ensuring the safety of your employees.

Business Challenge: Scanning must be successful on the first pass, so employees don't waste time on re-scans and error-prone manual data entry.

Solution: To increase the accuracy of your scanning activities the RS-1 uses a thumb-activated scanning button and has an indicator light that changes from red to green after a successful scan.

Business Challenge: You need a scanner compatible with other devices, to get the most value from your scanning tools and applications

Solution: You are able to use the scanning engine of the RS-1 with many scanning devices and terminals, enabling use in applications specific to your needs or as a replacement part.

Handle Items with Care and Scan with Greater Accuracy

Employees in inventory and package sorting applications need access to information, yet they also must have their hands free to safely handle items. With its low profile and light weight, the SRS-1 Ring Scanner offers greater freedom of movement, allowing workers to comfortably pick, scan and pack items even in the tightest spaces. The ergonomic design of the SRS-1 maximizes user comfort, with trigger placement equally suited for right- or left-handed use, reducing fatigue and increasing individual productivity.

Business Challenge: Your warehouse employees need an easy-to-use scanner that leaves their hands free to accurately perform high-volume pick and sort activities

Solution: The light, ergonomic form factor of the SRS-1 and its wearable hands-free design allow your employees to perform repetitive scanning tasks for longer periods without errors and without risk of injury from fatigue

Business Challenge: Workers waste too much time trying to determine if a scan has completed.

Solution: The SRS-1 scanner accurately scans codes up to 30 inches (76 cm) from the user and provides a visual indication of each positive scan—eliminating data inaccuracies and wasted effort from duplicate scans.

Business Challenge: You need a scanner capable of being used with your existing mobile devices and host systems.

Solution: You are able to use the scanning engine of the SRS-1 with many scanning devices and terminals, enabling it to be used in applications specific to your needs or as a replacement part

Keep your Hands Free for Faster Item Sorting and Picking with Wearable Scanning and Computing Devices

The WSS1000/1060 utilizes a ring scanner and wrist-mounted computer, so warehouse and shipping employees have both hands free to pick and sort inventory. The wearable scanning system allows them to move freely through inventory aisles and still be able to scan, access information and perform data entry. In packaging applications, the device allows you to reassign employees to different locations as needed to eliminate bottlenecks throughout your shipping operations. Scanning capabilities reduce the input errors common in paper-based tracking. The WSS1000 utilizes batch processing, and the WSS1060 utilizes wireless networking to support real-time data exchange to improve asset control.

Business Challenge: You have employees scanning inventory all day, every day and they need their hands free to handle materials, goods and packages.

Solution: The WSS1000 computer and scanner weighs just 11.3 ounces and is left- or right-hand operable to safely support your employees over full shifts.

Business Challenge: You need up-to-date information about inventory and pick-and-sort operations, but you're not ready to invest in a wireless networking infrastructure.

Solution: The WSS1000 exchanges batch data over a serial connection for efficient data transfer at any time during or after a shift

Business Challenge: You already have wireless networking capabilities and want to use it to track the movement of every package in your shipping operations in real time.

Solution: The WSS1060 has built-in 802.11b WLAN technology, enabling high-volume data transfers of up to 11 Mbps to support real-time tracking of customer packages.

Scan Bar Codes Hands-Free with Greater Accuracy and from Greater Distances

Worn on the back of the hand and triggered by a thumb-activated switch, the WS1200-LR gives your inventory, packaging and shipping employees the easy scanning capabilities of Symbol's ring scanning technology and the added benefit of accurate data capture over long distance. With the ability to scan items from up to 8 feet (2.4 meters) away, your loading dock, warehouse and shop floor employees are able to scan bar codes without getting off their forklift or climbing up a shelving system, increasing their efficiency and safety.

Business Challenge: You need quick and accurate bar code scanning of items on high shelves and on large pallets that are sometimes out of reach from your workers

Solution: The long-range scanning capability of the WS1200-LR supports scanning of bar codes up to 8 feet (2.4 meters) away from the user, allowing your employees to safely remain on the floor to scan. An innovative aim spot beam also increases accuracy of scans

Business Challenge: Your pick and sort employees need to be just as accurate at the end of their shifts as they are at the beginning.

Solution: The WS1200-LR weighs only 3.5 ounces (98 grams) for full-shift scanning productivity without the risk of injury from repetitive motion.

Business Challenge: You need a scanning device able to withstand day-to-day operation in rugged environments, so you don't lose time because of equipment failure. And it should be easy to replace worn-out components at minimal cost

Solution: You minimize device downtime and maintenance costs using the WS1200-LR because the wear items on the scanner—glove, straps, trigger, rubber cover—are easy and inexpensive to replace.

Box 13,

Mobile Computers

Enterprise Class

Symbol enterprise class mobile computers give your managers and executives more information and timelier insights into day-to-day operations. These insights allow them to respond quickly and accurately to changing conditions. A digital assistant gives your decision-makers access to information they need to better manage your supply chain, support employees while out in the field or respond to service issues when meeting with customers. Enterprise class handhelds are durable for use in varied environments, yet small and lightweight enough to encourage consistent use, extending your investments in enterprise mobility

Delivering Real-Time Enterprise Information to on-the-go Professionals

Your managers, executives, doctors and salespeople can't be tied to a desk. To be effective, they have to be on the shop floor, with an important customer, at a patient's bedside or in the retail aisle. With the MC50 enterprise digital assistant, they have immediate access to the most current enterprise information, using both voice and data communications on a single device. Your employees gain the freedom of movement to serve customers and engage in data entry according to the immediate needs of your enterprise, increasing your response to changing conditions and helping all employees be more successful in their jobs.

MC50

Provide Enterprise Professionals Real-Time Access to People and Information with the Voice and Data-Enabled MC50 Digital Assistant with Scanning Capabilities

Business Challenge: To make the right decisions about customer interactions, inventories and workflows, your managers must be able to send and receive timely information at the point of activity.

Solution: Your managers gain uninterrupted access to enterprise applications with the wireless networking capabilities of the MC50, making them more productive and supporting fast and accurate decisions.

Business Challenge: Your managers occasionally need to assume a task-worker role to eliminate bottlenecks in your operations.

Solution: Using the built-in scanning and imaging features of the MC50, your managers are equipped to serve customers, check on inventories, perform line-busting activities and other process-oriented tasks without switching devices.

Business Challenge: An enterprise digital assistant has to stand up to the same tough environments as industrial devices.

Solution: Unlike consumer-grade devices, the MC50 has a durable design to increase device uptime, as well as business-focused input options in support of efficient, accurate data entry

Business Challenge: Your managers need to be accessible by phone, wherever they are working.

Solution: Integrated voice over IP (VoIP) capabilities allow your managers to use the MC50 as a total communications platform, increasing individual productivity and eliminating the costs of buying, deploying and maintaining mobile phones.

Business Challenge: IT departments are already stretched thin; mobile devices add another level of maintenance and management for them to support.

Solution: With the Symbol Mobility Services Platform built into the MC50, the management of mobile devices and applications is automated, reducing support costs and allowing IT departments to focus on core tasks.

Get Enterprise Class Information in a Palm-Sized Device

The Symbol SPT1550 enterprise class mobile computer provides basic scanning and data entry functionality for your employees who are on the move. With standard Palm productivity applications and the ability to scan bar codes, the SPT1550 is an easy-to-use tool for speeding your response to customer needs, improving process efficiencies and increasing the range and accuracy of enterprise information. The simple, intuitive interface reduces your training costs, and the one-touch data synchronization reduces data input errors, increasing the strategic value of collected data. The SPT1550 gives you greater insights into your operations at a cost and management savings over other devices

SPT1550

Make Access to Enterprise Applications Convenient with the Pocket-Sized Palm Powered SPT1550 Mobile Computer.

Business Challenge: To make your data timely and accurate, the synchronization of captured data with your business applications should occur with minimal user effort.

Solution: With the push of a single button, your employees automatically synchronize the data from their SPT1550 device to your host system according to data management rules you establish, reducing data entry errors and giving employees more time for other productive tasks.

Business Challenge: Your sales managers do not work in scan-intensive environments, yet they occasionally need to accurately gather data from bar codes to confirm prices or track inventory.

Solution: A small scan engine on the SPT1550 with left- and right-hand triggers offers you the option of using the device as a scanner in applications where speed and accuracy of data capture are required

Business Challenge: It's costly and expensive to develop applications for your mobile devices

Solution: The Palm operating system is a simple development platform. Its broad industry support and wide availability of tools helps reduce your costs and shorten the development cycle

Business Challenge: Your employees need a device they will easily carry and use

Solution: The light, pocket-sized design of the SPT1550 makes it fit comfortably in the hand and is easily carried in a briefcase or bag for quick access whenever it's needed.

Extend the Enterprise with a Rugged Handheld Digital Assistant with the Palm OS

Symbol's SPT1800 helps you better manage the capture and movement of data both inside and outside the physical confines of your enterprise. To make timely and smart decisions when outside the office, your employees are given access to the same information with the Palm Powered SPT1800 as if they were onsite. In hospitals, resorts, manufacturing plants, delivery trucks, retail aisles—anywhere your workers must have accurate information to efficiently do their jobs—the SPT1800 delivers information quickly, securely and cost-effectively. As a result, you are better able to allocate people and resources in response to customer demands, giving you competitive advantage

SPT1800

Provide in-office access to out-of-office mobile workers with a rugged WWAN-enabled Palm handheld digital Business Challenge: Employees need the same access to information while on the road as they have while on your corporate campus.

Solution: Using the wireless networking capabilities of the SPT1800, your employees make smarter decisions onsite and offsite when they having real-time access to enterprise applications and information.

Business Challenge: Using the wireless networking capabilities of the SPT1800, your employees make smarter decisions onsite and offsite when they having real-time access to enterprise applications and information

Solution: The SPT1800's rugged design and advanced IP54-rated sealing from the elements give you more out of your device investments through longer device lifecycles and uninterrupted operational performance.

Business Challenge: Hackers try to infiltrate your enterprise by snooping on wireless networks.

Solution: The Kerberos data encryption security built in to the SPT1800, together with the security features of Symbol wireless infrastructure products and the Mobility Services Platform software, ensure your data and wired and wireless networks are more secure.

Business Challenge: To lower your training costs, you need to provide easy-to-use applications to your mobile workforce

Solution: The intuitive user interface of the Palm operating system reduces your application training costs, so your employees spend less time learning how to use the device and more time on productive activities.

Box 14,

Mobility Software AirBEAM

Provide Maximum Security for Your Wireless LAN Communications and Maximum Manageability for Your Mobile Device Software and Wireless LAN

AirBEAM's trio of mobility software solutions brings a new level of manageability to the software installed on your mobile devices, the security of your wireless communications and manageability of your Spectrum24 wireless LAN. Provide maximum protection for data traveling over your wireless LAN with AirBEAM Safe's wireless virtual private network (VPN). AirBEAM Smart allows your administrators to quickly, easily and remotely manage the software on your mobile devices. And AirBEAM Manager delivers the ability to remotely install, configure, monitor and manage all of your Spectrum24 access points from a single central location.

Symbol's AirBEAM Suite of Mobility Software Solutions—the Security and Manageability you Need to get the most out of Your Symbol Enterprise Mobility

The Power to Manage Every Aspect of Your Enterprise Mobility Solutions

Regardless of whether your enterprise mobility solution is comprised of all Symbol mobile devices or includes devices from other manufacturers, or whether your wireless infrastructure includes first-generation access points or next-generation wireless switches and access ports—or both—Symbol's comprehensive family of mobility software products provide the control you need to drive management costs down—and employee, security and network performance up.

Peak Performance and Manageability for Your Spectrum24® Symbol Wireless LAN Infrastructure

AirBEAM Manager provides a single point of control for your Spectrum24 wireless LAN. Administrators can install and configure access points remotely from a central console located anywhere in your network. The need to physically handle each access point is eliminated. Real-time visibility provides the power to monitor and manage your wireless LAN in real time—administrators can instantly identify and resolve network issues before performance is impacted, keeping your network available and your employees productive.

This complete package provides the tools you need to simplify and reduce the costs of management, maximizing the availability, security and effectiveness of your Spectrum24 wireless LAN. AirBEAM Manager—improving the return on investment and reducing the total cost of ownership for your Spectrum24-based wireless LAN

Business Challenge: You want to maximize your investment in your Spectrum24 WLAN.

Solution: AirBEAM Manager provides maximum uptime and peak performance for your Spectrum24 WLAN, protecting employee productivity as well as increasing your return on investment.

Business Challenge: You want to reduce the time and costs associated with management of your Spectrum24 WLAN.

Solution: Dramatically reduce the time and costs associated with managing individual access points with automatic discovery and configuration, and templates that automate configuration changes

Business Challenge: You would like to be able to be more proactive in planning for future network needs.

Solution: The ability to track and analyze trends in network traffic and usage, combined with the ability to customize reports provides the information you need to ensure you meet the network needs of your company today as well as tomorrow.

Solution

AirBEAM

AirBEAM's trio of mobility software solutions brings a new level of manageability to the software installed on your mobile devices, the security of your wireless communications and manageability of your Spectrum 24 wireless LAN

Robust Security for All Your Wireless Communications

When you need the equivalent of the end-to-end airtight security of a virtual private network (VPN) in the wired world, AirBEAM Safe delivers. Strong end-to-end encryption helps protect all your mobile handheld and notebook computers and resident data from hackers or other intruders with the highest level of wireless protection possible. Designed for wireless networks, AirBEAM Safe includes unique features, such as roaming, that enable users to move from your office WLAN to a WLAN in an airport or coffee shop, as well as a WWAN, without losing coverage or needing to repeat the logon process. AirBEAM Safe—superior performance, superior security

Business Challenge: You need to provide the highest level of security for your wireless data communications

Solution: AirBEAM Safe's wireless VPN provides true end-to-end encryption with the strongest security standards available, providing the highest level of protection possible for your wireless data.

Business Challenge: You don't want to sacrifice performance for security—you want both.

Solution: AirBEAM Safe deploys special optimization techniques that eliminate the usual decrease in transmission speed common with VPNs. The ability to roam between WLAN and WWAN networks ensures connectivity whether traveling between buildings on the campus, across town or in another city

Business Challenge: You want to provide your employees with maximum data protection, simply and easily—no matter where the workday takes them

Solution: AirBEAM Safe could not be easier to use. Network and device independence automatically provides support for all your devices and applications. And moving from network to network is seamless—the logon process doesn't need to be repeated as employees move from one WLAN to another (for example from the work WLAN to an airport WLAN), or to a WWAN (for example, when in a taxi and out of range of any WLAN).

Business Challenge: You want a solution for today and tomorrow

Solution: Scalable and able to meet future needs, AirBEAM Safe provides investment protection, and a lower total cost of ownership.

Manage the Software on your Mobile Devices—Automatically, Remotely and Cost-Effectively

Give your administrators the power to quickly, easily and remotely manage the software for your mobile devices. With AirBEAM Smart, your employees always start the day with the most recent applications, operating systems and firmware, ensuring maximum uptime and productivity. Updates can be performed either automatically when powered on, or on demand, delivering the flexibility to conveniently pre-schedule updates or update as needed to resolve end-user device issues. AirBEAM Smart—reducing management costs and the total cost of ownership for your Symbol enterprise mobility

Business Challenge: Ongoing management of software on mobile devices is too time-intensive and costly, often diverting IT staff attention away from more strategic tasks.

Solution: The ability to automatically, remotely and wirelessly update applications, operating systems and firmware on mobile devices eliminates the time and costs associated with software management—reducing the total cost of ownership for enterprise mobility solutions and freeing IT staff to focus on more critical tasks.

Business Challenge: Eliminate the high cost of manually deploying new mobile devices in enterprise mobility solutions.

Solution: AirBEAM Smart provides the ability to automatically and remotely configure and load appropriate software on new devices, eliminating the need for pre-staging and manual configuration—and the associated costs.

Business Challenge: Software version control is becoming a costly issue—employee productivity is reduced when devices that are not upgraded in a timely fashion can't function properly due to software incompatibility, and IT support staff time is wasted identifying the issue as well as manually managing the version control process.

Solution: AirBEAM Smart automatically and accurately identifies installed software on all devices as well as any software that requires updating

Manage Mobile Devices, Mobile Applications and Wireless Infrastructure from a Single Point of Control

Simplify and reduce the costs of managing your enterprise mobility solution with anywhere, anytime end-to-end visibility and control of all your mobile devices, mobile applications and wireless infrastructure. This scalable solution is ideal for any size environment—from a single corporate office or many locations around the world, and from hundreds to thousands of handheld computers, bar code scanners, wireless switches, access points and other mobile devices. And this single management system provides the flexibility to support your heterogeneous enterprise mobility solution—a single management system that supports all Symbol wireless infrastructure and mobile devices and Windows CE- and Pocket PC-based mobile devices.

MSP

Deploy, manage and support your entire enterprise mobility solution—mobile devices, mobile applications and wireless infrastructure—with unparalleled simplicity

Business Challenge: The daunting task of deploying the hundreds or thousands of devices required to support your enterprise is time consuming, very costly and complicated further by the fact that you have multiple office locations

Solution: MSP's powerful templates enable your administrators to quickly configure and deploy any number of devices, remotely and cost effectively, wherever they are located. Thousands of devices can be deployed in minutes instead of months, dramatically reducing the time and costs associated with initial and ongoing device deployment.

Business Challenge: Keeping software updated on mobile devices requires your administrators to physically locate and connect the devices to a PC. Not only is this an extremely time consuming and costly task, it also impacts user productivity while devices are being updated.

Solution: MSP delivers the power to remotely and automatically manage the applications, operating systems and firmware on your mobile devices, regardless of location. Updates that took weeks now take minutes, dramatically reducing the time and cost associated with ongoing software management

Business Challenge: You need to be able to support your end users and troubleshoot mobile device issues faster and more cost-effectively

Solution: MSP provides remote real-time visibility into a wide variety of mobile device metrics, enabling IT staff to quickly and easily identify and resolve end-user mobile device issues. IT staff time required for support is minimized—along with your support costs.

Business Challenge: Your wireless infrastructure is not easy to manage or control; issues are not visible in real time, often developing into major problems that impact performance. Deploying security is complex and costly. And your wireless LAN performance is not consistent or optimal, affecting network availability—and employee productivity.

Solution: MSP provides a single point of control for your entire wireless LAN infrastructure—whether you have one or many locations. Instant notification of network issues allows timely resolution before performance is impacted. Robust authentication and encryption security mechanisms can be quickly and easily deployed throughout your organization. And visibility into wireless network infrastructure metrics provides the information you need to keep your wireless LAN operating at peak performance, with maximum uptime

Simplify and Reduce the Costs of Managing Your Local or Worldwide Symbol Wireless LAN

Eliminate the complexities of managing a distributed wireless LAN network, from a single stand-alone campus-style environment to a worldwide network of branch offices. No matter where in the world your WLANs are deployed, SEMM 2.0 provides the visibility and management capabilities to keep your Symbol wireless and Ethernet switches, access points and access ports operating at peak performance. And one size fits all with this scalable management solution, which provides the flexibility to grow as your network needs grow and change, providing centralized control of your worldwide WLANs today and tomorrow

Business Challenge: You would like to reduce the time and cost associated with managing the components of your WLAN infrastructure—whether you have a single location or multiple locations throughout the world

Solution: Management time and costs are dramatically reduced through the ability to automatically discover and configure WLAN infrastructure, and simultaneously configure groups of devices through easy-to-use templates.

Business Challenge: Your wireless LAN is deployed in multiple locations that must be managed locally. Onsite management personnel and a management system are required at each location—you would like to eliminate the required duplication of effort, technology and costs.

Solution: SEMM 2.0 enables management of your WLANs in all your locations—from local to global—from a data center or your Network Operations Center (NOC).

Business Challenge: You do not have the information you need to project and plan for future network needs

Solution: The availability to collect and analyze historical data on a global basis enables proper planning—and budgeting—to meet future network needs.

Business Challenge: You do not receive timely notification as device failures occur, resulting in major wireless network performance issues, downtime and reduced workforce productivity.

Solution: SEMM 2.0 instantly identifies and sends instant notification of any device failures in real time, enabling the most prompt response. Network uptime is increased, and workforce disruptions due to an unavailable WLAN are reduced.

Business Challenge: Deploying security for WLANs in multiple locations is time consuming and complex.

Solution: SEMM 2.0 provides a single global user authentication database for all locations, simplifying and reducing the costs of deploying and managing security throughout the distributed enterprise

15,

All the shaded blocks are where direct combinations of TRAC technology and Symbol products can be combined and integrate 15 a Box is the wireless RFID components interfacing with box 15 combinations to deliver tracking and telemetry data with the wireless PS-1 HS-1 via Symbol PFNS.

Box 15a

RFID

Handheld Readers

Support Your Data Capture and Management Applications with Enterprise-Class Multi-Protocol RFID Readers

Symbol's radio frequency identification (RFID) readers wirelessly capture information essential for optimal operations, improve efficiency by automating manual processes and protect the value of your technology investment. Designed for enterprise environments, our open standards-based fixed and handheld readers offer multi-protocol reading and writing capabilities, enabling you to rapidly identify and track assets labeled with Generation 1 Class 0 and Class 1 Electronic Product Code (EPC)-compliant RFID tags. With built-in dense reader functionality, long read range capabilities and high read rates, our readers are ideal for environments where you need to deploy and manage multiple read points to ensure visibility into each key stage of your business processes. Symbol's readers are designed for quick deployment, long life and seamless interoperability with all the elements in your data infrastructure, throughout your enterprise.

MC9000-G RFID

Raise Your Supply Chain Awareness with a Rugged RFID Reader/Writer and Bar Code Scanner in a Single Handheld Computer.

RFID

Fixed Readers

Support Your Data Capture and Management Applications with Enterprise-Class Multi-Protocol RFID Readers

Symbol's radio frequency identification (RFID) readers wirelessly capture information essential for optimal operations, improve efficiency by automating manual processes and protect the value of your technology investment. Designed for enterprise environments, our open standards-based fixed and handheld readers offer multi-protocol reading and writing capabilities, enabling you to rapidly identify and track assets labeled with Generation 1 Class 0 and Class 1 Electronic Product Code (EPC)-compliant RFID tags. With built-in dense reader functionality, long read range capabilities and high read rates, our readers are ideal for environments where you need to deploy and manage multiple read points to ensure visibility into each key stage of your business processes. Symbol's readers are designed for quick deployment, long life and seamless interoperability with all the elements in your data infrastructure, throughout your enterprise

XR400

Automate high-performance, multi-protocol RFID tag reading and writing, and scale your system in response to your changing global enterprise business requirements.

AR400

Speed inventory management processes by deploying a proven, reliable reader solution at critical read zones

RFID

Antennas

Achieve efficient inventory tracking and asset management with comprehensive RFID antennas

With radio frequency identification (RFID) antennas from Symbol, you have the versatility and performance needed to accurately track inventory movement from any point in your enterprise and create superior read zones to deliver precise, uninterrupted reader-tag communications. Our High-performance Area Antennas provide long-range and large-area RFID tag reading, bringing RFID operational efficiency to environments that previously were too large to accommodate advanced wireless data communication applications

High Performance Area Antennas

Accelerate production capacity with high-performance radio frequency identification (RFID) area antennas

Symbol protocol set up technologies aid interfacing

RFID

RFID Kit

Quickly Deploy RFID for Wireless Data Capture

The RFID Kit from Symbol Technologies provides a fully functioning advanced data capture system for quick deployment of pilots and small- to medium-sized data capture applications. This kit enables you to deploy a complete RFID system to demonstrate and quantify the benefits of RFID in your specific environment.

Designed for quick and easy implementation, the Symbol RFID kit includes an advanced, multi-protocol RFID reader, antennas, tags and more:

100 UHF RFID read-only tag inlays

Reader Network Components:

AR400 advanced reader

Choice of high-performance area antennas or dual directional panel antenna array Cables

Power supply

System software and documentation

The Symbol RFID Kit delivers real-time visibility through unique identification of products and physical assets moving into and out of critical read zones. Ideal for small, focused deployments, this RFID kit enables you to effectively and affordably demonstrate integration with your current business processes while laying the groundwork for a cost-effective upgrade path.

Agile, Multi-Protocol Reader for High-Speed Read Rates

The Symbol AR400 advanced reader is an industrial-class, fixed reader that provides all of the RFID and control functions for superior, accurate data capture. A ready-to-connect intelligent network element transforms into an SNMP-managed networked hub that collects, writes, processes and communicates information from all EPC™-compliant classes of RFID tags. The AR400 has a rich feature set that includes tag filtering, reconciliation, user-defined association and selective visibility. The AR400 is easily adapted and configured to perform application-specific tasks.

A Comprehensive Suite of Application-Specific RFID Tag Inlays

Passive, EPC-compliant RFID tags are easily attached to containers, boxes, pallets, trays, totes and physical assets. These thin, flexible labels with RFID inlays contain a unique product identifier or EPC that enables you to track products and assets moving through your specific supply chain application. When materials with RFID tags pass through portal or dock doors, the AR400 reader captures the identification and immediately communicates the data back to a central database, providing real-time, dynamic data capture for significantly increased visibility.

Two Powerful Antennas to Create Superior Read Zones

The Symbol RFID kit gives you two antennas to choose from: High-Performance Area Antennas and Dual Directional Panel Antenna Arrays. High-Performance Area Antennas are general-purpose antennas for long range and large area RFID tag reading. Dual Directional Panel Antenna Arrays deliver maximum RFID performance in a compact, low-profile housing that is suitable for indoor and outdoor environments. Easy to deploy with the AR400, these antennas are ideal to create superior, application-specific read zones.

Symbol RFID Kit for Effective, Affordable Deployments

The RFID kit complements the portfolio of Symbol enterprise mobility solutions that enables organizations to capture, move and manage critical information to and from every point of business activity. Designed for small- and medium-sized deployments, this RFID kit offers a packaged solution for a faster, more streamlined implementation and increased access to real-time information.

Services for a More Successful Mobility Solution

Symbol offers a full suite of services, including complete analysis, design, installation, training and ongoing support for the seamless deployment, management and continued support of your RFID solution.

RFID Kit Specification Highlights

The actual read or write range of any given tag/inlay will vary based upon its usage and the application environment that it is used in. NOTICE: Repairs of this product may require the use of Symbol proprietary parts (and/or Symbol proprietary information). Symbol will sell these parts (and provide this proprietary information) only to end-user customers for self-service. It is Symbol's policy not to sell these parts to third-party service providers and not to allow a third-party service provider to act as an ordering or receiving agent for the parts necessary to repair this product. Applicable in the U.S. For all other countries, please contact your Symbol account manager or the local Symbol Customer Service representative in your area for further details.

RFID

Reader Systems

Improve Response and Lower Costs with Automated Tracking of Products in Motion

Symbol's DC600 and DC400 portal systems enable you to quickly and easily deploy radio frequency identification (RFID) technology where needed to accurately track assets, products and cargo moving into and among your facilities and storage areas. Rugged and easy to install, our solution packages provide you proven readers and high-performance antennas in turnkey, portal RFID implementations—helping you lower your total cost of ownership and maximize uptime.

These components are interfaced in local fixed operations as well and are further detailed in Box 2

DC600 Portal System

The turnkey, enterprise-class DC600 Portal System offers you the ability to quickly gain visibility into your inventory through easy-to-deploy radio frequency identification (RFID) technology

DC400 Portal System

Increase visibility at critical shipping and receiving read zones with the turnkey DC400 Portal Solution

Tags and Inlays

Identify products and assets for rapid, accurate radio frequency identification (RFID) capture and movement to reduce operational costs and improve response.

16

Symbol has some Remote Control RC capability throughout its architecture and some high level portable interfacing with its wireless products. TRAC technology augments this with PFN repeating stations in vehicles and equipment and the Trusted Remote Activity Controller provide local robotics and local processing have really robust RC and telematric control over connected vehicles and machines to provide the optimum first responder possibilities(no human contact with dangerous material equipment substances and people. This TRAC enhancement also has great commercial value in efficient business operations to service any public of customer base.

17,

The seventeen arrow shows the general data delivery of symbol products in a Symbol Intranet. TRAC Technology enhances Symbol's intranets by adding real-time product communication with business centers via the PFN relay stations interfaced on all prime movers/material handling equipment and transportation vehicles. The PFNs also allow these business centers to query PFNs for lost product or to report lost product if encountered, even if the PFN is on another company's truck or piece of equipment. Because the local PFN can divert data to numerous electronic addresses, more than one network can be updated more efficiently to include a TRAC Homeland Security Program Termed FACT for Federal Access Control Technology. Data in a specific application manner that allows for commercial privacy and security as well as government agency privacy while attaining and providing quick usable data for public safety/national security and efficient movement management.

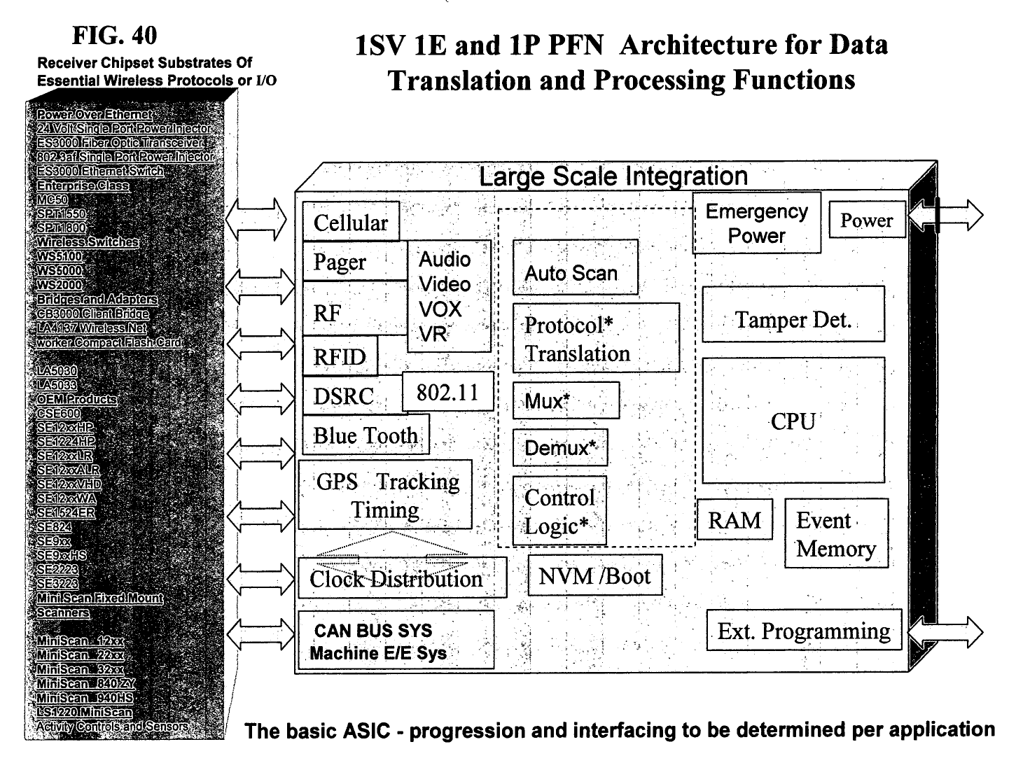

FIG. 40

FIG. 12 is basically the same and FIG. 13 is identical to slide 6 in the Symbol-TRAC presentation of the TRAC Application Specific Integrated Circuit or (ASIC) required to support and relay Symbol's RFID and Bar code products and data via long range wireless to multiple electronic addresses, intranets and or networks of intranets and internet if so desired. This local Relay Station/Equipment Controller circuit as stated earlier is also capable of being remotely programmed or preprogrammed to respond via robotics to Symbol data received and recognized through being a host piece of equipment it is electrically interfaced with.

FIG. 40 which is slide 6 in the Symbol-TRAC integration presentation gives an exemplary compliment of Symbol products interfaced and or integrated through this TRAC circuit design. Either as a hardware connections or dedicated short range wireless communication via transceiver chipsets with Symbol software or firmware impregnated or down loaded into the memory and processor unit.

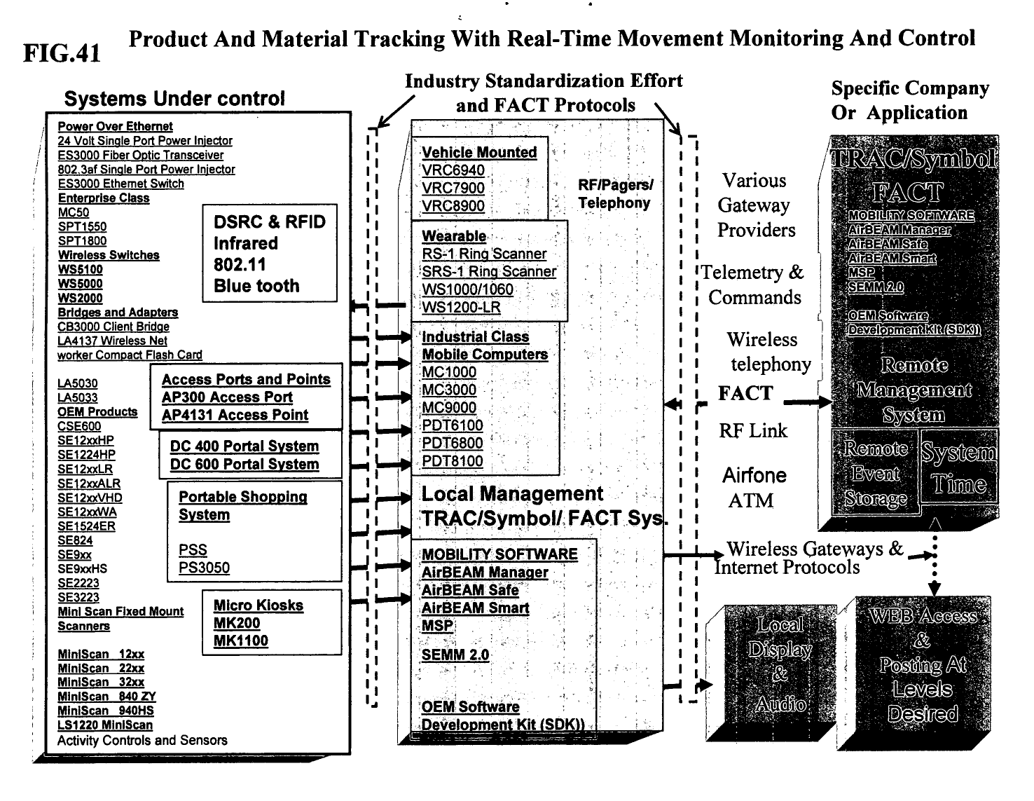

FIG. 41

Slide 7 in the Symbol-TRAC Presentation is FIG. 14 in this specification and is well detailed. In FIG. 14 of this specification the PFN unit or DRC drive resource Center as it is referred to is interfaced with the E/E system of the vehicle of CAN BUS. Along with being a Relay Station the reader can see the processor has all the connections to serve as a vehicle controller as well. While this FIG. 14 or slide 7 depicts the local service and control in the center of the figure the lower porting shows banks of computers to where data is transmitted to via wireless RF and or Telephony Satellite and cellular to mention a few.

Two sets of computers are represented by the Acronyms TRAC and FACT. They mean Trusted Remote Activity Control and Federal Access Control Technology. This is the PFN/TRAC System with FACT Security program and FIG. 6 in this specification illustrates the architecture. FIG. 6 in this specification is the same as slide 8 in the Symbol-TRAC Presentation and FIG. 41 is slide 9 in the presentation.

The remainder of the slide show presented to Maru Benni/Symbol integrating their products with TRAC technology used figures from this specification and will not be repeated. FIG. ______ from this specification is slide 10 in the presentation and FIG. ______ is slide 11 and FIG. ______ is slide 12. All these figures are detailed in this specification and earlier provisional as well as, other filings. The additional slides in the presentation detailing the TRAC Symbol interface architecture and application of RFID, Barcode technology are shown as FIGS. 36, 37, 38, 39, 40, 41. Symbol technology is exemplary of RFID, Bar Code and wired and wireless PFN interfacing locally and for a commercial and security matrix of networks.

1. An electronic socioeconomic, environmental, management and security system is claimed comprised of secure personal, mobile, and or portable wireless and or connected input terminals that are router/relay stations/controllers and link local input data and equipment data and short range sensor data and or alert signals to industries, commerce, corporations, communities, organizations, technologies, networks, mass data systems, civic groups, local government, state government, research centers, scientists, universities, academic centers, banks, monetary systems, the electronic payment industry, the electorate, legislatures, the courts and the individual citizen with equipment and or application relevant federal and government agencies, and services that maintain equipment registries and data systems to monitor relevant data equipment and or application, environment and societal infrastructure to analyze, evaluate, prepare and report on performance and condition of same to all of the above, and assess usage and wear values and bill and receive taxes and or fees per appropriate use of equipment, vehicles, machines, materials and societal infrastructure as well as, maintain express connection and service throughout the system and with NENA numbers to law enforcement, Homeland Security, DOT, FBI, FEMA, etc. and emergency services with accountability via memory storage in the local secure terminal/router/relay station/controller for all applications, that is optionally termed Primary Focal Node or PFN and with duplicate remote memory storage in the network and or mass data storage facilities as an, integrated and or interfaced part of a machine messaging intranet and or Internet/network with a focus on movement management of people, materials, equipment and vehicles and optionally termed The Primary Focal Node/Trusted Remote Activity Control System, or PFN/TRAC System, which additionally provides security monitoring and aggressive remote control through the secure terminal connection in the vehicle or machine interfaced, which is optionally termed Federal Access Control Technology or The FACT Security Program.

2. A claim according to claim 1 is made for electronic security to include interfacing the latest and or most appropriate identity recognition technology including any standard voice recognition, finger or palm recognition, eye/iris or face recognition technology, biometrics identity technology, standard ID systems, PIN number or security codes, cards, smart cards, barcode, electronic tags RFID passive and active, and or DNA recognition technology, or odor detection technology; and further including any casual or covert sensing application for identifying persons through referencing an individual that is assigned an RFID component, or has an operating Bluetooth, 802.11 device, Easy Pass, Mobile Electronic Gas Pass, Smart card, and or any unique electronic signal, yielding a unique electronic serial number, or providing an identifying data packet to include but not limited to wireless telephony and or short range communications, queried for, sensed or received by any component of the PFN/TRAC System or any security or electronic management and or control system for the purpose of identifying all such unique signals as a detection modality to locate possible relevant individuals as part of gathering information/evidence surrounding an event, either mysterious or criminal or an event identified by the system via robotics or preprogramming or post an event identified by investigators or analysts who query the system via a data search for all relevant data recovered within the event timeframe, optionally regarding the operation or movements of people, materials, objects, machines and or vehicles

3. A claim according to claim 1 is made for the invention's management system as an economic tool for society to evaluate aircraft, vehicles, equipment, machinery, transportation platforms and policies, types of energy employed per application, and technology impacts in general on the environment, the public's health and the nation's infrastructure; via the invention's real-time recording, reporting and processing of input data, the analysis of that data to include all public, voices, commercial interests and government decisions, thereby automating; the data accumulation, assessment, and decision making, as well as, maintaining transparent accountability and delivering appropriate charges/fees or taxes for the appropriate impacts and providing electronic collection/accounting of same to better and more efficiently provide for public safety, a healthy public, the best infrastructure and services that serves to provide the most coordinated responsive structure for national security and the Homeland Security Department HSD.

4. A claim according to claim 1 is made for the management and security system of the invention to have special protected and isolated mass data system with secure data links to individual secure terminals/ballot boxes that report to the mass data system for the national, state and local voting; the secure data links connect physically and electronically protected ballot boxes/terminals optionally termed PFN Ballot boxes and designed and constructed as the protected PFN/TRAC units, which may optionally be used in this voting process, so that the terminal/ballot box recognizes individual identities;
via the latest and or most appropriate identity recognition technology including any standard voice recognition, finger or palm recognition, eye/iris or face recognition technology, biometrics identity technology, standard ID systems, PIN number or security codes, cards, smart cards, barcode, electronic tags RFID passive and active, and or DNA recognition technology, or odor detection technology, or through a government voters card/Social Security Card, National ID card, Secure license/State or Federal card issued or device;
voter privacy is maintained for how an individual votes, and with the voter providing the appropriate identity data again can at anytime there after receive voting confirmation of how they voted upon a legitimate personal request for that information from the system, so that any individual can see their voting activities with their vote number in count to the total votes cast in real-time for each issue or constituent they cast their vote for; and print a receipt at the time they queried the isolated system;
an isolated mass data system that issues a non descript number to each individual voter that can be used to confirm legitimacy with no means to identify the voter personally so that voters can then re-enter their individual data to tracking websites run by concerned citizens, private interests groups, and or worthy and respected press websites and universities to quickly process all submissions again/simultaneously to check for any impropriety at the mass data system, making it extremely impossible to cheat in the process.

5. A claim according to claim 1 is made for an electronic national security control system with specially developed encrypted software, control centers and a national Homeland Security Department HSD Control Center with secure data links and direct command communications to connect or be connected to a progressive volume of mass data systems, land line processors, wireless processors, routers, relay stations, controllers and wireless sensor arrays, material tracking and telemetry systems, smart positioning technologies to provide movement and conditional data with local, regional and national connectability, integration and interface for government and privately owned and or commercially owned systems, vehicles and equipment to be monitored and controlled as to their movement of materials, machines and vehicles in real-time or near real-time to create and maintain mobile boarders, for public safety and national security, via using wireless control to slow, stop and secure and or control movement of materials and transport equipment via remote control of any transport vehicle, material handling equipment and or machine;
legitimately ordered and performed by Federal Officials/State Officials/Appropriate Local Officials and legitimate first responders to be optionally Termed Federal Access Control Technology or FACT Security Program.

6. A claim according to claim 1 is made for a system progression and commercial development in movement management through efficient commercial and cooperative development of global security with international growth and connect-ability and interface via structuring diplomatic, commercial and technical arrangements with tracking and telemetry technologies, wireless communications, global positioning systems and or smart location technologies, wireless sensor technologies and identity system technologies, and all countries and companies using these technologies, licensing them and or producing these products.

7. A claim according to claim 1 is made for the management and or security/control system to be structured in compliance with any existing or future standard, code, law, rule, legislation, regulation and or government RFIP, etc.

8. A claim according to claim 1 is made for the specific interface of RFID products to include but not be limited to Symbol products and inventories for monitoring either passive or active reading or sensing of materials, objects, animals and people for movement monitoring and, projected movement management of materials to include monitoring data bases/intranets, used to aid corporate management to increase product security, reporting on fixed locations or mobile data recovered in real-time data streams to include but not be limited to time data, product ID location data and tracking ID data either scanned in manually and or entered automatically during the commercial transport and transportation management process.

9. A claim according to claim 1 is made for a Primary Focal Node PFN interface and Trusted Remote Activity Controller or TRAC processor that provides stable protected wireless repeating/translation capacity for multiple electronics interfaced with additional functions as an accountable tool to include an aggressive equipment controller for materials, equipment, machines and vehicles.

10. A claim according to claim 1 is made for a series electrical platform Self Powered with Short range wireless communications as an independent sensor array optionally termed the PS-1 or the HS-1 when employed for Homeland Security which sends signal per application to wireless gateways or Primary Focal Nodes, additionally referred to as the PFN relay station.

11. A further claim according to claim 1 is made for self Powered Short range independent wireless sensor arrays optionally termed PS-1 and or HS-1 for Homeland security Sensor to detect and send Alert signal and or data application specific to any necessary sensing requirement for public safety and national security to any Primary Focal Node or PFN relay station/Trusted Remote Activity Control unit or wireless gateway.

12. A claim according to claim 1 is made for a remote control interface optionally termed a Primary Focal Node or PFN to interface with transportation prime movers like trucks and forklifts, for repeating signal or data to a wireless gate way/Intranet or commercial intranets or sets of data bases and to be optionally termed the PFN/TRAC System

13. A claim according to claim 1 is made for the secure/terminal/interface processor/router/relay station/controller optionally termed the Primary Focal Node or PFN to interface with transportation prime movers to include, but not be limited to; trucks and forklifts, cars, rail cars, ships and boats, aircraft, vehicles in general, material handling equipment and machines in general for repeating signal to the optionally termed Primary Focal Node/Trusted Remote Control System or PFN/TRAC System and or any commercial intranets or data bases.

14. A claim according to claim 1 is made to provide for the remote control and robotics of transportation prime movers to include, but not to be limited to; trucks and forklifts, cars, rail cars, ships and boats, aircraft, vehicles in general, material handling equipment and machines in general via special standards, legal processes and protocols detailed through out all the PFN/TRAC filings on the control of equipment, vehicles and machines which is accessible to government and optionally termed Federal Access Control Technology or FACT Security Program:

15. A claim according to claim 1 is made for the monitoring and control network option/matrix of government agencies and first responders that utilize local commercial automation remote control and robotics for legitimate first responder public safety and national security applications via hybrid cellular devices, RF devices wireless PDA terminals or personal and equipment PFN controllers or responsive command and control centers.

16. A claim according to claim 1 is made for an electrical interface platform optionally termed the Primary Focal Node or PFN or PFN/TRAC unit to additionally be a stable protected wireless repeating/translation station for multiple electronics protocols, optionally for spoken languages, and additionally interfacing and recording machine messaging to function as an accountable router for command strings for aggressive equipment control of materials, equipment machines, and or vehicles.

17. A claim according to claim 1 is made for any standards, legal processes and equipment control protocols regarding the appropriate handling of remote control equipment and data either for evidence or any other application, and as further detailed throughout related filings to this specification and is optionally termed the PFN/TRAC filings or system which further include critical data and control descriptions of equipment regarding accessible management and remote control of equipment by legitimate government officials/first responders and optionally refer to as Federal Activity Control Technology or FACT Security.

18. A claim is made according to claim 1 for a monitoring and control network option or matrix of government agencies and first responders to utilize local commercial automation, remote control and robotics for legitimate first responder public safety and national security applications, via hybrid cellular phone technology, RF controllers/hand held computers, wireless PDAs or the proprietary personal and equipment PFN/TRAC units and PS-1 controllers or via any responsive command and control center.

19. A claim according to claim 1 is made for a commercial and governmental system to have data and material handling coupled with electronics manufacturers already established in the transportation markets to include Symbol and symbol products but not be limited to, with ID scanning products, sensing and material tracking programs, to develop an aggressive accountable remote control and movement management system; optionally termed the Primary Focal Node or PFN/TRAC System with The optionally termed security program termed FACT Security for national and global movement management and security in transportation, and as an integrating master interface architecture for The Homeland Security Department.
